(19) United States
(12) Patent Application Publication
(10) Pub. No.: US 2025/0184093 A1
(43) Pub. Date: Jun. 5, 2025

(54) Feedback Operation for Multi-slot Transmission in Non-terrestrial Networks

(71) Applicant: Ofinno, LLC, Reston, VA (US)

(72) Inventors: Mohammad Ghadir Khoshkholgh Dashtaki, Reston, VA (US); Ali Cagatay Cirik, Chantilly, VA (US); Esmael Hejazi Dinan, McLean, VA (US); Hua Zhou, Vienna, VA (US); Hyoungsuk Jeon, Centreville, VA (US); Nazanin Rastegardoost, McLean, VA (US)

(73) Assignee: Ofinno, LLC, Reston, VA (US)

(21) Appl. No.: 19/048,475

(22) Filed: Feb. 7, 2025

Related U.S. Application Data
(63) Continuation of application No. PCT/US2023/029789, filed on Aug. 8, 2023.
(60) Provisional application No. 63/396,090, filed on Aug. 8, 2022.

(51) Int. Cl. H04L 5/00; H04W 72/1263

(52) U.S. Cl. CPC H04L 5/0055; H04W 72/1263

(57) ABSTRACT

A wireless device receives one or more configuration parameters for disabling hybrid automatic repeat request (HARQ) feedback. The one or more configuration parameters indicate one or more feedback enabled downlink HARQ processes and one or more feedback disabled downlink HARQ processes. The wireless device receives a downlink control information (DCI) scheduling multiple transport blocks (TBs). The wireless device receives the multiple TBs. The wireless device transmits multiple HARQ-acknowledgments (HARQ-ACKs) information corresponding to the multiple TBs. A HARQ process, associated with a first TB of the multiple TBs, is a feedback disabled HARQ process.

### CROSS-REFERENCE TO RELATED APPLICATIONS

This application is a continuation of International Application No. PCT/US2023/029789, filed Aug. 8, 2023, which claims the benefit of U.S. Provisional Application No. 63/396,090, filed Aug. 8, 2022, all of which are hereby incorporated by reference in their entireties.

### BRIEF DESCRIPTION OF THE DRAWINGS

Examples of several of the various embodiments of the present disclosure are described herein with reference to the drawings.

FIG. 1A and FIG. 1B illustrate example mobile communication networks in which embodiments of the present disclosure may be implemented.

FIG. 2A and FIG. 2B respectively illustrate a New Radio (NR) user plane and control plane protocol stack.

FIG. 3 illustrates an example of services provided between protocol layers of the NR user plane protocol stack of FIG. 2A.

FIG. 4A illustrates an example downlink data flow through the NR user plane protocol stack of FIG. 2A.

FIG. 4B illustrates an example format of a MAC subheader in a MAC PDU.

FIG. 5A and FIG. 5B respectively illustrate a mapping between logical channels, transport channels, and physical channels for the downlink and uplink.

FIG. 6 is an example diagram showing RRC state transitions of a UE.

FIG. 7 illustrates an example configuration of an NR frame into which OFDM symbols are grouped.

FIG. 8 illustrates an example configuration of a slot in the time and frequency domain for an NR carrier.

FIG. 9 illustrates an example of bandwidth adaptation using three configured BWPs for an NR carrier.

FIG. 10A illustrates three carrier aggregation configurations with two component carriers.

FIG. 10B illustrates an example of how aggregated cells may be configured into one or more PUCCH groups.

FIG. 11A illustrates an example of an SS/PBCH block structure and location.

FIG. 11B illustrates an example of CSI-RSs that are mapped in the time and frequency domains.

FIG. 12A and FIG. 12B respectively illustrate examples of three downlink and uplink beam management procedures.

FIG. 13A, FIG. 13B, and FIG. 13C respectively illustrate a four-step contention-based random access procedure, a two-step contention-free random access procedure, and another two-step random access procedure.

FIG. 14A illustrates an example of CORESET configurations for a bandwidth part.

FIG. 14B illustrates an example of a CCE-to-REG mapping for DCI transmission on a CORESET and PDCCH processing.

FIG. 15 illustrates an example of a wireless device in communication with a base station.

FIG. 16A, FIG. 16B, FIG. 16C, and FIG. 16D illustrate example structures for uplink and downlink transmission.

FIG. 17 shows several DCI formats.

FIG. 18A shows an example of a non-terrestrial network.

FIG. 18B is an example figure of different types of NTN platforms.

FIG. 19A shows an example of an NTN with a transparent NTN platform.

FIG. 19B shows examples of propagation delay corresponding to NTNs of different altitudes.

FIG. 20 shows an example embodiment of a HARQ operation/procedure in wireless communications systems per an aspect of the present disclosure.

FIG. 21 shows an example embodiment of a HARQ operation/procedure in wireless communications systems per an aspect of the present disclosure.

FIG. 22 shows an example embodiment of a HARQ operation/procedure in wireless communications systems per an aspect of the present disclosure.

FIG. 23 shows an example embodiment of a HARQ operation/procedure in wireless communications systems per an aspect of the present disclosure.

FIG. 24 shows an example embodiment of a HARQ operation/procedure in wireless communications systems per an aspect of the present disclosure.

FIG. 25 shows an example embodiment of a HARQ operation/procedure in wireless communications systems per an aspect of the present disclosure.

FIG. 26 shows an example embodiment of a HARQ operation/procedure in wireless communications systems per an aspect of the present disclosure.

FIG. 27 shows an example embodiment of a HARQ operation/procedure in wireless communications systems per an aspect of the present disclosure.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. In fact, after reading the description, it will be apparent to one skilled in the relevant art how to implement alternative embodiments. The present embodiments should not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices and/or base stations may support multiple technologies, and/or multiple releases of the same technology. Wireless devices may have some specific capability (ies) depending on wireless device category and/or capability (ies). When this disclosure refers to a base station communicating with a plurality of wireless devices, this disclosure may refer to a subset of the total wireless devices in a coverage area. This disclosure may refer to, for example, a plurality of wireless devices of a given LTE or 5G release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of base stations or a plurality of wireless devices in a coverage area that may not comply with the disclosed methods, for example, those wireless devices or base stations may perform based on older releases of LTE or 5G technology.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, should be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={cell1, cell2} are: {cell1}, {cell2}, and {cell1, cell2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

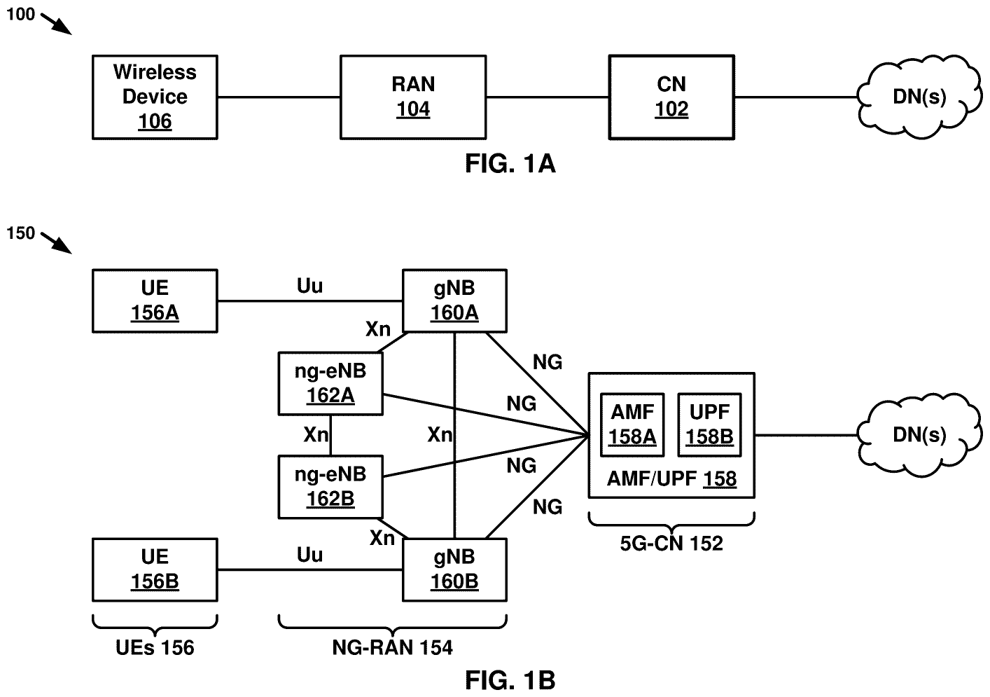

FIG. 1A illustrates an example of a mobile communication network 100 in which embodiments of the present disclosure may be implemented. The mobile communication network 100 may be, for example, a public land mobile network (PLMN) run by a network operator. As illustrated in FIG. 1A, the mobile communication network 100 includes a core network (CN) 102, a radio access network (RAN) 104, and a wireless device 106.

The CN 102 may provide the wireless device 106 with an interface to one or more data networks (DNs), such as public DNS (e.g., the Internet), private DNs, and/or intra-operator DNs. As part of the interface functionality, the CN 102 may set up end-to-end connections between the wireless device 106 and the one or more DNs, authenticate the wireless device 106, and provide charging functionality.

The RAN 104 may connect the CN 102 to the wireless device 106 through radio communications over an air interface. As part of the radio communications, the RAN 104 may provide scheduling, radio resource management, and retransmission protocols. The communication direction from the RAN 104 to the wireless device 106 over the air interface is known as the downlink and the communication direction from the wireless device 106 to the RAN 104 over the air interface is known as the uplink. Downlink transmissions may be separated from uplink transmissions using frequency division duplexing (FDD), time-division duplexing (TDD), and/or some combination of the two duplexing techniques.

The term wireless device may be used throughout this disclosure to refer to and encompass any mobile device or fixed (non-mobile) device for which wireless communication is needed or usable. For example, a wireless device may be a telephone, smart phone, tablet, computer, laptop, sensor, meter, wearable device, Internet of Things (IoT) device, vehicle road side unit (RSU), relay node, automobile, and/or any combination thereof. The term wireless device encompasses other terminology, including user equipment (UE), user terminal (UT), access terminal (AT), mobile station, handset, wireless transmit and receive unit (WTRU), and/or wireless communication device.

The RAN 104 may include one or more base stations (not shown). The term base station may be used throughout this disclosure to refer to and encompass a Node B (associated with UMTS and/or 3G standards), an Evolved Node B (eNB, associated with E-UTRA and/or 4G standards), a remote radio head (RRH), a baseband processing unit coupled to one or more RRHs, a repeater node or relay node used to extend the coverage area of a donor node, a Next Generation Evolved Node B (ng-eNB), a Generation Node B (gNB, associated with NR and/or 5G standards), an access point (AP, associated with, for example, WiFi or any other suitable wireless communication standard), and/or any combination thereof. A base station may comprise at least one gNB Central Unit (gNB-CU) and at least one a gNB Distributed Unit (gNB-DU).

A base station included in the RAN 104 may include one or more sets of antennas for communicating with the wireless device 106 over the air interface. For example, one or more of the base stations may include three sets of antennas to respectively control three cells (or sectors). The size of a cell may be determined by a range at which a receiver (e.g., a base station receiver) can successfully receive the transmissions from a transmitter (e.g., a wireless device transmitter) operating in the cell. Together, the cells of the base stations may provide radio coverage to the wireless device 106 over a wide geographic area to support wireless device mobility.

In addition to three-sector sites, other implementations of base stations are possible. For example, one or more of the base stations in the RAN 104 may be implemented as a sectored site with more or less than three sectors. One or more of the base stations in the RAN 104 may be implemented as an access point, as a baseband processing unit coupled to several remote radio heads (RRHs), and/or as a repeater or relay node used to extend the coverage area of a donor node. A baseband processing unit coupled to RRHs may be part of a centralized or cloud RAN architecture, where the baseband processing unit may be either centralized in a pool of baseband processing units or virtualized. A repeater node may amplify and rebroadcast a radio signal received from a donor node. A relay node may perform the same/similar functions as a repeater node but may decode the radio signal received from the donor node to remove noise before amplifying and rebroadcasting the radio signal.

The RAN 104 may be deployed as a homogenous network of macrocell base stations that have similar antenna patterns and similar high-level transmit powers. The RAN 104 may be deployed as a heterogeneous network. In heterogeneous networks, small cell base stations may be used to provide small coverage areas, for example, coverage areas that overlap with the comparatively larger coverage areas provided by macrocell base stations. The small coverage areas may be provided in areas with high data traffic (or so-called “hotspots”) or in areas with weak macrocell coverage. Examples of small cell base stations include, in order of decreasing coverage area, microcell base stations, picocell base stations, and femtocell base stations or home base stations.

The Third-Generation Partnership Project (3GPP) was formed in 1998 to provide global standardization of specifications for mobile communication networks similar to the mobile communication network 100 in FIG. 1A. To date, 3GPP has produced specifications for three generations of mobile networks: a third generation (3G) network known as Universal Mobile Telecommunications System (UMTS), a fourth generation (4G) network known as Long-Term Evolution (LTE), and a fifth generation (5G) network known as 5G System (5GS). Embodiments of the present disclosure are described with reference to the RAN of a 3GPP 5G network, referred to as next-generation RAN (NG-RAN). Embodiments may be applicable to RANs of other mobile communication networks, such as the RAN 104 in FIG. 1A, the RANs of earlier 3G and 4G networks, and those of future networks yet to be specified (e.g., a 3GPP 6G network). NG-RAN implements 5G radio access technology known as New Radio (NR) and may be provisioned to implement 4G radio access technology or other radio access technologies, including non-3GPP radio access technologies.

FIG. 1B illustrates another example mobile communication network 150 in which embodiments of the present disclosure may be implemented. Mobile communication network 150 may be, for example, a PLMN run by a network operator. As illustrated in FIG. 1B, mobile communication network 150 includes a 5G core network (5G-CN) 152, an NG-RAN 154, and UEs 156A and 156B (collectively UEs 156). These components may be implemented and operate in the same or similar manner as corresponding components described with respect to FIG. 1A.

The 5G-CN 152 provides the UEs 156 with an interface to one or more DNs, such as public DNS (e.g., the Internet), private DNs, and/or intra-operator DNs. As part of the interface functionality, the 5G-CN 152 may set up end-to-end connections between the UEs 156 and the one or more DNs, authenticate the UEs 156, and provide charging functionality. Compared to the CN of a 3GPP 4G network, the basis of the 5G-CN 152 may be a service-based architecture. This means that the architecture of the nodes making up the 5G-CN 152 may be defined as network functions that offer services via interfaces to other network functions. The network functions of the 5G-CN 152 may be implemented in several ways, including as network elements on dedicated or shared hardware, as software instances running on dedicated or shared hardware, or as virtualized functions instantiated on a platform (e.g., a cloud-based platform).

As illustrated in FIG. 1B, the 5G-CN 152 includes an Access and Mobility Management Function (AMF) 158A and a User Plane Function (UPF) 158B, which are shown as one component AMF/UPF 158 in FIG. 1B for ease of illustration. The UPF 158B may serve as a gateway between the NG-RAN 154 and the one or more DNs. The UPF 158B may perform functions such as packet routing and forwarding, packet inspection and user plane policy rule enforcement, traffic usage reporting, uplink classification to support routing of traffic flows to the one or more DNs, quality of service (QOS) handling for the user plane (e.g., packet filtering, gating, uplink/downlink rate enforcement, and uplink traffic verification), downlink packet buffering, and downlink data notification triggering. The UPF 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The UEs 156 may be configured to receive services through a PDU session, which is a logical connection between a UE and a DN.

The AMF 158A may perform functions such as Non-Access Stratum (NAS) signaling termination, NAS signaling security, Access Stratum (AS) security control, inter-CN node signaling for mobility between 3GPP access networks, idle mode UE reachability (e.g., control and execution of paging retransmission), registration area management, intra-system and inter-system mobility support, access authentication, access authorization including checking of roaming rights, mobility management control (subscription and policies), network slicing support, and/or session management function (SMF) selection. NAS may refer to the functionality operating between a CN and a UE, and AS may refer to the functionality operating between the UE and a RAN.

The 5G-CN 152 may include one or more additional network functions that are not shown in FIG. 1B for the sake of clarity. For example, the 5G-CN 152 may include one or more of a Session Management Function (SMF), an NR Repository Function (NRF), a Policy Control Function (PCF), a Network Exposure Function (NEF), a Unified Data Management (UDM), an Application Function (AF), and/or an Authentication Server Function (AUSF).

The NG-RAN 154 may connect the 5G-CN 152 to the UEs 156 through radio communications over the air interface. The NG-RAN 154 may include one or more gNBs, illustrated as gNB 160A and gNB 160B (collectively gNBs 160) and/or one or more ng-eNBs, illustrated as ng-eNB 162A and ng-eNB 162B (collectively ng-eNBs 162). The gNBs 160 and ng-eNBs 162 may be more generically referred to as base stations. The gNBs 160 and ng-eNBs 162 may include one or more sets of antennas for communicating with the UEs 156 over an air interface. For example, one or more of the gNBs 160 and/or one or more of the ng-eNBs 162 may include three sets of antennas to respectively control three cells (or sectors). Together, the cells of the gNBs 160 and the ng-eNBs 162 may provide radio coverage to the UEs 156 over a wide geographic area to support UE mobility.

As shown in FIG. 1B, the gNBs 160 and/or the ng-eNBs 162 may be connected to the 5G-CN 152 by means of an NG interface and to other base stations by an Xn interface. The NG and Xn interfaces may be established using direct physical connections and/or indirect connections over an underlying transport network, such as an internet protocol (IP) transport network. The gNBs 160 and/or the ng-eNBs 162 may be connected to the UEs 156 by means of a Uu interface. For example, as illustrated in FIG. 1B, gNB 160A may be connected to the UE 156A by means of a Uu interface. The NG, Xn, and Uu interfaces are associated with a protocol stack. The protocol stacks associated with the interfaces may be used by the network elements in FIG. 1B to exchange data and signaling messages and may include two planes: a user plane and a control plane. The user plane may handle data of interest to a user. The control plane may handle signaling messages of interest to the network elements.

The gNBs 160 and/or the ng-eNBs 162 may be connected to one or more AMF/UPF functions of the 5G-CN 152, such as the AMF/UPF 158, by means of one or more NG interfaces. For example, the gNB 160A may be connected to the UPF 158B of the AMF/UPF 158 by means of an NG-User plane (NG-U) interface. The NG-U interface may provide delivery (e.g., non-guaranteed delivery) of user plane PDUs between the gNB 160A and the UPF 158B. The gNB 160A may be connected to the AMF 158A by means of an NG-Control plane (NG-C) interface. The NG-C interface may provide, for example, NG interface management, UE context management, UE mobility management, transport of NAS messages, paging, PDU session management, and configuration transfer and/or warning message transmission.

The gNBs 160 may provide NR user plane and control plane protocol terminations towards the UEs 156 over the Uu interface. For example, the gNB 160A may provide NR user plane and control plane protocol terminations toward the UE 156A over a Uu interface associated with a first protocol stack. The ng-eNBs 162 may provide Evolved UMTS Terrestrial Radio Access (E-UTRA) user plane and control plane protocol terminations towards the UEs 156 over a Uu interface, where E-UTRA refers to the 3GPP 4G radio-access technology. For example, the ng-eNB 162B may provide E-UTRA user plane and control plane protocol terminations towards the UE 156B over a Uu interface associated with a second protocol stack.

The 5G-CN 152 was described as being configured to handle NR and 4G radio accesses. It will be appreciated by one of ordinary skill in the art that it may be possible for NR to connect to a 4G core network in a mode known as “non-standalone operation.” In non-standalone operation, a 4G core network is used to provide (or at least support) control-plane functionality (e.g., initial access, mobility, and paging). Although only one AMF/UPF 158 is shown in FIG. 1B, one gNB or ng-eNB may be connected to multiple AMF/UPF nodes to provide redundancy and/or to load share across the multiple AMF/UPF nodes.

As discussed, an interface (e.g., Uu, Xn, and NG interfaces) between the network elements in FIG. 1B may be associated with a protocol stack that the network elements use to exchange data and signaling messages. A protocol stack may include two planes: a user plane and a control plane. The user plane may handle data of interest to a user, and the control plane may handle signaling messages of interest to the network elements.

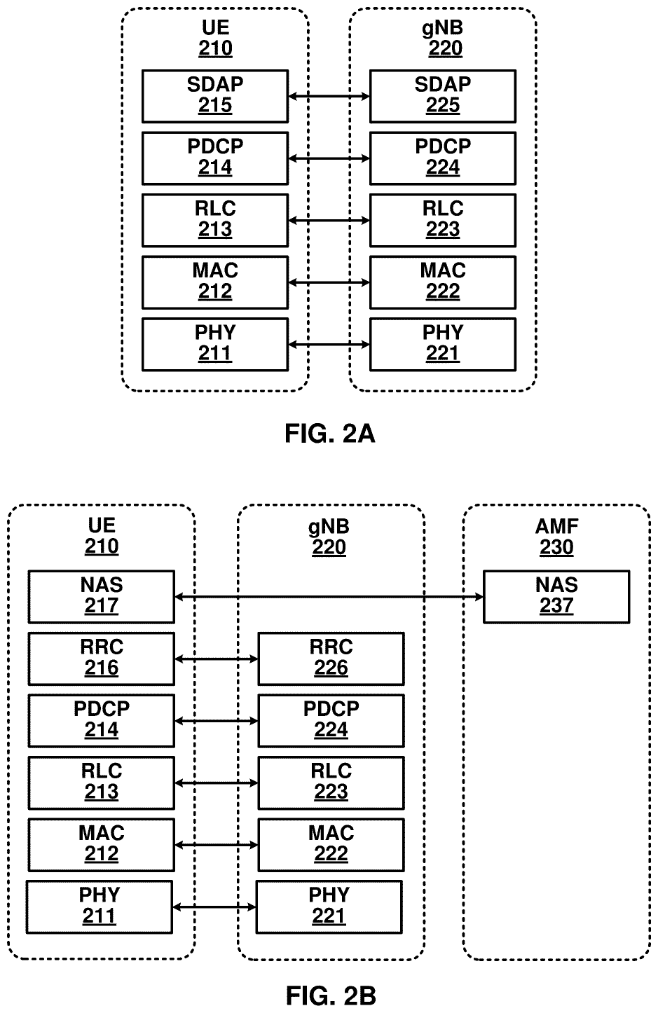

FIG. 2A and FIG. 2B respectively illustrate examples of NR user plane and NR control plane protocol stacks for the Uu interface that lies between a UE 210 and a gNB 220. The protocol stacks illustrated in FIG. 2A and FIG. 2B may be the same or similar to those used for the Uu interface between, for example, the UE 156A and the gNB 160A shown in FIG. 1B.

FIG. 2A illustrates a NR user plane protocol stack comprising five layers implemented in the UE 210 and the gNB 220. At the bottom of the protocol stack, physical layers (PHYs) 211 and 221 may provide transport services to the higher layers of the protocol stack and may correspond to layer 1 of the Open Systems Interconnection (OSI) model. The next four protocols above PHYs 211 and 221 comprise media access control layers (MACs) 212 and 222, radio link control layers (RLCs) 213 and 223, packet data convergence protocol layers (PDCPs) 214 and 224, and service data application protocol layers (SDAPs) 215 and 225. Together, these four protocols may make up layer 2, or the data link layer, of the OSI model.

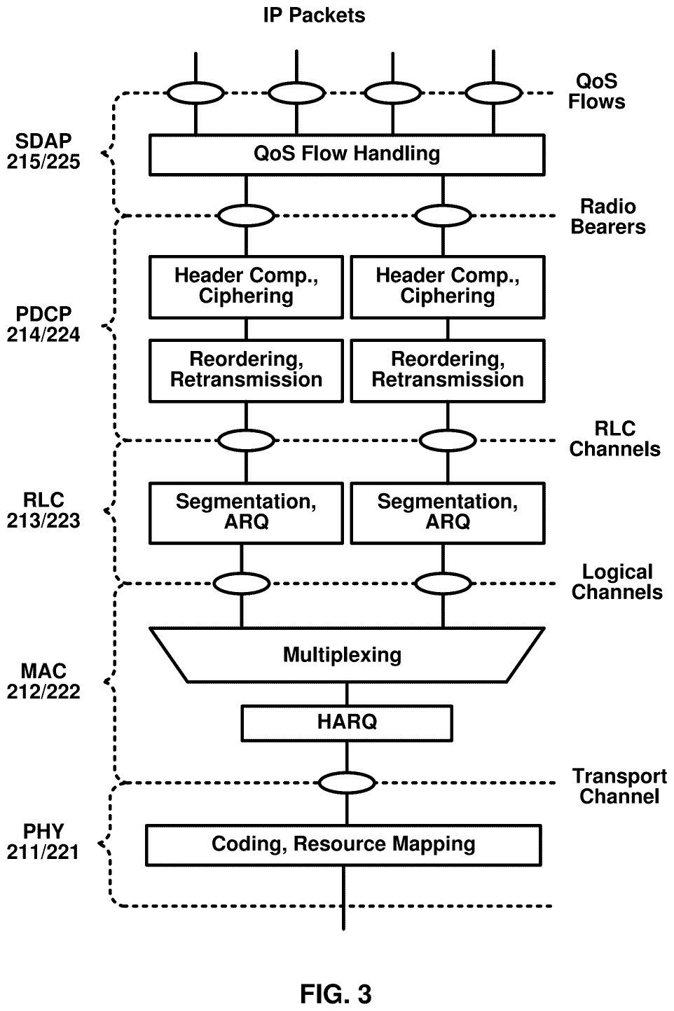

FIG. 3 illustrates an example of services provided between protocol layers of the NR user plane protocol stack. Starting from the top of FIG. 2A and FIG. 3, the SDAPs 215 and 225 may perform QoS flow handling. The UE 210 may receive services through a PDU session, which may be a logical connection between the UE 210 and a DN. The PDU session may have one or more QoS flows. A UPF of a CN (e.g., the UPF 158B) may map IP packets to the one or more QoS flows of the PDU session based on QoS requirements (e.g., in terms of delay, data rate, and/or error rate). The SDAPs 215 and 225 may perform mapping/de-mapping between the one or more QoS flows and one or more data radio bearers. The mapping/de-mapping between the QoS flows and the data radio bearers may be determined by the SDAP 225 at the gNB 220. The SDAP 215 at the UE 210 may be informed of the mapping between the QoS flows and the data radio bearers through reflective mapping or control signaling received from the gNB 220. For reflective mapping, the SDAP 225 at the gNB 220 may mark the downlink packets with a QoS flow indicator (QFI), which may be observed by the SDAP 215 at the UE 210 to determine the mapping/de-mapping between the QoS flows and the data radio bearers.

The PDCPs 214 and 224 may perform header compression/decompression to reduce the amount of data that needs to be transmitted over the air interface, ciphering/deciphering to prevent unauthorized decoding of data transmitted over the air interface, and integrity protection (to ensure control messages originate from intended sources. The PDCPs 214 and 224 may perform retransmissions of undelivered packets, in-sequence delivery and reordering of packets, and removal of packets received in duplicate due to, for example, an intra-gNB handover. The PDCPs 214 and 224 may perform packet duplication to improve the likelihood of the packet being received and, at the receiver, remove any duplicate packets. Packet duplication may be useful for services that require high reliability.

Although not shown in FIG. 3, PDCPs 214 and 224 may perform mapping/de-mapping between a split radio bearer and RLC channels in a dual connectivity scenario. Dual connectivity is a technique that allows a UE to connect to two cells or, more generally, two cell groups: a master cell group (MCG) and a secondary cell group (SCG). A split bearer is when a single radio bearer, such as one of the radio bearers provided by the PDCPs 214 and 224 as a service to the SDAPs 215 and 225, is handled by cell groups in dual connectivity. The PDCPs 214 and 224 may map/de-map the split radio bearer between RLC channels belonging to cell groups.

The RLCs 213 and 223 may perform segmentation, retransmission through Automatic Repeat Request (ARQ), and removal of duplicate data units received from MACs 212 and 222, respectively. The RLCs 213 and 223 may support three transmission modes: transparent mode (TM); unacknowledged mode (UM); and acknowledged mode (AM). Based on the transmission mode an RLC is operating, the RLC may perform one or more of the noted functions. The RLC configuration may be per logical channel with no dependency on numerologies and/or Transmission Time Interval (TTI) durations. As shown in FIG. 3, the RLCs 213 and 223 may provide RLC channels as a service to PDCPs 214 and 224, respectively.

The MACs 212 and 222 may perform multiplexing/demultiplexing of logical channels and/or mapping between logical channels and transport channels. The multiplexing/demultiplexing may include multiplexing/demultiplexing of data units, belonging to the one or more logical channels, into/from Transport Blocks (TBs) delivered to/from the PHYS 211 and 221. The MAC 222 may be configured to perform scheduling, scheduling information reporting, and priority handling between UEs by means of dynamic scheduling. Scheduling may be performed in the gNB 220 (at the MAC 222) for downlink and uplink. The MACs 212 and 222 may be configured to perform error correction through Hybrid Automatic Repeat Request (HARQ) (e.g., one HARQ entity per carrier in case of Carrier Aggregation (CA)), priority handling between logical channels of the UE 210 by means of logical channel prioritization, and/or padding. The MACs 212 and 222 may support one or more numerologies and/or transmission timings. In an example, mapping restrictions in a logical channel prioritization may control which numerology and/or transmission timing a logical channel may use. As shown in FIG. 3, the MACs 212 and 222 may provide logical channels as a service to the RLCs 213 and 223.

The PHYs 211 and 221 may perform mapping of transport channels to physical channels and digital and analog signal processing functions for sending and receiving information over the air interface. These digital and analog signal processing functions may include, for example, coding/decoding and modulation/demodulation. The PHYs 211 and 221 may perform multi-antenna mapping. As shown in FIG. 3, the PHYs 211 and 221 may provide one or more transport channels as a service to the MACs 212 and 222.

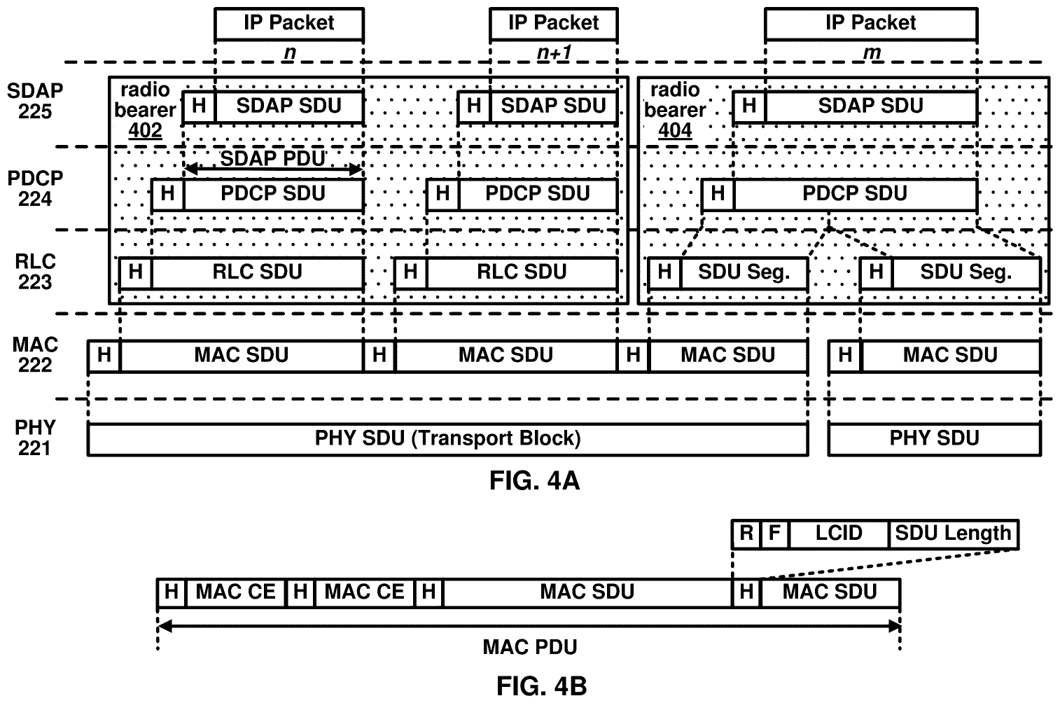

FIG. 4A illustrates an example downlink data flow through the NR user plane protocol stack. FIG. 4A illustrates a downlink data flow of three IP packets (n, n+1, and m) through the NR user plane protocol stack to generate two TBs at the gNB 220. An uplink data flow through the NR user plane protocol stack may be similar to the downlink data flow depicted in FIG. 4A.

The downlink data flow of FIG. 4A begins when SDAP 225 receives the three IP packets from one or more QoS flows and maps the three packets to radio bearers. In FIG. 4A, the SDAP 225 maps IP packets n and n+1 to a first radio bearer 402 and maps IP packet m to a second radio bearer 404. An SDAP header (labeled with an “H” in FIG. 4A) is added to an IP packet. The data unit from/to a higher protocol layer is referred to as a service data unit (SDU) of the lower protocol layer and the data unit to/from a lower protocol layer is referred to as a protocol data unit (PDU) of the higher protocol layer. As shown in FIG. 4A, the data unit from the SDAP 225 is an SDU of lower protocol layer PDCP 224 and is a PDU of the SDAP 225.

The remaining protocol layers in FIG. 4A may perform their associated functionality (e.g., with respect to FIG. 3), add corresponding headers, and forward their respective outputs to the next lower layer. For example, the PDCP 224 may perform IP-header compression and ciphering and forward its output to the RLC 223. The RLC 223 may optionally perform segmentation (e.g., as shown for IP packet m in FIG. 4A) and forward its output to the MAC 222. The MAC 222 may multiplex a number of RLC PDUs and may attach a MAC subheader to an RLC PDU to form a transport block. In NR, the MAC subheaders may be distributed across the MAC PDU, as illustrated in FIG. 4A. In LTE, the MAC subheaders may be entirely located at the beginning of the MAC PDU. The NR MAC PDU structure may reduce processing time and associated latency because the MAC PDU subheaders may be computed before the full MAC PDU is assembled.

FIG. 4B illustrates an example format of a MAC subheader in a MAC PDU. The MAC subheader includes: an SDU length field for indicating the length (e.g., in bytes) of the MAC SDU to which the MAC subheader corresponds; a logical channel identifier (LCID) field for identifying the logical channel from which the MAC SDU originated to aid in the demultiplexing process; a flag (F) for indicating the size of the SDU length field; and a reserved bit (R) field for future use.

FIG. 4B further illustrates MAC control elements (CEs) inserted into the MAC PDU by a MAC, such as MAC 223 or MAC 222. For example, FIG. 4B illustrates two MAC CEs inserted into the MAC PDU. MAC CEs may be inserted at the beginning of a MAC PDU for downlink transmissions (as shown in FIG. 4B) and at the end of a MAC PDU for uplink transmissions. MAC CEs may be used for in-band control signaling. Example MAC CEs include: scheduling-related MAC CEs, such as buffer status reports and power headroom reports; activation/deactivation MAC CEs, such as those for activation/deactivation of PDCP duplication detection, channel state information (CSI) reporting, sounding reference signal (SRS) transmission, and prior configured components; discontinuous reception (DRX) related MAC CEs; timing advance MAC CEs; and random access related MAC CEs. A MAC CE may be preceded by a MAC subheader with a similar format as described for MAC SDUs and may be identified with a reserved value in the LCID field that indicates the type of control information included in the MAC CE.

Before describing the NR control plane protocol stack, logical channels, transport channels, and physical channels are first described as well as a mapping between the channel types. One or more of the channels may be used to carry out functions associated with the NR control plane protocol stack described later below.

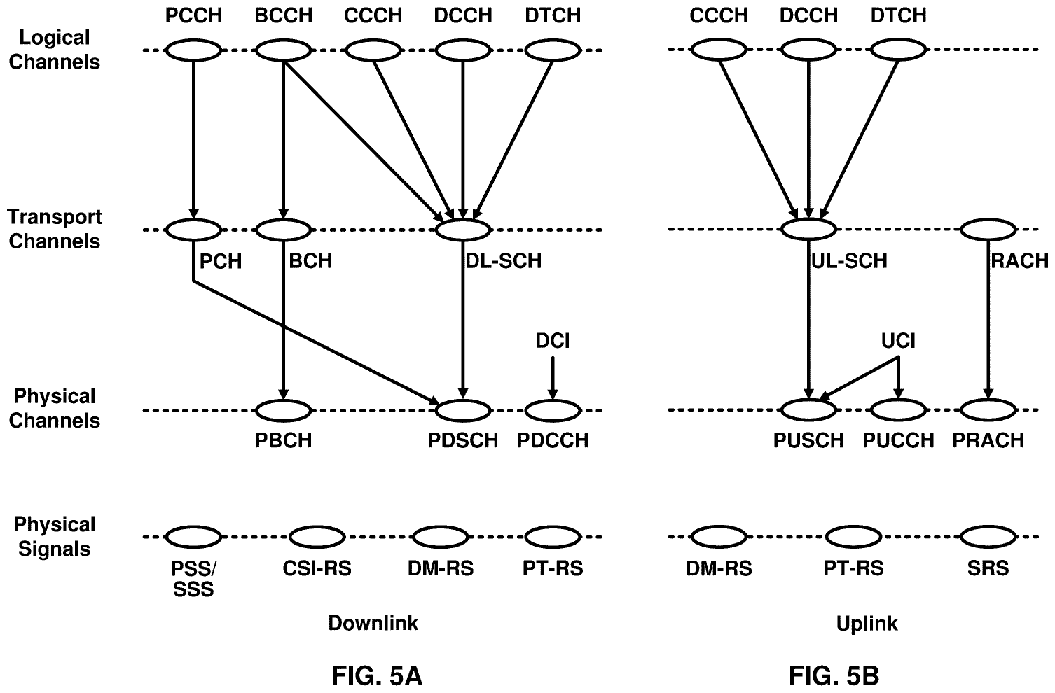

FIG. 5A and FIG. 5B illustrate, for downlink and uplink respectively, a mapping between logical channels, transport channels, and physical channels. Information is passed through channels between the RLC, the MAC, and the PHY of the NR protocol stack. A logical channel may be used between the RLC and the MAC and may be classified as a control channel that carries control and configuration information in the NR control plane or as a traffic channel that carries data in the NR user plane. A logical channel may be classified as a dedicated logical channel that is dedicated to a specific UE or as a common logical channel that may be used by more than one UE. A logical channel may also be defined by the type of information it carries. The set of logical channels defined by NR include, for example:
a paging control channel (PCCH) for carrying paging messages used to page a UE whose location is not known to the network on a cell level;
a broadcast control channel (BCCH) for carrying system information messages in the form of a master information block (MIB) and several system information blocks (SIBs), wherein the system information messages may be used by the UEs to obtain information about how a cell is configured and how to operate within the cell;
a common control channel (CCCH) for carrying control messages together with random access;
a dedicated control channel (DCCH) for carrying control messages to/from a specific the UE to configure the UE; and
a dedicated traffic channel (DTCH) for carrying user data to/from a specific the UE.

Transport channels are used between the MAC and PHY layers and may be defined by how the information they carry is transmitted over the air interface. The set of transport channels defined by NR include, for example:
a paging channel (PCH) for carrying paging messages that originated from the PCCH;
a broadcast channel (BCH) for carrying the MIB from the BCCH;
a downlink shared channel (DL-SCH) for carrying downlink data and signaling messages, including the SIBs from the BCCH;
an uplink shared channel (UL-SCH) for carrying uplink data and signaling messages; and
a random access channel (RACH) for allowing a UE to contact the network without any prior scheduling.

The PHY may use physical channels to pass information between processing levels of the PHY. A physical channel may have an associated set of time-frequency resources for carrying the information of one or more transport channels. The PHY may generate control information to support the low-level operation of the PHY and provide the control information to the lower levels of the PHY via physical control channels, known as L1/L2 control channels. The set of physical channels and physical control channels defined by NR include, for example:
a physical broadcast channel (PBCH) for carrying the MIB from the BCH;
a physical downlink shared channel (PDSCH) for carrying downlink data and signaling messages from the DL-SCH, as well as paging messages from the PCH;
a physical downlink control channel (PDCCH) for carrying downlink control information (DCI), which may include downlink scheduling commands, uplink scheduling grants, and uplink power control commands;
a physical uplink shared channel (PUSCH) for carrying uplink data and signaling messages from the UL-SCH and in some instances uplink control information (UCI) as described below;
a physical uplink control channel (PUCCH) for carrying UCI, which may include HARQ acknowledgments, channel quality indicators (CQI), pre-coding matrix indicators (PMI), rank indicators (RI), and scheduling requests (SR); and
a physical random access channel (PRACH) for random access.

Similar to the physical control channels, the physical layer generates physical signals to support the low-level operation of the physical layer. As shown in FIG. 5A and FIG. 5B, the physical layer signals defined by NR include: primary synchronization signals (PSS), secondary synchronization signals (SSS), channel state information reference signals (CSI-RS), demodulation reference signals (DMRS), sounding reference signals (SRS), and phase-tracking reference signals (PT-RS). These physical layer signals will be described in greater detail below.

FIG. 2B illustrates an example NR control plane protocol stack. As shown in FIG. 2B, the NR control plane protocol stack may use the same/similar first four protocol layers as the example NR user plane protocol stack. These four protocol layers include the PHYs 211 and 221, the MACs 212 and 222, the RLCs 213 and 223, and the PDCPs 214 and 224. Instead of having the SDAPs 215 and 225 at the top of the stack as in the NR user plane protocol stack, the NR control plane stack has radio resource controls (RRCs) 216 and 226 and NAS protocols 217 and 237 at the top of the NR control plane protocol stack.

The NAS protocols 217 and 237 may provide control plane functionality between the UE 210 and the AMF 230 (e.g., the AMF 158A) or, more generally, between the UE 210 and the CN. The NAS protocols 217 and 237 may provide control plane functionality between the UE 210 and the AMF 230 via signaling messages, referred to as NAS messages. There is no direct path between the UE 210 and the AMF 230 through which the NAS messages can be transported. The NAS messages may be transported using the AS of the Uu and NG interfaces. NAS protocols 217 and 237 may provide control plane functionality such as authentication, security, connection setup, mobility management, and session management.

The RRCs 216 and 226 may provide control plane functionality between the UE 210 and the gNB 220 or, more generally, between the UE 210 and the RAN. The RRCs 216 and 226 may provide control plane functionality between the UE 210 and the gNB 220 via signaling messages, referred to as RRC messages. RRC messages may be transmitted between the UE 210 and the RAN using signaling radio bearers and the same/similar PDCP, RLC, MAC, and PHY protocol layers. The MAC may multiplex control-plane and user-plane data into the same transport block (TB). The RRCs 216 and 226 may provide control plane functionality such as: broadcast of system information related to AS and NAS; paging initiated by the CN or the RAN; establishment, maintenance and release of an RRC connection between the UE 210 and the RAN; security functions including key management; establishment, configuration, maintenance and release of signaling radio bearers and data radio bearers; mobility functions; QoS management functions; the UE measurement reporting and control of the reporting; detection of and recovery from radio link failure (RLF); and/or NAS message transfer. As part of establishing an RRC connection, RRCs 216 and 226 may establish an RRC context, which may involve configuring parameters for communication between the UE 210 and the RAN.

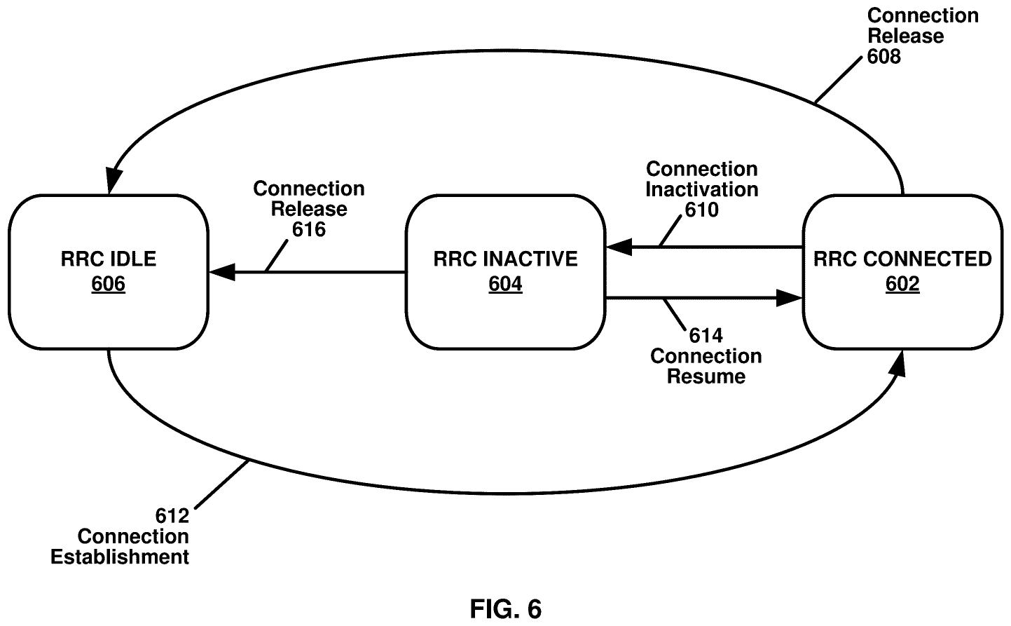

FIG. 6 is an example diagram showing RRC state transitions of a UE. The UE may be the same or similar to the wireless device 106 depicted in FIG. 1A, the UE 210 depicted in FIG. 2A and FIG. 2B, or any other wireless device described in the present disclosure. As illustrated in FIG. 6, a UE may be in at least one of three RRC states: RRC connected 602 (e.g., RRC_CONNECTED), RRC idle 604 (e.g., RRC_IDLE), and RRC inactive 606 (e.g., RRC_INACTIVE).

In RRC connected 602, the UE has an established RRC context and may have at least one RRC connection with a base station. The base station may be similar to one of the one or more base stations included in the RAN 104 depicted in FIG. 1A, one of the gNBs 160 or ng-eNBs 162 depicted in FIG. 1B, the gNB 220 depicted in FIG. 2A and FIG. 2B, or any other base station described in the present disclosure. The base station with which the UE is connected may have the RRC context for the UE. The RRC context, referred to as the UE context, may comprise parameters for communication between the UE and the base station. These parameters may include, for example: one or more AS contexts; one or more radio link configuration parameters; bearer configuration information (e.g., relating to a data radio bearer, signaling radio bearer, logical channel, QoS flow, and/or PDU session); security information; and/or PHY, MAC, RLC, PDCP, and/or SDAP layer configuration information. While in RRC connected 602, mobility of the UE may be managed by the RAN (e.g., the RAN 104 or the NG-RAN 154). The UE may measure the signal levels (e.g., reference signal levels) from a serving cell and neighboring cells and report these measurements to the base station currently serving the UE. The UE's serving base station may request a handover to a cell of one of the neighboring base stations based on the reported measurements. The RRC state may transition from RRC connected 602 to RRC idle 604 through a connection release procedure 608 or to RRC inactive 606 through a connection inactivation procedure 610.

In RRC idle 604, an RRC context may not be established for the UE. In RRC idle 604, the UE may not have an RRC connection with the base station. While in RRC idle 604, the UE may be in a sleep state for the majority of the time (e.g., to conserve battery power). The UE may wake up periodically (e.g., once in every discontinuous reception cycle) to monitor for paging messages from the RAN. Mobility of the UE may be managed by the UE through a procedure known as cell reselection. The RRC state may transition from RRC idle 604 to RRC connected 602 through a connection establishment procedure 612, which may involve a random access procedure as discussed in greater detail below.

In RRC inactive 606, the RRC context previously established is maintained in the UE and the base station. This allows for a fast transition to RRC connected 602 with reduced signaling overhead as compared to the transition from RRC idle 604 to RRC connected 602. While in RRC inactive 606, the UE may be in a sleep state and mobility of the UE may be managed by the UE through cell reselection. The RRC state may transition from RRC inactive 606 to RRC connected 602 through a connection resume procedure 614 or to RRC idle 604 though a connection release procedure 616 that may be the same as or similar to connection release procedure 608.

An RRC state may be associated with a mobility management mechanism. In RRC idle 604 and RRC inactive 606, mobility is managed by the UE through cell reselection. The purpose of mobility management in RRC idle 604 and RRC inactive 606 is to allow the network to be able to notify the UE of an event via a paging message without having to broadcast the paging message over the entire mobile communications network. The mobility management mechanism used in RRC idle 604 and RRC inactive 606 may allow the network to track the UE on a cell-group level so that the paging message may be broadcast over the cells of the cell group that the UE currently resides within instead of the entire mobile communication network. The mobility management mechanisms for RRC idle 604 and RRC inactive 606 track the UE on a cell-group level. They may do so using different granularities of grouping. For example, there may be three levels of cell-grouping granularity: individual cells; cells within a RAN area identified by a RAN area identifier (RAI); and cells within a group of RAN areas, referred to as a tracking area and identified by a tracking area identifier (TAI).

Tracking areas may be used to track the UE at the CN level. The CN (e.g., the CN 102 or the 5G-CN 152) may provide the UE with a list of TAIs associated with a UE registration area. If the UE moves, through cell reselection, to a cell associated with a TAI not included in the list of TAIs associated with the UE registration area, the UE may perform a registration update with the CN to allow the CN to update the UE's location and provide the UE with a new the UE registration area.

RAN areas may be used to track the UE at the RAN level. For a UE in RRC inactive 606 state, the UE may be assigned a RAN notification area. A RAN notification area may comprise one or more cell identities, a list of RAIs, or a list of TAls. In an example, a base station may belong to one or more RAN notification areas. In an example, a cell may belong to one or more RAN notification areas. If the UE moves, through cell reselection, to a cell not included in the RAN notification area assigned to the UE, the UE may perform a notification area update with the RAN to update the UE's RAN notification area.

A base station storing an RRC context for a UE or a last serving base station of the UE may be referred to as an anchor base station. An anchor base station may maintain an RRC context for the UE at least during a period of time that the UE stays in a RAN notification area of the anchor base station and/or during a period of time that the UE stays in RRC inactive 606.

A gNB, such as gNBs 160 in FIG. 1B, may be split in two parts: a central unit (gNB-CU), and one or more distributed units (gNB-DU). A gNB-CU may be coupled to one or more gNB-DUs using an F1 interface. The gNB-CU may comprise the RRC, the PDCP, and the SDAP. A gNB-DU may comprise the RLC, the MAC, and the PHY.

In NR, the physical signals and physical channels (discussed with respect to FIG. 5A and FIG. 5B) may be mapped onto orthogonal frequency divisional multiplexing (OFDM) symbols. OFDM is a multicarrier communication scheme that transmits data over F orthogonal subcarriers (or tones). Before transmission, the data may be mapped to a series of complex symbols (e.g., M-quadrature amplitude modulation (M-QAM) or M-phase shift keying (M-PSK) symbols), referred to as source symbols, and divided into F parallel symbol streams. The F parallel symbol streams may be treated as though they are in the frequency domain and used as inputs to an Inverse Fast Fourier Transform (IFFT) block that transforms them into the time domain. The IFFT block may take in F source symbols at a time, one from each of the F parallel symbol streams, and use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. After some processing (e.g., addition of a cyclic prefix) and up-conversion, an OFDM symbol provided by the IFFT block may be transmitted over the air interface on a carrier frequency. The F parallel symbol streams may be mixed using an FFT block before being processed by the IFFT block. This operation produces Discrete Fourier Transform (DFT)-precoded OFDM symbols and may be used by UEs in the uplink to reduce the peak to average power ratio (PAPR). Inverse processing may be performed on the OFDM symbol at a receiver using an FFT block to recover the data mapped to the source symbols.

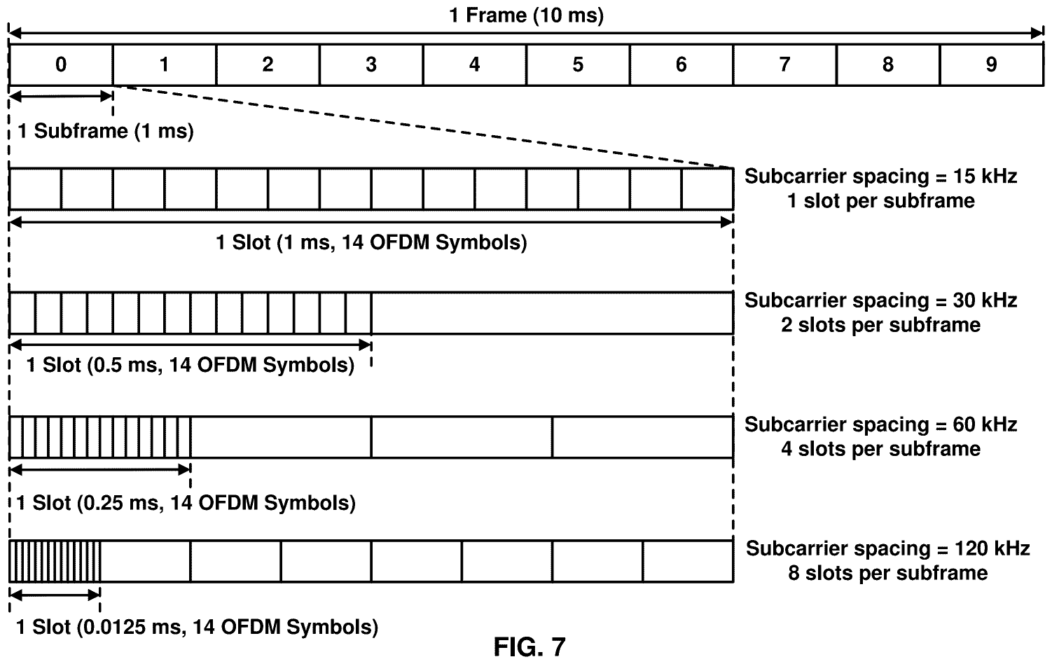

FIG. 7 illustrates an example configuration of an NR frame into which OFDM symbols are grouped. An NR frame may be identified by a system frame number (SFN). The SFN may repeat with a period of 1024 frames. As illustrated, one NR frame may be 10 milliseconds (ms) in duration and may include 10 subframes that are 1 ms in duration. A subframe may be divided into slots that include, for example, 14 OFDM symbols per slot.

The duration of a slot may depend on the numerology used for the OFDM symbols of the slot. In NR, a flexible numerology is supported to accommodate different cell deployments (e.g., cells with carrier frequencies below 1 GHz up to cells with carrier frequencies in the mm-wave range). A numerology may be defined in terms of subcarrier spacing and cyclic prefix duration. For a numerology in NR, subcarrier spacings may be scaled up by powers of two from a baseline subcarrier spacing of 15 kHz, and cyclic prefix durations may be scaled down by powers of two from a baseline cyclic prefix duration of 4.7 μs. For example, NR defines numerologies with the following subcarrier spacing/cyclic prefix duration combinations: 15 kHz/4.7 μs; 30 KHz/2.3 μs; 60 KHz/1.2 μs; 120 KHz/0.59 μs; and 240 kHz/0.29 μs.

A slot may have a fixed number of OFDM symbols (e.g., 14 OFDM symbols). A numerology with a higher subcarrier spacing has a shorter slot duration and, correspondingly, more slots per subframe. FIG. 7 illustrates this numerology-dependent slot duration and slots-per-subframe transmission structure (the numerology with a subcarrier spacing of 240 kHz is not shown in FIG. 7 for ease of illustration). A subframe in NR may be used as a numerology-independent time reference, while a slot may be used as the unit upon which uplink and downlink transmissions are scheduled. To support low latency, scheduling in NR may be decoupled from the slot duration and start at any OFDM symbol and last for as many symbols as needed for a transmission. These partial slot transmissions may be referred to as mini-slot or subslot transmissions.

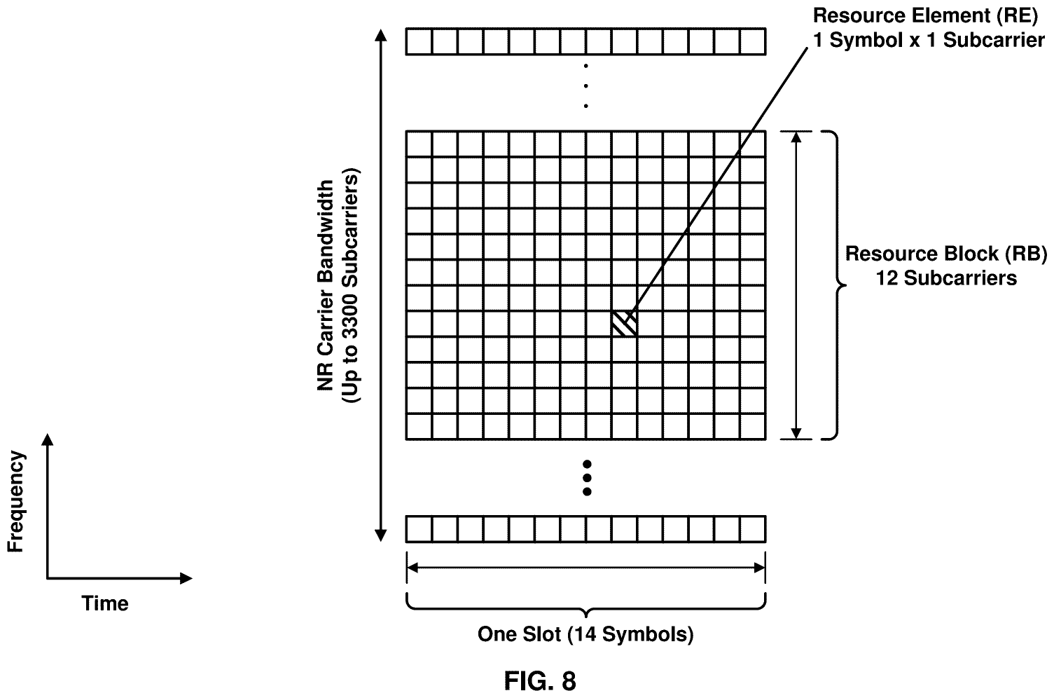

FIG. 8 illustrates an example configuration of a slot in the time and frequency domain for an NR carrier. The slot includes resource elements (REs) and resource blocks (RBs). An RE is the smallest physical resource in NR. An RE spans one OFDM symbol in the time domain by one subcarrier in the frequency domain as shown in FIG. 8. An RB spans twelve consecutive REs in the frequency domain as shown in FIG. 8. An NR carrier may be limited to a width of 275 RBs or 275×12=3300 subcarriers. Such a limitation, if used, may limit the NR carrier to 50, 100, 200, and 400 MHz for subcarrier spacings of 15, 30, 60, and 120 kHz, respectively, where the 400 MHz bandwidth may be set based on a 400 MHz per carrier bandwidth limit.

FIG. 8 illustrates a single numerology being used across the entire bandwidth of the NR carrier. In other example configurations, multiple numerologies may be supported on the same carrier.

NR may support wide carrier bandwidths (e.g., up to 400 MHz for a subcarrier spacing of 120 kHz). Not all UEs may be able to receive the full carrier bandwidth (e.g., due to hardware limitations). Also, receiving the full carrier bandwidth may be prohibitive in terms of UE power consumption. In an example, to reduce power consumption and/or for other purposes, a UE may adapt the size of the UE's receive bandwidth based on the amount of traffic the UE is scheduled to receive. This is referred to as bandwidth adaptation.

NR defines bandwidth parts (BWPs) to support UEs not capable of receiving the full carrier bandwidth and to support bandwidth adaptation. In an example, a BWP may be defined by a subset of contiguous RBs on a carrier. A UE may be configured (e.g., via RRC layer) with one or more downlink BWPs and one or more uplink BWPs per serving cell (e.g., up to four downlink BWPs and up to four uplink BWPs per serving cell). At a given time, one or more of the configured BWPs for a serving cell may be active. These one or more BWPs may be referred to as active BWPs of the serving cell. When a serving cell is configured with a secondary uplink carrier, the serving cell may have one or more first active BWPs in the uplink carrier and one or more second active BWPs in the secondary uplink carrier.

For unpaired spectra, a downlink BWP from a set of configured downlink BWPs may be linked with an uplink BWP from a set of configured uplink BWPs if a downlink BWP index of the downlink BWP and an uplink BWP index of the uplink BWP are the same. For unpaired spectra, a UE may expect that a center frequency for a downlink BWP is the same as a center frequency for an uplink BWP.

For a downlink BWP in a set of configured downlink BWPs on a primary cell (PCell), a base station may configure a UE with one or more control resource sets (CORESETs) for at least one search space. A search space is a set of locations in the time and frequency domains where the UE may find control information. The search space may be a UE-specific search space or a common search space (potentially usable by a plurality of UEs). For example, a base station may configure a UE with a common search space, on a PCell or on a primary secondary cell (PSCell), in an active downlink BWP.

For an uplink BWP in a set of configured uplink BWPs, a BS may configure a UE with one or more resource sets for one or more PUCCH transmissions. A UE may receive downlink receptions (e.g., PDCCH or PDSCH) in a downlink BWP according to a configured numerology (e.g., subcarrier spacing and cyclic prefix duration) for the downlink BWP. The UE may transmit uplink transmissions (e.g., PUCCH or PUSCH) in an uplink BWP according to a configured numerology (e.g., subcarrier spacing and cyclic prefix length for the uplink BWP).

One or more BWP indicator fields may be provided in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a UE with a default downlink BWP within a set of configured downlink BWPs associated with a PCell. If the base station does not provide the default downlink BWP to the UE, the default downlink BWP may be an initial active downlink BWP. The UE may determine which BWP is the initial active downlink BWP based on a CORESET configuration obtained using the PBCH.

A base station may configure a UE with a BWP inactivity timer value for a PCell. The UE may start or restart a BWP inactivity timer at any appropriate time. For example, the UE may start or restart the BWP inactivity timer (a) when the UE detects a DCI indicating an active downlink BWP other than a default downlink BWP for a paired spectra operation; or (b) when a UE detects a DCI indicating an active downlink BWP or active uplink BWP other than a default downlink BWP or uplink BWP for an unpaired spectra operation. If the UE does not detect DCI during an interval of time (e.g., 1 ms or 0.5 ms), the UE may run the BWP inactivity timer toward expiration (for example, increment from zero to the BWP inactivity timer value, or decrement from the BWP inactivity timer value to zero). When the BWP inactivity timer expires, the UE may switch from the active downlink BWP to the default downlink BWP.

In an example, a base station may semi-statically configure a UE with one or more BWPs. A UE may switch an active BWP from a first BWP to a second BWP in response to receiving a DCI indicating the second BWP as an active BWP and/or in response to an expiry of the BWP inactivity timer (e.g., if the second BWP is the default BWP).

Downlink and uplink BWP switching (where BWP switching refers to switching from a currently active BWP to a not currently active BWP) may be performed independently in paired spectra. In unpaired spectra, downlink and uplink BWP switching may be performed simultaneously. Switching between configured BWPs may occur based on RRC signaling, DCI, expiration of a BWP inactivity timer, and/or an initiation of random access.

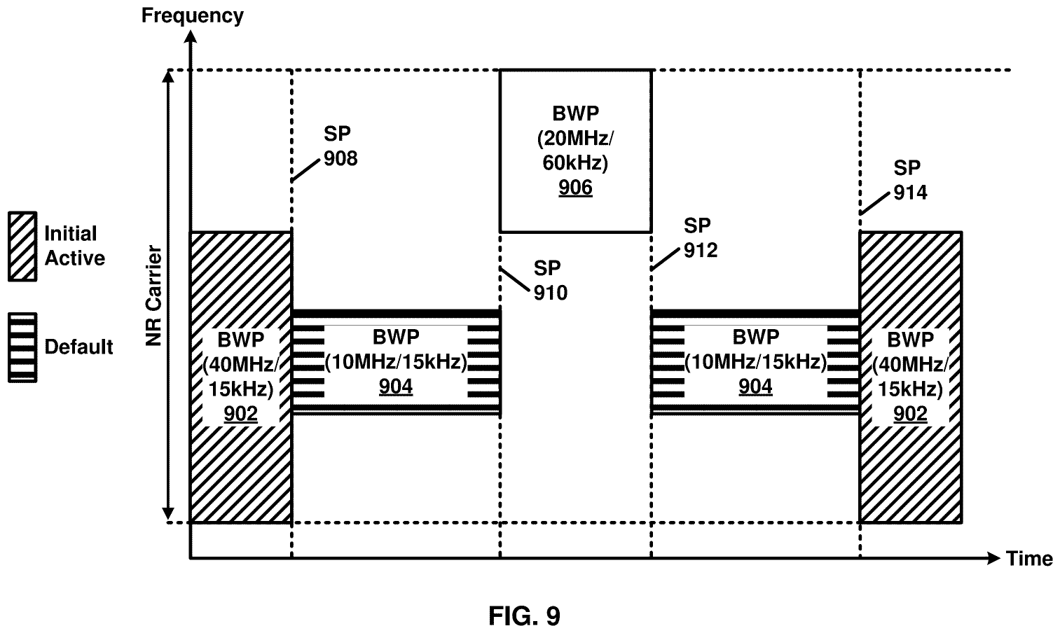

FIG. 9 illustrates an example of bandwidth adaptation using three configured BWPs for an NR carrier. A UE configured with the three BWPs may switch from one BWP to another BWP at a switching point. In the example illustrated in FIG. 9, the BWPs include: a BWP 902 with a bandwidth of 40 MHz and a subcarrier spacing of 15 kHz; a BWP 904 with a bandwidth of 10 MHz and a subcarrier spacing of 15 kHz; and a BWP 906 with a bandwidth of 20 MHz and a subcarrier spacing of 60 KHz. The BWP 902 may be an initial active BWP, and the BWP 904 may be a default BWP. The UE may switch between BWPs at switching points. In the example of FIG. 9, the UE may switch from the BWP 902 to the BWP 904 at a switching point 908. The switching at the switching point 908 may occur for any suitable reason, for example, in response to an expiry of a BWP inactivity timer (indicating switching to the default BWP) and/or in response to receiving a DCI indicating BWP 904 as the active BWP. The UE may switch at a switching point 910 from active BWP 904 to BWP 906 in response receiving a DCI indicating BWP 906 as the active BWP. The UE may switch at a switching point 912 from active BWP 906 to BWP 904 in response to an expiry of a BWP inactivity timer and/or in response receiving a DCI indicating BWP 904 as the active BWP. The UE may switch at a switching point 914 from active BWP 904 to BWP 902 in response receiving a DCI indicating BWP 902 as the active BWP.

If a UE is configured for a secondary cell with a default downlink BWP in a set of configured downlink BWPs and a timer value, UE procedures for switching BWPs on a secondary cell may be the same/similar as those on a primary cell. For example, the UE may use the timer value and the default downlink BWP for the secondary cell in the same/similar manner as the UE would use these values for a primary cell.

To provide for greater data rates, two or more carriers can be aggregated and simultaneously transmitted to/from the same UE using carrier aggregation (CA). The aggregated carriers in CA may be referred to as component carriers (CCs). When CA is used, there are a number of serving cells for the UE, one for a CC. The CCs may have three configurations in the frequency domain.

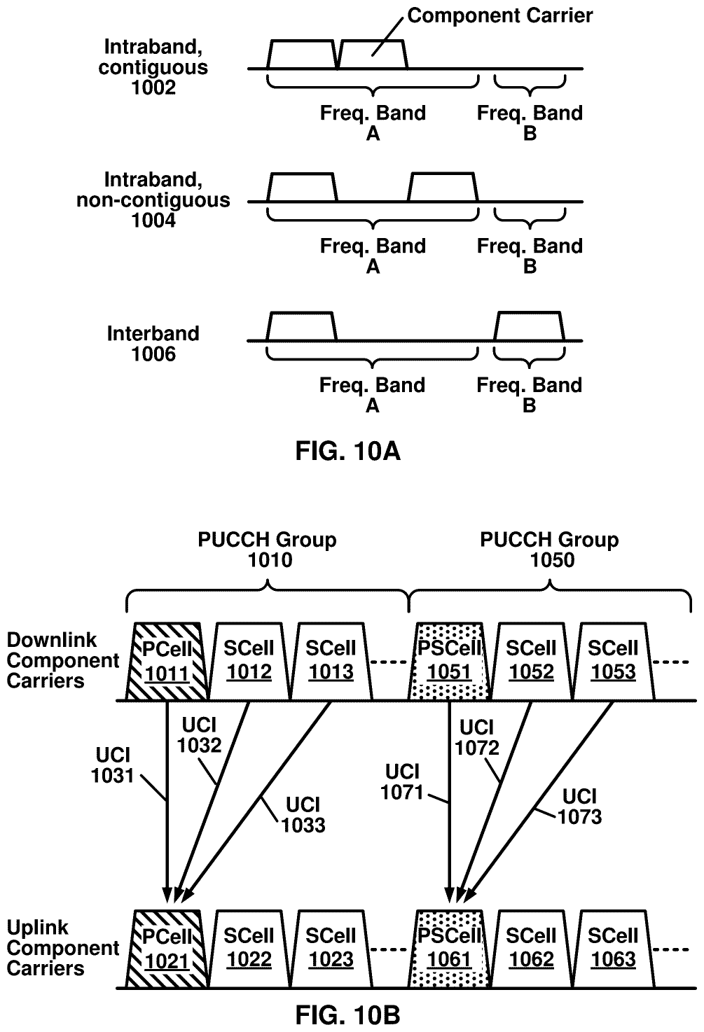

FIG. 10A illustrates the three CA configurations with two CCs. In the intraband, contiguous configuration 1002, the two CCs are aggregated in the same frequency band (frequency band A) and are located directly adjacent to each other within the frequency band. In the intraband, non-contiguous configuration 1004, the two CCs are aggregated in the same frequency band (frequency band A) and are separated in the frequency band by a gap. In the interband configuration 1006, the two CCs are located in frequency bands (frequency band A and frequency band B).

In an example, up to 32 CCs may be aggregated. The aggregated CCs may have the same or different bandwidths, subcarrier spacing, and/or duplexing schemes (TDD or FDD). A serving cell for a UE using CA may have a downlink CC. For FDD, one or more uplink CCs may be optionally configured for a serving cell. The ability to aggregate more downlink carriers than uplink carriers may be useful, for example, when the UE has more data traffic in the downlink than in the uplink.

When CA is used, one of the aggregated cells for a UE may be referred to as a primary cell (PCell). The PCell may be the serving cell that the UE initially connects to at RRC connection establishment, reestablishment, and/or handover. The PCell may provide the UE with NAS mobility information and the security input. UEs may have different PCells. In the downlink, the carrier corresponding to the PCell may be referred to as the downlink primary CC (DL PCC). In the uplink, the carrier corresponding to the PCell may be referred to as the uplink primary CC (UL PCC). The other aggregated cells for the UE may be referred to as secondary cells (SCells). In an example, the SCells may be configured after the PCell is configured for the UE. For example, an SCell may be configured through an RRC Connection Reconfiguration procedure. In the downlink, the carrier corresponding to an SCell may be referred to as a downlink secondary CC (DL SCC). In the uplink, the carrier corresponding to the SCell may be referred to as the uplink secondary CC (UL SCC).

Configured SCells for a UE may be activated and deactivated based on, for example, traffic and channel conditions. Deactivation of an SCell may mean that PDCCH and PDSCH reception on the SCell is stopped and PUSCH, SRS, and CQI transmissions on the SCell are stopped. Configured SCells may be activated and deactivated using a MAC CE with respect to FIG. 4B. For example, a MAC CE may use a bitmap (e.g., one bit per SCell) to indicate which SCells (e.g., in a subset of configured SCells) for the UE are activated or deactivated. Configured SCells may be deactivated in response to an expiration of an SCell deactivation timer (e.g., one SCell deactivation timer per SCell).

Downlink control information, such as scheduling assignments and scheduling grants, for a cell may be transmitted on the cell corresponding to the assignments and grants, which is known as self-scheduling. The DCI for the cell may be transmitted on another cell, which is known as cross-carrier scheduling. Uplink control information (e.g., HARQ acknowledgments and channel state feedback, such as CQI, PMI, and/or RI) for aggregated cells may be transmitted on the PUCCH of the PCell. For a larger number of aggregated downlink CCs, the PUCCH of the PCell may become overloaded. Cells may be divided into multiple PUCCH groups.

FIG. 10B illustrates an example of how aggregated cells may be configured into one or more PUCCH groups. A PUCCH group 1010 and a PUCCH group 1050 may include one or more downlink CCs, respectively. In the example of FIG. 10B, the PUCCH group 1010 includes three downlink CCs: a PCell 1011, an SCell 1012, and an SCell 1013. The PUCCH group 1050 includes three downlink CCs in the present example: a PCell 1051, an SCell 1052, and an SCell 1053. One or more uplink CCs may be configured as a PCell 1021, an SCell 1022, and an SCell 1023. One or more other uplink CCs may be configured as a primary Scell (PSCell) 1061, an SCell 1062, and an SCell 1063. Uplink control information (UCI) related to the downlink CCs of the PUCCH group 1010, shown as UCI 1031, UCI 1032, and UCI 1033, may be transmitted in the uplink of the PCell 1021. Uplink control information (UCI) related to the downlink CCs of the PUCCH group 1050, shown as UCI 1071, UCI 1072, and UCI 1073, may be transmitted in the uplink of the PSCell 1061. In an example, if the aggregated cells depicted in FIG. 10B were not divided into the PUCCH group 1010 and the PUCCH group 1050, a single uplink PCell to transmit UCI relating to the downlink CCs, and the PCell may become overloaded. By dividing transmissions of UCI between the PCell 1021 and the PSCell 1061, overloading may be prevented.

A cell, comprising a downlink carrier and optionally an uplink carrier, may be assigned with a physical cell ID and a cell index. The physical cell ID or the cell index may identify a downlink carrier and/or an uplink carrier of the cell, for example, depending on the context in which the physical cell ID is used. A physical cell ID may be determined using a synchronization signal transmitted on a downlink component carrier. A cell index may be determined using RRC messages. In the disclosure, a physical cell ID may be referred to as a carrier ID, and a cell index may be referred to as a carrier index. For example, when the disclosure refers to a first physical cell ID for a first downlink carrier, the disclosure may mean the first physical cell ID is for a cell comprising the first downlink carrier. The same/similar concept may apply to, for example, a carrier activation. When the disclosure indicates that a first carrier is activated, the specification may mean that a cell comprising the first carrier is activated.

In CA, a multi-carrier nature of a PHY may be exposed to a MAC. In an example, a HARQ entity may operate on a serving cell. A transport block may be generated per assignment/grant per serving cell. A transport block and potential HARQ retransmissions of the transport block may be mapped to a serving cell.

In the downlink, a base station may transmit (e.g., unicast, multicast, and/or broadcast) one or more Reference Signals (RSs) to a UE (e.g., PSS, SSS, CSI-RS, DMRS, and/or PT-RS, as shown in FIG. 5A). In the uplink, the UE may transmit one or more RSs to the base station (e.g., DMRS, PT-RS, and/or SRS, as shown in FIG. 5B). The PSS and the SSS may be transmitted by the base station and used by the UE to synchronize the UE to the base station. The PSS and the SSS may be provided in a synchronization signal (SS)/physical broadcast channel (PBCH) block that includes the PSS, the SSS, and the PBCH. The base station may periodically transmit a burst of SS/PBCH blocks.

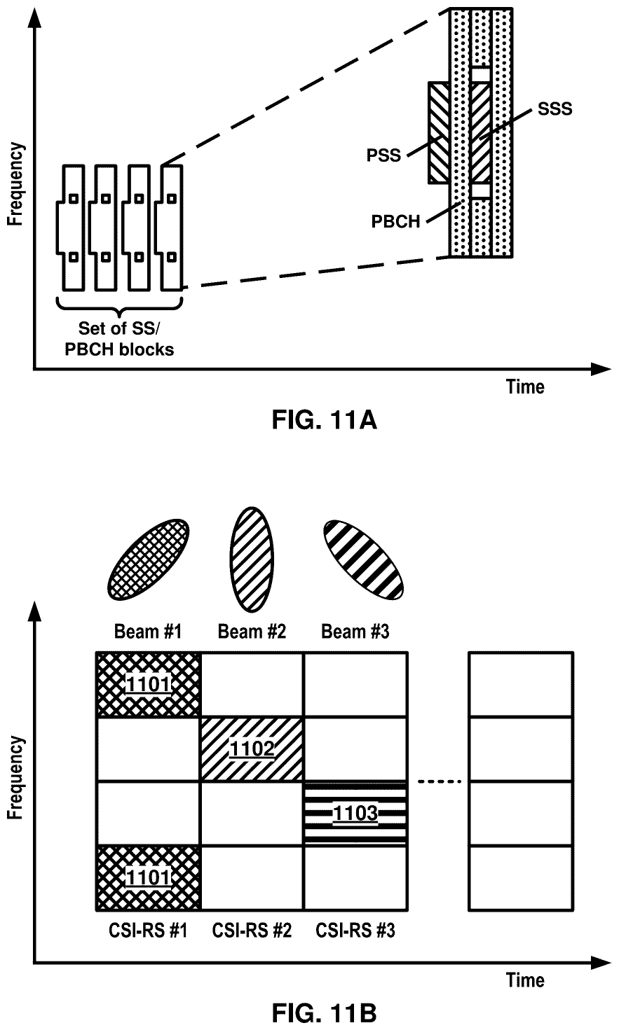

FIG. 11A illustrates an example of an SS/PBCH block's structure and location. A burst of SS/PBCH blocks may include one or more SS/PBCH blocks (e.g., 4 SS/PBCH blocks, as shown in FIG. 11A). Bursts may be transmitted periodically (e.g., every 2 frames or 20 ms). A burst may be restricted to a half-frame (e.g., a first half-frame having a duration of 5 ms). It will be understood that FIG. 11A is an example, and that these parameters (number of SS/PBCH blocks per burst, periodicity of bursts, position of burst within the frame) may be configured based on, for example: a carrier frequency of a cell in which the SS/PBCH block is transmitted; a numerology or subcarrier spacing of the cell; a configuration by the network (e.g., using RRC signaling); or any other suitable factor. In an example, the UE may assume a subcarrier spacing for the SS/PBCH block based on the carrier frequency being monitored, unless the radio network configured the UE to assume a different subcarrier spacing.

The SS/PBCH block may span one or more OFDM symbols in the time domain (e.g., 4 OFDM symbols, as shown in the example of FIG. 11A) and may span one or more subcarriers in the frequency domain (e.g., 240 contiguous subcarriers). The PSS, the SSS, and the PBCH may have a common center frequency. The PSS may be transmitted first and may span, for example, 1 OFDM symbol and 127 subcarriers. The SSS may be transmitted after the PSS (e.g., two symbols later) and may span 1 OFDM symbol and 127 subcarriers. The PBCH may be transmitted after the PSS (e.g., across the next 3 OFDM symbols) and may span 240 subcarriers.

The location of the SS/PBCH block in the time and frequency domains may not be known to the UE (e.g., if the UE is searching for the cell). To find and select the cell, the UE may monitor a carrier for the PSS. For example, the UE may monitor a frequency location within the carrier. If the PSS is not found after a certain duration (e.g., 20 ms), the UE may search for the PSS at a different frequency location within the carrier, as indicated by a synchronization raster. If the PSS is found at a location in the time and frequency domains, the UE may determine, based on a known structure of the SS/PBCH block, the locations of the SSS and the PBCH, respectively. The SS/PBCH block may be a cell-defining SS block (CD-SSB). In an example, a primary cell may be associated with a CD-SSB. The CD-SSB may be located on a synchronization raster. In an example, a cell selection/search and/or reselection may be based on the CD-SSB.

The SS/PBCH block may be used by the UE to determine one or more parameters of the cell. For example, the UE may determine a physical cell identifier (PCI) of the cell based on the sequences of the PSS and the SSS, respectively. The UE may determine a location of a frame boundary of the cell based on the location of the SS/PBCH block. For example, the SS/PBCH block may indicate that it has been transmitted in accordance with a transmission pattern, wherein a SS/PBCH block in the transmission pattern is a known distance from the frame boundary.

The PBCH may use a QPSK modulation and may use forward error correction (FEC). The FEC may use polar coding. One or more symbols spanned by the PBCH may carry one or more DMRSs for demodulation of the PBCH.

The PBCH may include an indication of a current system frame number (SFN) of the cell and/or a SS/PBCH block timing index. These parameters may facilitate time synchronization of the UE to the base station. The PBCH may include a master information block (MIB) used to provide the UE with one or more parameters. The MIB may be used by the UE to locate remaining minimum system information (RMSI) associated with the cell. The RMSI may include a System Information Block Type 1 (SIB1). The SIB1 may contain information needed by the UE to access the cell. The UE may use one or more parameters of the MIB to monitor PDCCH, which may be used to schedule PDSCH. The PDSCH may include the SIB1. The SIB1 may be decoded using parameters provided in the MIB. The PBCH may indicate an absence of SIB1. Based on the PBCH indicating the absence of SIB1, the UE may be pointed to a frequency. The UE may search for an SS/PBCH block at the frequency to which the UE is pointed.

The UE may assume that one or more SS/PBCH blocks transmitted with a same SS/PBCH block index are quasi co-located (QCLed) (e.g., having the same/similar Doppler spread, Doppler shift, average gain, average delay, and/or spatial Rx parameters). The UE may not assume QCL for SS/PBCH block transmissions having different SS/PBCH block indices.

SS/PBCH blocks (e.g., those within a half-frame) may be transmitted in spatial directions (e.g., using different beams that span a coverage area of the cell). In an example, a first SS/PBCH block may be transmitted in a first spatial direction using a first beam, and a second SS/PBCH block may be transmitted in a second spatial direction using a second beam.

In an example, within a frequency span of a carrier, a base station may transmit a plurality of SS/PBCH blocks. In an example, a first PCI of a first SS/PBCH block of the plurality of SS/PBCH blocks may be different from a second PCI of a second SS/PBCH block of the plurality of SS/PBCH blocks. The PCIs of SS/PBCH blocks transmitted in different frequency locations may be different or the same.

The CSI-RS may be transmitted by the base station and used by the UE to acquire channel state information (CSI). The base station may configure the UE with one or more CSI-RSs for channel estimation or any other suitable purpose. The base station may configure a UE with one or more of the same/similar CSI-RSs. The UE may measure the one or more CSI-RSs. The UE may estimate a downlink channel state and/or generate a CSI report based on the measuring of the one or more downlink CSI-RSs. The UE may provide the CSI report to the base station. The base station may use feedback provided by the UE (e.g., the estimated downlink channel state) to perform link adaptation.

The base station may semi-statically configure the UE with one or more CSI-RS resource sets. A CSI-RS resource may be associated with a location in the time and frequency domains and a periodicity. The base station may selectively activate and/or deactivate a CSI-RS resource. The base station may indicate to the UE that a CSI-RS resource in the CSI-RS resource set is activated and/or deactivated.

The base station may configure the UE to report CSI measurements. The base station may configure the UE to provide CSI reports periodically, aperiodically, or semi-persistently. For periodic CSI reporting, the UE may be configured with a timing and/or periodicity of a plurality of CSI reports. For aperiodic CSI reporting, the base station may request a CSI report. For example, the base station may command the UE to measure a configured CSI-RS resource and provide a CSI report relating to the measurements. For semi-persistent CSI reporting, the base station may configure the UE to transmit periodically, and selectively activate or deactivate the periodic reporting. The base station may configure the UE with a CSI-RS resource set and CSI reports using RRC signaling.

The CSI-RS configuration may comprise one or more parameters indicating, for example, up to 32 antenna ports. The UE may be configured to employ the same OFDM symbols for a downlink CSI-RS and a control resource set (CORESET) when the downlink CSI-RS and CORESET are spatially QCLed and resource elements associated with the downlink CSI-RS are outside of the physical resource blocks (PRBs) configured for the CORESET. The UE may be configured to employ the same OFDM symbols for downlink CSI-RS and SS/PBCH blocks when the downlink CSI-RS and SS/PBCH blocks are spatially QCLed and resource elements associated with the downlink CSI-RS are outside of PRBs configured for the SS/PBCH blocks.

Downlink DMRSs may be transmitted by a base station and used by a UE for channel estimation. For example, the downlink DMRS may be used for coherent demodulation of one or more downlink physical channels (e.g., PDSCH). An NR network may support one or more variable and/or configurable DMRS patterns for data demodulation. At least one downlink DMRS configuration may support a front-loaded DMRS pattern. A front-loaded DMRS may be mapped over one or more OFDM symbols (e.g., one or two adjacent OFDM symbols). A base station may semi-statically configure the UE with a number (e.g. a maximum number) of front-loaded DMRS symbols for PDSCH. A DMRS configuration may support one or more DMRS ports. For example, for single user-MIMO, a DMRS configuration may support up to eight orthogonal downlink DMRS ports per UE. For multiuser-MIMO, a DMRS configuration may support up to 4 orthogonal downlink DMRS ports per UE. A radio network may support (e.g., at least for CP-OFDM) a common DMRS structure for downlink and uplink, wherein a DMRS location, a DMRS pattern, and/or a scrambling sequence may be the same or different. The base station may transmit a downlink DMRS and a corresponding PDSCH using the same precoding matrix. The UE may use the one or more downlink DMRSs for coherent demodulation/channel estimation of the PDSCH.

In an example, a transmitter (e.g., a base station) may use a precoder matrices for a part of a transmission bandwidth. For example, the transmitter may use a first precoder matrix for a first bandwidth and a second precoder matrix for a second bandwidth. The first precoder matrix and the second precoder matrix may be different based on the first bandwidth being different from the second bandwidth. The UE may assume that a same precoding matrix is used across a set of PRBs. The set of PRBs may be denoted as a precoding resource block group (PRG).

A PDSCH may comprise one or more layers. The UE may assume that at least one symbol with DMRS is present on a layer of the one or more layers of the PDSCH. A higher layer may configure up to 3 DMRSs for the PDSCH.

Downlink PT-RS may be transmitted by a base station and used by a UE for phase-noise compensation. Whether a downlink PT-RS is present or not may depend on an RRC configuration. The presence and/or pattern of the downlink PT-RS may be configured on a UE-specific basis using a combination of RRC signaling and/or an association with one or more parameters employed for other purposes (e.g., modulation and coding scheme (MCS)), which may be indicated by DCI. When configured, a dynamic presence of a downlink PT-RS may be associated with one or more DCI parameters comprising at least MCS. An NR network may support a plurality of PT-RS densities defined in the time and/or frequency domains. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. Downlink PT-RS may be confined in the scheduled time/frequency duration for the UE. Downlink PT-RS may be transmitted on symbols to facilitate phase tracking at the receiver.

The UE may transmit an uplink DMRS to a base station for channel estimation. For example, the base station may use the uplink DMRS for coherent demodulation of one or more uplink physical channels. For example, the UE may transmit an uplink DMRS with a PUSCH and/or a PUCCH. The uplink DM-RS may span a range of frequencies that is similar to a range of frequencies associated with the corresponding physical channel. The base station may configure the UE with one or more uplink DMRS configurations. At least one DMRS configuration may support a front-loaded DMRS pattern. The front-loaded DMRS may be mapped over one or more OFDM symbols (e.g., one or two adjacent OFDM symbols). One or more uplink DMRSs may be configured to transmit at one or more symbols of a PUSCH and/or a PUCCH. The base station may semi-statically configure the UE with a number (e.g. maximum number) of front-loaded DMRS symbols for the PUSCH and/or the PUCCH, which the UE may use to schedule a single-symbol DMRS and/or a double-symbol DMRS. An NR network may support (e.g., for cyclic prefix orthogonal frequency division multiplexing (CP-OFDM)) a common DMRS structure for downlink and uplink, wherein a DMRS location, a DMRS pattern, and/or a scrambling sequence for the DMRS may be the same or different.

A PUSCH may comprise one or more layers, and the UE may transmit at least one symbol with DMRS present on a layer of the one or more layers of the PUSCH. In an example, a higher layer may configure up to three DMRSs for the PUSCH.

Uplink PT-RS (which may be used by a base station for phase tracking and/or phase-noise compensation) may or may not be present depending on an RRC configuration of the UE. The presence and/or pattern of uplink PT-RS may be configured on a UE-specific basis by a combination of RRC signaling and/or one or more parameters employed for other purposes (e.g., Modulation and Coding Scheme (MCS), which may be indicated by DCI. When configured, a dynamic presence of uplink PT-RS may be associated with one or more DCI parameters comprising at least MCS. A radio network may support a plurality of uplink PT-RS densities defined in time/frequency domain. When present, a frequency domain density may be associated with at least one configuration of a scheduled bandwidth. The UE may assume a same precoding for a DMRS port and a PT-RS port. A number of PT-RS ports may be fewer than a number of DMRS ports in a scheduled resource. For example, uplink PT-RS may be confined in the scheduled time/frequency duration for the UE.

SRS may be transmitted by a UE to a base station for channel state estimation to support uplink channel dependent scheduling and/or link adaptation. SRS transmitted by the UE may allow a base station to estimate an uplink channel state at one or more frequencies. A scheduler at the base station may employ the estimated uplink channel state to assign one or more resource blocks for an uplink PUSCH transmission from the UE. The base station may semi-statically configure the UE with one or more SRS resource sets. For an SRS resource set, the base station may configure the UE with one or more SRS resources. An SRS resource set applicability may be configured by a higher layer (e.g., RRC) parameter. For example, when a higher layer parameter indicates beam management, an SRS resource in a SRS resource set of the one or more SRS resource sets (e.g., with the same/similar time domain behavior, periodic, aperiodic, and/or the like) may be transmitted at a time instant (e.g., simultaneously). The UE may transmit one or more SRS resources in SRS resource sets. An NR network may support aperiodic, periodic and/or semi-persistent SRS transmissions. The UE may transmit SRS resources based on one or more trigger types, wherein the one or more trigger types may comprise higher layer signaling (e.g., RRC) and/or one or more DCI formats. In an example, at least one DCI format may be employed for the UE to select at least one of one or more configured SRS resource sets. An SRS trigger type 0 may refer to an SRS triggered based on a higher layer signaling. An SRS trigger type 1 may refer to an SRS triggered based on one or more DCI formats. In an example, when PUSCH and SRS are transmitted in a same slot, the UE may be configured to transmit SRS after a transmission of a PUSCH and a corresponding uplink DMRS.

The base station may semi-statically configure the UE with one or more SRS configuration parameters indicating at least one of following: a SRS resource configuration identifier; a number of SRS ports; time domain behavior of an SRS resource configuration (e.g., an indication of periodic, semi-persistent, or aperiodic SRS); slot, mini-slot, and/or subframe level periodicity; offset for a periodic and/or an aperiodic SRS resource; a number of OFDM symbols in an SRS resource; a starting OFDM symbol of an SRS resource; an SRS bandwidth; a frequency hopping bandwidth; a cyclic shift; and/or an SRS sequence ID.

An antenna port is defined such that the channel over which a symbol on the antenna port is conveyed can be inferred from the channel over which another symbol on the same antenna port is conveyed. If a first symbol and a second symbol are transmitted on the same antenna port, the receiver may infer the channel (e.g., fading gain, multipath delay, and/or the like) for conveying the second symbol on the antenna port, from the channel for conveying the first symbol on the antenna port. A first antenna port and a second antenna port may be referred to as quasi co-located (QCLed) if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming require beam management. Beam management may comprise beam measurement, beam selection, and beam indication. A beam may be associated with one or more reference signals. For example, a beam may be identified by one or more beamformed reference signals. The UE may perform downlink beam measurement based on downlink reference signals (e.g., a channel state information reference signal (CSI-RS)) and generate a beam measurement report. The UE may perform the downlink beam measurement procedure after an RRC connection is set up with a base station.

FIG. 11B illustrates an example of channel state information reference signals (CSI-RSs) that are mapped in the time and frequency domains. A square shown in FIG. 11B may span a resource block (RB) within a bandwidth of a cell. A base station may transmit one or more RRC messages comprising CSI-RS resource configuration parameters indicating one or more CSI-RSs. One or more of the following parameters may be configured by higher layer signaling (e.g., RRC and/or MAC signaling) for a CSI-RS resource configuration: a CSI-RS resource configuration identity, a number of CSI-RS ports, a CSI-RS configuration (e.g., symbol and resource element (RE) locations in a subframe), a CSI-RS subframe configuration (e.g., subframe location, offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

The three beams illustrated in FIG. 11B may be configured for a UE in a UE-specific configuration. Three beams are illustrated in FIG. 11B (beam #1, beam #2, and beam #3), more or fewer beams may be configured. Beam #1 may be allocated with CSI-RS 1101 that may be transmitted in one or more subcarriers in an RB of a first symbol. Beam #2 may be allocated with CSI-RS 1102 that may be transmitted in one or more subcarriers in an RB of a second symbol. Beam #3 may be allocated with CSI-RS 1103 that may be transmitted in one or more subcarriers in an RB of a third symbol. By using frequency division multiplexing (FDM), a base station may use other subcarriers in a same RB (for example, those that are not used to transmit CSI-RS 1101) to transmit another CSI-RS associated with a beam for another UE. By using time domain multiplexing (TDM), beams used for the UE may be configured such that beams for the UE use symbols from beams of other UEs.

CSI-RSs such as those illustrated in FIG. 11B (e.g., CSI-RS 1101, 1102, 1103) may be transmitted by the base station and used by the UE for one or more measurements. For example, the UE may measure a reference signal received power (RSRP) of configured CSI-RS resources. The base station may configure the UE with a reporting configuration and the UE may report the RSRP measurements to a network (for example, via one or more base stations) based on the reporting configuration. In an example, the base station may determine, based on the reported measurement results, one or more transmission configuration indication (TCI) states comprising a number of reference signals. In an example, the base station may indicate one or more TCI states to the UE (e.g., via RRC signaling, a MAC CE, and/or a DCI). The UE may receive a downlink transmission with a receive (Rx) beam determined based on the one or more TCI states. In an example, the UE may or may not have a capability of beam correspondence. If the UE has the capability of beam correspondence, the UE may determine a spatial domain filter of a transmit (Tx) beam based on a spatial domain filter of the corresponding Rx beam. If the UE does not have the capability of beam correspondence, the UE may perform an uplink beam selection procedure to determine the spatial domain filter of the Tx beam. The UE may perform the uplink beam selection procedure based on one or more sounding reference signal (SRS) resources configured to the UE by the base station. The base station may select and indicate uplink beams for the UE based on measurements of the one or more SRS resources transmitted by the UE.

In a beam management procedure, a UE may assess (e.g., measure) a channel quality of one or more beam pair links, a beam pair link comprising a transmitting beam transmitted by a base station and a receiving beam received by the UE. Based on the assessment, the UE may transmit a beam measurement report indicating one or more beam pair quality parameters comprising, e.g., one or more beam identifications (e.g., a beam index, a reference signal index, or the like), RSRP, a precoding matrix indicator (PMI), a channel quality indicator (CQI), and/or a rank indicator (RI).

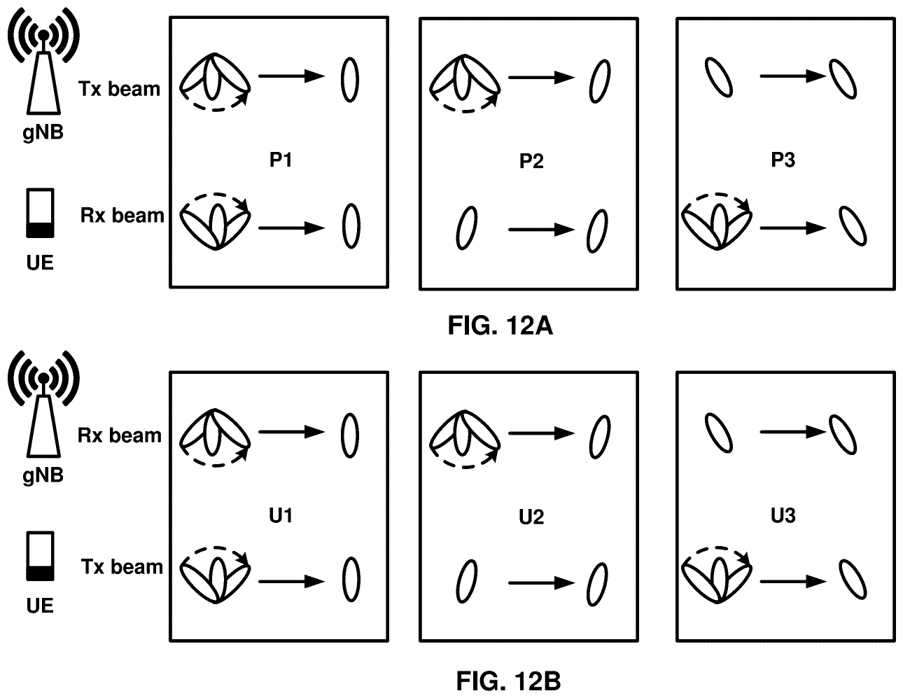

FIG. 12A illustrates examples of three downlink beam management procedures: P1, P2, and P3. Procedure P1 may enable a UE measurement on transmit (Tx) beams of a transmission reception point (TRP) (or multiple TRPs), e.g., to support a selection of one or more base station Tx beams and/or UE Rx beams (shown as ovals in the top row and bottom row, respectively, of P1). Beamforming at a TRP may comprise a Tx beam sweep for a set of beams (shown, in the top rows of P1 and P2, as ovals rotated in a counter-clockwise direction indicated by the dashed arrow). Beamforming at a UE may comprise an Rx beam sweep for a set of beams (shown, in the bottom rows of P1 and P3, as ovals rotated in a clockwise direction indicated by the dashed arrow). Procedure P2 may be used to enable a UE measurement on Tx beams of a TRP (shown, in the top row of P2, as ovals rotated in a counter-clockwise direction indicated by the dashed arrow). The UE and/or the base station may perform procedure P2 using a smaller set of beams than is used in procedure P1, or using narrower beams than the beams used in procedure P1. This may be referred to as beam refinement. The UE may perform procedure P3 for Rx beam determination by using the same Tx beam at the base station and sweeping an Rx beam at the UE.

FIG. 12B illustrates examples of three uplink beam management procedures: U1, U2, and U3. Procedure U1 may be used to enable a base station to perform a measurement on Tx beams of a UE, e.g., to support a selection of one or more UE Tx beams and/or base station Rx beams (shown as ovals in the top row and bottom row, respectively, of U1). Beamforming at the UE may include, e.g., a Tx beam sweep from a set of beams (shown in the bottom rows of U1 and U3 as ovals rotated in a clockwise direction indicated by the dashed arrow). Beamforming at the base station may include, e.g., an Rx beam sweep from a set of beams (shown, in the top rows of U1 and U2, as ovals rotated in a counter-clockwise direction indicated by the dashed arrow). Procedure U2 may be used to enable the base station to adjust its Rx beam when the UE uses a fixed Tx beam. The UE and/or the base station may perform procedure U2 using a smaller set of beams than is used in procedure P1, or using narrower beams than the beams used in procedure P1. This may be referred to as beam refinement The UE may perform procedure U3 to adjust its Tx beam when the base station uses a fixed Rx beam.

A UE may initiate a beam failure recovery (BFR) procedure based on detecting a beam failure. The UE may transmit a BFR request (e.g., a preamble, a UCI, an SR, a MAC CE, and/or the like) based on the initiating of the BFR procedure. The UE may detect the beam failure based on a determination that a quality of beam pair link(s) of an associated control channel is unsatisfactory (e.g., having an error rate higher than an error rate threshold, a received signal power lower than a received signal power threshold, an expiration of a timer, and/or the like).

The UE may measure a quality of a beam pair link using one or more reference signals (RSs) comprising one or more SS/PBCH blocks, one or more CSI-RS resources, and/or one or more demodulation reference signals (DMRSs). A quality of the beam pair link may be based on one or more of a block error rate (BLER), an RSRP value, a signal to interference plus noise ratio (SINR) value, a reference signal received quality (RSRQ) value, and/or a CSI value measured on RS resources. The base station may indicate that an RS resource is quasi co-located (QCLed) with one or more DM-RSs of a channel (e.g., a control channel, a shared data channel, and/or the like). The RS resource and the one or more DMRSs of the channel may be QCLed when the channel characteristics (e.g., Doppler shift, Doppler spread, average delay, delay spread, spatial Rx parameter, fading, and/or the like) from a transmission via the RS resource to the UE are similar or the same as the channel characteristics from a transmission via the channel to the UE.

A network (e.g., a gNB and/or an ng-eNB of a network) and/or the UE may initiate a random access procedure. A UE in an RRC_IDLE state and/or an RRC_INACTIVE state may initiate the random access procedure to request a connection setup to a network. The UE may initiate the random access procedure from an RRC_CONNECTED state. The UE may initiate the random access procedure to request uplink resources (e.g., for uplink transmission of an SR when there is no PUCCH resource available) and/or acquire uplink timing (e.g., when uplink synchronization status is non-synchronized). The UE may initiate the random access procedure to request one or more system information blocks (SIBs) (e.g., other system information such as SIB2, SIB3, and/or the like). The UE may initiate the random access procedure for a beam failure recovery request. A network may initiate a random access procedure for a handover and/or for establishing time alignment for an SCell addition.

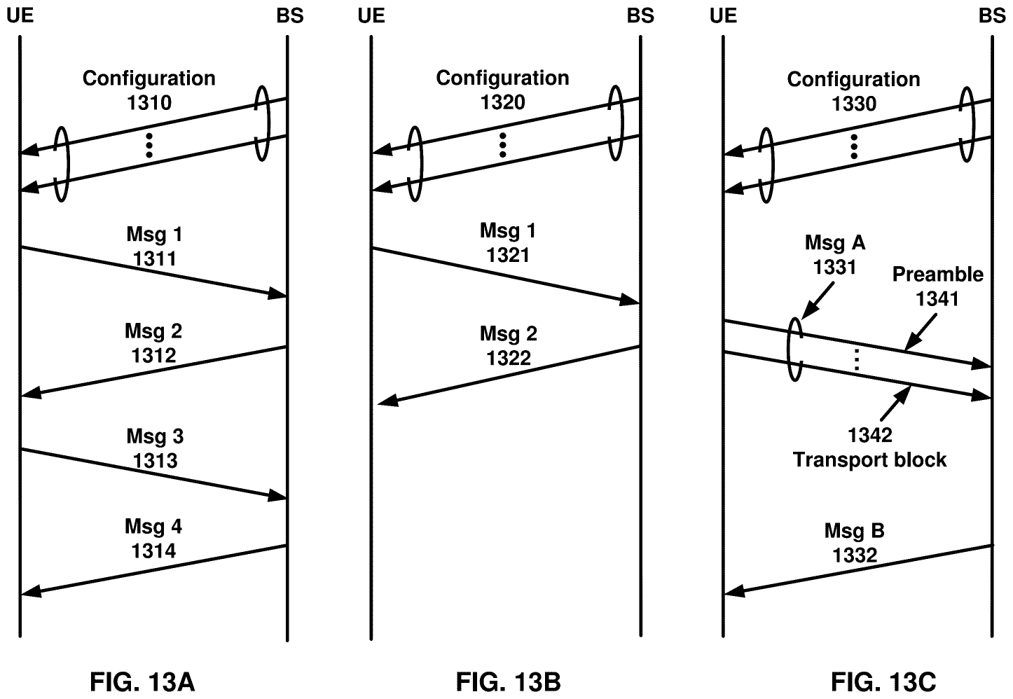

FIG. 13A illustrates a four-step contention-based random access procedure. Prior to initiation of the procedure, a base station may transmit a configuration message 1310 to the UE. The procedure illustrated in FIG. 13A comprises transmission of four messages: a Msg 1 1311, a Msg 2 1312, a Msg 3 1313, and a Msg 4 1314. The Msg 1 1311 may include and/or be referred to as a preamble (or a random access preamble). The Msg 2 1312 may include and/or be referred to as a random access response (RAR).

The configuration message 1310 may be transmitted, for example, using one or more RRC messages. The one or more RRC messages may indicate one or more random access channel (RACH) parameters to the UE. The one or more RACH parameters may comprise at least one of following: general parameters for one or more random access procedures (e.g., RACH-configGeneral); cell-specific parameters (e.g., RACH-ConfigCommon); and/or dedicated parameters (e.g., RACH-configDedicated). The base station may broadcast or multicast the one or more RRC messages to one or more UEs. The one or more RRC messages may be UE-specific (e.g., dedicated RRC messages transmitted to a UE in an RRC_CONNECTED state and/or in an RRC_INACTIVE state). The UE may determine, based on the one or more RACH parameters, a time-frequency resource and/or an uplink transmit power for transmission of the Msg 1 1311 and/or the Msg 3 1313. Based on the one or more RACH parameters, the UE may determine a reception timing and a downlink channel for receiving the Msg 2 1312 and the Msg 4 1314.

The one or more RACH parameters provided in the configuration message 1310 may indicate one or more Physical RACH (PRACH) occasions available for transmission of the Msg 1 1311. The one or more PRACH occasions may be predefined. The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. For example, the one or more RACH parameters may indicate a number of SS/PBCH blocks mapped to a PRACH occasion and/or a number of preambles mapped to a SS/PBCH blocks.

The one or more RACH parameters provided in the configuration message 1310 may be used to determine an uplink transmit power of Msg 1 1311 and/or Msg 3 1313. For example, the one or more RACH parameters may indicate a reference power for a preamble transmission (e.g., a received target power and/or an initial power of the preamble transmission). There may be one or more power offsets indicated by the one or more RACH parameters. For example, the one or more RACH parameters may indicate: a power ramping step; a power offset between SSB and CSI-RS; a power offset between transmissions of the Msg 1 1311 and the Msg 3 1313; and/or a power offset value between preamble groups. The one or more RACH parameters may indicate one or more thresholds based on which the UE may determine at least one reference signal (e.g., an SSB and/or CSI-RS) and/or an uplink carrier (e.g., a normal uplink (NUL) carrier and/or a supplemental uplink (SUL) carrier).

The Msg 1 1311 may include one or more preamble transmissions (e.g., a preamble transmission and one or more preamble retransmissions). An RRC message may be used to configure one or more preamble groups (e.g., group A and/or group B). A preamble group may comprise one or more preambles. The UE may determine the preamble group based on a pathloss measurement and/or a size of the Msg 3 1313. The UE may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The UE may select at least one preamble associated with the one or more reference signals and/or a selected preamble group, for example, if the association between the one or more preambles and the at least one reference signal is configured by an RRC message.

The UE may determine the preamble based on the one or more RACH parameters provided in the configuration message 1310. For example, the UE may determine the preamble based on a pathloss measurement, an RSRP measurement, and/or a size of the Msg 3 1313. As another example, the one or more RACH parameters may indicate: a preamble format; a maximum number of preamble transmissions; and/or one or more thresholds for determining one or more preamble groups (e.g., group A and group B). A base station may use the one or more RACH parameters to configure the UE with an association between one or more preambles and one or more reference signals (e.g., SSBs and/or CSI-RSs). If the association is configured, the UE may determine the preamble to include in Msg 1 1311 based on the association. The Msg 1 1311 may be transmitted to the base station via one or more PRACH occasions. The UE may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The UE may perform a preamble retransmission if no response is received following a preamble transmission. The UE may increase an uplink transmit power for the preamble retransmission. The UE may select an initial preamble transmit power based on a pathloss measurement and/or a target received preamble power configured by the network. The UE may determine to retransmit a preamble and may ramp up the uplink transmit power. The UE may receive one or more RACH parameters (e.g., PREAMBLE_POWER_RAMPING_STEP) indicating a ramping step for the preamble retransmission. The ramping step may be an amount of incremental increase in uplink transmit power for a retransmission. The UE may ramp up the uplink transmit power if the UE determines a reference signal (e.g., SSB and/or CSI-RS) that is the same as a previous preamble transmission. The UE may count a number of preamble transmissions and/or retransmissions (e.g., PREAMBLE_TRANSMISSION_COUNTER). The UE may determine that a random access procedure completed unsuccessfully, for example, if the number of preamble transmissions exceeds a threshold configured by the one or more RACH parameters (e.g., preamble TransMax).

The Msg 2 1312 received by the UE may include an RAR. In some scenarios, the Msg 2 1312 may include multiple RARs corresponding to multiple UEs. The Msg 2 1312 may be received after or in response to the transmitting of the Msg 1 1311. The Msg 2 1312 may be scheduled on the DL-SCH and indicated on a PDCCH using a random access RNTI (RA-RNTI). The Msg 2 1312 may indicate that the Msg 1 1311 was received by the base station. The Msg 2 1312 may include a time-alignment command that may be used by the UE to adjust the UE's transmission timing, a scheduling grant for transmission of the Msg 3 1313, and/or a Temporary Cell RNTI (TC-RNTI). After transmitting a preamble, the UE may start a time window (e.g., ra-ResponseWindow) to monitor a PDCCH for the Msg 2 1312. The UE may determine when to start the time window based on a PRACH occasion that the UE uses to transmit the preamble. For example, the UE may start the time window one or more symbols after a last symbol of the preamble (e.g., at a first PDCCH occasion from an end of a preamble transmission). The one or more symbols may be determined based on a numerology. The PDCCH may be in a common search space (e.g., a Type1-PDCCH common search space) configured by an RRC message. The UE may identify the RAR based on a Radio Network Temporary Identifier (RNTI). RNTIs may be used depending on one or more events initiating the random access procedure. The UE may use random access RNTI (RA-RNTI). The RA-RNTI may be associated with PRACH occasions in which the UE transmits a preamble. For example, the UE may determine the RA-RNTI based on: an OFDM symbol index; a slot index; a frequency domain index; and/or a UL carrier indicator of the PRACH occasions. An example of RA-RNTI may be as follows:

$$RA - RNTI = 1 + s\_id + 14 \times t\_id + 14 \times 80 \times f\_id + 14 \times 80 \times 8 \times ul\_carrier \_id$$

where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The UE may transmit the Msg 3 1313 in response to a successful reception of the Msg 2 1312 (e.g., using resources identified in the Msg 2 1312). The Msg 3 1313 may be used for contention resolution in, for example, the contention-based random access procedure illustrated in FIG. 13A. In some scenarios, a plurality of UEs may transmit a same preamble to a base station and the base station may provide an RAR that corresponds to a UE. Collisions may occur if the plurality of UEs interpret the RAR as corresponding to themselves. Contention resolution (e.g., using the Msg 3 1313 and the Msg 4 1314) may be used to increase the likelihood that the UE does not incorrectly use an identity of another the UE. To perform contention resolution, the UE may include a device identifier in the Msg 3 1313 (e.g., a C-RNTI if assigned, a TC-RNTI included in the Msg 2 1312, and/or any other suitable identifier).

The Msg 4 1314 may be received after or in response to the transmitting of the Msg 3 1313. If a C-RNTI was included in the Msg 3 1313, the base station will address the UE on the PDCCH using the C-RNTI. If the UE's unique C-RNTI is detected on the PDCCH, the random access procedure is determined to be successfully completed. If a TC-RNTI is included in the Msg 3 1313 (e.g., if the UE is in an RRC_IDLE state or not otherwise connected to the base station), Msg 4 1314 will be received using a DL-SCH associated with the TC-RNTI. If a MAC PDU is successfully decoded and a MAC PDU comprises the UE contention resolution identity MAC CE that matches or otherwise corresponds with the CCCH SDU sent (e.g., transmitted) in Msg 3 1313, the UE may determine that the contention resolution is successful and/or the UE may determine that the random access procedure is successfully completed.

The UE may be configured with a supplementary uplink (SUL) carrier and a normal uplink (NUL) carrier. An initial access (e.g., random access procedure) may be supported in an uplink carrier. For example, a base station may configure the UE with two separate RACH configurations: one for an SUL carrier and the other for an NUL carrier. For random access in a cell configured with an SUL carrier, the network may indicate which carrier to use (NUL or SUL). The UE may determine the SUL carrier, for example, if a measured quality of one or more reference signals is lower than a broadcast threshold. Uplink transmissions of the random access procedure (e.g., the Msg 1 1311 and/or the Msg 3 1313) may remain on the selected carrier. The UE may switch an uplink carrier during the random access procedure (e.g., between the Msg 1 1311 and the Msg 3 1313) in one or more cases. For example, the UE may determine and/or switch an uplink carrier for the Msg 1 1311 and/or the Msg 3 1313 based on a channel clear assessment (e.g., a listen-before-talk).

FIG. 13B illustrates a two-step contention-free random access procedure. Similar to the four-step contention-based random access procedure illustrated in FIG. 13A, a base station may, prior to initiation of the procedure, transmit a configuration message 1320 to the UE. The configuration message 1320 may be analogous in some respects to the configuration message 1310. The procedure illustrated in FIG. 13B comprises transmission of two messages: a Msg 1 1321 and a Msg 2 1322. The Msg 1 1321 and the Msg 2 1322 may be analogous in some respects to the Msg 1 1311 and a Msg 2 1312 illustrated in FIG. 13A, respectively. As will be understood from FIGS. 13A and 13B, the contention-free random access procedure may not include messages analogous to the Msg 3 1313 and/or the Msg 4 1314.

The contention-free random access procedure illustrated in FIG. 13B may be initiated for a beam failure recovery, other SI request, SCell addition, and/or handover. For example, a base station may indicate or assign to the UE the preamble to be used for the Msg 1 1321. The UE may receive, from the base station via PDCCH and/or RRC, an indication of a preamble (e.g., ra-PreambleIndex).

After transmitting a preamble, the UE may start a time window (e.g., ra-ResponseWindow) to monitor a PDCCH for the RAR. In the event of a beam failure recovery request, the base station may configure the UE with a separate time window and/or a separate PDCCH in a search space indicated by an RRC message (e.g., recoverySearchSpaceId). The UE may monitor for a PDCCH transmission addressed to a Cell RNTI (C-RNTI) on the search space. In the contention-free random access procedure illustrated in FIG. 13B, the UE may determine that a random access procedure successfully completes after or in response to transmission of Msg 1 1321 and reception of a corresponding Msg 2 1322. The UE may determine that a random access procedure successfully completes, for example, if a PDCCH transmission is addressed to a C-RNTI. The UE may determine that a random access procedure successfully completes, for example, if the UE receives an RAR comprising a preamble identifier corresponding to a preamble transmitted by the UE and/or the RAR comprises a MAC sub-PDU with the preamble identifier. The UE may determine the response as an indication of an acknowledgement for an SI request.

FIG. 13C illustrates another two-step random access procedure. Similar to the random access procedures illustrated in FIGS. 13A and 13B, a base station may, prior to initiation of the procedure, transmit a configuration message 1330 to the UE. The configuration message 1330 may be analogous in some respects to the configuration message 1310 and/or the configuration message 1320. The procedure illustrated in FIG. 13C comprises transmission of two messages: a Msg A 1331 and a Msg B 1332.

Msg A 1331 may be transmitted in an uplink transmission by the UE. Msg A 1331 may comprise one or more transmissions of a preamble 1341 and/or one or more transmissions of a transport block 1342. The transport block 1342 may comprise contents that are similar and/or equivalent to the contents of the Msg 3 1313 illustrated in FIG. 13A. The transport block 1342 may comprise UCI (e.g., an SR, a HARQ ACK/NACK, and/or the like). The UE may receive the Msg B 1332 after or in response to transmitting the Msg A 1331. The Msg B 1332 may comprise contents that are similar and/or equivalent to the contents of the Msg 2 1312 (e.g., an RAR) illustrated in FIGS. 13A and 13B and/or the Msg 4 1314 illustrated in FIG. 13A.

The UE may initiate the two-step random access procedure in FIG. 13C for licensed spectrum and/or unlicensed spectrum. The UE may determine, based on one or more factors, whether to initiate the two-step random access procedure. The one or more factors may be: a radio access technology in use (e.g., LTE, NR, and/or the like); whether the UE has valid TA or not; a cell size; the UE's RRC state; a type of spectrum (e.g., licensed vs. unlicensed); and/or any other suitable factors.

The UE may determine, based on two-step RACH parameters included in the configuration message 1330, a radio resource and/or an uplink transmit power for the preamble 1341 and/or the transport block 1342 included in the Msg A 1331. The RACH parameters may indicate a modulation and coding schemes (MCS), a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the UE to determine a reception timing and a downlink channel for monitoring for and/or receiving Msg B 1332.

The transport block 1342 may comprise data (e.g., delay-sensitive data), an identifier of the UE, security information, and/or device information (e.g., an International Mobile Subscriber Identity (IMSI). The base station may transmit the Msg B 1332 as a response to the Msg A 1331. The Msg B 1332 may comprise at least one of following: a preamble identifier; a timing advance command; a power control command; an uplink grant (e.g., a radio resource assignment and/or an MCS); a UE identifier for contention resolution; and/or an RNTI (e.g., a C-RNTI or a TC-RNTI). The UE may determine that the two-step random access procedure is successfully completed if: a preamble identifier in the Msg B 1332 is matched to a preamble transmitted by the UE; and/or the identifier of the UE in Msg B 1332 is matched to the identifier of the UE in the Msg A 1331 (e.g., the transport block 1342).

A UE and a base station may exchange control signaling. The control signaling may be referred to as L1/L2 control signaling and may originate from the PHY layer (e.g., layer 1) and/or the MAC layer (e.g., layer 2). The control signaling may comprise downlink control signaling transmitted from the base station to the UE and/or uplink control signaling transmitted from the UE to the base station.

The downlink control signaling may comprise: a downlink scheduling assignment; an uplink scheduling grant indicating uplink radio resources and/or a transport format; a slot format information; a preemption indication; a power control command; and/or any other suitable signaling. The UE may receive the downlink control signaling in a payload transmitted by the base station on a physical downlink control channel (PDCCH). The payload transmitted on the PDCCH may be referred to as downlink control information (DCI). In some scenarios, the PDCCH may be a group common PDCCH (GC-PDCCH) that is common to a group of UEs.

A base station may attach one or more cyclic redundancy check (CRC) parity bits to a DCI in order to facilitate detection of transmission errors. When the DCI is intended for a UE (or a group of the UEs), the base station may scramble the CRC parity bits with an identifier of the UE (or an identifier of the group of the UEs). Scrambling the CRC parity bits with the identifier may comprise Modulo-2 addition (or an exclusive OR operation) of the identifier value and the CRC parity bits. The identifier may comprise a 16-bit value of a radio network temporary identifier (RNTI).

DCIs may be used for different purposes. A purpose may be indicated by the type of RNTI used to scramble the CRC parity bits. For example, a DCI having CRC parity bits scrambled with a paging RNTI (P-RNTI) may indicate paging information and/or a system information change notification. The P-RNTI may be predefined as “FFFE” in hexadecimal. A DCI having CRC parity bits scrambled with a system information RNTI (SI-RNTI) may indicate a broadcast transmission of the system information. The SI-RNTI may be predefined as “FFFF” in hexadecimal. A DCI having CRC parity bits scrambled with a random access RNTI (RA-RNTI) may indicate a random access response (RAR). A DCI having CRC parity bits scrambled with a cell RNTI (C-RNTI) may indicate a dynamically scheduled unicast transmission and/or a triggering of PDCCH-ordered random access. A DCI having CRC parity bits scrambled with a temporary cell RNTI (TC-RNTI) may indicate a contention resolution (e.g., a Msg 3 analogous to the Msg 3 1313 illustrated in FIG. 13A). Other RNTIs configured to the UE by a base station may comprise a Configured Scheduling RNTI (CS-RNTI), a Transmit Power Control-PUCCH RNTI (TPC-PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C-RNTI), and/or the like.

Depending on the purpose and/or content of a DCI, the base station may transmit the DCIs with one or more DCI formats. For example, DCI format 0_0 may be used for scheduling of PUSCH in a cell. DCI format 0_0 may be a fallback DCI format (e.g., with compact DCI payloads). DCI format 0_1 may be used for scheduling of PUSCH in a cell (e.g., with more DCI payloads than DCI format 0_0). DCI format 1_0 may be used for scheduling of PDSCH in a cell. DCI format 1_0 may be a fallback DCI format (e.g., with compact DCI payloads). DCI format 1_1 may be used for scheduling of PDSCH in a cell (e.g., with more DCI payloads than DCI format 1_0). DCI format 2_0 may be used for providing a slot format indication to a group of UEs. DCI format 2_1 may be used for notifying a group of UEs of a physical resource block and/or OFDM symbol where the UE may assume no transmission is intended to the UE. DCI format 2_2 may be used for transmission of a transmit power control (TPC) command for PUCCH or PUSCH. DCI format 2_3 may be used for transmission of a group of TPC commands for SRS transmissions by one or more UEs. DCI format(s) for new functions may be defined in future releases. DCI formats may have different DCI sizes, or may share the same DCI size.

After scrambling a DCI with a RNTI, the base station may process the DCI with channel coding (e.g., polar coding), rate matching, scrambling and/or QPSK modulation. A base station may map the coded and modulated DCI on resource elements used and/or configured for a PDCCH. Based on a payload size of the DCI and/or a coverage of the base station, the base station may transmit the DCI via a PDCCH occupying a number of contiguous control channel elements (CCEs). The number of the contiguous CCEs (referred to as aggregation level) may be 1, 2, 4, 8, 16, and/or any other suitable number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

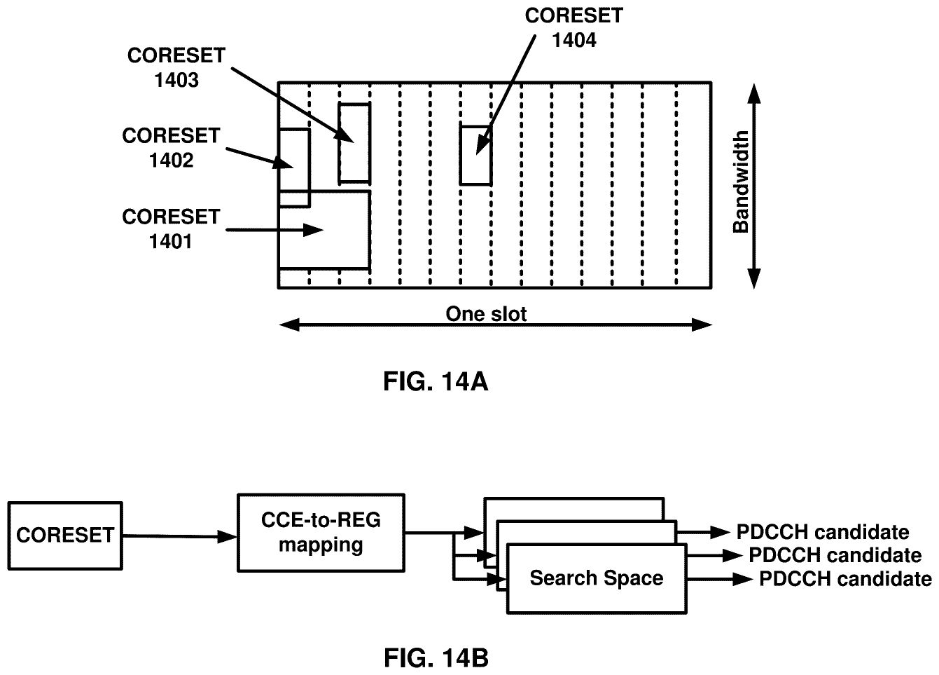

FIG. 14A illustrates an example of CORESET configurations for a bandwidth part. The base station may transmit a DCI via a PDCCH on one or more control resource sets (CORESETs). A CORESET may comprise a time-frequency resource in which the UE tries to decode a DCI using one or more search spaces. The base station may configure a CORESET in the time-frequency domain. In the example of FIG. 14A, a first CORESET 1401 and a second CORESET 1402 occur at the first symbol in a slot. The first CORESET 1401 overlaps with the second CORESET 1402 in the frequency domain. A third CORESET 1403 occurs at a third symbol in the slot. A fourth CORESET 1404 occurs at the seventh symbol in the slot. CORESETs may have a different number of resource blocks in frequency domain.

FIG. 14B illustrates an example of a CCE-to-REG mapping for DCI transmission on a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping by RRC configuration. A CORESET may be configured with an antenna port quasi co-location (QCL) parameter. The antenna port QCL parameter may indicate QCL information of a demodulation reference signal (DMRS) for PDCCH reception in the CORESET.

The base station may transmit, to the UE, RRC messages comprising configuration parameters of one or more CORESETs and one or more search space sets. The configuration parameters may indicate an association between a search space set and a CORESET. A search space set may comprise a set of PDCCH candidates formed by CCEs at a given aggregation level. The configuration parameters may indicate: a number of PDCCH candidates to be monitored per aggregation level; a PDCCH monitoring periodicity and a PDCCH monitoring pattern; one or more DCI formats to be monitored by the UE; and/or whether a search space set is a common search space set or a UE-specific search space set. A set of CCEs in the common search space set may be predefined and known to the UE. A set of CCEs in the UE-specific search space set may be configured based on the UE's identity (e.g., C-RNTI).

As shown in FIG. 14B, the UE may determine a time-frequency resource for a CORESET based on RRC messages. The UE may determine a CCE-to-REG mapping (e.g., interleaved or non-interleaved, and/or mapping parameters) for the CORESET based on configuration parameters of the CORESET. The UE may determine a number (e.g., at most 10) of search space sets configured on the CORESET based on the RRC messages. The UE may monitor a set of PDCCH candidates according to configuration parameters of a search space set. The UE may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding a DCI content of one or more PDCCH candidates with possible (or configured) PDCCH locations, possible (or configured) PDCCH formats (e.g., number of CCEs, number of PDCCH candidates in common search spaces, and/or number of PDCCH candidates in the UE-specific search spaces) and possible (or configured) DCI formats. The decoding may be referred to as blind decoding. The UE may determine a DCI as valid for the UE, in response to CRC checking (e.g., scrambled bits for CRC parity bits of the DCI matching a RNTI value). The UE may process information contained in the DCI (e.g., a scheduling assignment, an uplink grant, power control, a slot format indication, a downlink preemption, and/or the like).

The UE may transmit uplink control signaling (e.g., uplink control information (UCI) to a base station. The uplink control signaling may comprise hybrid automatic repeat request (HARQ) acknowledgements for received DL-SCH transport blocks. The UE may transmit the HARQ acknowledgements after receiving a DL-SCH transport block. Uplink control signaling may comprise channel state information (CSI) indicating channel quality of a physical downlink channel. The UE may transmit the CSI to the base station. The base station, based on the received CSI, may determine transmission format parameters (e.g., comprising multi-antenna and beamforming schemes) for a downlink transmission. Uplink control signaling may comprise scheduling requests (SR). The UE may transmit an SR indicating that uplink data is available for transmission to the base station. The UE may transmit a UCI (e.g., HARQ acknowledgements (HARQ-ACK), CSI report, SR, and the like) via a physical uplink control channel (PUCCH) or a physical uplink shared channel (PUSCH). The UE may transmit the uplink control signaling via a PUCCH using one of several PUCCH formats.

There may be five PUCCH formats and the UE may determine a PUCCH format based on a size of the UCI (e.g., a number of uplink symbols of UCI transmission and a number of UCI bits). PUCCH format 0 may have a length of one or two OFDM symbols and may include two or fewer bits. The UE may transmit UCI in a PUCCH resource using PUCCH format 0 if the transmission is over one or two symbols and the number of HARQ-ACK information bits with positive or negative SR (HARQ-ACK/SR bits) is one or two. PUCCH format 1 may occupy a number between four and fourteen OFDM symbols and may include two or fewer bits. The UE may use PUCCH format 1 if the transmission is four or more symbols and the number of HARQ-ACK/SR bits is one or two. PUCCH format 2 may occupy one or two OFDM symbols and may include more than two bits. The UE may use PUCCH format 2 if the transmission is over one or two symbols and the number of UCI bits is two or more. PUCCH format 3 may occupy a number between four and fourteen OFDM symbols and may include more than two bits. The UE may use PUCCH format 3 if the transmission is four or more symbols, the number of UCI bits is two or more and PUCCH resource does not include an orthogonal cover code. PUCCH format 4 may occupy a number between four and fourteen OFDM symbols and may include more than two bits. The UE may use PUCCH format 4 if the transmission is four or more symbols, the number of UCI bits is two or more and the PUCCH resource includes an orthogonal cover code.

The base station may transmit configuration parameters to the UE for a plurality of PUCCH resource sets using, for example, an RRC message. The plurality of PUCCH resource sets (e.g., up to four sets) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a number (e.g. a maximum number) of UCI information bits the UE may transmit using one of the plurality of PUCCH resources in the PUCCH resource set. When configured with a plurality of PUCCH resource sets, the UE may select one of the plurality of PUCCH resource sets based on a total bit length of the UCI information bits (e.g., HARQ-ACK, SR, and/or CSI). If the total bit length of UCI information bits is two or fewer, the UE may select a first PUCCH resource set having a PUCCH resource set index equal to “0”. If the total bit length of UCI information bits is greater than two and less than or equal to a first configured value, the UE may select a second PUCCH resource set having a PUCCH resource set index equal to “1”. If the total bit length of UCI information bits is greater than the first configured value and less than or equal to a second configured value, the UE may select a third PUCCH resource set having a PUCCH resource set index equal to “2”. If the total bit length of UCI information bits is greater than the second configured value and less than or equal to a third value (e.g., 1406), the UE may select a fourth PUCCH resource set having a PUCCH resource set index equal to “3”.

After determining a PUCCH resource set from a plurality of PUCCH resource sets, the UE may determine a PUCCH resource from the PUCCH resource set for UCI (HARQ-ACK, CSI, and/or SR) transmission. The UE may determine the PUCCH resource based on a PUCCH resource indicator in a DCI (e.g., with a DCI format 1_0 or DCI for 1_1) received on a PDCCH. A three-bit PUCCH resource indicator in the DCI may indicate one of eight PUCCH resources in the PUCCH resource set. Based on the PUCCH resource indicator, the UE may transmit the UCI (HARQ-ACK, CSI and/or SR) using a PUCCH resource indicated by the PUCCH resource indicator in the DCI.

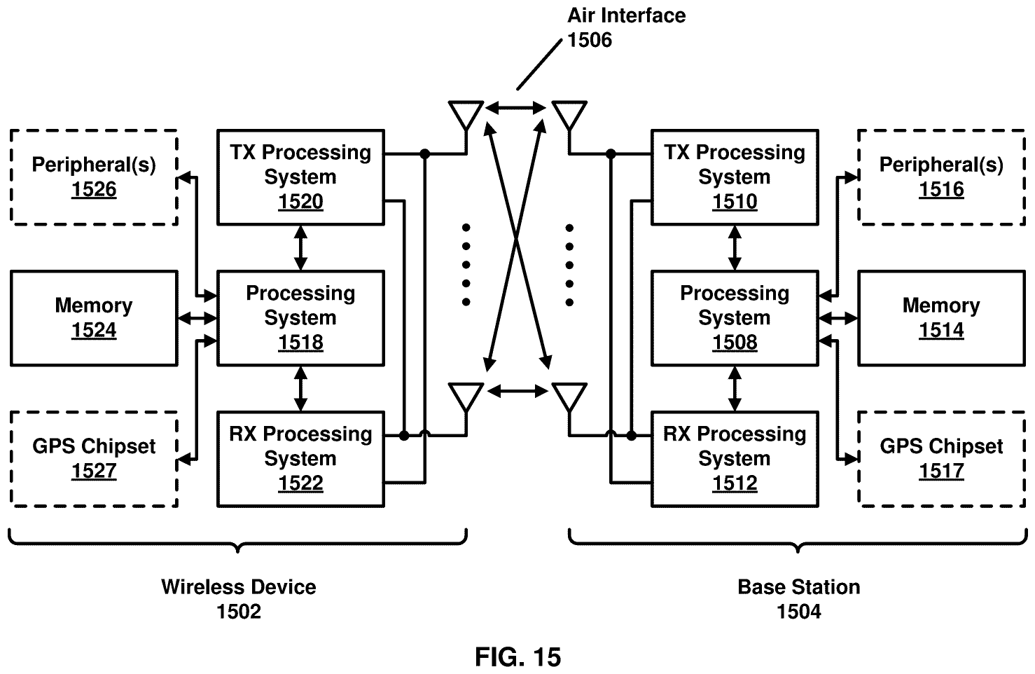

FIG. 15 illustrates an example of a wireless device 1502 in communication with a base station 1504 in accordance with embodiments of the present disclosure. The wireless device 1502 and base station 1504 may be part of a mobile communication network, such as the mobile communication network 100 illustrated in FIG. 1A, the mobile communication network 150 illustrated in FIG. 1B, or any other communication network. Only one wireless device 1502 and one base station 1504 are illustrated in FIG. 15, but it will be understood that a mobile communication network may include more than one UE and/or more than one base station, with the same or similar configuration as those shown in FIG. 15.

The base station 1504 may connect the wireless device 1502 to a core network (not shown) through radio communications over the air interface (or radio interface) 1506. The communication direction from the base station 1504 to the wireless device 1502 over the air interface 1506 is known as the downlink, and the communication direction from the wireless device 1502 to the base station 1504 over the air interface is known as the uplink. Downlink transmissions may be separated from uplink transmissions using FDD, TDD, and/or some combination of the two duplexing techniques.

In the downlink, data to be sent to the wireless device 1502 from the base station 1504 may be provided to the processing system 1508 of the base station 1504. The data may be provided to the processing system 1508 by, for example, a core network. In the uplink, data to be sent to the base station 1504 from the wireless device 1502 may be provided to the processing system 1518 of the wireless device 1502. The processing system 1508 and the processing system 1518 may implement layer 3 and layer 2 OSI functionality to process the data for transmission. Layer 2 may include an SDAP layer, a PDCP layer, an RLC layer, and a MAC layer, for example, with respect to FIG. 2A, FIG. 2B, FIG. 3, and FIG. 4A. Layer 3 may include an RRC layer as with respect to FIG. 2B.

After being processed by processing system 1508, the data to be sent to the wireless device 1502 may be provided to a transmission processing system 1510 of base station 1504. Similarly, after being processed by the processing system 1518, the data to be sent to base station 1504 may be provided to a transmission processing system 1520 of the wireless device 1502. The transmission processing system 1510 and the transmission processing system 1520 may implement layer 1 OSI functionality. Layer 1 may include a PHY layer with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

At the base station 1504, a reception processing system 1512 may receive the uplink transmission from the wireless device 1502. At the wireless device 1502, a reception processing system 1522 may receive the downlink transmission from base station 1504. The reception processing system 1512 and the reception processing system 1522 may implement layer 1 OSI functionality. Layer 1 may include a PHY layer with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

As shown in FIG. 15, a wireless device 1502 and the base station 1504 may include multiple antennas. The multiple antennas may be used to perform one or more MIMO or multi-antenna techniques, such as spatial multiplexing (e.g., single-user MIMO or multi-user MIMO), transmit/receive diversity, and/or beamforming. In other examples, the wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518 to carry out one or more of the functionalities discussed in the present application. Although not shown in FIG. 15, the transmission processing system 1510, the transmission processing system 1520, the reception processing system 1512, and/or the reception processing system 1522 may be coupled to a memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and the base station 1504 to operate in a wireless environment.

The processing system 1508 and/or the processing system 1518 may be connected to one or more peripherals 1516 and one or more peripherals 1526, respectively. The one or more peripherals 1516 and the one or more peripherals 1526 may include software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive user input data from and/or provide user output data to the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 and/or the processing system 1518 may be connected to a GPS chipset 1517 and a GPS chipset 1527, respectively. The GPS chipset 1517 and the GPS chipset 1527 may be configured to provide geographic location information of the wireless device 1502 and the base station 1504, respectively.

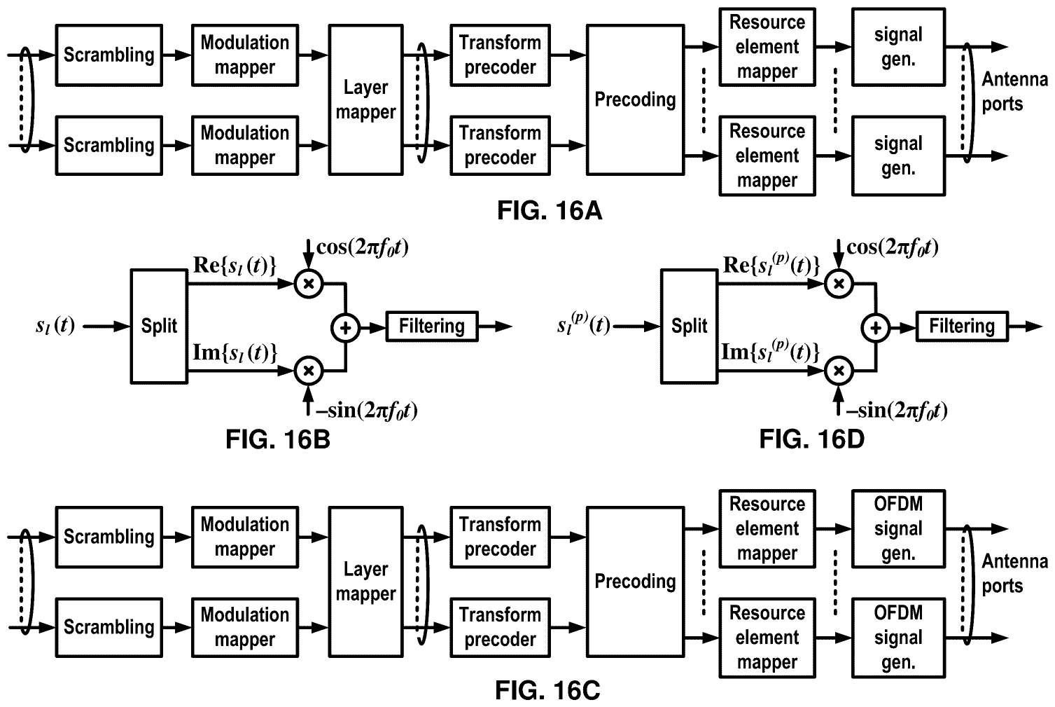

FIG. 16A illustrates an example structure for uplink transmission. A baseband signal representing a physical uplink shared channel may perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA) or CP-OFDM signal for an antenna port; and/or the like. In an example, when transform precoding is enabled, a SC-FDMA signal for uplink transmission may be generated. In an example, when transform precoding is not enabled, an CP-OFDM signal for uplink transmission may be generated by FIG. 16A. These functions are illustrated as examples and it is anticipated that other mechanisms may be implemented in various embodiments.

FIG. 16B illustrates an example structure for modulation and up-conversion of a baseband signal to a carrier frequency. The baseband signal may be a complex-valued SC-FDMA or CP-OFDM baseband signal for an antenna port and/or a complex-valued Physical Random Access Channel (PRACH) baseband signal. Filtering may be employed prior to transmission.

FIG. 16C illustrates an example structure for downlink transmissions. A baseband signal representing a physical downlink channel may perform one or more functions. The one or more functions may comprise: scrambling of coded bits in a codeword to be transmitted on a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are illustrated as examples and it is anticipated that other mechanisms may be implemented in various embodiments.

FIG. 16D illustrates another example structure for modulation and up-conversion of a baseband signal to a carrier frequency. The baseband signal may be a complex-valued OFDM baseband signal for an antenna port. Filtering may be employed prior to transmission.

A wireless device may receive from a base station one or more messages (e.g. RRC messages) comprising configuration parameters of a plurality of cells (e.g. primary cell, secondary cell). The wireless device may communicate with at least one base station (e.g. two or more base stations in dual-connectivity) via the plurality of cells. The one or more messages (e.g. as a part of the configuration parameters) may comprise parameters of physical, MAC, RLC, PCDP, SDAP, RRC layers for configuring the wireless device. For example, the configuration parameters may comprise parameters for configuring physical and MAC layer channels, bearers, etc. For example, the configuration parameters may comprise parameters indicating values of timers for physical, MAC, RLC, PCDP, SDAP, RRC layers, and/or communication channels.

A timer may begin running once it is started and continue running until it is stopped or until it expires. A timer may be started if it is not running or restarted if it is running. A timer may be associated with a value (e.g. the timer may be started or restarted from a value or may be started from zero and expire once it reaches the value). The duration of a timer may not be updated until the timer is stopped or expires (e.g., due to BWP switching). A timer may be used to measure a time period/window for a process. When the specification refers to an implementation and procedure related to one or more timers, it will be understood that there are multiple ways to implement the one or more timers. For example, it will be understood that one or more of the multiple ways to implement a timer may be used to measure a time period/window for the procedure. For example, a random access response window timer may be used for measuring a window of time for receiving a random access response. In an example, instead of starting and expiry of a random access response window timer, the time difference between two time stamps may be used. When a timer is restarted, a process for measurement of time window may be restarted. Other example implementations may be provided to restart a measurement of a time window.

A base station may transmit one or more MAC PDUs to a wireless device. In an example, a MAC PDU may be a bit string that is byte aligned (e.g., aligned to a multiple of eight bits) in length. In an example, bit strings may be represented by tables in which the most significant bit is the leftmost bit of the first line of the table, and the least significant bit is the rightmost bit on the last line of the table. More generally, the bit string may be read from left to right and then in the reading order of the lines. In an example, the bit order of a parameter field within a MAC PDU is represented with the first and most significant bit in the leftmost bit and the last and least significant bit in the rightmost bit.

In an example, a MAC SDU may be a bit string that is byte aligned (e.g., aligned to a multiple of eight bits) in length. In an example, a MAC SDU may be included in a MAC PDU from the first bit onward. A MAC CE may be a bit string that is byte aligned (e.g., aligned to a multiple of eight bits) in length. A MAC subheader may be a bit string that is byte aligned (e.g., aligned to a multiple of eight bits) in length. In an example, a MAC subheader may be placed immediately in front of a corresponding MAC SDU, MAC CE, or padding. A MAC entity may ignore a value of reserved bits in a DL MAC PDU.

In an example, a MAC PDU may comprise one or more MAC subPDUs. A MAC subPDU of the one or more MAC subPDUs may comprise: a MAC subheader only (including padding); a MAC subheader and a MAC SDU; a MAC subheader and a MAC CE; a MAC subheader and padding, or a combination thereof. The MAC SDU may be of variable size. A MAC subheader may correspond to a MAC SDU, a MAC CE, or padding.

In an example, when a MAC subheader corresponds to a MAC SDU, a variable-sized MAC CE, or padding, the MAC subheader may comprise: a Reserve field (R field) with a one bit length; an Format field (F field) with a one-bit length; a Logical Channel Identifier (LCID) field with a multi-bit length; a Length field (L field) with a multi-bit length, indicating the length of the corresponding MAC SDU or variable-size MAC CE in bytes, or a combination thereof. In an example, F field may indicate the size of the L field.

In an example, a MAC entity of the base station may transmit one or more MAC CEs (e.g., MAC CE commands) to a MAC entity of a wireless device. The one or more MAC CEs may comprise at least one of: a SP ZP CSI-RS Resource Set Activation/Deactivation MAC CE, a PUCCH spatial relation Activation/Deactivation MAC CE, a SP SRS Activation/Deactivation MAC CE, a SP CSI reporting on PUCCH Activation/Deactivation MAC CE, a TCI State Indication for UE-specific PDCCH MAC CE, a TCI State Indication for UE-specific PDSCH MAC CE, an Aperiodic CSI Trigger State Subselection MAC CE, a SP CSI-RS/CSI-IM Resource Set Activation/Deactivation MAC CE, a UE contention resolution identity MAC CE, a timing advance command MAC CE, a DRX command MAC CE, a Long DRX command MAC CE, an SCell activation/deactivation MAC CE (1 Octet), an SCell activation/deactivation MAC CE (4 Octet), and/or a duplication activation/deactivation MAC CE. In an example, a MAC CE, such as a MAC CE transmitted by a MAC entity of the base station to a MAC entity of the wireless device, may have an LCID in the MAC subheader corresponding to the MAC CE. In an example, a first MAC CE may has a first LCID in the MAC subheader that may be different than the second LCID in the MAC subheader of a second MAC CE. For example, an LCID given by 111011 in a MAC subheader may indicate that the MAC CE associated with the MAC subheader is a Long DRX command MAC CE.

In an example, the MAC entity of the wireless device may transmit to the MAC entity of the base station one or more MAC CEs. The one or more MAC CEs may comprise at least one of: a short buffer status report (BSR) MAC CE, a long BSR MAC CE, a C-RNTI MAC CE, a configured grant confirmation MAC CE, a single entry PHR MAC CE, a multiple entry PHR MAC CE, a Short truncated BSR, and/or a Long truncated BSR. In an example, a MAC CE may have an LCID in the MAC subheader corresponding to the MAC CE. In an example, a first MAC CE may has a first LCID in the MAC subheader that may be different than the second LCID in the MAC subheader of a second MAC CE. For example, an LCID given by 111011 in a MAC subheader may indicate that a MAC CE associated with the MAC subheader is a short-truncated command MAC CE.

In carrier aggregation (CA), two or more component carriers (CCs) may be aggregated. The wireless device may, using the technique of CA, simultaneously receive or transmit on one or more CCs, depending on capabilities of the wireless device. In an example, the wireless device may support CA for contiguous CCs and/or for non-contiguous CCs. CCs may be organized into cells. For example, CCs may be organized into one primary cell (PCell) and one or more secondary cells (SCells).

When configured with CA, the wireless device may have one RRC connection with a network. During an RRC connection establishment/re-establishment/handover, a cell providing NAS mobility information may be a serving cell. During an RRC connection re-establishment/handover procedure, a cell providing a security input may be the serving cell. In an example, the serving cell may be a PCell.

In an example, the base station may transmit, to the wireless device, one or more messages (e.g., one or more downlink signals). The one or more messages may comprise one or more RRC messages, e.g., one or more RRC configuration/reconfiguration messages. For example, the one or more RRC messages may comprise one or more configuration parameters (e.g., one or more RRC configuration parameters).

In an example, the one or more configuration parameters may comprise configuration parameters of a plurality of one or more SCells, depending on capabilities of the wireless device. When configured with CA, the base station and/or the wireless device may employ an activation/deactivation mechanism of an SCell to improve battery or power consumption of the wireless device. When the wireless device is configured with one or more SCells, the base station may activate or deactivate at least one of the one or more SCells. Upon configuration of an SCell, the SCell may be deactivated unless the SCell state associated with the SCell is set to “activated” or “dormant.” The wireless device may activate/deactivate the SCell in response to receiving an SCell Activation/Deactivation MAC CE.

For example, the base station may configure (e.g., via the one or more RRC messages/parameters) the wireless device with uplink (UL) bandwidth parts (BWPs) and downlink (DL) BWPs to enable bandwidth adaptation (BA) on a PCell. If carrier aggregation (CA) is configured, the base station may further configure the wireless device with at least one DL BWP (i.e., there may be no UL BWP in the UL) to enable BA on an SCell. For the PCell, an initial active BWP may be a first BWP used for initial access. In paired spectrum (e.g., FDD), the base station and/or the wireless device may independently switch a DL BWP and an UL BWP. In unpaired spectrum (e.g., TDD), the base station and/or the wireless device may simultaneously switch the DL BWP and the UL BWP.

In an example, the base station and/or the wireless device may switch a BWP between configured BWPs by means of a DCI or a BWP invalidity timer. When the BWP invalidity timer is configured for the serving cell, the base station and/or the wireless device may switch the active BWP to a default BWP in response to the expiry of the BWP invalidity timer associated with the serving cell. The default BWP may be configured by the network. In an example, for FDD systems, when configured with BA, one UL BWP for each uplink carrier and one DL BWP may be active at a time in the active serving cell. In an example, for TDD systems, one DL/UL BWP pair may be active at a time in the active serving cell. Operating on one UL BWP and one DL BWP (or one DL/UL pair) may improve the wireless device battery consumption. One or more BWPs other than the active UL BWP and the active DL BWP, which the wireless device may work on, may be deactivated. On the deactivated one or more BWPs, the wireless device may: not monitor PDCCH; and/or not transmit on PUCCH, PRACH, and UL-SCH. In an example, the MAC entity of the wireless device may apply normal operations on the active BWP for an activated serving cell configured with a BWP comprising: transmitting on UL-SCH; transmitting on RACH; monitoring a PDCCH; transmitting PUCCH; receiving DL-SCH; and/or (re-) initializing any suspended configured uplink grants of configured grant Type 1 according to a stored configuration, if any. In an example, on the inactive BWP for each activated serving cell configured with a BWP, the MAC entity of the wireless device may: not transmit on UL-SCH; not transmit on RACH; not monitor a PDCCH; not transmit PUCCH; not transmit SRS, not receive DL-SCH; clear any configured downlink assignment and configured uplink grant of configured grant Type 2; and/or suspend any configured uplink grant of configured Type 1.

In an example, a DCI addressed to an RNTI may comprise a CRC of the DCI being scrambled with the RNTI. The wireless device may monitor PDCCH addressed to (or for) the RNTI for detecting the DCI. For example, the PDCCH may carry (or be with) the DCI. In an example, the PDCCH may not carry the DCI.

In an example, a set of PDCCH candidates for the wireless device to monitor is defined in terms of one or more search space sets. A search space set may comprise a common search space (CSS) set or a UE-specific search space (USS) set. The wireless device may monitor one or more PDCCH candidates in one or more of the following search space sets: a Type0-PDCCH CSS set configured by pdcch-ConfigSIB1 in MIB or by searchSpace SIB1 in PDCCH-ConfigCommon or by searchSpaceZero in PDCCH-ConfigCommon for a DCI format with CRC scrambled by a SI-RNTI on the primary cell of the MCG, a Type0A-PDCCH CSS set configured by search SpaceOtherSystemInformation in PDCCH-ConfigCommon for a DCI format with CRC scrambled by the SI-RNTI on the primary cell of the MCG, a Type1-PDCCH CSS set configured by ra-SearchSpace in PDCCH-ConfigCommon for a DCI format with CRC scrambled by a RA-RNTI, a MSGB-RNTI, or a TC-RNTI on the primary cell, a Type2-PDCCH CSS set configured by pagingSearch Space in PDCCH-ConfigCommon for a DCI format with CRC scrambled by a P-RNTI on the primary cell of the MCG, a Type3-PDCCH CSS set configured by SearchSpace in PDCCH-Config with search Space Type=common for DCI formats with CRC scrambled by a INT-RNTI, a SFI-RNTI, a TPC-PUSCH-RNTI, a TPC-PUCCH-RNTI, a TPC-SRS-RNTI, a CI-RNTI, or a power saving RNTI (PS-RNTI) and, only for the primary cell, a C-RNTI, a MCS-C-RNTI, or a CS-RNTI(s), and the USS set configured by SearchSpace in PDCCH-Config with searchSpace Type=ue-Specific for DCI formats with CRC scrambled by the C-RNTI, the MCS-C-RNTI, a SP-CSI-RNTI, the CS-RNTI(s), a SL-RNTI, a SL-CS-RNTI, or a SL-L-CS-RNTI.

In an example, the wireless device may monitor the one or more PDCCH candidates according to one or more configuration parameters of the search space set. For example, the search space set may comprise a plurality of search spaces (SSs). The wireless device may monitor the one or more PDCCH candidates in one or more CORESETs for detecting one or more DCIs. Monitoring the one or more PDCCH candidates may comprise decoding at least one PDCCH candidate of the one or more PDCCH candidates according to the monitored DCI formats. For example, monitoring the one or more PDCCH candidates may comprise decoding (e.g., blind decoding) a DCI content of the at least one PDCCH candidate via possible (or configured) PDCCH location(s), possible (or configured) PDCCH format(s), e.g., number of CCEs, number of PDCCH candidates in CSS set(s), and/or number of PDCCH candidates in the USS(s), and/or possible (or configured) DCI format(s).

In an example, the wireless device may receive the C-RNTI (e.g., via one or more previous transmissions) from the base station. For example, the one or more previous transmissions may comprise a Msg2 1312, Msg4 1314, or a MsgB 1332. If the wireless device is not provided the Type3-PDCCH CSS set or the USS set and if provided the Type1-PDCCH CSS set, the wireless device may monitor the one or more PDCCH candidates for DCI format 0_0 and DCI format 1_0 with CRC scrambled by the C-RNTI in the Type1-PDCCH CSS set.

For example, the one or more search space sets may correspond to one or more of searchSpaceZero, searchSpaceSIB1, searchSpaceOtherSystemInformation, pagingSearch Space, ra-SearchSpace, and the C-RNTI, the MCS-C-RNTI, or the CS-RNTI. The wireless device may monitor the one or more PDCCH candidates for the DCI format 0_0 and the DCI format 1_0 with CRC scrambled by the C-RNTI, the MCS-C-RNTI, or the CS-RNTI in the one or more search space sets in a slot where the wireless device monitors the one or more PDCCH candidates for at least the DCI format 0_0 or the DCI format 1_0 with CRC scrambled by the SI-RNTI, the RA-RNTI, the MSGB-RNTI, or the P-RNTI.

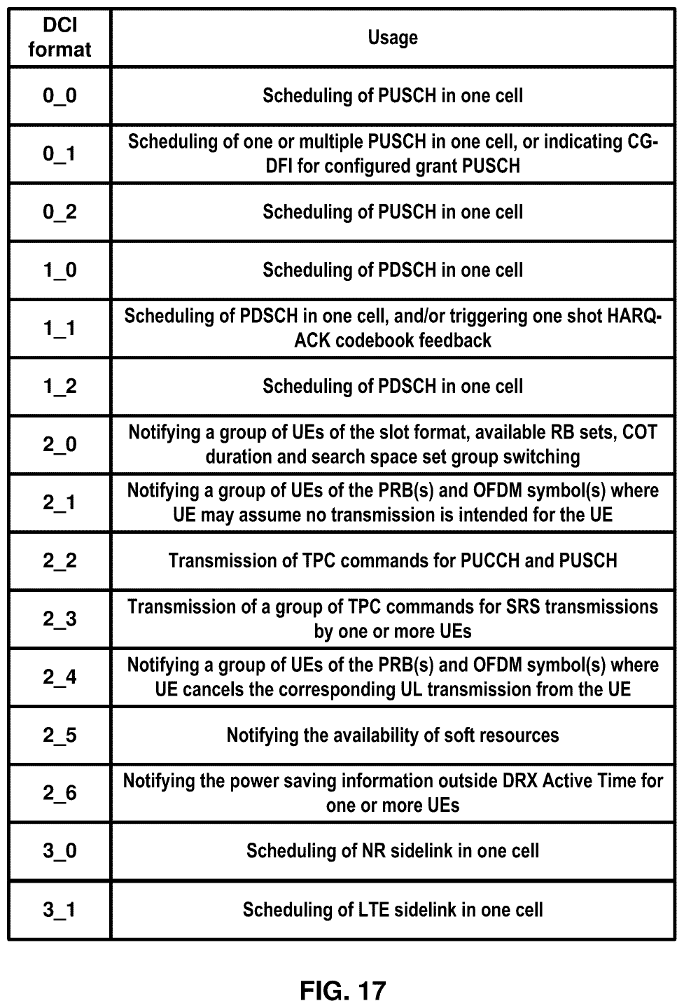

FIG. 17 shows several DCI formats. For example, the base station may use the DCI formats to transmit downlink control information to the wireless device. In an example, the wireless device may use the DCI formats for PDCCH monitoring. Different DCI formats may comprise different DCI fields and/or have different DCI payload sizes. Different DCI formats may have different signaling purposes. As shown in FIG. 17, DCI format 0_0 may be used to schedule PUSCH in one cell. In an example, DCI format 0_1 may be used to schedule one or multiple PUSCH in one cell or indicate CG-DFI (configured grant-Downlink Feedback Information) for configured grant PUSCH, etc.

In an example, the wireless device may support a baseline processing time/capability. For example, the wireless device may support additional aggressive/faster processing time/capability. In an example, the wireless device may report to the base station a processing capability, e.g., per sub-carrier spacing. In an example, a PDSCH processing time may be considered to determine, by a wireless device, a first uplink symbol of a PUCCH (e.g., determined at least based on a HARQ-ACK timing K1 and one or more PUCCH resources to be used and including the effect of the timing advance) comprising the HARQ-ACK information of the PDSCH scheduled by a DCI. In an example, the first uplink symbol of the PUCCH may not start earlier than a time gap (e.g., T_{proc,1}) after a last symbol of the PDSCH reception associated with the HARQ-ACK information. In an example, the first uplink symbol of the PUCCH which carries the HARQ-ACK information may start no earlier than at symbol L1, where L1 is defined as the next uplink symbol with its Cyclic Prefix (CP) starting after the time gap T_{proc,1} after the end of the last symbol of the PDSCH.

In an example, a PUSCH preparation/processing time may be considered for determining the transmission time of an UL data. For example, if the first uplink symbol in the PUSCH allocation for a transport block (including DM-RS) is no earlier than at symbol L2, the wireless device may perform transmitting the PUSCH. In an example, the symbol L2 may be determined, by a wireless device, at least based on a slot offset (e.g., K2), SLIV of the PUSCH allocation indicated by time domain resource assignment of a scheduling DCI. In an example, the symbol L2 may be specified as the next uplink symbol with its CP starting after a time gap with length T_{proc,2} after the end of the reception of the last symbol of the PDCCH carrying the DCI scheduling the PUSCH.

In an example, the one or more configuration parameters may comprise one or more DRX configuration parameters (e.g., DRX-Config). The one or more DRX configuration parameters may configure the wireless device with DRX operation. In an example, the one or more DRX configuration parameters may indicate monitoring the PDCCH for the DRX operation. For example, when in an RRC_CONNECTED state, if the DRX operation is configured (e.g., the DRX is configured or a DRX cycle is configured), for all the activated Serving Cells (e.g., the serving cell), the MAC entity of the wireless device may monitor the PDCCH discontinuously using the DRX operation. Otherwise, the MAC entity may monitor the PDCCH continuously.

For example, the wireless device may, based on the DRX operation being configured, use the DRX operation while communicating with the base station in the serving cell. For example, a MAC entity (or the MAC layer) of the wireless device, based on the DRX operation being configured, may control the PDCCH monitoring activity of the MAC entity. When the DRX operation is configured, the wireless device may monitor the PDCCH for at least one RNTI. In an example, the at least one RNTI may comprise one or more of the following: C-RNTI, cancelation indication RNTI (CI-RNTI), configured scheduling RNTI (CS-RNTI), interruption RNTI (INT-RNTI), slot format indication RNTI (SFI-RNTI), semi-persistent channel state information RNTI (SP-CSI-RNTI), transmit power control physical uplink control channel RNTI (TPC-PUCCH-RNTI), transmit power control physical shared channel RNTI (TPC-PUSCH-RNTI), transmit power control sounding reference signal RNTI (TPC-SRS-RNTI), or availability indicator RNTI (AI-RNTI).

In an example, the one or more DRX configuration parameters may comprise: DRX on duration timer/period/window (e.g., drx-onDurationTimer) indicating a duration at the beginning of a DRX cycle, drx-SlotOffset indicating a delay before starting the DRX on duration timer, DRX inactivity timer/period/window (e.g., drx-InactivityTimer) indicating a duration after a PDCCH occasion in which the PDCCH indicates a new UL or DL transmission for the MAC entity, DRX retransmission timer of DL (e.g., drx-Retransmission TimerDL), per DL HARQ process except for the broadcast process, indicating a maximum duration until a DL retransmission is received, DRX retransmission timer of UL (e.g., drx-Retransmission TimerUL), per UL HARQ process, indicating a maximum duration until a grant for UL retransmission is received, drx-LongCycleStartOffset indicating a Long DRX cycle and drx-StartOffset which defines a subframe where a Long and Short DRX cycle starts, drx-ShortCycle for a Short DRX cycle, drx-ShortCycle Timer indicating a duration the wireless device may follow the Short DRX cycle, drx-HARQ-RTT-TimerDL (per DL HARQ process except for the broadcast process) indicating a minimum duration before a DL assignment for HARQ retransmission is expected by the MAC entity, drx-HARQ-RTT-TimerUL (per UL HARQ process) indicating a minimum duration before an UL HARQ retransmission grant is expected by the MAC entity.

In an example, the Serving Cells (e.g., the serving cell) of a MAC entity may be configured the one or more DRX configuration parameters in two DRX groups with separate DRX parameters. When a secondary DRX group is not configured, there may be only one DRX group (e.g., a DRX group) and the Serving Cells (e.g., the serving cell) may belong to the DRX group. When the two DRX groups are configured (e.g., the DRX group and a second DRX group), each Serving Cell (e.g., the serving cell) is uniquely assigned (or belong) to either of the DRX group or the second DRX group. The DRX configuration parameters that are separately configured for each DRX group are: the DRX on duration timer (e.g., the drx-onDuration Timer) and/or the DRX inactivity timer (e.g., the drx-InactivityTimer). The one or more DRX configuration parameters that are common to the two DRX groups are: drx-SlotOffset, drx-Retransmission TimerDL, drx-Retransmission TimerUL, drx-LongCycleStartOffset, drx-ShortCycle (optional), drx-ShortCycle Timer (optional), drx-HARQ-RTT-TimerDL, and drx-HARQ-RTT-TimerUL.

For example, when the DRX operation is configured, the wireless device may be in an on duration of the DRX operation (e.g., a DRX on duration) or an off duration of the DRX operation (e.g., a DRX off duration). For example, the DRX on duration may start based on starting the DRX on duration timer/period. For example, when the wireless device is not in the DRX on duration, the wireless device may be in the DRX off duration. For example, the DRX off duration may stop based on starting the DRX on duration timer. For example, the wireless device may switch/transit from the DRX on duration to the DRX off duration based on stopping the DRX on duration timer. For example, the wireless device may switch/transit from the DRX off duration to the DRX on duration based on starting the DRX on duration.

In an example, when the DRX operation is configured, the wireless device may determine whether the wireless device is in an active time (or a DRX active state or Active Time) for the serving cell (or the Serving Cells) in the DRX group. For example, the wireless device may determine that the active time for the serving cell in the DRX group comprises the DRX on duration.

For example, the wireless device may determine that the active time for the serving cell in the DRX group comprises the time while: the DRX on duration timer (e.g., drx-onDuration Timer) or the DRX inactivity timer (e.g., drx-Inactivity Timer) configured for the DRX group is running, or the DRX retransmission timer of DL (e.g., drx-Retransmission TimerDL) or the DRX retransmission timer of the UL (e.g., drx-RetransmissionTimerUL) is running on any of the Serving Cells (e.g., the serving cell) in the DRX group, or a contention resolution timer (e.g., ra-ContentionResolution Timer) or a message B (MsgB) response window (e.g., msgB-ResponseWindow) is running, or a scheduling request (SR) is sent/transmitted on PUCCH and is pending, or a PDCCH indicating a new transmission addressed to the C-RNTI not being received after successful reception of a random access response (RAR) for a Random Access Preamble (or a preamble 1311/1321/1341) that is not selected by the MAC entity among the contention-based Random Access Preamble(s).

For example, when the wireless device is outside the active time for the serving cell in the DRX goup, the wireless device may be in a DRX inactive state (or a DRX non-active time or a DRX non-active state). For example, when the wireless device is in the active time for the serving cell in the DRX goup, the wireless device may be in a DRX active state.

For example, the wireless device may evaluate one or more DRX active time conditions (or one or more DRX Active Time conditions) to determine whether the wireless device is in the active time (for the serving cell in the DRX group) or not. For example, based on evaluating the one or more DRX active time conditions, the wireless device may determine that the wireless device is in active time based on the one or more DRX active time conditions being satisfied.

For example, the one or more DRX active time conditions may be satisfied based on the DRX on duration timer (e.g., drx-onDuration Timer) configured for the DRX group is running, or the DRX inactivity timer (e.g., drx-InactivityTimer) configured for the DRX group is running, or the DRX retransmission timer for DL (e.g., drx-Retransmission TimerDL), on any of the Serving Cells (including the serving cell) in the DRX group, is running, or the DRX retransmission timer for UL (e.g., drx-RetransmissionTimerUL), on any of the Serving Cells (including the serving cell) in the DRX group, is running, or the contention resolution timer (e.g., ra-ContentionResolution Timer) is running, or the MsgB response window (e.g., msgB-ResponseWindow) is running, or the PDCCH indicating the new transmission addressed to the C-RNTI (after successful reception of RAR for preamble that is not selected by the MAC entity among the contention-based preamble(s) has been received, or the SR is sent/transmitted on PUCCH and is pending.

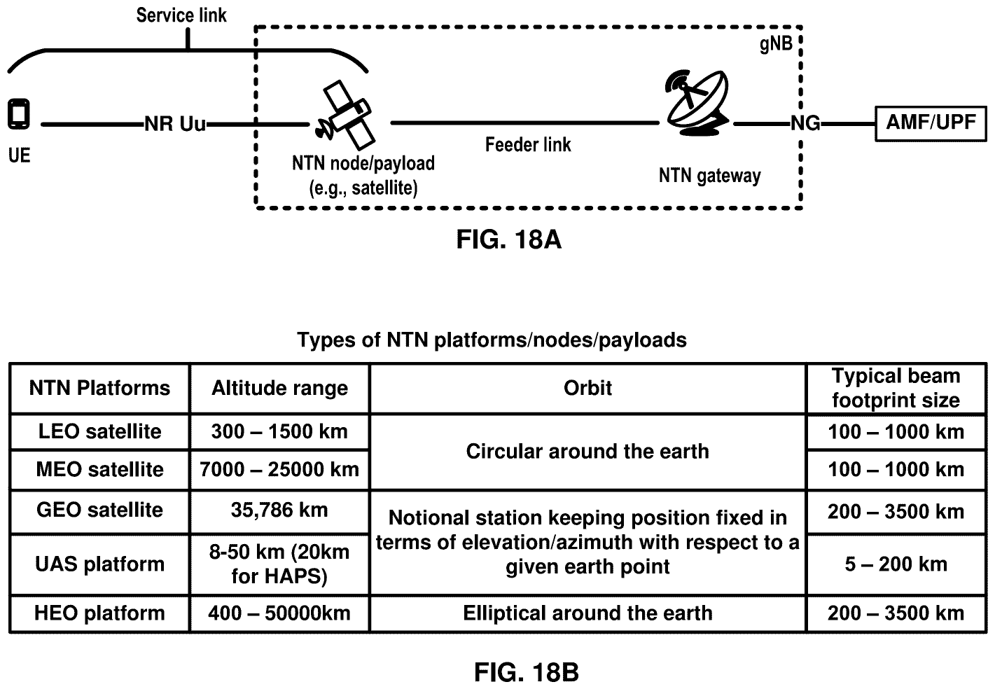

FIG. 18A shows an example of a non-terrestrial network. The non-terrestrial network (NTN) network (e.g., a satellite network) may be a network or network segment (e.g., an NG-RAN consisting of gNBs) for providing non-terrestrial NR access to wireless devices. The NTN may use a space-borne vehicle to embark a transmission equipment relay node (e.g., radio remote unit or a transparent payload) or a base station (or a regenerative payload). While a terrestrial network is a network located on the surface of the earth, an NTN may be a network which uses an NTN node (e.g., a satellite) as an access network, a backhaul interface network, or both. In an example, an NTN may comprise one or more NTN nodes (or payloads and/or space-borne vehicles), each of which may provide connectivity functions, between the service link and the feeder link.

An NTN node may embark a bent pipe payload (e.g., a transparent payload) or a regenerative payload. The NTN node with the transparent payload may comprise transmitter/receiver circuitries without the capability of on-board digital signal processing (e.g., modulation and/or coding) and connect to a base station (e.g., a base station of an NTN or the NTN base station or a non-terrestrial access point) via a feeder link. In some respects, as shown in FIG. 18A, the base station (e.g., a gNB) may further comprise the transparent NTN node, the feeder link, and/or a gateway (e.g., an NTN gateway). The gateway may be an earth station that is located at the surface of the earth, providing connectivity to the NTN payload using a feeder link. In some examples, the NTN node with the regenerative payload (e.g., the base station of the NTN or the NTN base station) may comprise functionalities of a base station, e.g., the on-board processing used to demodulate and decode the received signal and/or regenerate the signal before sending/transmitting it back to the earth. In some respects, as shown in FIG. 18A, the base station (e.g., the gNB) may further comprise the regenerative NTN node, the feeder link, and/or the gateway (e.g., the NTN gateway).

In some examples, the NTN node may be a satellite, a balloon, an air ship, an airplane, an unmanned aircraft system (UAS), an unmanned aerial vehicle (UAV), a drone, or the like. For example, the UAS may be a blimp, a high-altitude platform station (HAPS), e.g., an airborne vehicle embarking the NTN payload placed at an altitude between 8 and 50 km, or a pseudo satellite station. FIG. 18B is an example figure of different types of NTN platforms. In an example, a satellite may be placed into a low-earth orbit (LEO) at an altitude between 250 km to 1500 km, with orbital periods ranging from 90-130 minutes. From the perspective of a given point on the surface of the earth, the position of the LEO satellite may change. In an example, a satellite may be placed into a medium-earth orbit (MEO) at an altitude between 5000 to 20000 km, with orbital periods ranging from 2 hours to 14 hours. In an example, a satellite may be placed into a geostationary satellite earth orbit (GEO) at 35,786 km altitude, and directly above the equator. From the perspective of a given point on the surface of the earth, the position of the GEO satellite may not change.

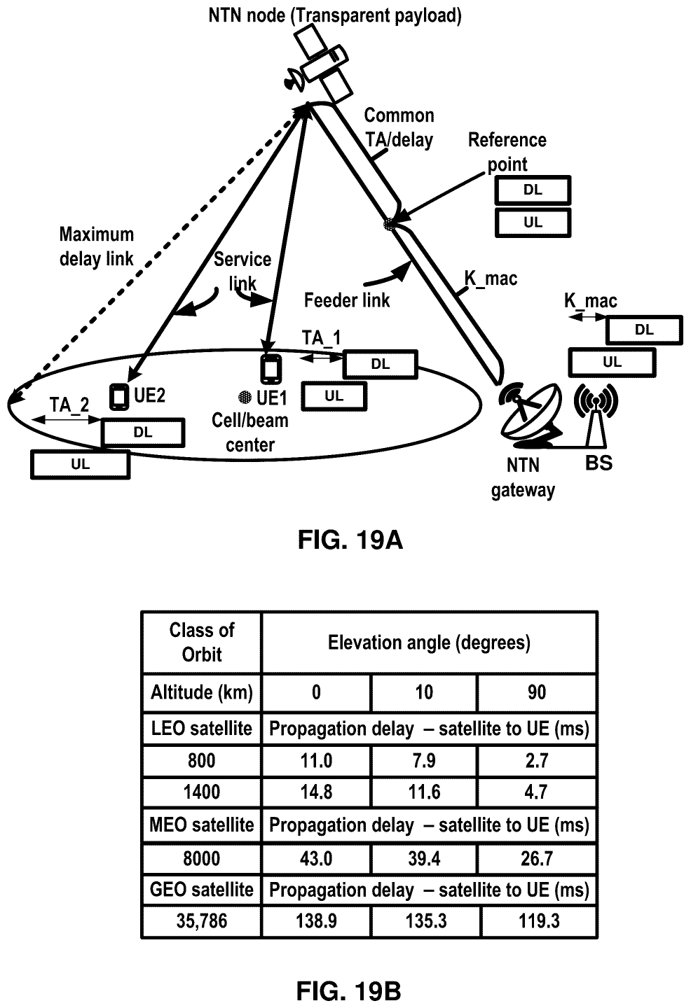

FIG. 19A shows an example of an NTN with a transparent NTN platform. As shown in FIG. 19A, the NTN node (e.g., the satellite) may forward a received signal from the NTN gateway on the ground back to the earth over the feeder link. In an example, the gateway and the base station may not be collocated. The NTN node may forward a received signal to the wireless device or the base station from another NTN node, e.g., over inter-link satellite communication links.

The NTN node may generate one or more beams over a given area (e.g., a coverage area or a cell). The footprint of a beam (or the cell) may be referred to as a spotbeam. For example, the footprint of a cell/beam may move over the Earth's surface with the satellite movement (e.g., a LEO with moving cells or a HAPS with moving cells). The footprint of a cell/beam may be Earth fixed with some beam pointing mechanism used by the satellite to compensate for its motion (e.g., a LEO with earth fixed cells). As shown in FIG. 18B, the size of a spotbeam may range from tens of kilometers to a few thousand kilometers. For example, the size of the spotbeam may depend on the system design.

A propagation delay may be an amount of time it takes for the head of the signal to travel from a sender (e.g., the base station or the NTN node) to a receiver (e.g., the wireless device) or vice versa. For uplink, the sender may be the wireless device and the receiver may be the base station/access network. For downlink, the sender may be the base station/access network and the receiver may be the wireless device. The propagation delay may vary depending on a change in distance between the sender and the receiver, e.g., due to movement of the NTN node, movement of the wireless device, a change of an inter-satellite link, and/or feeder link switching.

FIG. 19B shows examples of propagation delay corresponding to NTNs of different altitudes. The propagation delay in the figure may be one-way latency/delay. In an example, one-way latency/delay may be an amount of time used to propagate through a telecommunication system from the sender (e.g., the base station) to the receiver (e.g., the wireless device). In an example shown in FIG. 19B, for the transparent NTN, the round-trip propagation delay (RTD or UE-gNB RTT) may comprise service link delay (e.g., between the NTN node and the wireless device), feeder link delay (e.g., between the NTN gateway and the NTN node), and/or between the gateway and the base station (e.g., in the case the gateway and the NTN base station are not collocated). For example, the UE-gNB RTT (or the RTD) may be twice of the one-way delay between the wireless device and the base station. From FIG. 19B, in case of a GEO satellite with the transparent payload, the RTD may be four times of 138.9 milliseconds (approximately 556 milliseconds). In an example, the RTD of a terrestrial network (e.g., NR, E-UTRA, LTE) may be negligible compared to the RTD of an NTN scenario (e.g., the RTD of a terrestrial network may be less than 1 millisecond). A maximum RTD of a LEO satellite with the transparent payload and altitude of 600 km is approximately 25.77 milliseconds and with altitude of 1200 km is approximately 41.77 milliseconds.

A differential delay within a beam/cell of a NTN node may depend on, for example, the maximum diameter of the beam/cell footprint at nadir. For example, the differential delay withing the beam/cell may depend on the maximum delay link in FIG. 19A. In an example, the differential delay may imply the maximum difference between communication latency that two wireless devices, e.g., a first wireless device (UE1) that is located close to the center of the cell/beam and a second wireless device (UE2) that is located close to the edge of the cell/beam in FIG. 19B, may experience while communicating with the base station via the NTN node. The first wireless device may experience a smaller RTD compared to the second wireless device. The link with a maximum propagation delay (e.g., the maximum delay link) may experience the highest propagation delay (or the maximum RTD) in the cell/beam. In an example, the differential delay may imply a difference between the maximum delay of the cell/beam and a minimum delay of the cell/beam. In an example, the service link to a cell/beam center may experience the minimum propagation delay in the cell/beam. Depending on implementation, for a LEO satellite, the differential delay may be at least 3.12 milliseconds and may increase up to 8 milliseconds. In an example of a GEO satellite, depending on implementation, the differential delay may be as large as 32 milliseconds.

The wireless device (e.g., the first wireless device and/or the second wireless device in FIG. 19B) may receive the one or more configuration parameters, e.g., the one or more RRC configuration parameters from the base station. For example, the one or more configuration parameters may comprise one or more NTN configuration parameters. In some aspects, the wireless device may indicate a capability for NR NTN access (e.g., nonTerrestrialNetwork-r17), e.g., to receive the one or more NTN configuration parameters (e.g., via one or more NTN-specific SIBs). For example, the one or more NTN configuration parameters may be received, by the wireless device, from a broadcast system information (e.g., SIB1 and/or the one or more NTN-specific SIBs). The one or more NTN configuration parameters may facilitate/manage the calculation/determination/measurement of the propagation delay (e.g., the UE-gNB RTT) and/or a timing advance (TA) at one or more wireless devices (e.g., the wireless device) camping in the cell/beam. In an example, the one or more NTN configuration parameters may comprise at least one or more ephemeris parameters (e.g., satellite ephemeris parameters or NTN ephemeris parameters), one or more common delay/TA parameters, a validity duration/timer/window (e.g., ntn-UlSyncValidityDuration) for UL synchronization, an epoch time, and/or one or more timing offset parameters. For example, the one or more NTN configuration parameters may enable a TA reporting.

In an example, the wireless device may maintain/calculate a cell-specific timing offset, one or more beam-specific timing offsets, and/or a UE-specific timing offset (e.g., UE-specific K_Offset) based on the one or more timing offset parameters and/or one or more MAC CE commands and/or one or more RRC signaling. For example, the one or more timing offset parameters may comprise a first timing offset (e.g., Koffset in ServingCellConfigCommon). In some aspects, the first timing offset may account for the maximum RTD of the cell/beam. For example, the wireless device may track/update/maintain the cell/beam-specific timing offset based on receiving an update of the first timing offset from the base station. For example, the wireless device may receive a second timing offset (e.g., a Differential UE-Specific K_Offset MAC CE). The wireless device may update/track/maintain the UE-specific timing offset based on the second timing offset and/or the cell-specific timing offset.

In some examples, the one or more timing offset parameters may configure/indicate a third timing offset. The wireless device (or the base station) may set a MAC-specific timing offset (or a MAC layer timing offset), denoted by K-Mac, based on the third timing offset. For example, K-Mac may be 0, e.g., when the third timing offset is not indicated/configured. For example, in an NTN scenario with the transparent NTN node, when the UL frame and the DL frame is aligned at the base station, the third timing offset may be absent from the one or more NTN configuration parameters or may be 0. In an example, as shown in FIG. 19B, the MAC-specific timing offset may indicate a portion of the propagation delay (e.g., the UE-gNB RTT) that the base station may pre-compensate (e.g., when the UL frame and the DL frame are not aligned at the base station), e.g., the third timing offset may indicate the difference between the UL frame/configuration timing and the DL frame/configuration timing at the base station. As shown in FIG. 19B, the UL frame and DL frame may be aligned at a reference point on the feeder link. For example, the reference point may be the NTN node, e.g., the third timing offset is equal to the feeder link delay.

To maintain uplink orthogonality, transmissions from different wireless devices in a cell/beam (e.g., the first wireless device and the second wireless device in FIG. 19B) may be time-aligned at the base station and/or the NTN node (e.g., satellite). In an example, time alignment/synchronization may be achieved by using different timing advance (TA) values at different wireless devices to compensate for their different propagation delays (or RTDs). As shown in FIG. 19B, the first wireless device may use the first TA value (e.g., TA_1) and the second wireless device may use the second TA value (TA_2).

For example, the wireless device may calculate/measure/maintain a current TA (value) of the wireless device (e.g., NTA) based on at least a combination of a closed-loop TA procedure/control and/or an open-loop TA procedure/control. The current TA value of the first wireless device may be TA_1 and the current TA value of the second wireless device may be TA_2.

The closed-loop TA procedure/control may be based on receiving at least one TA command (TAC) MAC CE from the base station. For example, the at least one TAC CE may comprise a TA (or an absolute TA) command field of a Msg2 1312 (or a MsgB 1332).

The open-loop TA procedure/control may use a GNSS-acquired position (or location information) of the wireless device and/or receiving the one or more NTN configuration parameters, e.g., the one or more ephemeris parameters (e.g., the satellite ephemeris data), and/or the one or more common delay/TA parameters (e.g., the common TA value). The wireless device may, based on an implemented orbital predictor/propagator model, may use the one or more ephemeris parameters (and/or the GNSS-acquired position) to measure/calculate/maintain movement pattern of the satellite, estimate/measure the service link delay, and/or to adjust the current TA value (e.g., the TA of the wireless device) via the open-loop TA procedure/control. In an example, a combination of the closed-loop TA control and the open-loop TA control may be based on adding/summing the open-loop TA value (e.g., derived/calculated based on the open-loop TA procedure/control) and the closed-loop TA value (or a portion of the closed-loop TA procedure/control).

In an example, the wireless device may calculate/measure/estimate the UE-gNB RTT (or the RTD) based on the current TA value and the third timing offset (e.g., K-Mac). For example, the UE-gNB RTT may be the summation of the current TA value and K-Mac. In an example, if the third timing offset is not indicated or when the K-Mac is 0, the wireless device may determine/measure the UE-gNB RTT based on the current TA value, e.g., the UE-gNB RTT is equal to the current TA value. In an example, the wireless device may maintain/calculate/update the open-loop TA value (or the UE-gNB RTT) over the validity duration. For example, the validity duration may indicate the validity period of the (satellite) ephemeris data/information and/or the one or more common TA parameters. In an example, the validity duration may specify/indicate a maximum period/window (e.g., corresponding to an orbit predictor/propagator model the wireless device is using to estimate/calculate the propagation delay and/or a maximum tolerable error in estimating/measuring/calculating the open-loop TA value) during which the wireless device may not read/update/acquire the satellite ephemeris data and/or to acquire the one or more NTN-specific SIBs. For example, upon or in response to acquiring the new (satellite) ephemeris data (or parameters) and/or the one or more NTN-specific SIBs, the wireless device may start/restart the validity duration based on the epoch time indicated by the one or more NTN configuration parameters. In an example, in response to determining that the validity duration being expired, the wireless device may acquire the one or more NTN-specific SIBs to receive an updated (satellite) ephemeris data/information and/or an update of the one or more common TA parameters. In an example, upon the expiry of the validity duration and when the wireless device is not able to acquire the one or more NTN-specific SIBs, the wireless device may become unsynchronized with the base station, e.g., for UL communication with the base station.

In some aspects, in response to receiving the one or more NTN configuration parameters (e.g., via acquiring the one or more NTN-specific SIBs) and/or acquiring an updated GNSS-acquired position, the wireless device may calculate/measure/update the current TA value via the open-loop TA procedure/control. In another example, the wireless device may update the current TA value based on the closed-loop TA procedure/control, for example, based on receiving the one or more TAC MAC CEs. In an example, based on the current TA value being updated, the wireless device may adjust (recalculate) the UE-gNB RTT. In an example, based on receiving a new third timing offset, the wireless device may set K-Mac and adjust (recalculate) the UE-gNB RTT. In another example, the wireless device may periodically calculate/measure/update the current TA value. For example, the wireless device may, prior to performing an uplink transmission, calculate/measure/update the current TA value.

In an example, the wireless device may set the common TA/delay by zero in response to determining that the one or more common TA/delay parameters are absent from the one or more NTN configuration message. For example, when the reference point is located at the NTN node (e.g., the third timing offset is equal to the feeder link delay), the common TA/delay may be zero. In another example, for an NTN with the transparent payload, when the UL timing synchronization is held at the NTN node (e.g., the UL and DL frames are aligned at the base station), the wireless device may not pre-compensate the common TA.

In an example, the wireless device with GNSS capability may estimate the propagation delay (or the service link delay) based on one or more measurements. For example, the one or more measurements may indicate the GNSS-acquired location information (position) of the wireless device. In an example, the one or more measurements may allow the wireless device to calculate/estimate the propagation delay (or the open-loop TA value) using the GNSS-acquired position and the (satellite) ephemeris data/information. In another example, the one or more measurements may allow the wireless devices to estimate/calculate the propagation delay via one or more timestamps (e.g., the timestamp of a configured broadcast signal) and/or the epoch time. In an example, the one or more measurements may allow the wireless device to estimate/measure a variation rate by which the common TA and/or the service link delay changes over a period.

In existing technologies, e.g., in a TN scenario, a base station may, via/based on a (single) DCI, schedule transmission/reception of multiple TBs (e.g., M>1 different TBs) by a wireless device (e.g., multiple PDSCHs/PUSCHs by the single DCI and/or multi-slot DL/UL scheduling by the single DCI). For example, the base station may transmit the DCI, with a first DCI format (e.g., a DCI format 0_1 or a DCI format 1_1), to the wireless device. The base station may reduce signaling overhead/payload by scheduling the multiple TBs with/by/using/based on the (single) DCI. In existing technologies, e.g., in a TN scenario, for scheduling the multiple TBs with the (single) DCI, the base station may use a same set of resources, e.g., a same resource allocation/assignment (e.g., frequency resources) and/or a same modulation and coding scheme (MCS). Using the same set of resources (e.g., the same MCS) may reduce a payload (or size) of the DCI. For example, the wireless device for transmitting/receiving each TB of the multiple TBs may use the same set of resources, e.g., each TB of the multiple TBs may have the same TB size (TBS).

In existing technologies, e.g., in a TN scenario, the DCI may indicate (only) a first DL HARQ process (HP) number/ID/index (or a first UL HP ID/number/index), e.g., DL HP #n or UL HP #n. In response to receiving the DCI, the wireless device may, based on the DL HP #n, determine a DL/UL HP ID for reception/transmission of each TB of the multiple TBs. For example, the wireless device may determine that the first DL/UL HP (e.g., DL/UL HP #n) corresponds to transmission/reception of a first/earliest/initial/starting TB of the multiple TBs. The wireless device may further determine that a second DL/UL HP, corresponding to an m-th transmission/reception of the multiple TBs, where m=1, . . . , M−1, has DL/UL HP ID of n+m, e.g., the wireless device may increase the DL/UL HP #n by a scheduled order of the m-th TB of the multiple TBs (e.g., m) to determine index/number/ID of the second DL/UL HP. However, when the base station configures the wireless device with feedback-enabled/disabled DL HPs (e.g., via downlinkHARQ-FeedbackDisabled in PDSCH-ServingCellConfig IE) and/or mode-A/mode-B UL HPs (e.g., via uplinkHARQ-mode in PUSCH-ServingCellConfig IE), e.g., in an NTN scenario, the base station and/or the wireless device may encounter difficulties (and/or inflexibilities and/or inconsistencies) for determining the second DL/UL HP number/ID/index.

For example, using the same set of resources for scheduling the multiple TBs with the DCI (e.g., when a first set of TBs of the multiple TBs are associated with a first HARQ mode (e.g., a feedback-enabled DL HP or a mode-A UL HP) and a second set of TBs of the multiple TBs are associated with (or correspond to) a second HARQ mode (e.g., a feedback-disabled DL HP or a mode-B UL HP) may not be efficient and/or flexible. For example, the decoding error at the wireless device and/or the base station may increase when the multiple TBs are transmitted (e.g., by the base station or the wireless device) using the same set of resources (e.g., the same MCS). This may result in an increase of UL/DL transmission and/or an increase of consumed power of the wireless device (e.g., for transmitting/receiving retransmissions of some TBs of the multiple TBs). In another example, based on LCP procedure, the wireless device may drop/cancel transmitting a second TB of the multiple TBs when there is a mismatch between allowed HARQ mode (e.g., allowedHARQ-mode in LogicalChannelConfig IE) of a logical channel corresponding to the second TB and HARQ mode (e.g., mode A or mode B) of the second UL HP.

When the base station configures the wireless device with the feedback-enabled/disabled DL HPs and/or the mode-A/mode-B UL HPs, improvements to HARQ operation for scheduling the multiple TBs by the DCI (e.g., the multi-slot PDSCH/PUSCH) may improve UL/DL data transmission efficiency (e.g., reducing decoding error).

According to example embodiments of the present disclosure, corresponding to reception of m-th TB/PDSCH, m=1, 2, . . . , M−1, of the multiple (e.g., M>1 different) TBs/PDSCHs scheduled by a (single) DCI, the wireless device may determine a second DL HP ID/number/index (e.g., HP #nₘ) based on whether a first DL HP ID (e.g., HP #n), indicated by the DCI, corresponds to a feedback-enabled DL HP or a feedback-disabled DL HP. The base station may configure the wireless device (e.g., via the one or more configuration parameters) with the feedback-enabled/disabled DL HPs (e.g., via downlinkHARQ-FeedbackDisabled in PDSCH-ServingCellConfig IE) and a multiple-PDSCH time-domain resource allocation (TDRA) table with a first number of entries (e.g., via pdcsh-TimeDomainResourceAllocationListForMultiPDSCH or pdsch-TimeDomainAllocationListForMultiPDSCH). For example, the DCI may schedule reception of the multiple TBs/PDSCHs across multiple reception occasions/slots. The m-th TB/PDSCH, m=1, 2, . . . , M−1, may be different than a first/initial/starting/earliest (e.g., m=0) TB of the multiple TBs, e.g., a reception occasion/slot (e.g., a first/initial/starting symbol) of the second TB/PDSCH of the multiple TBs/PDSCHs may be after a reception occasion/slot (e.g., a last/ending/final/latest symbol) of the first/initial/starting/earliest TB/PDSCH of the multiple TBs/PDSCHs.

In an example embodiment, corresponding to reception of the m-th TB/PDSCH, m=1, 2, . . . , M−1, of the multiple (e.g., M>1 different) TBs/PDSCHs, the wireless device may determine a second DL HP, with the second DL HP ID/number/index (e.g., HP #nₘ), such that the second DL HP and a first DL HP, with the first DL HP ID, have a same DL HARQ mode (e.g., the first DL HP and the second DL HP are the feedback-enabled DL HP or the first DL HP and the second DL HP are the feedback-disabled DL HP). In some cases, a difference between the second DL HP ID and the first DL HP ID may be greater than the scheduling order m.

In an example embodiment, corresponding to reception of the m-th TB/PDSCH, m=1, 2, . . . , M−1, of the multiple (e.g., M>1 different) TBs/PDSCHs, the wireless device may increase the first DL HP ID by a first number (e.g., n1) to determine the second DL HP ID. The first number may be based on scheduling order m and a first set of configuration parameters (e.g., corresponding to the feedback-enabled/disabled DL HPs of the one or more configuration parameters, e.g., downlinkHARQ-FeedbackDisabled). In an example embodiment, the downlinkHARQ-FeedbackDisabled may comprise a first consecutive number of DL HP IDs (e.g., N1_DL>0) and a second consecutive number of DL HP IDs (N2_DL>0). In some cases, the first consecutive number of DL HP IDs and the second consecutive number of DL HP IDs may sum up to a total number of DL HPs N_DL (e.g., indicated by nrofHARQ-ProcessesForPDSCH or a predefined number if nrofHARQ-ProcessesForPDSCH not being indicated), e.g., N_DL=N1_DL+N2_DL. In an example embodiment, corresponding to reception of the m-th TB/PDSCH, m=1, 2, . . . , M−1, with scheduling order m, based on the first DL HP being a feedback-enabled DL HP, the wireless device may determine the first number n1 as mod (n+m, N1_DL). In an example embodiment, corresponding to the m-th TB/PDSCH, m=1, 2, . . . , M−1, with scheduling order m, based on the first DL HP being a feedback-disabled DL HP, the wireless device may determine the first number n1 as mod (n+m, N2_DL)+N1_DL.

In an example embodiment, the one or more configuration parameters may indicate/configure a first configuration parameter. In response to determining the first configuration parameters being configured (or being enabled or not being disabled or not being absent), the wireless device may determine the second DL HP ID based on the scheduling order of the m-th TB/PDSCH, m=1, 2, . . . , M−1, and the feedback-enabled/disabled DL HPs of the one or more configuration parameters, e.g., downlinkHARQ-FeedbackDisabled). For example, in response to determining the first configuration parameters not being configured (or being disabled or not being enabled or being absent), the wireless device may determine the second DL HP ID based on the scheduling order m-th TB/PDSCH, m=1, 2, . . . , M−1, e.g., by increasing the first DL HP ID by the scheduling order m to determine the second DL HP ID.

In an example embodiment, corresponding to transmission of m-th TB (or each PUSCH) m=1, 2, . . . , M−1, of the multiple (e.g., M>1 different) TBs (or multiple PUSCHs) scheduled by the DCI, the wireless device may determine a second UL HP ID/number/index e.g., HP #nₘ) based on whether a first UL HP ID, indicated by a DCI, corresponds to a mode-A UL HP or a mode-B UL HP. The base station may configure the wireless device (e.g., via the one or more configuration parameters) with the feedback-enabled/disabled DL HPs and/or the mode-A/mode-B UL HPs (e.g., via uplinkHARQ-mode in PUSCH-ServingCellConfig IE) and a multiple-PUSCH time-domain resource allocation (TDRA) table with a second number of entries (e.g., via pucsh-TimeDomainResourceAllocationListForMultiPUSCH or pusch-TimeDomainAllocationListForMultiPUSCH). For example, the DCI may schedule transmission of the multiple TBs/PUSCHs across multiple reception occasions/slots. For example, the m-th TB/PUSCH, m=1, 2, . . . , M−1, of the multiple TBs/PUSCHs may be different than a first/initial/starting/earliest (e.g., m=0) TB of the multiple TBs, e.g., a transmission occasion/slot (e.g., a first/initial/starting symbol) of the second TB/PUSCH of the multiple TBs/PUSCHs may be after a transmission occasion/slot (e.g., a last/ending/final/latest symbol) of the first/initial/starting/earliest TB/PUSCH of the multiple TBs/PUSCHs.

In an example embodiment, corresponding to transmission of the m-th TB/PDSCH, m=1, 2, . . . , M−1, with scheduling order m, the wireless device may determine a second UL HP, identified with the second UL HP ID/number/index, such that the second UL HP and a first UL HP, identified with the first UL HP ID, have same UL HARQ mode (e.g., the first UL HP and the second UL HP are the mode-A UL HP or the first UL HP and the second UL HP are the mode-B UL HP).

In an example embodiment, corresponding to reception of the m-th TB/PDSCH, m=1, 2, . . . , M−1, with scheduling order m, the wireless device may increase the first UL HP ID by a second number n2 to determine the second UL HP ID. The first number n2 may be based on scheduling order m, m=1, 2, . . . , M−1, and a second set of configuration parameters (e.g., corresponding to the mode-A/mode-B UL HPs of the one or more configuration parameters, e.g., uplinkHARQ-mode). For example, the uplinkHARQ-mode may comprise a first consecutive number of UL HP IDs (e.g., N1_UL>0) corresponding to the mode-A UL HPs and a second consecutive number of UL HP IDs (N2_UL>0) corresponding to the mode-B UL HPs. For example, the first consecutive number of UL HP IDs and the second consecutive number of UL HP IDs may sum up to a total number of UL HPs N_UL (e.g., indicated by nrofHARQ-ProcessesForPUSCH or a predefined number if nrofHARQ-ProcessesForPUSCH not being indicated), e.g., N_UL=N1_UL+N2_UL. In an example embodiment, based on the first UL HP being the mode-A UL HP and corresponding to reception of the m-th TB/PDSCH, m=1, 2, . . . , M−1, with scheduling order m, the wireless device may determine the second number n2 as mod (n+m, N1_UL). In an example embodiment, based on the first UL HP being the mode-B UL HP and corresponding to reception of the m-th TB/PDSCH, m=1, 2, . . . , M−1, with scheduling order m, the wireless device may determine the second number n2 as mod (n+m, N2_UL)+N1_UL.

In an example embodiment, the one or more configuration parameters may indicate/configure a second configuration parameter. In response to determining the second configuration parameters being configured (or being enabled or not being disabled or not being absent), corresponding to reception of the m-th TB/PDSCH, m=1, 2, . . . , M−1, with scheduling order m, the wireless device may determine the second UL HP ID based on scheduling order m and the mode-A/mode-B UL HPs of the one or more configuration parameters, e.g., uplinkHARQ-mode). For example, in response to determining the second configuration parameters not being configured (or being disabled or not being enabled or being absent), corresponding to reception of the m-th TB/PDSCH, m=1, 2, . . . , M−1, with scheduling order m, the wireless device may determine the second UL HP ID based on scheduling order m, e.g., by increasing the first UL HP ID by the scheduling order of the second TB to determine the second UL HP ID.

Example embodiments may improve UL/DL transmission efficiency (e.g., by reducing decoding error at the wireless device and/or the base station). Some example embodiments may reduce the consumed power of the wireless device e.g., by reducing possibility of UL/DL data retransmissions. Example embodiments may improve flexibility of the base station for scheduling the multiple TBs by the (single) DCI when the base station configure the wireless device with the feedback-enabled/disabled DL HPs and/or the mode-A/mode-B UL HPs. In some cases, example embodiments may provide a consistent UL/DL HARQ behavior across transmission/reception of the multiple TBs, e.g., each TB of the multiple TBs is associated with a same HARQ mode (e.g., feedback-enabled or feedback-disabled or mode A or mode B).

In existing technologies, e.g., in a TN scenario, when a base station schedules the multiple TBs (e.g., M>1 different TBs) via/based on a (single) DCI, a wireless device may determine M based on the TDRA table of the multiple PDSCHs (e.g., for receiving the multiple TBs) and/or the TDRA table of the multiple PUSCHs (e.g., for transmitting the multiple TBs). In some examples, based on a number of entries of the multiple-PUSCH TDRA table (e.g., the number of entries of TimeDomainAllocationListForMultiPUSCH, e.g., maxNrofMultiplePUSCHs), the wireless device may determine bit width of Time domain resource allocation (TDRA) field of the DCI. For example, value b (e.g., b=0, 1, . . . , M−1), in the Time domain resource allocation field of the DCI may correspond to a b-th element in the multiple-PUSCH TDRA table (e.g., the number of entries of the TimeDomainAllocationListForMultiPUSCH). For example, the wireless device may, for transmitting the multiple TBs/PUSCHs, map (e.g., in a one-to-one approach and in accordance with scheduling order of the multiple TBs/PUSCHs) one or more bits of Redundancy version (RV) field (and/or one or more bits of New data indicator, NDI, field) of the DCI to each TB/PUSCH of the M TBs/PUSCHs. In some cases, the LSB bits of the Redundancy version field (and/or the NDI field) of the DCI may correspond to a last/final/ending/latest (e.g., M−1) scheduled TB/PUSCH of the multiple TBs/PUSCHs (e.g., indicated by the Time domain resource allocation field of the DCI).

In some other examples, based on a number of entries of the multiple-PDSCH TDRA table (e.g., the number of entries of TimeDomainAllocationListForMultiPDSCH, e.g., maxNrofMultiplePDSCHs), the wireless device may determine bit width of Time domain resource allocation field of the DCI. For example, value b (e.g., b=0, 1, . . . , M−1), in the Time domain resource allocation field of the DCI may correspond to a b-th element in the one or more bits of TDRA table (e.g., the number of entries of the TimeDomainAllocationListForMultiPDSCH). For example, the wireless device may, for receiving the multiple TBs/PDSCHs, map (e.g., in a one-to-one approach and in accordance with scheduling order of the multiple TBs/PDSCHs) one or more bits of Redundancy version field (and/or NDI field) of the DCI to each TB/PDSCH of the M TBs/PDSCHs. In some cases, the LSB bits of the Redundancy version field (and/or the NDI field) of the DCI may correspond to a last/final/ending/latest (e.g., M−1) scheduled TB/PDSCH of the multiple TBs/PDSCHs (e.g., indicated by the Time domain resource allocation field of the DCI).

However, when the base station configures the wireless device with the feedback-enabled/disabled DL HPs (e.g., via IE PDSCH-ServingCellConfig) and/or the mode-A/mode-B UL HPs (e.g., via IE PUSCH-ServingCellConfig), e.g., in an NTN scenario, the wireless device may encounter difficulties for determining the number of scheduled TBs by the DCI (e.g., M). In some cases, using the number of entries of the multiple-PUSCH (or the multiple-PDSCH) TDRA table for determining the number of scheduled TBs by the DCI may provide an overestimation of the (actual) number of scheduled TBs by the DCI. For example, the wireless device may, based on overestimating the number of scheduled TBs by the DCI, mistakenly determine redundancy version and/or the NDI of one or more TB of the multiple TBs. By mistakenly determining the redundancy version (and/or the NDI) of the one or more TB of the multiple TBs, the performance/efficiency of the UL/DL communications may reduce (e.g., higher decoding error and/or possibility of one or more UL/DL data retransmissions). When the base station configures the wireless device with the feedback-enabled/disabled DL HPs and/or the mode-A/mode-B UL HPs, improvements to HARQ operation for scheduling the multiple TBs by the DCI (e.g., the multi-slot PDSCH/PUSCH) may improve UL/DL data transmission efficiency (e.g., by reducing decoding error).

According to example embodiments of the present disclosure, when the base station configures the wireless device with the feedback-enabled/disabled DL HPs, the wireless device may, based on a first value and/or a second value, determine at least one of: a number of (scheduled) TBs/PDSCHs by a DCI (e.g., M), and/or a bit width of Time domain resource allocation (TDRA) field of the DCI, and/or a bit width of a New data indicator (NDI) field of the DCI, and/or a bit width of a Redundancy version (RV) field of the DCI. In some cases, the first value may indicate a number of DL HPs that have HARQ mode (e.g., feedback-enabled or feedback-disabled) of the first DL HP. In some cases, the second value may be a number of entries of the multiple-PDSCH TDRA table (e.g., the number of entries of pdsch-TimeDomainAllocationListForMultiPDSCH). In some other cases, the second value may be a maximum number (e.g., maxNrofMultiplePDSCHs) of schedulable PDSCHs among all entries in the TDRA table of the multiple PDSCHs.

For example, the bit width of a field (e.g., the TDRA field and/or the NDI field and/or the RV field) of DCI may be based on a minimum of the first value and the second value. In some examples, the wireless device may skip (or ignore) r bits (e.g., a first/starting/earliest r bits or a last/ending/final r bits) of the field (e.g., the TDRA field and/or the NDI field and/or the RV field) of the DCI for receiving the multiple TBs/PDSCHs. For example, the skipped/ignored bits (e.g., r) may be based on a difference between the second value and the first value. Based on the first value being smaller than the second value, the wireless device may skip (or ignore) r bits of the field (e.g., the TDRA field and/or the NDI field and/or the RV field) of the DCI. In other examples, based on the first value not being smaller than the second value, the wireless device may not skip/ignore any bits of the field (e.g., the TDRA field and/or the NDI field and/or the RV field) of the DCI. In an example embodiment, wireless device may, based on the bit width of the TDRA field of the DCI, determine a reception time/occasion of each TB/PDSCH of the multiple (e.g., M) TBs/PDSCHs. In an example embodiment, wireless device may, based on the bit width of the NDI field of the DCI, determine whether each TB/PDSCH of the multiple TBs/PDSCHs is a new transmission or a retransmission. In an example embodiment, wireless device may, based on the bit width of the RV field of the DCI, determine RV value corresponding to each TB/PDSCH of the multiple TBs/PDSCHs.

In an example embodiment, the wireless device (and/or the base station) may determine the DCI size based on the first value and/or the second value. For example, in response to the first DL HP being a feedback-enabled DL HP, the wireless device (and/or the base station) may determine the DCI size based on the second value and a number of the feedback-enabled DL HPs (e.g., a first value). In an example embodiment, in response to the first DL HP being a feedback-disabled DL HP, the wireless device (and/or the base station) may determine the DCI size based on the second value and a number of the feedback-disabled DL HPs (e.g., a first value). In some cases, the wireless device may determine the DCI size based on a minimum (or maximum or summation) of the first value and the second value. In some other cases, the wireless device may determine the DCI size based on a number of configured DL HPs. Example embodiments may reduce decoding/detecting the DCI based on a fixed (or a predefined) DCI size.

According to example embodiments of the present disclosure, when the base station configures the wireless device with the feedback-enabled/disabled DL HPs, the wireless device may, based on a third value and/or the second value, determine at least one of: a number of scheduled TBs/PDSCHs by a DCI (e.g., M), and/or a bit width of Time domain resource allocation (TDRA) field of the DCI, and/or a bit width of a New data indicator (NDI) field of the DCI, and/or a bit width of a Redundancy version (RV) field of the DCI. For example, the DCI may indicate the third value (e.g., the DCI may have a third field indicating the third value for the number of scheduled TBs/PDSCHs by the DCI). In some other cases, the wireless device may determine the third value based on determining how many consecutive DL HP IDs, started from the first DL HP ID, has HARQ mode (e.g., feedback-enabled or feedback-disabled) as of the first DL HP identified with (or by) the first DL HP ID. For example, a bit width of a field (e.g., the TDRA field and/or the NDI field and/or the RV field) of DCI may be based on a minimum of the third value and the second value. In some examples, the wireless device may skip (or ignore) r bits of the field (e.g., the TDRA field and/or the NDI field and/or the RV field) of the DCI to determine the bit width of the field of the DCI (e.g., the TDRA field and/or the NDI field and/or the RV field). For example, the skipped/ignored bits (e.g., r) may be based on a difference between the second value and the third value. Based on the third value being smaller than the second value, the wireless device may skip (or ignore) r bits of the field (e.g., the TDRA field and/or the NDI field and/or the RV field) of the DCI. In other examples, based on the third value not being smaller than the second value, the wireless device may not skip/ignore any bits of the field (e.g., the TDRA field and/or the NDI field and/or the RV field) of the DCI.

In an example embodiment, the wireless device may, based on the HARQ mode of the first DL HP, determine a HARQ information corresponding to a TB/PDSCH of the multiple TBs/PDSCHs. In some cases, based on the DCI and/or the HARQ mode of the first DL HP, the wireless device may determine the HARQ information corresponding to (or of or associated to) a TB/PDSCH of the multiple TBs/PDSCHs. For example, corresponding to an m-th TB/PDSCH of the multiple TBs/PDSCHs (e.g., m=0, 1, 2, . . . , M−1), the wireless device may determine a corresponding HARQ information. In some cases, the corresponding HARQ information of the m-th TB/PDSCH of the multiple TBs/PDSCHs (e.g., m=0, 1, 2, . . . , M−1) may comprise at least one of: a corresponding DL HP ID (e.g., HP #n when m=0 and HP #nₘ when m>0), a corresponding NDI, a corresponding RV, and/or a corresponding TB size. In some cases, to determine the corresponding HARQ information of the m-th TB/PDSCH of the multiple TBs/PDSCHs (e.g., m=0, 1, 2, . . . , M−1), the wireless device may, based on the first value and/or the second value and/or the third value, determine at least one of the following: a number of scheduled TBs/PDSCHs by the DCI (e.g., M), and/or a bit width of a TDRA field of the DCI, and/or a bit width of an NDI field of the DCI, and/or a bit width of an RV field of the DCI.

According to example embodiments of the present disclosure, when the base station configures the wireless device with the mode-A/mode-B UL HPs, the wireless device may, based on a first value and/or a second value, determine at least one of a number of scheduled TBs/PUSCHs by a DCI (e.g., M), and/or a bit width of Time domain resource allocation (TDRA) field of the DCI, and/or a bit width of a New data indicator (NDI) field of the DCI, and/or a bit width of a Redundancy version (RV) field of the DCI. In some cases, the first value may indicate a number of UL HPs that have the HARQ mode (e.g., mode A or mode B) of the first UL HP indicated by the DCI. In some cases, the second value may be a number of entries of the multiple-PUSCH TDRA table (e.g., the number of entries of pusch-TimeDomainAllocationListForMultiPUSCH). In some other cases, the second value may be a maximum number (e.g., maxNrofMultiplePUSCHs) of schedulable PUSCHs among all entries in the TDRA table of the multiple PUSCHs.

For example, the bit width of a field (e.g., the TDRA field and/or the NDI field and/or the RV field) of DCI may be based on a minimum of the first value and the second value. In some examples, the wireless device may skip (or ignore) r bits of the field (e.g., the TDRA field and/or the NDI field and/or the RV field) of the DCI to determine the bit width of the field of the DCI (e.g., the TDRA field and/or the NDI field and/or the RV field). For example, the skipped/ignored bits (e.g., r) may be based on a difference between the second value and the first value. Based on the first value being smaller than the second value, the wireless device may skip (or ignore) r bits of the field (e.g., the TDRA field and/or the NDI field and/or the RV field) of the DCI. In other examples, based on the first value not being smaller than the second value, the wireless device may not skip/ignore any bits of the field (e.g., the TDRA field and/or the NDI field and/or the RV field) of the DCI. In an example embodiment, the wireless device may, based on the first value and/or the second value, determine at least one of: a transmission time/occasion of each TB/PUSCH of the multiple (e.g., M) TBs/PUSCHs, and/or a whether each TB/PUSCH of the multiple TBs/PUSCHs is a new transmission or a retransmission (e.g., by determining an NDI associated with each TB/PUSCH), and/or a RV corresponding to each TB/PUSCH of the multiple TBs/PUSCHs.

In an example embodiment, the wireless device (and/or the base station) may determine the DCI size based on the first value and/or the second value. For example, in response to the first UL HP being a mode-A UL HP, the wireless device (and/or the base station) may determine the DCI size based on the second value and a number of the mode-A UL HPs (e.g., a first value). In an example embodiment, in response to the first UL HP being a mode-B UL HP, the wireless device (and/or the base station) may determine the DCI size based on the second value and a number of the mode-B UL HPs (e.g., a first value). In some cases, the wireless device may determine the DCI size based on a minimum (or maximum or summation) of the first value and the second value. In some other cases, the wireless device may determine the DCI size based on a number of configured UL HPs. Example embodiments may reduce decoding/detecting the DCI based on a fixed (or a predefined) DCI size.

According to example embodiments of the present disclosure, when the base station configures the wireless device with the mode-A/mode-B UL HPs, the wireless device may, based on a third value and/or the second value, determine at least one of: a number of scheduled TBs/PUSCHs by a DCI (e.g., M), and/or a bit width of Time domain resource allocation (TDRA) field of the DCI, and/or a bit width of a New data indicator (NDI) field of the DCI, and/or a bit width of a Redundancy version (RV) field of the DCI. For example, the DCI may indicate the third value (e.g., the DCI may have a third field indicating the third value for the number of scheduled TBs/PUSCHs by the DCI). In some other cases, the wireless device may determine based on determining how many consecutive UL HP IDs, started from the first UL HP ID, has HARQ mode (e.g., mode-A or mode-B) as of the first UL HP identified with (or by) the first UL HP ID. For example, the applicable (or valid) bit width of a field (e.g., the TDRA field and/or the NDI field and/or the RV field) of DCI may be a minimum of the third value and the second value. In some examples, the wireless device may skip (or ignore) r bits of the field (e.g., the TDRA field and/or the NDI field and/or the RV field) of the DCI to determine the bit width of the field of the DCI (e.g., the TDRA field and/or the NDI field and/or the RV field). For example, the skipped/ignored bits (e.g., r) may be based on a difference between the second value and the third value. Based on the third value being smaller than the second value, the wireless device may skip (or ignore) r bits of the field (e.g., the TDRA field and/or the NDI field and/or the RV field) of the DCI. In other examples, based on the third value not being smaller than the second value, the wireless device may not skip/ignore any bits of the field (e.g., the TDRA field and/or the NDI field and/or the RV field) of the DCI.

In an example embodiment, the wireless device may, based on a HARQ mode of the first UL HP and/or the DCI, determine a HARQ information corresponding to a TB/PUSCH of the multiple TBs/PUSCHs. For example, corresponding to an m-th TB/PUSCH of the multiple TBs/PUSCHs (e.g., m=0, 1, 2, . . . , M−1), the wireless device may determine a corresponding HARQ information. In some cases, the corresponding HARQ information of the m-th TB/PUSCH of the multiple TBs/PUSCHs (e.g., m=0, 1, 2, . . . , M−1) may comprise at least one of: a corresponding UL HP ID (e.g., HP #n when m=0 and HP #nₘ when m>0), a corresponding NDI, a corresponding RV, and/or a corresponding TB size. In some cases, to determine the corresponding HARQ information of the m-th TB/PUSCH of the multiple TBs/PUSCHs (e.g., m=0, 1, 2, . . . , M−1), the wireless device may, based on the first value and/or the second value and/or the third value, determine at least one of the following: a number of scheduled TBs/PUSCHs by the DCI (e.g., M), and/or a bit width of a TDRA field of the DCI, and/or a bit width of an NDI field of the DCI, and/a bit width of an RV field of the DCI.

When the base station configures the wireless device with the feedback-enabled/disabled DL HPs and/or the mode-A/mode-B UL HPs, some example embodiments may allow the wireless device to dynamically determine the number of multiple TBs scheduled by the DCI, e.g., in order to maintain a consistent HARQ behavior across the multiple TBs. Example embodiments may allow the wireless device to determine (e.g., based on HARQ mode of the HP indicated by the DCI) bit widths of one or more fields (e.g., TDRA and/or RV and/or NDI) of the DCI. Example embodiments may improve the UL/DL transmission performance.

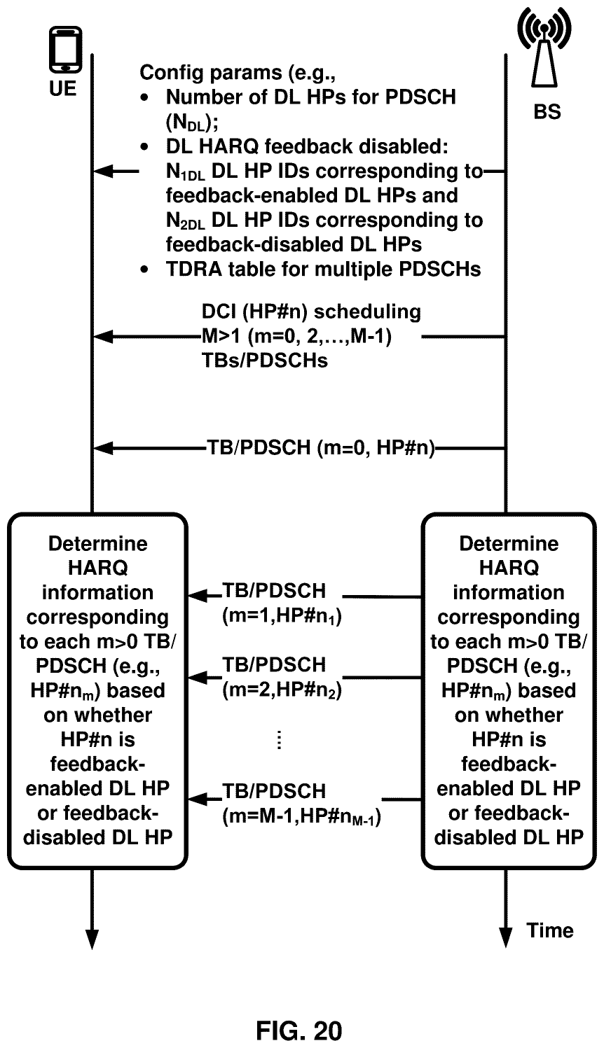

FIG. 20 shows an example embodiment of a HARQ operation/procedure in wireless communications systems per an aspect of the present disclosure. FIG. 20 may, for example, show an implementation of a method (or a process) for UL/DL transmissions at a base station and/or a wireless device. The base station may communicate with the wireless device, e.g., via/using a cell (e.g., a serving cell). For example, the wireless device may be in an RRC_CONNECTED (or an RRC connected) state/mode.

In some implementations, the wireless device may communicate with the base station via a non-terrestrial network (NTN), e.g., the wireless device and the base station may operate in the NTN and/or the base station may be an NTN base station and/or the cell (e.g., the serving cell) may be part of the NTN. In some other implementations, the wireless device may not communicate with the base station via the NTN (e.g., in a terrestrial network scenario). For example, the cell may not be part of the NTN.

As shown in FIG. 20, the wireless device may receive the one or more configuration parameters from the base station. The one or more configuration parameters may comprise the one or more NTN configuration parameters. The one or more configuration parameters may configure the wireless device with one or more serving cell configuration parameters (e.g., ServingCellConfigCommon, ServingCellConfigCommonSIB, and/or ServingCellConfig, and the like). For example, the one or more configuration parameters configure the wireless device with one or more PDSCH configuration parameters (e.g., PDSCH-Config IE). In some cases, the one or more PDSCH configuration parameters may comprise multiple-PDSCH (or multi-PDSCH) time-domain resource allocation/assignment (TDRA) table (or configuration parameters). For example, the multiple-PDSCH TDRA table may indicate a TDRA table for multiple PDSCHs. The multiple-PDSCH TDRA table (e.g., pdsch-TimeDomainAllocationListForMultiPDSCH or pdsch-TimeDomainResourceAllocationListForMultiPDSCH) may configure the wireless device for receiving multiple PDSCHs that is scheduled by a single DCI. In some implementations, the multiple-PDSCH TDRA table may comprise a list of time-domain configuration(s). For example, the multiple-PDSCH TDRA table may indicate the list of time-domain configuration(s) for timing of DL assignment (e.g., the single DCI) to DL data. In some cases, the DL data may comprise multiple (different) TBs scheduled by the single DCI. In some other cases, the DL data may correspond to multiple PDSCHs scheduled by the single DCI. In some other cases, the DL data may correspond to multiple PDSCHs scheduled by the single DCI. In some implementations, one or more rows of the multiple-PDSCH TDRA table (e.g., pdsch-TimeDomainAllocationListForMultiPDSCH or pdsch-TimeDomainResourceAllocationListForMultiPDSCH) may contain one or more (e.g., multiple or at least one) SLIVs for PDSCH on a DL BWP of the cell (e.g., the serving cell).

The one or more configuration parameters may further configure (e.g., via nrofHARQ-ProcessesForPDSCH in PDSCH-ServingCellConfig IE) the wireless device with a first number of DL HPs for PDSCH of the cell (e.g., the serving cell), e.g., N_{DL}>0 DL HPs. For example, when the one or more configuration parameters does not comprise/indicate the nrofHARQ-ProcessesForPDSCH in PDSCH-ServingCellConfig IE, the wireless device may determine the first number of DL HPs for PDSCH of the cell based on a predefined (or hard coded) value (e.g., N_{DL}=8 or N_{DL}=16 or N_{DL}=32).

In some implementations, as shown in FIG. 20, the one or more configuration parameters may configure the wireless device with feedback-disabled (or deactivated) DL HPs, e.g., via downlinkHARQ-FeedbackDisabled (or HARQ-feedbackEnabling-disablingperHARQprocess) in PDSCH-ServingCellConfig IE. The one or more configuration parameters may, for example, comprise the feedback-disabled DL HPs (e.g., a second plurality of DL HP IDs or a second plurality of DL HPs) and feedback-enabled (or activated) DL HPs (e.g., a first plurality of DL HP IDs or a first plurality of DL HPs). For example, the one or more configuration parameters may configure N_{1DL}>0 DL HPs of the first number of DL HPs as the feedback-enabled DL HPs and N_{1DL}>0 DL HPs of the first number of DL HPs as the feedback-disabled DL HPs. For example, a cardinality (or size or a number) of the feedback-enabled DL HPs may be N_{1DL} and a cardinality (or size or a number) of the feedback-disabled DL HPs may be N_{2DL}.

For example, the wireless device (and/or the base station) may determine a HARQ mode of a DL HP based on whether a corresponding DL HP ID being in the first plurality of DL HP IDs or the second plurality of DL HP IDs. The HARQ mode of the DL HP may be feedback-enabled (or feedback-deactivated or an enabled HARQ feedback or an activated HARQ feedback or a HARQ feedback enabled or enabled) based on the corresponding DL HP ID being in the first plurality of DL HP IDs (e.g., the DL HP being the feedback-enabled DL HP). The HARQ mode of the DL HP may be feedback-disabled (or feedback-deactivated or a disabled HARQ feedback or a deactivated HARQ feedback or a HARQ feedback disabled or disabled) based on the corresponding DL HP ID being in the second plurality of DL HP IDs (e.g., the DL HP being the feedback-disabled DL HP).

The wireless device may monitor one or more (or a set of) PDCCH candidates in one or more CORESETs on an active DL BWP on the cell (or on each activated serving cell). The base station may configure the wireless device (e.g., via the one or more configuration parameters) with PDCCH monitoring. The wireless device may monitor the PDCCH (e.g., the one or more PDCCH candidates) according to corresponding search space sets. In some aspects, by monitoring the PDCCH, the wireless device may receiving each PDCCH candidate of the one or more PDCCH candidates. For example, the wireless device may decode each PDCCH candidate of the one or more PDCCH candidates according to one or more monitored DCI formats (e.g., DCI format 1_1 or DCI format 0_1).

As shown in FIG. 20, the base station may transmit to the wireless device a (single) DCI for scheduling multiple (e.g., M>1 different) TBs (or multiple PDSCHs). For example, the wireless device may, by monitoring the one or more PDCCH candidates, receive/detect the DCI scheduling the multiple TBs/PDSCHs. For example, the DCI may be a DCI format 1_1 with CRC scrambled by C-RNTI or CS-RNTI or MCS-C-RNTI. For example, the DCI may schedule reception of the multiple TBs/PDSCHs during/across multiple (e.g., M) reception occasions/slots.

The wireless device may receive a DCI indicating at least one DL grant for DL transmission(s). For example, the DCI may indicate a first DL HP identified by/with HP #n (e.g., the first DL HP ID). For example, the wireless device may determine values of one or more fields of the DCI. For example, the one or more fields of the DCI may comprise a TDRA field, a RV field, and/or an NDI field. For example, the wireless device may determine a bit width of the TDRA field, a bit width of the RV field, and/or a bit width of the NDI field to receive the DL transmissions (e.g., the multiple TBs/PDSCHs). In some cases, the wireless device may determine how many (different) TBs/PDSCHs are scheduled by the DCI based on a number of entries of the multiple-PDSCH TDRA table and/or the TDRA field of the DCI (e.g., the bit width of the TDRA table of the DCI).

In some examples, the DCI may indicate a first DL HP. For example, the DCI may comprise a bitfield indicating the first DL HP ID (e.g., HP #n in FIG. 20) corresponding to the first DL HP. For example, the first DL HP may be a feedback-enabled DL HP, e.g., when the first DL HP belongs to the feedback-enabled DL HPs. In another example, the first DL HP may be a feedback-disabled DL HP, e.g., when the first DL HP belongs to the feedback-disabled DL HPs.

For example, the wireless device and the base station may communicate the multiple TBs scheduled with the DCI. The base station may, for communicating the multiple TBs to the wireless device, transmit the multiple TBs across/via/using/based on multiple (e.g., M>1 different) transmission occasions/slots. In some cases, the base station may transmit each TB of the multiple TBs via/using/based on each PDSCH of multiple PDSCHs during a transmission occasion/slot of the multiple transmission occasions/slots. The wireless device may receive the multiple TBs across multiple (e.g., M>1 different) reception occasions/slots. In some cases, the wireless device may, e.g., based on the multiple-PDSCH TDRA table, receive each TB/PDSCH of the multiple TBs/PDSCHs during/using each reception occasion/slot of the multiple reception occasions/slots.

In an example embodiment, as shown in FIG. 20, the wireless device (and/or the base station) may determine a HARQ information corresponding to each TB/PDSCH of the multiple TBs/PDSCHs. In some cases, based on the DCI and/or a HARQ mode of the first DL HP, the wireless device (and/or the base station) may determine the HARQ information corresponding to (or of or associated to) each TB/PDSCH of the multiple TBs/PDSCHs. For example, the corresponding HARQ information of the m-th TB/PDSCH of the multiple TBs/PDSCHs (e.g., m=0, 1, 2, . . . , M−1) may comprise at least one of: a corresponding DL HP ID (e.g., as shown in FIG. 20, HP #n when m=0 and HP #nₘ when m>0), a corresponding NDI of the m-th TB/PDSCH, a corresponding RV of the m-th TB/PDSCH, and/or a corresponding TB size (TBS) of the m-th TB/PDSCH (e.g., determined from an MSC field of the DCI).

In an example embodiment, as shown in FIG. 20, the wireless device (and/or the base station) may determine a corresponding DL HP ID of the m-th TB/PDSCH of the multiple TBs/PDSCHs (e.g., m=1, 2, . . . , M−1), e.g., HP #nₘ, based on whether a first DL HP indicated by the DCI being a feedback-enabled DL HP or a feedback-disabled DL HP (e.g., based on a HARQ mode of the first DL HP). For example, corresponding to a m-th TB/PDSCH of the multiple TBs/PDSCHs (e.g., m=1, 2, . . . , M−1), the wireless device (and/or the base station) may determine a corresponding HARQ information based on whether the first HP DL is a feedback-enabled DL HP or a feedback-disabled DL HP (e.g., based on a HARQ mode of the first DL HP).

For example, a HARQ information corresponding to a first/initial/starting/earliest TB/PDSCH of the multiple TBs/PDSCHs (e.g., m=0) may be based on the DCI, e.g., the first DL HP ID (e.g., HP #n), a corresponding NDI of the TB/PDSCH m=0, a corresponding RV of the TB/PDSCH m=0, and/or a corresponding TB size of the TB/PDSCH m=0.

In an example, a HARQ information corresponding to the m-th TB/PDSCH of the multiple TBs/PDSCHs (e.g., m=1, 2, . . . , M−1) may be based on the DCI and a HARQ mode of the first DL HP (e.g., whether the first DL HP is a feedback-disabled HP or a feedback-enabled HP). For example, based on the DCI the wireless device (and/or the base station) may determine: the first DL HP ID (e.g., HP #n), a corresponding NDI of the TB/PDSCH m>0, a corresponding RV of the TB/PDSCH m>0, and/or a corresponding TB size of the TB/PDSCH m>0. For example, the wireless device may determine the corresponding DL HP ID of the m-th TB/PDSCH of the multiple TBs/PDSCHs (e.g., HP #nₘ) to determine the corresponding HARQ information. In some cases, when the one or more configuration parameters does not indicate the feedback-disabled DL HPs (e.g., when all the configured DL HPs are feedback-enabled DL HPs), the wireless device (and/or the base station) may determine the HARQ information HARQ information corresponding to the m-th TB/PDSCH of the multiple TBs/PDSCHs (e.g., m=0, 1, 2, . . . , M−1) may be based on the DCI.

In an example embodiment, the wireless device (and/or the base station) may determine the corresponding DL HP ID of the m-th TB/PDSCH of the multiple TBs/PDSCHs (e.g., m=1, 2, . . . , M−1) based on whether a first DL HP indicated by the DCI being a feedback-enabled DL HP or a feedback-disabled DL HP (e.g., based on a HARQ mode of the first DL HP). For example, corresponding to a m-th TB/PDSCH of the multiple TBs/PDSCHs (e.g., m=1, 2, . . . , M−1), the wireless device may determine a corresponding HARQ information based on whether the first HP DL is a feedback-enabled DL HP or a feedback-disabled DL HP (e.g., based on a HARQ mode of the first DL HP).

In some cases, the wireless device may, e.g., based on the multiple-PDSCH TDRA table, receive each TB/PDSCH of the multiple TBs/PDSCHs during/using each reception occasion/slot of the multiple reception occasions/slots. For example, using a Time domain resource allocation (TDRA) field of the DCI, the wireless device may receive the multiple TBs/PDSCHs. In some examples, the wireless device may determine a bit-width of the TDRA field of the DCI (e.g., 0, 1, 2, 3, 4, 5, or 6 bits) based on a number of entries of the multiple-PDSCH TDRA table. For example, the wireless device may receive the multiple TBs/PDSCHs based on the DCI and/or the one or more configuration parameters (e.g., the multiple PDSCHs TDRA table, e.g., via pdsch-TimeDomainResourceAllocationListForMultiPDSCH). The multiple PDSCHs TDRA table may indicate multiple time domain relations between the DCI (e.g., DL assignment) and each TB/PDSCH of the multiple TBs/PDSCHs. In some cases, the wireless device may determine a bit width of the TDRA field of the DCI based on a number of entries in the multiple PDSCHs TDRA table (e.g., the pdsch-TimeDomainResourceAllocationListForMultiPDSCH). The wireless device may receive the m-th TB/PDSCH, m=0, 1, . . . , M−1, of the multiple TBs/PDSCHs based on the m-th entry (e.g., using k0, mapping Type, startSymbolAndLength, repetitionNumber, and the like) of the DSCH-TimeDomainResourceAllocation IE field of the multiple PDSCHs TDRA table (e.g., the pdsch-TimeDomainResourceAllocationListForMultiPDSCH). For example, the wireless device may determine a reception occasion/time (e.g., slot or symbol) of each TB/PDSCH of the multiple TBs/PDSCHs based on the one or more NTN configuration parameters (e.g., the cell/beam-specific timing offset, the UE-specific timing offset, satellite ephemeris data, common TA values, and/or the like) and/or one or more numerology.

For example, the wireless device (and/or the base station) may map an m-th bit (m=0, 1, . . . , M−1) of the RV field of the DCI to the m-th (m=0, 1, . . . , M−1) scheduled TB/PDSCH of the multiple TBs/PDSCHs. In some implementations, the wireless device may, for receiving the multiple TBs/PDSCHs, map (e.g., in a one-to-one approach and in accordance with scheduling order of the multiple TBs/PDSCHs) each bit of the RV field of the DCI to each TB/PDSCH of the multiple TBs/PDSCHs. In some cases, the LSB bits of the RV field of the DCI may correspond to a last/final/ending/latest (e.g., M−1) scheduled TB/PDSCH of the multiple TBs/PDSCHs (e.g., indicated by the TDRA field of the DCI).

For example, the wireless device (and/or the base station) may map a m-th (m=0, 1, . . . , M−1) bit of the NDI field of the DCI to the m-th (m=0, 1, . . . , M−1) scheduled TB/PDSCH of the multiple TBs/PDSCHs. In some implementations, the wireless device may, for receiving the multiple TBs/PDSCHs, map (e.g., in a one-to-one approach and in accordance with scheduling order of the multiple TBs/PDSCHs) each bit of the NDI field of the DCI to each TB/PDSCH of the multiple TBs/PDSCHs. In some cases, the LSB bits of the NDI field of the DCI may correspond to a last/final/ending/latest (e.g., M−1) scheduled TB/PDSCH of the multiple TBs/PDSCHs (e.g., indicated by the TDRA field of the DCI).

In an example embodiment, as shown in FIG. 20, corresponding to each TB/PDSCH of the multiple TBs/PDSCH scheduled by the DCI, the base station may determine a second DL HP ID/number/index based on whether the first DL HP ID correspond to a feedback-enabled DL HP or a feedback-disabled DL HP (e.g., whether the first DL HP is a feedback-enabled DL HP or a feedback-disabled DL HP and/or whether a HARQ feedback of the first DL HP is disabled or not). For example, the base station may transmit a first/initial/starting/earliest (e.g., with a scheduling order m=0) TB/PDSCH of the multiple TBs/PDSCHs corresponding to the first DL HP (e.g., the HP #n). For transmission of the m-th TB of the multiple TBs, with a scheduling order m=1, 2, . . . , M−1, the base station may use a second DL HP, identified with a second DL HP ID (e.g., HP #nₘ). In an example embodiment, the base station may determine the second DL HP ID (e.g., the HP #nₘ), corresponding to transmission of the m-th TB/PDSCH, m=1, 2, . . . , M−1, of the multiple TBs/PDSCH based on whether the first DL HP is a feedback-enabled DL HP or a feedback-disabled DL HP. For example, the base station may determine the second DL HP ID (e.g., the HP #nₘ) based on the scheduling order m, the first DL HP ID, and/or whether the first DL HP is a feedback-enabled DL HP or a feedback-disabled DL HP. In another example, the base station may determine the second DL HP ID (e.g., the HP #nₘ) based on the scheduling order m, the first DL HP ID, whether the first DL HP is a feedback-enabled DL HP or a feedback-disabled DL HP, and/or the feedback-enabled/disabled DL HPs (e.g., via downlinkHARQ-FeedbackDisabled in PDSCH-ServingCellConfig IE). For example, the first DL HP and the second DL HP may have same HARQ mode (e.g., both the first DL HP and the second DL HP are feedback-enabled DL HPs or both the first DL HP and the second DL HP are feedback-disabled DL HPs).

In an example embodiment, corresponding to transmission of the m-th TB/PDSCH of the multiple TBs/PDSCHs (where m=1, 2, . . . , M−1) and based on the first DL HP being feedback enabled, the base station may determine the second DL HP ID (e.g., the HP #nₘ) such that a second DL HP, identified with the second DL HP ID (e.g., the HP #nₘ), being feedback enabled For example, the first DL HP and the second DL HP may have same HARQ mode (e.g., both the first DL HP and the second DL HP are feedback-enabled DL HPs).

In an example embodiment, corresponding to transmission of the m-th TB/PDSCH of the multiple TBs/PDSCHs (where m=1, 2, . . . , M−1) and based on the first DL HP being feedback disabled, the base station may determine the second DL HP ID (e.g., the HP #nₘ) such that a second DL HP, identified with the second DL HP ID, being feedback disabled. For example, the first DL HP and the second DL HP may have same HARQ mode (e.g., both the first DL HP and the second DL HP are feedback-disabled DL HPs).

For example, corresponding to transmission of the m-th TB/PDSCH of the multiple TBs/PDSCHs (m=1, 2, . . . , M−1), the base station may increase a third DL HP ID, corresponding to a scheduling order of m−1 (e.g., HP #nₘ₋₁), by a positive number/such that a second DL HP identified with index nₘ=/+nₘ₋₁ has a same HARQ mode as a third DL HP identified with ID HP #nₘ₋₁ (e.g., both the third DL HP and the second DL HP are feedback-enabled DL HP or both the third DL HP and the second DL HP are feedback-disabled DL HP). For example, the third DL HP ID may have the same HARQ mode of the first DL HP. In some cases, the positive number/may be larger than 1, e.g., when a HARQ mode of a fifth DL HP identified with ID of nₘ₋₁+1 is not the same as the HARQ mode of the third DL HP and/or when the fifth DL HP not being configured by the one or more configuration parameters. In some other cases, the positive number/may be 1, e.g., when a HARQ mode of the fifth DL HP identified with ID of nₘ₋₁+1 is the same as the HARQ mode of the third DL HP (e.g., nₘ=1+nₘ₋₁ and/or the fifth DL HP is the second DL HP).

As shown in FIG. 20, corresponding to each TB of the multiple TBs scheduled by the DCI, the wireless device may determine the second DL HP ID/number/index based on whether the first DL HP ID correspond to a feedback-enabled DL HP or a feedback-disabled DL HP (e.g., whether the first DL HP is a feedback-enabled DL HP or a feedback-disabled DL HP and/or whether a HARQ feedback of the first DL HP is disabled or not). For example, the wireless device may receive a first/initial/starting/earliest TB (or PDSCH), e.g., with a scheduling order m=0, of the multiple TBs (or multiple PDSCHs) based on the first DL HP (e.g., the HP #n). For reception of a m-th TB of the multiple TBs, with a scheduling order m>0 where m=1, 2, . . . , M−1, the wireless device may use a second DL HP, identified with the second DL HP ID (e.g., HP #nₘ), e.g., the m-th TB of the multiple TBs correspond to the second DL HP. In an example embodiment, the wireless device may determine the second DL HP ID (e.g., the HP #nₘ), corresponding to reception of the m-th TB of the multiple TBs, where m=1, 2, . . . , M−1, based on whether the first DL HP is a feedback-enabled DL HP or a feedback-disabled DL HP. For example, the wireless device may determine the second DL HP ID (e.g., the HP #nₘ) based on the scheduling order m, the first DL HP ID, and/or whether the first DL HP is a feedback-enabled DL HP or a feedback-disabled DL HP. In another example, the wireless device may determine the second DL HP ID (e.g., the HP #nₘ) based on the scheduling order m, the first DL HP ID, whether the first DL HP is a feedback-enabled DL HP or a feedback-disabled DL HP, and/or the feedback-enabled/disabled DL HPs.

In an example embodiment, corresponding to reception of the m-th TB of the multiple TBs (where m=1, 2, . . . , M−1) and based on the first DL HP being feedback enabled (a feedback-enabled DL HP), the wireless device may determine the second DL HP ID (e.g., the HP #nₘ) such that a second DL HP, identified with the second DL HP ID, being feedback enabled. For example, the first DL HP and the second DL HP may have same HARQ mode (e.g., both the first DL HP and the second DL HP are feedback-enabled DL HPs).

In an example embodiment, corresponding to transmission of the m-th TB of the multiple TBs (where m=1, 2, . . . , M−1) and based on the first DL HP being feedback disabled (a feedback-disabled DL HP), the wireless device may determine the second DL HP ID (e.g., the HP #nₘ) such that a second DL HP, identified with the second DL HP ID, being feedback disabled. For example, the first DL HP and the second DL HP may have same HARQ mode (e.g., both the first DL HP and the second DL HP are feedback-disabled DL HPs).

For example, corresponding to reception of the m-th TB of the multiple TBs (m=1, 2, . . . , M−1), the wireless device may increase a third DL HP ID, corresponding to a scheduling order of m−1 (e.g., HP #nₘ₋₁), by a (smallest) positive number/such that a fourth DL HP identified with index nₘ=/+nₘ₋₁ has a same HARQ mode as a third DL HP identified with ID HP #nₘ₋₁ (e.g., both the third DL HP and the second DL HP are feedback-enabled DL HP or both the third DL HP and the second DL HP are feedback-disabled DL HP). In some cases, the positive number/may be larger than 1, e.g., when a HARQ mode of the fifth DL HP identified with ID of nₘ₋₁+1 is not the same as the HARQ mode of the third DL HP. In some other cases, the positive number/may be 1, e.g., when a HARQ mode of the fifth DL HP identified with ID of nₘ₋₁+1 is the same as the HARQ mode of the third DL HP (e.g., nₘ=1+nₘ₋₁ and/or the fifth DL HP is the second DL HP).

In an example embodiment, the one or more configuration parameters (e.g., the one or more RRC configuration parameters) may configure/indicate a first configuration parameter. For example, the base station may indicate the first configuration parameters via a downlink signal (e.g., a MAC CE, a second DCI, and/or a RRC message). The second DCI may be the DCI. In some examples, the second DCI may be different than the DCI. In response to determining the first configuration parameters being configured/indicated (or being enabled or not being disabled or not being absent from the one or more configuration parameters), the wireless device may determine a second DL HP (e.g., corresponding to reception of the m-th TB (or the m-th PDSCH) of the multiple TBs (or the multiple PDSCH), m=1, 2, . . . , M−1), identified with a second DL HP ID (e.g., the HP #nₘ), based on a scheduling order of the m-th TB (e.g., m) and the feedback-enabled/disabled DL HPs of the one or more configuration parameters (e.g., downlinkHARQ-FeedbackDisabled in PDSCH-ServingCellConfig IE). In an example embodiment, corresponding to reception of the m-th TB (or the m-th PDSCH) of the multiple TBs (or multiple PDSCHs), the wireless device may determine the second DL HP, identified with the second DL HP ID/number/index (e.g., the HP #nₘ), such that the second DL HP and the first DL HP, identified with the first DL HP ID (e.g., the HP #n), have the same HARQ mode, e.g., the first DL HP and the second DL HP are the feedback-enabled DL HP or the first DL HP and the second DL HP are the feedback-disabled DL HP. For example, the second TB may be different than a first/initial/starting/earliest TB of the multiple TBs, e.g., a reception occasion/slot (e.g., a first/initial/starting symbol) of the second TB/PDSCH of the multiple TBs/PDSCHs may be after a reception occasion/slot (e.g., a last/ending/final/latest symbol) of the first/initial/starting/earliest TB/PDSCH of the multiple TBs/PDSCHs.

For example, in response to determining the first configuration parameters not being configured/indicated (or being disabled or not being enabled or not being present in the one or more configuration parameters), the wireless device may determine the second DL HP ID based on the scheduling order of the m-th TB, e.g., by increasing the first DL HP ID by the scheduling order of the m-th TB (e.g., m).

In some implementations, the wireless device may determine scheduling order (e.g., m) corresponding to receiving the m-th TB/PDSCH of the multiple TBs/PDSCHs (e.g., m=0, 1, . . . , M−1) based on determining the corresponding reception occasion/slot of the m-th TB/PDSCH not overlapping/colliding with no UL symbol, e.g., indicated by tdd-UL-DL-ConfigurationCommon or tdd-UL-DL-ConfigurationDedicated if provided. For example, the corresponding reception occasion/slot of the m-th TB/PDSCH may comprise one or more DL symbols.

In response to the first DL HP being the feedback-enabled DL HP, the wireless device may transmit a multiple (e.g., M) HARQ-ACK information bits corresponding to the multiple TBs/PDSCHs. For example, a m-th HARQ-ACK information bit of the multiple HARQ-ACK information bits may correspond to a decoding result of the m-th TB/PDSCH of the multiple TBs/PDSCHs. For the m-th HARQ-ACK information bit of the multiple HARQ-ACK information bits, the wireless device may generate a positive acknowledgement (ACK) based on the wireless device correctly decoding the m-th TB of the multiple TBs. In another example, for the m-th HARQ-ACK information bit of the multiple HARQ-ACK information bits, the wireless device may generate a negative acknowledgement (NACK) based on the wireless device incorrectly decoding the m-th TB of the multiple TBs. For example, the wireless device may transmit the HARQ-ACK information bits in one or more PUCCH transmission occasion(s)/slot(s). The wireless device may determine the PUCCH transmission occasion(s) based on a PDSCH-to-HARQ_feedback timing indicator field of the DCI and/or a last/final/ending/latest symbol of a TB/PDSCH (a last/final/ending/latest TB/PDSCH) of the multiple TBs/PDSCHs.

In response to the first DL HP being the feedback-disabled DL HP, the wireless device may not transmit the multiple (e.g., M) HARQ-ACK information bits corresponding to the multiple TBs/PDSCHs. For example, the one or more configuration parameters may configure the wireless device with pdsch-HARQ-ACK-Codebook=dynamic or with pdsch-HARQ-ACK-Codebook-r16.

In some implementations, in response to the first DL HP being the feedback-disabled DL HP, the wireless device may transmit a multiple (e.g., M) HARQ-ACK information bits corresponding to the multiple TBs/PDSCHs such that each HARQ-ACK information bit of the multiple HARQ-ACK information bits comprises a NACK value (e.g., regardless of the decoding result of a corresponding TB of the multiple TBs). For example, the one or more configuration parameters may configure the wireless device with pdsch-HARQ-ACK-Codebook=semi-static (e.g., the wireless device may use Type-1 HARQ-ACK codebook to transmit the multiple HARQ-ACK information bits). The wireless device may determine the PUCCH transmission occasion(s) based on a PDSCH-to-HARQ_feedback timing indicator field of the DCI and/or a last/final/ending/latest symbol of a TB/PDSCH (a last/final/ending/latest TB/PDSCH) of the multiple TBs/PDSCHs.

Example embodiments may allow the wireless device to determine DL HP IDs (and/or HARQ information) corresponding to the reception of the multiple TBs when the base station configure the wireless device with the feedback-enabled/disabled DL HPs. Some example embodiments may improve DL transmission efficiency (e.g., by reducing decoding error at the wireless device) and/or may reduce the consumed power of the wireless device (e.g., by reducing possibility of DL data retransmissions). Example embodiments may improve flexibility of the base station for scheduling the multiple TBs by the (single) DCI when the base station configure the wireless device with the feedback-enabled/disabled DL HPs.

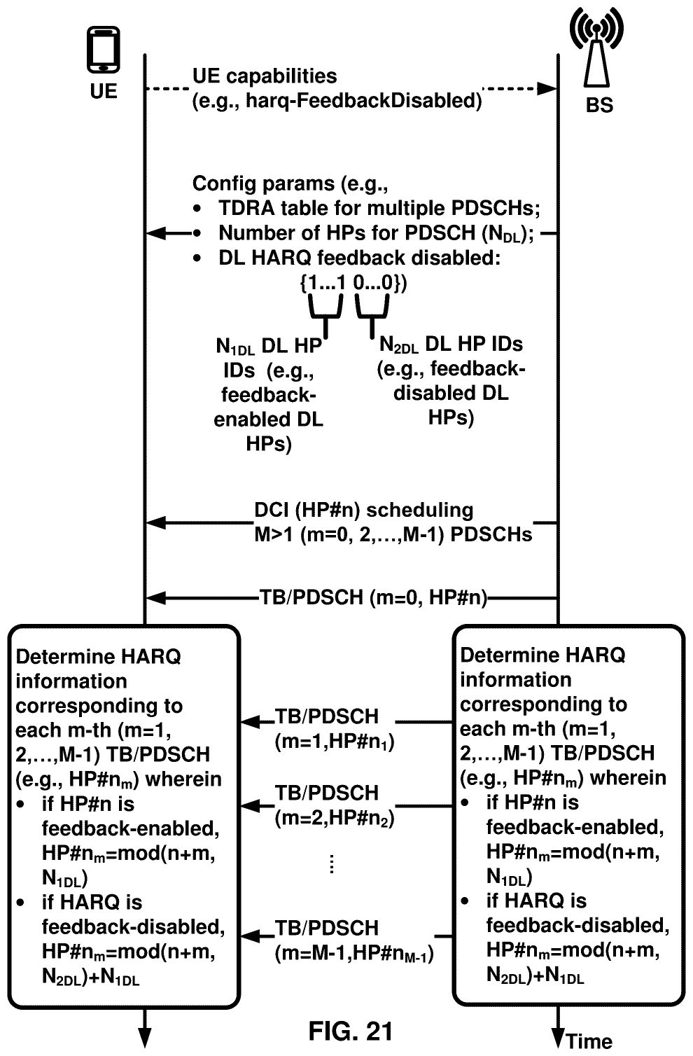

FIG. 21 shows an example embodiment of a HARQ operation/procedure in wireless communications systems per an aspect of the present disclosure. FIG. 21 may, for example, show an implementation of a method (or a process) for UL/DL transmissions at a base station and/or a wireless device. The base station may communicate with the wireless device via/using a cell (e.g., a serving cell). For example, the wireless device may be in an RRC_CONNECTED (or an RRC connected) state/mode. In some implementations, the wireless device may, for example, communicate with the base station via a non-terrestrial network (NTN), e.g., the wireless device and the base station may operate in the NTN and/or the base station may be an NTN base station and/or the cell (e.g., the serving cell) may be part of the NTN. In some other implementations, the wireless device may not communicate with the base station via the NTN (e.g., in a terrestrial network scenario). For example, the cell may not be part of the NTN.

As shown in FIG. 21, the wireless device may transmit one or more messages to the base station. The one or more messages may comprise one or more UE capability messages. The one or more messages may, for example, comprise a plurality of capabilities of the wireless device. In some aspects, the plurality of capabilities may comprise/indicate a capability for NTN access (e.g., nonTerrestrialNetwork-r17), e.g., a first capability (or feature) among/from/of the plurality of capabilities. The first capability may, for example, indicate whether the wireless device supports NR NTN access and/or satellite access. When the wireless device indicates the first capability, the wireless device may support one or more NTN essential features. In an example, the one or more NTN essential features may comprise at least one of the following: timer extension in higher layers (e.g., MAC/RLC/PDCP layers) of the wireless device, a RACH adaptation to handle long RTT, and/or acquiring NTN-specific SIB (e.g., the one or more NTN configuration parameters). In some implementations, when the wireless device indicates the first capability, the base station may configure the wireless device with the one or more NTN configuration parameters.

In some aspects, the plurality of capabilities may comprise a second capability (or feature) of the wireless device. For example, the second capability may indicate whether the wireless device supports a disabled HARQ feedback for downlink transmission (e.g., harq-FeedbackDisabled). In some cases, the wireless device that is supporting the second capability (e.g., the disabled HARQ feedback for downlink transmission) may indicate the first capability, e.g., the support of the NR NTN access (e.g., non TerrestrialNetwork-r17). In some other cases, the wireless device that is supporting/indicating the disabled HARQ feedback for downlink transmission (e.g., the second feature/capability) may not support (or indicate) the NTN access (e.g., non TerrestrialNetwork-r17), e.g., when the wireless device is operating in an unlicensed band (NR-U) and/or for extended reality (XR) applications and/or a sub-band full-duplex operation.

As shown in FIG. 21, the wireless device may receive the one or more configuration parameters from the base station. The one or more configuration parameters may comprise the one or more NTN configuration parameters. The one or more configuration parameters may configure the wireless device with one or more serving cell configuration parameters (e.g., ServingCellConfigCommon, ServingCellConfigCommonSIB, and/or ServingCellConfig). For example, the one or more configuration parameters configure the wireless device with the PDSCH configuration(s) (e.g., PDSCH-Config IE). In some cases, the PDSCH configuration(s) may comprise the TDRA table (or configuration parameters) for the multiple PDSCHs (e.g., pdsch-TimeDomainAllocationListForMultiPDSCH). In some cases, the one or more configuration parameters may configure (e.g., via nrofHARQ-ProcessesForPDSCH in PDSCH-ServingCellConfig IE) the wireless device with the first number of DL HPs for PDSCH of the cell (e.g., the serving cell), e.g., N_{DL}>0 DL HPs. In some other cases, when the one or more configuration parameters does not comprise/indicate the nrofHARQ-ProcessesForPDSCH, the wireless device may determine the first number of DL HPs for PDSCH of the cell by a predefined (or hard coded) value (e.g., N_{DL}=8 or N_{DL}=16).

In some implementations, as shown in FIG. 21, the one or more configuration parameters may configure the wireless device with the feedback-enabled DL HPs and/or the feedback-disabled DL HPs (e.g., via downlinkHARQ-FeedbackDisabled in PDSCH-ServingCellConfig IE). For example, the one or more configuration parameters may configure N_{1DL}>0 DL HPs as feedback-enabled DL HPs and N_{1DL}>0 DL HPs as feedback-disabled DL HPs, where N_{DL}=N_{1DL}+N_{2DL}.

In an example embodiment, the base station may, in response to determining the plurality of the capabilities comprising the second capability, configure the wireless device with a first set of DL HP IDs and a second set of DL HP IDs. As shown in FIG. 21, the first set of DL HP IDs may comprise N_{1DL}>0 consecutive DL HPs with a first HARQ mode (e.g., the feedback-enabled DL HP or the feedback-disabled DL HP). For example, the second set of DL HP IDs may comprise N_{2DL}>0 consecutive DL HPs with a second HARQ mode (e.g., the feedback-enabled DL HP or the feedback-disabled DL HP). The first HARQ mode may be different than the second HARQ mode.

In an example, the N_{1DL} leftmost bits of the downlinkHARQ-FeedbackDisabled may indicate DL HP IDs of the feedback-enabled DL HPs (e.g., the first set of DL HP IDs), e.g., a=0 for i=1, 2, . . . , N_{1DL}. The next N_{2DL} bits (or the N_{2DL} rightmost bits) of the downlinkHARQ-FeedbackDisabled may indicate DL HP IDs of the feedback-disabled DL HPs (e.g., the second set of DL HP IDs), e.g., aᵢ=1 for i=N_{1DL}+1, N_{1DL}+2, . . . , N_{1DL}+N_{2DL}. For example, a DL HP ID of each feedback-enabled DL HP may be smaller than a DL HP ID of each feedback-disabled DL HP.

In another example, the N_{2DL} leftmost bits of the downlinkHARQ-FeedbackDisabled may indicate DL HP IDs of the feedback-disabled DL HPs (e.g., the second set of DL HP IDs), e.g., aᵢ=1 for i=1, 2, . . . , N_{2DL}. The next N_{1DL} bits (or the N_{1DL} rightmost bits) of the downlinkHARQ-FeedbackDisabled may indicate DL HP IDs of the feedback-enabled DL HPs (e.g., the second set of DL HP IDs), e.g., aᵢ=0 for i=N_{2DL}+1, N_{2DL}+2, . . . , N_{2DL}+N_{1DL}. For example, a DL HP ID of each feedback-enabled DL HP may be larger than a DL HP ID of each feedback-disabled DL HP.

As shown in FIG. 21, the base station may transmit to the wireless device the (single) DCI for scheduling the multiple (e.g., M>1 different) TBs. For example, the wireless device may, by monitoring the one or more PDCCH candidates, receive/detect the DCI scheduling reception of the multiple TBs. In some examples, the DCI may indicate a first DL HP (e.g., HP #n in FIG. 21). For example, the DCI may comprise a bitfield indicating the first DL HP ID corresponding to the first DL HP. For example, the first DL HP may be a feedback-enabled DL HP, e.g., when the first DL HP ID belongs to the feedback-enabled DL HPs or the first set of DL HP IDs. In another example, the first DL HP may be a feedback-disabled DL HP, e.g., when the first DL HP belongs to the feedback-disabled DL HPs or the second set of DL HP IDs.

The wireless device may receive the DCI indicating at least one DL grant for DL transmission(s). For example, the DCI may indicate a first DL HP identified by/with HP #n (e.g., the first DL HP ID). For example, the wireless device may determine the DCI indicate one or more fields comprising a TDRA field, a RV field, and/or an NDI field. For example, the wireless device may determine bit width of the TDRA field, the RV field, and/or the NDI field to receive the DL transmissions (e.g., the multiple TBs/PDSCHs). In some cases, the wireless device may determine how many (different) TBs/PDSCHs are scheduled by the DCI based on a number of entries of the multiple-PDSCH TDRA table.

In an example embodiment, the wireless device may determine a HARQ information corresponding to each TB/PDSCH of the multiple TBs/PDSCHs. In some cases, based on the DCI the wireless device may determine the HARQ information corresponding to (or of or associated to) each TB/PDSCH of the multiple TBs/PDSCHs. In some cases, the corresponding HARQ information of the m-th TB/PDSCH of the multiple TBs/PDSCHs (e.g., m=0, 1, 2, . . . , M−1) may comprise at least one of: a corresponding DL HP ID (e.g., HP #n when m=0 and HP #nₘ when m>0), a corresponding NDI (e.g., determined from a NDI field of the DCI and/or the multiple-PDSCH TDRA table), a corresponding RV (e.g., determined from an RV field of the DCI and/or the multiple-PDSCH TDRA table), and/or a corresponding TB size (e.g., determined from an MSC field of the DCI).

In an example embodiment, the wireless device may determine the corresponding DL HP ID of the m-th TB/PDSCH of the multiple TBs/PDSCHs (e.g., m=1, 2, . . . , M−1) based on whether a first DL HP indicated by the DCI being a feedback-enabled DL HP or a feedback-disabled DL HP (e.g., based on a HARQ mode of the first DL HP). For example, corresponding to a m-th TB/PDSCH of the multiple TBs/PDSCHs (e.g., m=1, 2, . . . , M−1), the wireless device may determine a corresponding HARQ information based on whether the first HP DL is a feedback-enabled DL HP or a feedback-disabled DL HP (e.g., based on a HARQ mode of the first DL HP).

For example, a HARQ information corresponding to a first/initial/starting/earliest TB/PDSCH of the multiple TBs/PDSCHs (e.g., m=0) may be based on the DCI, e.g., the first DL HP ID (e.g., HP #n), a corresponding NDI of the TB/PDSCH m=0 (e.g., determined from a NDI field of the DCI), a corresponding RV of the TB/PDSCH m=0 (e.g., determined from an RV field of the DCI, and/or a corresponding TB size of the TB/PDSCH m=0 (e.g., determined from an MSC field of the DCI).

In an example, a HARQ information corresponding to the m-th TB/PDSCH of the multiple TBs/PDSCHs (e.g., m=1, 2, . . . , M−1) may be based on the DCI and a HARQ mode of the first DL HP. For example, based on the DCI the wireless device may determine: the first DL HP ID (e.g., HP #n), a corresponding NDI of the TB/PDSCH m>0 (e.g., determined from a NDI field of the DCI and/or multiple-PDSCH TDRA table), a corresponding RV of the TB/PDSCH m>0 (e.g., determined from an RV field of the DCI and/or multiple-PDSCH TDRA table), and/or a corresponding TB size of the TB/PDSCH m>0 (e.g., determined from an MSC field of the DCI). For example, the wireless device may determine the corresponding DL HP ID of the m-th TB/PDSCH of the multiple TBs/PDSCHs to determine the corresponding HARQ information.

As shown in FIG. 21, corresponding to each TB of the multiple TBs scheduled by the DCI, the base station may determine a second DL HP ID/number/index based on whether the first DL HP ID correspond to a feedback-enabled DL HP or a feedback-disabled DL HP (e.g., whether the first DL HP is a feedback-enabled DL HP or a feedback-disabled DL HP and/or whether a HARQ feedback of the first DL HP is disabled or not). For example, the base station may transmit a first/initial/starting/earliest TB/PDSCH of the multiple TBs/PDSCHs, e.g., with a scheduling order m=0, based on the first DL HP (e.g., the HP #n). For transmission of a m-th TB of the multiple TBs, with a scheduling order m>0 where m=1, 2, . . . , M−1, the base station may use a second DL HP, identified with a second DL HP ID (e.g., HP #nₘ). In an example embodiment, the base station may determine a second DL HP ID (e.g., the HP #nₘ), corresponding to transmission of the m-th TB of the multiple TBs, where m=1, 2, . . . , M−1, based on whether the first DL HP is a feedback-enabled DL HP or a feedback-disabled DL HP. For example, the base station may determine second DL HP ID (e.g., the HP #nₘ) based on the scheduling order m, the first DL HP ID, and/or whether the first DL HP is a feedback-enabled DL HP or a feedback-disabled DL HP. In another example, the base station may determine the second DL HP ID (e.g., the HP #nₘ) based on the scheduling order m, the first DL HP ID, whether the first DL HP is a feedback-enabled DL HP or a feedback-disabled DL HP, and/or the feedback-enabled/disabled DL HPs (e.g., via downlinkHARQ-FeedbackDisabled in PDSCH-ServingCellConfig IE).

In an example embodiment, as shown in FIG. 21, corresponding to transmission of the m-th TB of the multiple TBs (where m=1, 2, . . . , M−1) and based on the first DL HP being feedback enabled (a feedback-enabled DL HP), the base station may determine the second DL HP ID (e.g., the HP #nₘ) such that a second DL HP, identified with the second DL HP ID, being feedback enabled (e.g., the first DL HP and the second DL HP having same HARQ mode in the DL). For example, nₘ=mod (n+m, N_{1DL}) (e.g., when the N_{1DL} leftmost bits of the downlinkHARQ-FeedbackDisabled correspond to the feedback-enabled DL HPs) or nₘ=mod (n+m, N_{1DL})+N_{2DL} (e.g., when the N_{2DL} leftmost bits of the downlinkHARQ-FeedbackDisabled correspond to the feedback-disabled DL HPs).

For example, the base station may determine that nₘ corresponds to (or being associated to) a DL HP that is not configured. For example, the base station may determine the HP #nₘ based on nₘ=mod (n+m+1, N_{1DL}) (e.g., when the N_{1DL} leftmost bits of the downlinkHARQ-FeedbackDisabled correspond to the feedback-enabled DL HPs) or nₘ=mod (n+m+1, N_{1DL})+N_{2DL} (e.g., when the N_{2DL} leftmost bits of the downlinkHARQ-FeedbackDisabled correspond to the feedback-disabled DL HPs).

In an example embodiment, corresponding to transmission of the m-th TB of the multiple TBs (where m=1, 2, . . . , M−1) and based on the first DL HP being feedback disabled (a feedback-disabled DL HP), the base station may determine the second DL HP ID (e.g., the HP #nₘ) such that a second DL HP, identified with the second DL HP ID, being feedback disabled. For example, the first DL HP and the second DL HP may have same HARQ mode (e.g., both the first DL HP and the second DL HP are feedback-enabled DL HPs or both the first DL HP and the second DL HP are feedback-disabled DL HPs). For example, nₘ=mod (n+m, N_{2DL}) (e.g., when the N_{2DL} leftmost bits of the downlinkHARQ-FeedbackDisabled correspond to the feedback-disabled DL HPs) or nₘ=mod (n+m, N_{2DL})+N_{1DL} (e.g., when the N_{1DL} leftmost bits of the downlinkHARQ-FeedbackDisabled correspond to the feedback-enabled DL HPs).

For example, the base station may determine that nₘ corresponds to (or being associated to) a DL HP that is not configured. For example, the base station may determine the HP #nₘ nₘ=mod (n+m+1, N_{2DL}) (e.g., when the N_{2DL} leftmost bits of the downlinkHARQ-FeedbackDisabled correspond to the feedback-disabled DL HPs) or nₘ=mod (n+m+1, N_{2DL})+N_{1DL} (e.g., when the N_{1DL} leftmost bits of the downlinkHARQ-FeedbackDisabled correspond to the feedback-enabled DL HPs).

As shown in FIG. 21, corresponding to each TB of the multiple TBs scheduled by the DCI, the wireless device may determine the second DL HP ID/number/index based on whether the first DL HP ID correspond to a feedback-enabled DL HP or a feedback-disabled DL HP (e.g., whether the first DL HP is a feedback-enabled DL HP or a feedback-disabled DL HP and/or whether a HARQ feedback of the first DL HP is disabled or not). For example, the wireless device may receive a first/initial/starting/earliest TB (or PDSCH), e.g., with a scheduling order m=0, of the multiple TBs (or multiple PDSCHs) based on the first DL HP (e.g., the HP #n). For reception of a m-th TB of the multiple TBs, with a scheduling order m>0 where m=1, 2, . . . , M−1, the wireless device may use a second DL HP, identified with the second DL HP ID (e.g., HP #nₘ), e.g., the m-th TB of the multiple TBs correspond to the second DL HP. In an example embodiment, the wireless device may determine the second DL HP ID (e.g., the HP #nₘ), corresponding to reception of the m-th TB of the multiple TBs, where m=1, 2, . . . , M−1, based on whether the first DL HP is a feedback-enabled DL HP or a feedback-disabled DL HP. For example, the wireless device may determine the second DL HP ID (e.g., the HP #nₘ) based on the scheduling order m, the first DL HP ID, and/or whether the first DL HP is a feedback-enabled DL HP or a feedback-disabled DL HP. In another example, the wireless device may determine the second DL HP ID (e.g., the HP #nₘ) based on the scheduling order m, the first DL HP ID, whether the first DL HP is a feedback-enabled DL HP or a feedback-disabled DL HP, and/or the feedback-enabled/disabled DL HPs.

In an example embodiment, corresponding to reception of the m-th TB of the multiple TBs (where m=1, 2, . . . , M−1) and based on the first DL HP being feedback enabled (a feedback-enabled DL HP), the wireless device may determine the second DL HP ID (e.g., the HP #nₘ) such that a second DL HP, identified with the second DL HP ID, being feedback enabled. For example, the first DL HP and the second DL HP may have same HARQ mode (e.g., both the first DL HP and the second DL HP are feedback-enabled DL HPs). For example, nₘ=mod (n+m, N_{1DL}) (e.g., when the N_{1DL} leftmost bits of the downlinkHARQ-FeedbackDisabled correspond to the feedback-enabled DL HPs) or nₘ=mod (n+m, N_{1DL})+N_{2DL} (e.g., when the N_{2DL} leftmost bits of the downlinkHARQ-FeedbackDisabled correspond to the feedback-disabled DL HPs).

For example, the wireless device may determine that nₘ corresponds to (or being associated to) a DL HP that is not configured. For example, the base station may determine the HP #nₘ based on nₘ=mod (n+m+1, N_{1DL}) (e.g., when the N_{1DL} leftmost bits of the downlinkHARQ-FeedbackDisabled correspond to the feedback-enabled DL HPs) or nₘ=mod (n+m+1, N_{1DL})+N_{2DL} (e.g., when the N_{2DL} leftmost bits of the downlinkHARQ-FeedbackDisabled correspond to the feedback-disabled DL HPs).

In an example embodiment, corresponding to transmission of the m-th TB of the multiple TBs (where m=1, 2, . . . , M−1) and based on the first DL HP being feedback disabled (a feedback-disabled DL HP), the wireless device may determine the second DL HP ID (e.g., the HP #nₘ) such that a second DL HP, identified with the second DL HP ID, being feedback disabled. For example, the first DL HP and the second DL HP may have same HARQ mode (e.g., both the first DL HP and the second DL HP are feedback-disabled DL HPs). For example, nₘ=mod (n+m, N_{2DL}) (e.g., when the N_{2DL} leftmost bits of the downlinkHARQ-FeedbackDisabled correspond to the feedback-disabled DL HPs) or nₘ=mod (n+m, N_{2DL})+N_{1DL} (e.g., when the N_{1DL} leftmost bits of the downlinkHARQ-FeedbackDisabled correspond to the feedback-enabled DL HPs).

For example, the wireless device may determine that nₘ corresponds to (or being associated to) a DL HP that is not configured. For example, the base station may determine the HP #nₘ nₘ=mod (n+m+1, N_{2DL}) (e.g., when the N_{2DL} leftmost bits of the downlinkHARQ-FeedbackDisabled correspond to the feedback-disabled DL HPs) or nₘ=mod (n+m+1, N_{2DL})+N_{1DL} (e.g., when the N_{1DL} leftmost bits of the downlinkHARQ-FeedbackDisabled correspond to the feedback-enabled DL HPs).

In some implementations, the wireless device may determine scheduling order (e.g., m) corresponding to receiving the m-th TB/PDSCH of the multiple TBs/PDSCHs (e.g., m=0, 1, . . . , M−1) based on determining the corresponding reception occasion/slot of the m-th TB/PDSCH not overlapping/colliding with no UL symbol, e.g., indicated by tdd-UL-DL-ConfigurationCommon or tdd-UL-DL-ConfigurationDedicated if provided. For example, the corresponding reception occasion/slot of the m-th TB/PDSCH may comprise one or more DL symbols.

Example embodiments may allow the wireless device to determine DL HP IDs corresponding to the reception of the multiple TBs when the base station configure the wireless device with the feedback-enabled/disabled DL HPs. Some example embodiments may improve DL transmission efficiency (e.g., by reducing decoding error at the wireless device) and/or may reduce the consumed power of the wireless device (e.g., by reducing possibility of DL data retransmissions). Example embodiments may improve flexibility of the base station for scheduling the multiple TBs by the (single) DCI when the base station configure the wireless device with the feedback-enabled/disabled DL HPs.

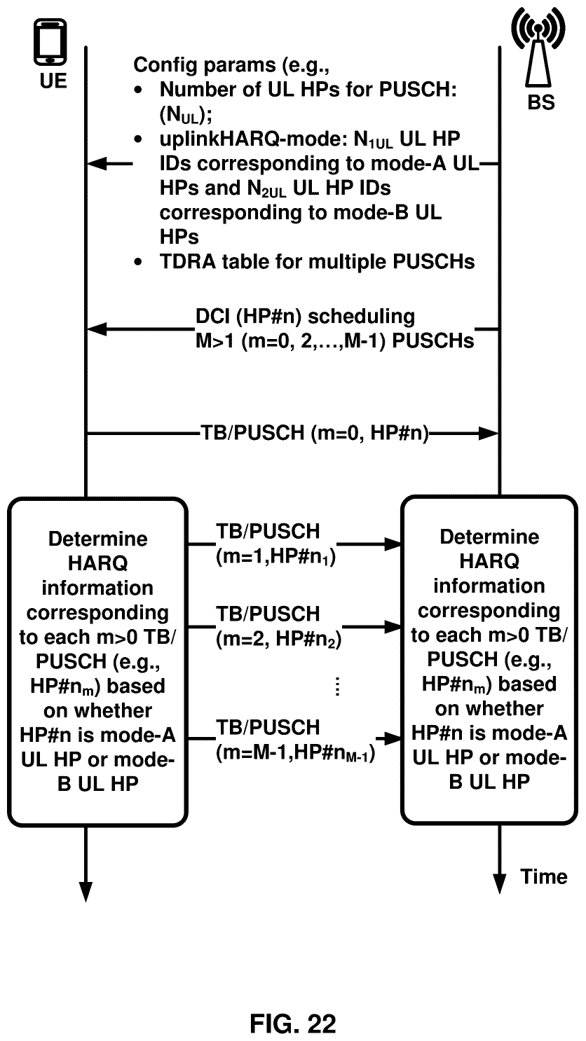

FIG. 22 shows an example embodiment of a HARQ operation/procedure in wireless communications systems per an aspect of the present disclosure. FIG. 22 may, for example, show an implementation of a method (or a process) for UL/DL transmissions at a base station and/or a wireless device. The base station may communicate with the wireless device via/using a cell (e.g., a serving cell). For example, the wireless device may be in an RRC_CONNECTED (or an RRC connected) state/mode. In some implementations, the wireless device may, for example, communicate with the base station via a non-terrestrial network (NTN), e.g., the wireless device and the base station may operate in the NTN and/or the base station may be an NTN base station and/or the cell (e.g., the serving cell) may be part of the NTN.

As shown in FIG. 22, the wireless device may receive the one or more configuration parameters from the base station. The one or more configuration parameters may comprise the one or more NTN configuration parameters. The one or more configuration parameters may configure the wireless device with one or more serving cell configuration parameters (e.g., ServingCellConfigCommon, ServingCellConfigCommonSIB, and/or ServingCellConfig). For example, the one or more configuration parameters configure the wireless device with PUSCH configuration(s) (e.g., PUSCH-Config IE). In some cases, the PUSCH configuration(s) may comprise one or more configuration parameters for multiple PUSCHs, e.g., time-domain resource allocation/assignment (TDRA) table (or configuration parameters) for the multiple PUSCHs (e.g., pusch-TimeDomainAllocationListForMultiPUSCH and/or pusch-TimeDomainResourceAllocationListForMultiPUSCH). The multiple-PUSCH TDRA table may configure the wireless device for receiving multiple PUSCHs that is scheduled by a single DCI. In some implementations, the multiple-PUSCH TDRA table may comprise a list of time-domain configuration(s). For example, the multiple-PUSCH TDRA table may indicate the list of time-domain configuration(s) for timing of DL assignment (e.g., the single DCI) to UL data. In some cases, the UL data may comprise multiple (different) TBs scheduled by the single DCI. In some other cases, the UL data may correspond to multiple PUSCHs scheduled by the single DCI. In some implementations, one or more rows of the multiple-PUSCH TDRA table may contain one or more (e.g., multiple or at least one) SLIVs for PUSCH on an UL BWP of the cell (e.g., the serving cell).

In some cases, the one or more configuration parameters may configure (e.g., via nrofHARQ-ProcessesForPUSCH in PUSCH-ServingCellConfig IE) the wireless device with a second number of UL HPs for PUSCH of the cell (e.g., the serving cell), e.g., N_{UL}>0 UL HPs. In some other cases, when the one or more configuration parameters does not comprise/indicate the nrofHARQ-ProcessesForPUSCH, the wireless device may determine the second number of UL HPs for PUSCH of the cell by a predefined (or hard coded) value (e.g., N_{UL}=8 or N_{UL}=16).

In some implementations, as shown in FIG. 22, the one or more configuration parameters may configure the wireless device with mode-A (e.g., HARQmodeA or an enabled HARQ retransmission mode) UL HPs and/or mode-B (e.g., HARQmodeB or a disabled HARQ retransmission mode or a no HARQ retransmission mode) UL HPs (e.g., via uplinkHARQ-mode in PUSCH-ServingCellConfig IE). For example, the one or more configuration parameters may configure N_{1UL}>0 UL HPs of the second number UL HPs as mode-A UL HPs (e.g., a first plurality of UL HP IDs or a first plurality of UL HPs) and N_{1UL}>0 UL HPs of the second number of UL HPs as mode-B UL HPs (e.g., a second plurality of UL HP IDs or a second plurality of UL HPs), where N_{UL}=N_{1UL}+N_{2UL}. For example, a cardinality (or size or a number) of the mode-A UL HPs may be N_{1DL} and a cardinality (or size or a number) of the mode-A HPs may be N_{2DL}.

For example, a HARQ mode of an UL HP identified with/by an UL HP ID may be a HARQ mode A (or uplink HARQ mode A or HARQmodeA) based on the UL HP ID being in the first plurality of UL HPs (e.g., the UL HP being in the mode-A UL HPs). The HARQ mode of the UL HP may, for example, be a HARQ mode B (or uplink HARQ mode B or HARQmodeB) based on the UL HP ID being in the second plurality of UL HPs (e.g., the UL HP being in the mode-B UL HPs).

In some cases, when a HARQ mode of an UL HP is the HARQ mode A, the wireless device may start monitoring PDCCH for receiving an UL grant for retransmission of an UL data associated with the UL HP after an initial/first transmission of the UL data. In some cases, when the drx-Retransmission TimerUL corresponding to the UL HP is running, the wireless device may monitor the PDCCH. For example, the wireless device may start the drx-Retransmission TimerUL corresponding to the UL HP after an offset (e.g., the UE-gNB RTT) the initial transmission of the UL data.

In some cases, when a HARQ mode of an UL HP is the HARQ mode B, the wireless device may not start monitoring PDCCH for receiving an UL grant for retransmission of an UL data associated with the UL HP after an initial/first transmission of the UL data. In some cases, the wireless device may not start the drx-Retransmission TimerUL corresponding to the UL HP after the initial transmission of the UL data.

For example, the wireless device (and/or the base station) may determine a HARQ mode of an UL HP based on whether a corresponding UL HP ID being in the first plurality of UL HP IDs or the second plurality of UL HP IDs. The HARQ mode of the UL HP may be mode A (or HARQmodeA or an enabled HARQ retransmission mode) based on the UL HP ID being in the first plurality of UL HP IDs (e.g., the UL HP being the mode-A UL HP). The HARQ mode of the UL HP may be mode B (or HARQmodeB or a disabled HARQ retransmission mode or a no HARQ retransmission mode) based on the UL HP ID being in the second plurality of UL HP IDs (e.g., the DL HP being the mode-B UL HP).

As shown in FIG. 22, the base station may transmit to the wireless device a (single) DCI for scheduling multiple (e.g., M>1 different) TBs. For example, the wireless device may, by monitoring the one or more PDCCH candidates, receive/detect the DCI scheduling reception of the multiple TBs. For example, the DCI may be a DCI format 0_1 with CRC scrambled by C-RNTI or CSRNTI or SP-CSI-RNTI or MCS-C-RNTI, scheduling transmission of the multiple TBs (or multiple PUSCHs) by the wireless device. For example, the wireless device and the base station may communicate the multiple TBs scheduled with the DCI.

The wireless device may receive the DCI indicating at least one UL grant for UL data transmission(s). For example, the DCI may indicate a first UL HP identified with HP #n (e.g., the first UL HP ID). For example, the wireless device may determine values of one or more fields of the DCI. the one or more fields of the DCI may comprise a TDRA field, a RV field, and/or an NDI field. For example, the wireless device may determine a bit width of the TDRA field, a bit width of the RV field, and/or a bit width of the NDI field to receive the DL transmission. In some cases, the wireless device may determine how many (different) TBs/PUSCHs are scheduled by the DCI based on a number of entries of the multiple-PUSCH TDRA table and/or the TDRA field of the DCI (e.g., the bit width of the TDRA field of the DCI).

In some examples, the DCI may indicate a first UL HP (e.g., HP #n in FIG. 22). For example, the DCI may comprise a bitfield indicating the first UL HP ID corresponding to the first UL HP. For example, the first UL HP may be a mode-A UL HP, e.g., when the first UL HP belongs to the mode-A UL HPs. In another example, the first UL HP may be a mode-B UL HP, e.g., when the first UL HP belongs to the mode-B DL HPs.

The wireless device may, for example, transmit the multiple TBs across/via/using/based on multiple (e.g., M>1 different) transmission occasions/slots. The base station may, for example, receive the multiple TBs across multiple (e.g., M>1 different) reception occasions/slots. In some cases, the wireless device may transmit each TB of the multiple TBs via/using/based on each PUSCH of multiple PUSCHs during a transmission occasion/slot of the multiple transmission occasions/slots.

In an example embodiment, the wireless device (and/or the base station) may determine a HARQ information corresponding to a TB/PUSCH of the multiple TBs/PUSCHs. For example, corresponding to an m-th TB/PUSCH of the multiple TBs/PUSCHs (e.g., m=0, 1, 2, . . . , M−1), the wireless device (and/or the base station) may determine a corresponding HARQ information. In some cases, the corresponding HARQ information of the m-th TB/PUSCH of the multiple TBs/PUSCHs (e.g., m=0, 1, 2, . . . , M−1) may comprise at least one of: a corresponding UL HP ID (e.g., HP #n when m=0 and HP #nₘ when m>0), a corresponding NDI, a corresponding RV, and/or a corresponding TB size. For example, the wireless device may determine HP #nₘ for m>0. In some cases, to determine the corresponding HARQ information of the m-th TB/PUSCH of the multiple TBs/PUSCHs (e.g., m=0, 1, 2, . . . , M−1), the wireless device (and/or the base station) may determine at least one of the following: a number of scheduled TBs/PUSCHs by the DCI (e.g., M), a bit width of a TDRA field of the DCI, and/or a bit width of an NDI field of the DCI, and/or a bit width of an RV field of the DCI. For example, the wireless device may determine the TB size of the m-th TB/PUSCH of the multiple TBs/PUSCHs (e.g., m=0, 1, 2, . . . , M−1) based on a modulation and coding scheme (MSC) field of the DCI.

In an example embodiment, the wireless device (and/or the base station) may determine the corresponding UL HP ID of the m-th TB/PDSCH of the multiple TBs/PDSCHs (e.g., m=1, 2, . . . , M−1) based on whether a first UL HP indicated by the DCI being a mode-A UL HP or a mode-B UL HP (e.g., based on a HARQ mode of the first UL HP). For example, corresponding to a m-th TB/PDSCH of the multiple TBs/PDSCHs (e.g., m=1, 2, . . . , M−1), the wireless device (and/or the base station) may determine a corresponding HARQ information based on whether the first UL HP is mode-A UL HP or a mode-B UL HP (e.g., based on a HARQ mode of the first UL HP).

For example, a HARQ information corresponding to a first/initial/starting/earliest TB/PUSCH of the multiple TBs/PUSCHs (e.g., m=0) may be based on the DCI, e.g., the first UL HP ID (e.g., HP #n), a corresponding NDI of the TB/PUSCH m=0 (e.g., determined from a NDI field of the DCI and/or the multiple-PUSCH TDRA table), a corresponding RV of the TB/PUSCH m=0 (e.g., determined from an RV field of the DCI and/or the multiple-PUSCH TDRA table), and/or a corresponding TB size of the TB/PUSCH m=0 (e.g., determined from an MSC field of the DCI).

In an example, a HARQ information corresponding to the m-th TB/PUSCH of the multiple TBs/PUSCHs (e.g., m=1, 2, . . . , M−1) may be based on the DCI and a HARQ mode of the first UL HP. For example, based on the DCI the wireless device may determine: the first UL HP ID (e.g., HP #n), a corresponding NDI of the TB/PUSCH m>0 (e.g., determined from a NDI field of the DCI), a corresponding RV of the TB/PUSCH m>0 (e.g., determined from an RV field of the DCI, and/or a corresponding TB size of the TB/PUSCH m>0 (e.g., determined from an MSC field of the DCI). For example, the wireless device may determine the corresponding UL HP ID of the m-th TB/PUSCH of the multiple TBs/PUSCHs to determine the corresponding HARQ information.

For example, the wireless device may, based on the TDRA table for the multiple PUSCHs, transmit each TB of the multiple TBs via/using/based on each PUSCH of multiple PUSCHs during a transmission occasion/slot of the multiple reception occasions/slots. For example, the wireless device may transmit the multiple TBs/PUSCHs based on the DCI and/or the one or more configuration parameters (e.g., the TDRA table for the multiple PUSCHs, e.g., PUSCH-TimeDomainResourceAllocation IE and/or pusch-TimeDomainAllocationListForMultiPUSCH). The TDRA table for the multiple PUSCHs (e.g., PUSCH-TimeDomainResourceAllocation IE and/or pusch-TimeDomainAllocationListForMultiPUSCH) may indicate a time domain relation between the DCI and the multiple TBs/PUSCHs. In some cases, the wireless device may determine a bit width of a Time domain resource assignment field of the DCI based on number of entries in the pusch-TimeDomainResourceAllocationListForMultiPUSCH. The wireless device may transmit the m-th TB/PUSCH, m=0, 1, . . . , M−1, of the multiple TBs based on m-th entry (e.g., k2, mappingType, startSymbolAndLength, and the like) of the PUSCH-TimeDomainResourceAllocation IE. For example, the wireless device may determine a transmission occasion/time of each TB/PUSCH of the multiple TBs/PUSCHs based on the one or more NTN configuration parameters (e.g., the cell/beam-specific timing offset, the UE-specific timing offset, satellite ephemeris data, common TA values, and/or the like) and/or one or more numerology. For example, the wireless device may determine a redundancy version for each TB of the multiple TBs based on one or more bits of a Redundancy version field, the Time domain resource assignment field of the (single) DCI, and a preconfigured table.

For example, the wireless device (and/or the base station) may map an m-th bit (m=0, 1, . . . , M−1) of the RV field of the DCI to the m-th (m=0, 1, . . . , M−1) scheduled TB/PUSCH of the multiple TBs/PUSCHs. In some implementations, the wireless device may, for transmitting the multiple TBs/PUSCHs, map (e.g., in a one-to-one approach and in accordance with scheduling order of the multiple TBs/PUSCHs) each bit of the RV field of the DCI to each TB/PUSCH of the multiple TBs/PUSCHs. In some cases, the LSB bits of the RV field of the DCI may correspond to a last/final/ending/latest (e.g., M−1) scheduled TB/PUSCH of the multiple TBs/PUSCHs (e.g., indicated by the TDRA field of the DCI).

For example, the wireless device (and/or the base station) may map a m-th (m=0, 1, . . . , M−1) bit of the NDI field of the DCI to the m-th (m=0, 1, . . . , M−1) scheduled TB/PUSCH of the multiple TBs/PUSCHs. In some implementations, the wireless device may, for transmitting the multiple TBs/PUSCHs, map (e.g., in a one-to-one approach and in accordance with scheduling order of the multiple TBs/PUSCHs) each bit of the NDI field of the DCI to each TB/PUSCH of the multiple TBs/PUSCHs. In some cases, the LSB bits of the NDI field of the DCI may correspond to a last/final/ending/latest (e.g., M−1) scheduled TB/PUSCH of the multiple TBs/PUSCHs (e.g., indicated by the TDRA field of the DCI).

As shown in FIG. 22, corresponding to each TB of the multiple TBs scheduled by the DCI, the base station may determine a second UL HP ID/number/index based on whether the first UL HP ID correspond to a mode-A UL HP or a mode-B UL HP (e.g., whether the first UL HP is a mode-A UL HP or a mode-B UL HP). For example, the base station may receive a first/initial/starting/earliest TB/PUSCH of the multiple TBs/PUSCHs, e.g., with a scheduling order m=0, based on the first UL HP (e.g., the HP #n). For reception of a m-th TB of the multiple TBs, with a scheduling order m>0 where m=1, 2, . . . , M−1, the base station may use a second UL HP, identified with a second UL HP ID (e.g., HP #nₘ). In an example embodiment, the base station may determine a second UL HP ID (e.g., the HP #nₘ), corresponding to reception of the m-th TB of the multiple TBs, where m=1, 2, . . . , M−1, based on whether the first UL HP is a mode-A UL HP or a mode-B UL HP. For example, the base station may determine second UL HP ID (e.g., the HP #nₘ) based on the scheduling order m, the first UL HP ID, and/or whether the first UL HP is a mode-A UL HP or a mode-B UL HP. In another example, the base station may determine the second UL HP ID (e.g., the HP #nₘ) based on the scheduling order m, the first UL HP ID, whether the first UL HP is a mode-A UL HP or a mode-B UL HP, and/or the mode-A/mode-B UL HPs (e.g., via uplinkHARQ-mode in PUSCH-ServingCellConfig IE).

In an example embodiment, corresponding to transmission of the m-th TB of the multiple TBs (where m=1, 2, . . . , M−1) and based on the first UL HP being a mode-A UL HP, the base station may determine the second UL HP ID (e.g., the HP #nₘ) such that a second UL HP, identified with the second UL HP ID, being a mode-B UL HP (e.g., the first UL HP and the second UL HP having same HARQ mode in the UL).

In an example embodiment, corresponding to reception of the m-th TB of the multiple TBs (where m=1, 2, . . . , M−1) and based on the first UL HP being a mode-B UL HP, the base station may determine the second UL HP ID (e.g., the HP #nₘ) such that a second UL HP, identified with the second UL HP ID, being mode-B UL HP. For example, the first UL HP and the second UL HP may have same HARQ mode.

For example, corresponding to reception of the m-th TB of the multiple TBs (m=1, 2, . . . , M−1), the base station may increase a third UL HP ID, corresponding to a scheduling order of m−1 (e.g., HP #nₘ₋₁), by a (smallest) positive number/such that a second UL HP identified with index nₘ=/+nₘ₋₁ has a same HARQ mode as a third UL HP identified with ID HP #nₘ₋₁ (e.g., both the third UL HP and the second UL HP are mode-A UL HPs or both the third UL HP and the second UL HP are mode-B UL HPs). For example, the third UL HP ID may have the same HARQ mode of the first UL HP. In some cases, the positive number/may be larger than 1, e.g., when a HARQ mode of a fifth UL HP identified with ID of nₘ₋₁+1 is not the same as the HARQ mode of the third UL HP and/or the fifth UL HP is not configured. In some other cases, the positive number/may be 1, e.g., when a HARQ mode of the fifth UL HP identified with ID of nₘ₋₁+1 is the same as the HARQ mode of the third UL HP (e.g., nₘ=1+nₘ₋₁ and/or the fifth UL HP is the second UL HP).

As shown in FIG. 22, corresponding to each TB of the multiple TBs scheduled by the DCI, the wireless device may determine the second UL HP ID/number/index based on whether the first UL HP ID correspond to a mode-A UL HP or a mode-B UL HP (e.g., whether the first UL HP is a mode-A UL HP or a mode-B UL HP). For example, the wireless device may transmit a first/initial/starting/earliest TB (or PUSCH), e.g., with a scheduling order m=0, of the multiple TBs (or multiple PUSCHs) based on the first UL HP (e.g., the HP #n). For transmission of a m-th TB of the multiple TBs, with a scheduling order m>0 where m=1, 2, . . . , M−1, the wireless device may use a second UL HP identified with the second UL HP ID (e.g., HP #nₘ), e.g., the m-th TB of the multiple TBs correspond to the second UL HP. In an example embodiment, the wireless device may determine the second UL HP ID (e.g., the HP #nₘ), corresponding to transmission of the m-th TB of the multiple TBs, where m=1, 2, . . . , M−1, based on whether the first UL HP is a mode-A UL HP or a mode-B UL HP. For example, the wireless device may determine the second UL HP ID (e.g., the HP #nₘ) based on the scheduling order m, the first UL HP ID, and/or whether the first UL HP is a mode-A UL HP or a mode-B UL HP. In another example, the wireless device may determine the second UL HP ID (e.g., the HP #nₘ) based on the scheduling order m, the first UL HP ID, whether the first UL HP is a mode-A UL HP or a mode-B UL HP, and/or the mode-A/mode-B UL HPs (e.g., uplinkHARQ-mode in PUSCH-ServingCellConfig IE).

In an example embodiment, corresponding to reception of the m-th TB of the multiple TBs (where m=1, 2, . . . , M−1) and based on the first UL HP being mode-A UL HP, the wireless device may determine the second UL HP ID (e.g., the HP #nₘ) such that a second UL HP, identified with the second UL HP ID, being mode-A UL HP. For example, the first UL HP and the second UL HP may have same HARQ mode (e.g., both the first UL HP and the second UL HP are mode-A UL HPs).

In an example embodiment, corresponding to reception of the m-th TB of the multiple TBs (where m=1, 2, . . . , M−1) and based on the first UL HP being mode-B UL HP, the wireless device may determine the second UL HP ID (e.g., the HP #nₘ) such that a second UL HP, identified with the second UL HP ID, being mode-B UL HP. For example, the first UL HP and the second UL HP may have same HARQ mode (e.g., both the first UL HP and the second UL HP are mode-B UL HPs).

For example, corresponding to transmission of the m-th TB of the multiple TBs (m=1, 2, . . . , M−1), the wireless device may increase a third UL HP ID, corresponding to a scheduling order of m−1 (e.g., HP #nₘ₋₁), by a (smallest) positive number/such that a fourth UL HP identified with index nₘ=/+nₘ₋₁ has a same HARQ mode as a third UL HP identified with ID HP #nₘ₋₁ (e.g., both the third UL HP and the second UL HP are mode-A UL HPs or both the third UL HP and the second UL HP are mode-B UL HPs). In some cases, the positive number/may be larger than 1, e.g., when a HARQ mode of the fifth UL HP identified with ID of nₘ₋₁+1 is not the same as the HARQ mode of the third UL HP and/or the fifth UL HP is not configured (e.g., by the one or more configuration parameters). In some other cases, the positive number/may be 1, e.g., when a HARQ mode of the fifth UL HP identified with ID of nₘ₋₁+1 is the same as the HARQ mode of the third UL HP (e.g., nₘ=1+nₘ₋₁ and/or the fifth UL HP is the second UL HP).

In an example embodiment, the one or more configuration parameters (e.g., the one or more RRC configuration parameters) may configure/indicate a second configuration parameter. For example, the base station may indicate the second configuration parameters via a downlink signal (e.g., a MAC CE, a second DCI, and/or a RRC message). The second DCI may be the DCI. In some examples, the second DCI may be different than the DCI. In response to determining the second configuration parameters being configured/indicated (or being enabled or not being disabled or not being absent), the wireless device may determine a second UL HP (e.g., corresponding to transmission of the m-th TB/PUSCH of the multiple TBs/PUSCHs, m=1, 2, . . . , M−1), identified with a second UL HP ID (e.g., the HP #nₘ), based on a scheduling order of the m-th TB (e.g., m) and the mode-A/mode-B UL HPs of the one or more configuration parameters (e.g., uplinkHARQ-mode in PUSCH-ServingCellConfig IE). In an example embodiment, corresponding to transmission of the m-th TB (or the m-th PUSCH) of the multiple TBs (or multiple PUSCHs), the wireless device may determine the second UL HP, identified with the second UL HP ID/number/index (e.g., the HP #nₘ), such that the second UL HP and the first UL HP, identified with the first UL HP ID (e.g., the HP #n), have the same HARQ mode, e.g., the first UL HP and the second UL HP are the mode-A UL HPs or the first UL HP and the second UL HP are the mode-B UL HPs. For example, the second TB may be different than a first/initial/starting/earliest TB of the multiple TBs, e.g., a transmission occasion/slot (e.g., a first/initial/starting symbol) of the second TB/PUSCH of the multiple TBs/PUSCHs may be after a transmission occasion/slot (e.g., a last/ending/final/latest symbol) of the first/initial/starting/earliest TB/PUSCH of the multiple TBs/PUSCHs.

For example, in response to determining the second configuration parameters not being configured/indicated (or being disabled or not being enabled or not being present), the wireless device may determine the second UL HP ID based on the scheduling order of the m-th TB, e.g., by increasing the first UL HP ID by the scheduling order of the m-th TB (e.g., m).

In some implementations, the wireless device may determine scheduling order (e.g., m) corresponding to transmitting the m-th (e.g., m=0, 1, . . . , M−1) TB/PUSCH of the multiple TBs/PUSCHs based on determining the corresponding transmission occasion/slot of the m-th TB/PUSCH not overlapping/colliding with no DL symbol, e.g., indicated by tdd-UL-DL-ConfigurationCommon or tdd-UL-DL-ConfigurationDedicated if provided. For example, the corresponding reception occasion/slot of the m-th TB/PUSCH may comprise one or more UL symbols.

In some scenarios, an UL HP corresponding to the m-th (e.g., m=0, 1, . . . , M−1) TB/PUSCH of the multiple TBs/PUSCHs may be a mode-A UL HP, e.g., when the UL HP belongs to (or is in) the mode-A UL HPs. In response to the UL HP being the mode-A UL HP, the wireless device may perform a logical channel prioritization (LCP) procedure to select at least one logical channel with UL data (e.g., corresponding the m-th TB of the multiple TBs) from one or more first logical channels. For example, a (or each) logical channel of the at least one logical channel may not be configured (e.g., via LogicalChannelConfig in the one or more configuration parameters) with an allowedHARQ-mode restriction/field. The wireless device may transit the m-th TB/PUSCH of the multiple TBs/PUSCHs by selecting UL data from the logical channel of the at least one logical channel.

In another example, the wireless device may determine a (or each) logical channel of the at least one logical channel being configured (e.g., via LogicalChannelConfig in the one or more configuration parameters) with an allowedHARQ-mode field/restriction. For example, the wireless device may determine the value of the allowedHARQ-mode field of the logical channel of the at least one logical channel being the HARQ mode B (e.g., HARQmodeA, e.g., the value of the allowedHARQ-mode field not being equal to the HARQ mode of the UL HP). In some cases, the wireless device may drop transmitting the m-th TB/PUSCH of the multiple TBs/PUSCHs based on determining there is no logical channels (of the one or more second logical channels) with UL data and the corresponding allowedHARQ-mode field indicating the HARQ mode A (e.g., HARQmodeA).

In yet another example, the wireless device may determine a (or each) logical channel of the at least one logical channel being configured (e.g., via LogicalChannelConfig in the one or more configuration parameters) with an allowedHARQ-mode field/restriction. For example, the wireless device may determine the value of the allowedHARQ-mode field of the logical channel of the at least one logical channel being the HARQ mode A (e.g., HARQmodeA, e.g., the value of the allowedHARQ-mode field being equal to the HARQ mode of the UL HP). The wireless device may transit the m-th TB/PUSCH of the multiple TBs/PUSCHs by selecting UL data from the logical channel of the at least one logical channel.

In another example, an UL HP corresponding to the m-th (e.g., m=0, 1, . . . , M−1) TB/PUSCH of the multiple TBs/PUSCHs may be a mode-B UL HP, e.g., when the UL HP belongs to (or is in) the mode-B UL HPs. In response to the UL HP being the mode-B UL HP, the wireless device may perform a logical channel prioritization (LCP) procedure to select at least one logical channel with UL data (e.g., corresponding the m-th TB of the multiple TBs) from one or more second logical channels. For example, a (or each) logical channel of the at least one logical channel may not be configured (e.g., via LogicalChannelConfig in the one or more configuration parameters) with an allowedHARQ-mode restriction/field. The wireless device may transit the m-th TB/PUSCH of the multiple TBs/PUSCHs by selecting UL data from the logical channel of the at least one logical channel.

In another example, the wireless device may determine a (or each) logical channel of the at least one logical channel being configured (e.g., via LogicalChannelConfig in the one or more configuration parameters) with an allowedHARQ-mode field/restriction. For example, the wireless device may determine the value of the allowedHARQ-mode field of the logical channel of the at least one logical channel being the HARQ mode A (e.g., HARQmodeA, e.g., the value of the allowedHARQ-mode field not being equal to the HARQ mode of the UL HP). In some cases, the wireless device may drop transmitting the m-th TB/PUSCH of the multiple TBs/PUSCHs based on determining there is no logical channels (of the one or more second logical channels) with UL data and the corresponding allowedHARQ-mode field indicating the HARQ mode B (e.g., HARQmodeB).

In yet another example, the wireless device may determine a (or each) logical channel of the at least one logical channel being configured (e.g., via LogicalChannelConfig in the one or more configuration parameters) with an allowedHARQ-mode field/restriction. For example, the wireless device may determine the value of the allowedHARQ-mode field of the logical channel of the at least one logical channel being the HARQ mode B (e.g., HARQmodeB, e.g., the value of the allowedHARQ-mode field being equal to the HARQ mode of the UL HP). The wireless device may transit the m-th TB/PUSCH of the multiple TBs/PUSCHs by selecting UL data from the logical channel of the at least one logical channel.

In some scenarios, the wireless device may, to request UL grant(s) for transmission of the multiple TBs/PUSCHs, trigger a BSR in response to at least one logical channel has pending UL data. For example, all logical channels of the at least one logical channel may be configured (e.g., via the one or more configuration parameters) with a same value of allowedHARQ-mode field. In some cases, a logical channel of the at least one logical channel may not be configured with allowedHARQ-mode field. In response to the triggered BSR, the wireless device may transmit the BSR. For example, the base station may transmit the DCI scheduling the multiple TBs/PUSCHs in response to the BSR. Example embodiments may reduce possibility of dropping one or more TBs/PUSCHs of the multiple TBs/PUSCHs as a result of the LCP procedure.

In some cases, the one or more configuration parameters may configure the wireless device with discontinuous reception (DRX) operation. For example, the wireless device may determine an UL HP (e.g., corresponding to the m-th (e.g., m=0, 1, . . . , M−1) TB/PUSCH of the multiple TBs/PUSCHs may be a mode-B UL HP) being the mode-A UL HP. In an example, the wireless device may determine a HARQ-RTT-TimerUL-NTN corresponding to the UL HP being expired. In some implementations, the HARQ-RTT-TimerUL-NTN corresponding to the second UL HP may indicate a minimum duration before a UL HARQ retransmission grant is expected by the wireless device. For example, the wireless device may start a drx-Retransmission TimerUL for the UL HP in a first/starting/earliest/initial symbol after the expiry of HARQ-RTT-TimerUL-NTN. In some cases, the wireless device may set the HARQ-RTT-TimerUL-NTN for the UL HP equal to drx-HARQ-RTT-TimerUL plus the (latest available) UE-gNB RTT value. In an example, the wireless device may start the HARQ-RTT-TimerUL-NTN for the UL HP in a first/starting/earliest symbol after a last/ending/final/latest symbol of the m-th PUSCH of the multiple PUSCHs.

For example, the wireless device may determine an UL HP (e.g., corresponding to the m-th (e.g., m=0, 1, . . . , M−1) TB/PUSCH of the multiple TBs/PUSCHs may be a mode-B UL HP) being the mode-B UL HP. For example, the wireless device may start a drx-Retransmission TimerUL for the UL HP in a first/starting/earliest/initial symbol after the transmission of the m-th PUSCH/TB of the multiple PUSCHs/TBs. In an example, the wireless device may not start the HARQ-RTT-TimerUL-NTN for the UL HP in response to transmitting the m-th PUSCH of the multiple PUSCHs.

Example embodiments may allow the wireless device to determine UL HP IDs corresponding to the transmission of the multiple TBs when the base station configure the wireless device with the mode-A/mode-B UL HPs. Some example embodiments may improve UL transmission efficiency (e.g., by reducing decoding error at the base station) and/or may reduce the consumed power of the wireless device (e.g., by reducing possibility of UL data retransmissions). Example embodiments may improve flexibility of the base station for scheduling the multiple TBs by the (single) DCI when the base station configure the wireless device with the mode-A/mode-B UL HPs.

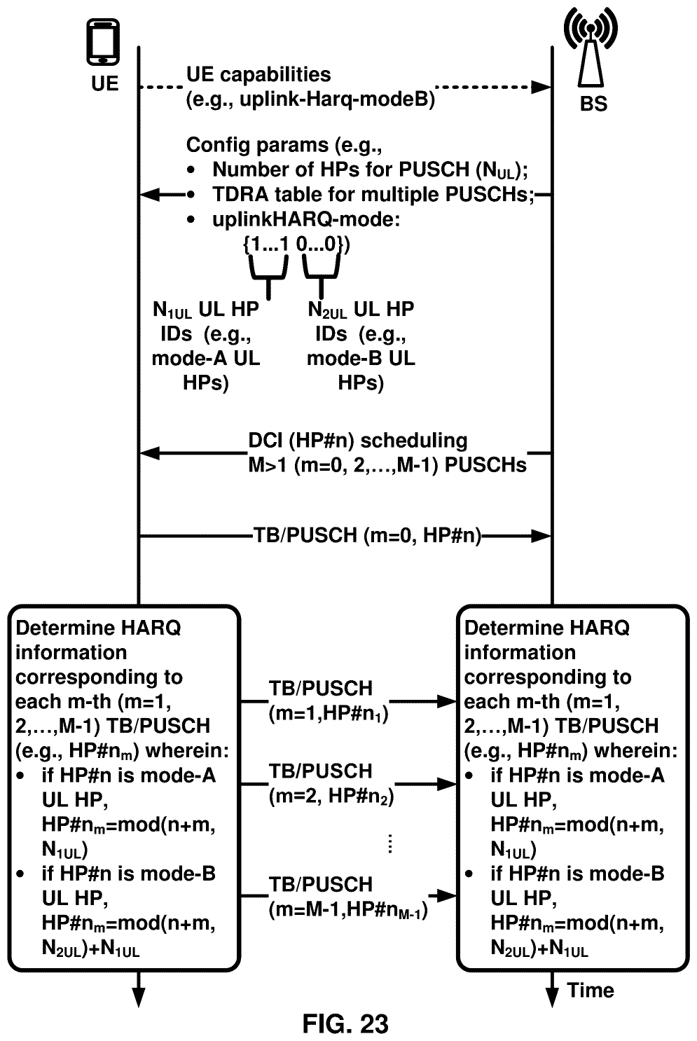

FIG. 23 shows an example embodiment of a HARQ operation/procedure in wireless communications systems per an aspect of the present disclosure. FIG. 23 may, for example, show an implementation of a method (or a process) for UL/DL transmissions at a base station and/or a wireless device. The base station may communicate with the wireless device via/using a cell (e.g., a serving cell). For example, the wireless device may be in an RRC_CONNECTED (or an RRC connected) state/mode. In some implementations, the wireless device may, for example, communicate with the base station via a non-terrestrial network (NTN), e.g., the wireless device and the base station may operate in the NTN and/or the base station may be an NTN base station and/or the cell (e.g., the serving cell) may be part of the NTN.

For example, the wireless device may transmit the one or more messages to the base station. The one or more messages may comprise the plurality of capabilities of the wireless device. In some aspects, the plurality of capabilities may comprise/indicate the first capability (e.g., a capability for NR NTN access, e.g., nonTerrestrialNetwork-r17). For example, the third may indicate whether the wireless device supports HARQ Mode B and corresponding LCP restriction(s) for uplink transmission (e.g., uplink-Harq-mode-B). In some cases, the wireless device that is supporting the HARQ Mode B for uplink transmission feature/capability (e.g., uplink-Harq-mode-B) may also indicate the support of the NR NTN access (e.g., nonTerrestrialNetwork-r17). In some other cases, the wireless device that is supporting the HARQ Mode B for uplink transmission feature/capability (e.g., uplink-Harq-mode-B) may not (necessarily) support the NR NTN access (e.g., when the wireless device is operating in an unlicensed band (NR-U) and/or for extended reality (XR) applications and/or a sub-band full-duplex operation).

As shown in FIG. 23, the wireless device may receive the one or more configuration parameters from the base station. The one or more configuration parameters may comprise the one or more NTN configuration parameters. The one or more configuration parameters may configure the wireless device with one or more serving cell configuration parameters (e.g., ServingCellConfigCommon, ServingCellConfigCommonSIB, and/or ServingCellConfig). For example, the one or more configuration parameters configure the wireless device with PUSCH configuration(s) (e.g., PUSCH-Config IE). In some cases, the PUSCH configuration(s) may comprise the TDRA table for the multiple PUSCHs (e.g., pusch-TimeDomainAllocationListForMultiPUSCH and/or PUSCH-TimeDomainResourceAllocationList). In some cases, the one or more configuration parameters may configure (e.g., via nrofHARQ-ProcessesForPUSCH in PUSCH-ServingCellConfig IE) the wireless device with a second number of UL HPs for PUSCH of the cell (e.g., the serving cell), e.g., N_{UL}>0 UL HPs. In some other cases, when the one or more configuration parameters does not comprise/indicate the nrofHARQ-ProcessesForPUSCH, the wireless device may determine the second number of uL HPs for PUSCH of the cell by a predefined (or hard coded) value (e.g., N_{UL}=8 or N_{UL}=16).

In some implementations, as shown in FIG. 23, the one or more configuration parameters may configure the wireless device with mode-A UL HPs and/or mode-B UL HPs (e.g., via uplinkHARQ-mode in PUSCH-ServingCellConfig IE). For example, the one or more configuration parameters may configure N_{1UL}>0 UL HPs as mode-A UL HPs and N_{1UL}>0 UL HPs as mode-B UL HPs, where N_{UL}=N_{UL}+N_{2UL}.

In an example embodiment, the base station may, in response to determining the plurality of the capabilities comprising the third capability, configure the wireless device with a first set of UL HP IDs and a second set of UL HP IDs. As shown in FIG. 23, the first set of UL HP IDs may comprise N_{1UL}>0 consecutive UL HPs with a first HARQ mode (e.g., the mode A or mode B). For example, the second set of UL HP IDs may comprise N_{2UL}>0 consecutive UL HPs with a second HARQ mode (e.g., the mode A or the mode B). The first HARQ mode may be different than the second HARQ mode. For example, the first set of UL HP IDs comprise IDs of UL HPs that are with the first HARQ mode. For example, the second set of UL HP IDs comprise IDs of UL HPs that are with the second HARQ mode.

In an example, the N_{1UL} leftmost bits of the uplinkHARQ-mode may indicate UL HP IDs of the mode-A UL HPs (e.g., the first set of UL HP IDs), e.g., aᵢ=1 for i=1, 2, . . . , N_{1UL}. The next N_{2UL} bits (or the N_{2UL} rightmost bits) of the uplinkHARQ-mode may indicate UL HP IDs of the mode-B UL HPs (e.g., the second set of UL HP IDs), e.g., aᵢ=0 for i=N_{1UL}+1, N_{1UL}+2, . . . , N_{1UL}+N_{2UL}. For example, an UL HP ID of each mode-A UL HP may be smaller than an UL HP ID of each mode-B UL HP.

In another example, the N_{2DL} leftmost bits of the uplinkHARQ-mode may indicate UL HP IDs of the mode-B UL HPs (e.g., the second set of UL HP IDs), e.g., aᵢ=0 for i=1, 2, . . . , N_{2UL}. The next N_{1UL} bits (or the N_{1UL} rightmost bits) of the uplinkHARQ-mode may indicate UL HP IDs of the mode-A UL HPs (e.g., the second set of UL HP IDs), e.g., aᵢ=1 for i=N_{2UL}+1, N_{2UL}+2, . . . , N_{2UL}+N_{1DL}. For example, an UL HP ID of each mode-A UL HP may be larger than an UL HP ID of each mode-B UL HP.

As shown in FIG. 23, the base station may transmit to the wireless device a (single) DCI for scheduling multiple (e.g., M>1 different) TBs. For example, the wireless device may, by monitoring the one or more PDCCH candidates, receive/detect the DCI scheduling reception of the multiple TBs. The wireless device may, for example, transmit the multiple TBs across/via/using/based on multiple (e.g., M>1 different) transmission occasions/slots. The base station may, for example, receive the multiple TBs across multiple (e.g., M>1 different) reception occasions/slots. In some cases, the wireless device may transmit each TB of the multiple TBs via/using/based on each PDSCH of multiple PDSCHs during a transmission occasion/slot of the multiple transmission occasions/slots.

In some examples, the DCI may indicate a first UL HP (e.g., HP #n in FIG. 23). For example, the DCI may comprise a bitfield indicating the first UL HP ID corresponding to the first UL HP. For example, the first UL HP may be a mode-A UL HP, e.g., when the first UL HP belongs to the mode-A UL HPs. In another example, the first UL HP may be a mode-B UL HP, e.g., when the first UL HP belongs to the mode-B DL HPs.

In an example embodiment, the wireless device (and/or the base station) may determine a HARQ information corresponding to a TB/PUSCH of the multiple TBs/PUSCHs. For example, corresponding to an m-th TB/PUSCH of the multiple TBs/PUSCHs (e.g., m=0, 1, 2, . . . , M−1), the wireless device (and/or the base station) may determine a corresponding HARQ information. In some cases, the corresponding HARQ information of the m-th TB/PUSCH of the multiple TBs/PUSCHs (e.g., m=0, 1, 2, . . . , M−1) may comprise at least one of: a corresponding UL HP ID (e.g., HP #n when m=0 and HP #nₘ when m>1), a corresponding NDI, a corresponding RV, and/or a corresponding TB size. In some cases, to determine the corresponding HARQ information of the m-th TB/PUSCH of the multiple TBs/PUSCHs (e.g., m=0, 1, 2, . . . , M−1), the wireless device (and/or the base station) may determine at least one of the following: a number of scheduled TBs/PUSCHs by the DCI (e.g., M), a bit width of a TDRA field of the DCI, and/or a bit width of an NDI field of the DCI, and/or a bit width of an RV field of the DCI. For example, the wireless device (and/or the base station) may determine the TB size of the m-th TB/PUSCH of the multiple TBs/PUSCHs (e.g., m=0, 1, 2, . . . , M−1) based on a modulation and coding scheme (MSC) field of the DCI.

In an example embodiment, the wireless device (and/or the base station) may determine the corresponding UL HP ID of the m-th TB/PDSCH of the multiple TBs/PDSCHs (e.g., m=1, 2, . . . , M−1) based on whether a first UL HP indicated by the DCI being a mode-A UL HP or a mode-B UL HP (e.g., based on a HARQ mode of the first UL HP). For example, corresponding to a m-th TB/PDSCH of the multiple TBs/PDSCHs (e.g., m=1, 2, . . . , M−1), the wireless device (and/or the base station) may determine a corresponding HARQ information based on whether the first UL HP is mode-A UL HP or a mode-B UL HP (e.g., based on a HARQ mode of the first UL HP).

For example, a HARQ information corresponding to a first/initial/starting/earliest TB/PUSCH of the multiple TBs/PUSCHs (e.g., m=0) may be based on the DCI, e.g., the first UL HP ID (e.g., HP #n), a corresponding NDI of the TB/PUSCH m=0 (e.g., determined from a NDI field of the DCI), a corresponding RV of the TB/PUSCH m=0 (e.g., determined from an RV field of the DCI, and/or a corresponding TB size of the TB/PUSCH m=0 (e.g., determined from an MSC field of the DCI).

In an example, a HARQ information corresponding to the m-th TB/PUSCH of the multiple TBs/PUSCHs (e.g., m=1, 2, . . . , M−1) may be based on the DCI and a HARQ mode of the first UL HP. For example, based on the DCI the wireless device (and/or the base station) may determine: the first UL HP ID (e.g., HP #n), a corresponding NDI of the TB/PUSCH m>0 (e.g., determined from a NDI field of the DCI), a corresponding RV of the TB/PUSCH m>0 (e.g., determined from an RV field of the DCI, and/or a corresponding TB size of the TB/PUSCH m>0 (e.g., determined from an MSC field of the DCI). For example, the wireless device may determine the corresponding UL HP ID of the m-th TB/PUSCH of the multiple TBs/PUSCHs to determine the corresponding HARQ information.

As shown in FIG. 23, corresponding to each TB of the multiple TBs scheduled by the DCI, the base station may determine a second UL HP ID/number/index based on whether the first UL HP ID correspond to a mode-A UL HP or a mode-B UL HP (e.g., whether the first UL HP is a mode-A UL HP or a mode-B UL HP). For example, the base station may receive a first/initial/starting/earliest TB/PUSCH of the multiple TBs/PUSCHs, e.g., with a scheduling order m=0, based on the first UL HP (e.g., the HP #n). For reception of a m-th TB of the multiple TBs, with a scheduling order m>0 where m=1, 2, . . . , M−1, the base station may use a second UL HP, identified with a second UL HP ID (e.g., HP #nₘ). In an example embodiment, the base station may determine a second UL HP ID (e.g., the HP #nₘ), corresponding to reception of the m-th TB of the multiple TBs, where m=1, 2, . . . , M−1, based on whether the first UL HP is a mode-A UL HP or a mode-B UL HP. For example, the base station may determine second UL HP ID (e.g., the HP #nₘ) based on the scheduling order m, the first UL HP ID, and/or whether the first UL HP is a mode-A UL HP or a mode-B UL HP. In another example, the base station may determine the second UL HP ID (e.g., the HP #nₘ) based on the scheduling order m, the first UL HP ID, whether the first UL HP is a mode-A UL HP or a mode-B UL HP, and/or the mode-A/mode-B UL HPs (e.g., via uplinkHARQ-mode in PUSCH-ServingCellConfig IE).

In an example embodiment, corresponding to transmission of the m-th TB of the multiple TBs (where m=1, 2, . . . , M−1) and based on the first UL HP being a mode-A UL HP, the base station may determine the second UL HP ID (e.g., the HP #nₘ) such that a second UL HP, identified with the second UL HP ID, being a mode-B UL HP (e.g., the first UL HP and the second UL HP having same HARQ mode in the UL). For example, nₘ=mod (n+m, N_{1UL}) (e.g., when the N_{UL} leftmost bits of the uplinkHARQ-mode correspond to the mode-A UL HPs) or nₘ=mod (n+m, N_{1UL})+N_{2UL} (e.g., when the N_{2UL} leftmost bits of the uplinkHARQ-mode correspond to the mode-A UL HPs).

For example, the base station may determine that nₘ corresponds to (or being associated to) a UL HP that is not configured (e.g., by the one or more configuration parameters). For example, the base station may determine the HP #nₘ based on nₘ=mod (n+m+1, N_{1UL}) (e.g., when the N_{1UL} leftmost bits of the uplinkHARQ-mode correspond to the mode-A UL HPs) or nₘ=mod (n+m+1, N_{1UL})+N_{2UL} (e.g., when the N_{2DL} leftmost bits of the uplinkHARQ-mode correspond to the mode-A UL HPs).

In an example embodiment, corresponding to reception of the m-th TB of the multiple TBs (where m=1, 2, . . . , M−1) and based on the first UL HP being a mode-B UL HP, the base station may determine the second UL HP ID (e.g., the HP #nₘ) such that a second UL HP, identified with the second UL HP ID, being mode-B UL HP. For example, the first UL HP and the second UL HP may have same HARQ mode. For example, nₘ=mod (n+m, N_{2UL}) (e.g., when the N_{2UL} leftmost bits of the uplinkHARQ-mode correspond to the mode-B UL HPs) or nₘ=mod (n+m, N_{2UL})+N_{1UL} (e.g., when the N_{2UL} leftmost bits of the uplinkHARQ-mode correspond to the mode-B UL HPs).

For example, the base station may determine that nₘ corresponds to (or being associated to) a UL HP that is not configured (e.g., by the one or more configuration parameters). For example, the base station may determine the HP #nₘ based on nₘ=mod (n+m+1, N_{2UL}) (e.g., when the N_{2UL} leftmost bits of the uplinkHARQ-mode correspond to the mode-B UL HPs) or nₘ=mod (n+m+1, N_{2UL})+N_{1UL} (e.g., when the N_{2UL} leftmost bits of the uplinkHARQ-mode correspond to the mode-B UL HPs).

As shown in FIG. 23, corresponding to each TB of the multiple TBs scheduled by the DCI, the wireless device may determine the second UL HP ID/number/index based on whether the first UL HP ID correspond to a mode-A UL HP or a mode-B UL HP (e.g., whether the first UL HP is a mode-A UL HP or a mode-B UL HP). For example, the wireless device may transmit a first/initial/starting/earliest TB (or PUSCH), e.g., with a scheduling order m=0, of the multiple TBs (or multiple PUSCHs) based on the first UL HP (e.g., the HP #n). For transmission of a m-th TB of the multiple TBs, with a scheduling order m>0 where m=1, 2, . . . , M−1, the wireless device may use a second UL HP, identified with the second UL HP ID (e.g., HP #nₘ), e.g., the m-th TB of the multiple TBs correspond to the second UL HP. In an example embodiment, the wireless device may determine the second UL HP ID (e.g., the HP #nₘ), corresponding to transmission of the m-th TB of the multiple TBs, where m=1, 2, . . . , M−1, based on whether the first UL HP is a mode-A UL HP or a mode-B UL HP. For example, the wireless device may determine the second UL HP ID (e.g., the HP #nₘ) based on the scheduling order m, the first UL HP ID, and/or whether the first UL HP is a mode-A UL HP or a mode-B UL HP. In another example, the wireless device may determine the second UL HP ID (e.g., the HP #nₘ) based on the scheduling order m, the first UL HP ID, whether the first UL HP is a mode-A UL HP or a mode-B UL HP, and/or the mode-A/mode-B UL HPs (e.g., uplinkHARQ-mode in PUSCH-ServingCellConfig IE).

In an example embodiment, corresponding to reception of the m-th TB of the multiple TBs (where m=1, 2, . . . , M−1) and based on the first UL HP being mode-A UL HP, the wireless device may determine the second UL HP ID (e.g., the HP #nₘ) such that a second UL HP, identified with the second UL HP ID, being mode-A UL HP. For example, the first UL HP and the second UL HP may have same HARQ mode (e.g., both the first UL HP and the second UL HP are mode-A UL HPs). For example, nₘ=mod (n+m, N_{1UL}) (e.g., when the N_{1UL} leftmost bits of the uplinkHARQ-mode correspond to the mode-A UL HPs) or nₘ=mod (n+m, N_{1UL})+N_{UL} (e.g., when the N_{2UL} leftmost bits of the uplinkHARQ-mode correspond to the mode-A UL HPs).

For example, the wireless device may determine that nₘ corresponds to (or being associated to) a UL HP that is not configured (e.g., by the one or more configuration parameters). For example, the base station may determine the HP #nₘ based on nₘ=mod (n+m+1, N_{1UL}) (e.g., when the N_{1UL} leftmost bits of the uplinkHARQ-mode correspond to the mode-A UL HPs) or nₘ=mod (n+m+1, N_{1UL})+N_{2UL} (e.g., when the N_{2DL} leftmost bits of the uplinkHARQ-mode correspond to the mode-A UL HPs).

In an example embodiment, corresponding to reception of the m-th TB of the multiple TBs (where m=1, 2, . . . , M−1) and based on the first UL HP being mode-B UL HP, the wireless device may determine the second UL HP ID (e.g., the HP #nₘ) such that a second UL HP, identified with the second UL HP ID, being mode-B UL HP. For example, the first UL HP and the second UL HP may have same HARQ mode (e.g., both the first UL HP and the second UL HP are mode-B UL HPs). For example, nₘ=mod (n+m, N_{2UL}) (e.g., when the N_{2UL} leftmost bits of the uplinkHARQ-mode correspond to the mode-B UL HPs) or nₘ=mod (n+m, N_{2UL})+N_{1UL} (e.g., when the N_{2UL} leftmost bits of the uplinkHARQ-mode correspond to the mode-B UL HPs).

For example, the wireless device may determine that nₘ corresponds to (or being associated to) a UL HP that is not configured (e.g., by the one or more configuration parameters). For example, the base station may determine the HP #nₘ based on nₘ=mod (n+m+1, N_{2UL}) (e.g., when the N_{2UL} leftmost bits of the uplinkHARQ-mode correspond to the mode-B UL HPs) or nₘ=mod (n+m+1, N_{2UL})+N_{1UL} (e.g., when the N_{2UL} leftmost bits of the uplinkHARQ-mode correspond to the mode-B UL HPs).

In some implementations, the wireless device may determine scheduling order (e.g., m) corresponding to transmitting the m-th TB/PUSCH of the multiple TBs/PUSCHs (e.g., m=0, 1, . . . , M−1) based on determining the corresponding transmission occasion/slot of the m-th TB/PUSCH not overlapping/colliding with no DL symbol, e.g., indicated by tdd-UL-DL-ConfigurationCommon or tdd-UL-DL-ConfigurationDedicated if provided. For example, the corresponding reception occasion/slot of the m-th TB/PUSCH may comprise one or more UL symbols.

Example embodiments may allow the wireless device to determine UL HP IDs corresponding to the transmission of the multiple TBs when the base station configure the wireless device with the mode-A/mode-B UL HPs. Some example embodiments may improve UL transmission efficiency (e.g., by reducing decoding error at the base station) and/or may reduce the consumed power of the wireless device (e.g., by reducing possibility of UL data retransmissions). Example embodiments may improve flexibility of the base station for scheduling the multiple TBs by the (single) DCI when the base station configure the wireless device with the mode-A/mode-B UL HPs.

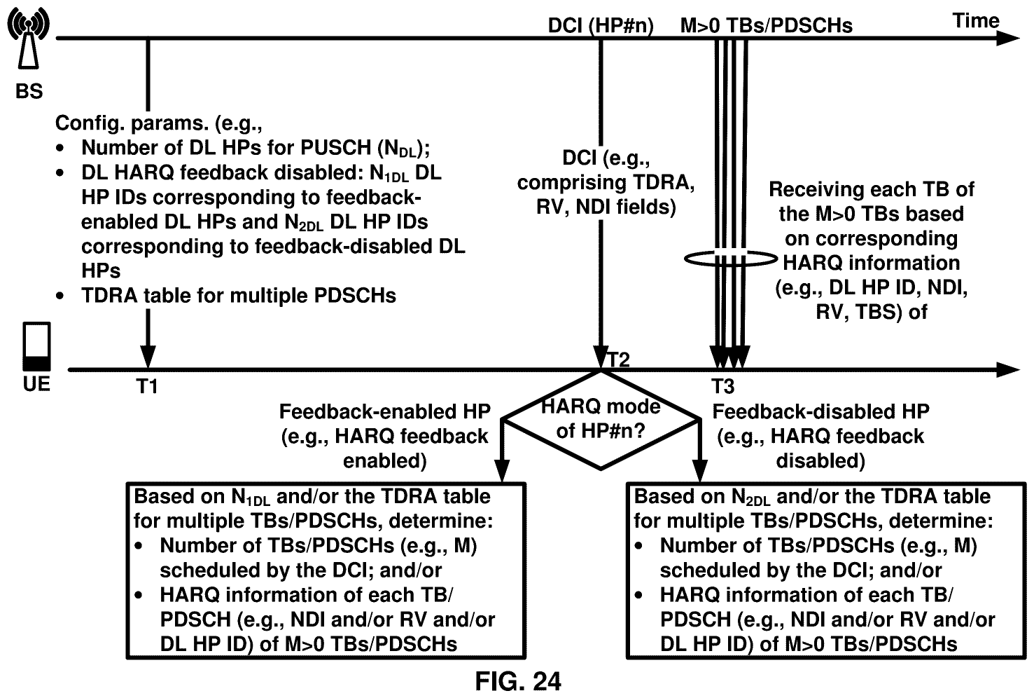

FIG. 24 shows an example embodiment of a HARQ operation/procedure in wireless communications systems per an aspect of the present disclosure. FIG. 24 may, for example, show an implementation of a method (or a process) for UL/DL transmissions at a base station and/or a wireless device. The base station may communicate with the wireless device via/using a cell (e.g., a serving cell). For example, the wireless device may be in an RRC_CONNECTED (or an RRC connected) state/mode. In some implementations, the wireless device may communicate with the base station via a non-terrestrial network (NTN), e.g., the wireless device and the base station may operate in the NTN and/or the base station may be an NTN base station and/or the cell (e.g., the serving cell) may be part of the NTN. In some other implementations, the wireless device may not communicate with the base station via the NTN (e.g., in a terrestrial network scenario). For example, the cell may not be part of the NTN.

As shown in FIG. 24, the wireless device may receive the one or more configuration parameters from the base station. The one or more configuration parameters may comprise the one or more NTN configuration parameters. The one or more configuration parameters may configure the wireless device with one or more serving cell configuration parameters (e.g., ServingCellConfigCommon, ServingCellConfigCommonSIB, and/or ServingCellConfig). For example, the one or more configuration parameters configure the wireless device with the PDSCH configuration(s) (e.g., PDSCH-Config IE). In some cases, the PDSCH configuration(s) may comprise the TDRA table (or configuration parameters) for the multiple PDSCHs (e.g., the multiple-PDSCH TDRA table or pdsch-TimeDomainAllocationListForMultiPDSCH). In some cases, the one or more configuration parameters may configure (e.g., via nrofHARQ-ProcessesForPDSCH in PDSCH-ServingCellConfig IE) the wireless device with the first number of DL HPs for PDSCH of the cell (e.g., the serving cell), e.g., N_{DL}>0 DL HPs. In some other cases, when the one or more configuration parameters does not comprise/indicate the nrofHARQ-ProcessesForPDSCH, the wireless device may determine the first number of DL HPs for PDSCH of the cell by a predefined (or hard coded) value (e.g., N_{DL}=8 or N_{DL}=16).

In some implementations, as shown in FIG. 24, the one or more configuration parameters may configure the wireless device with the feedback-enabled DL HPs and/or the feedback-disabled DL HPs (e.g., via downlinkHARQ-FeedbackDisabled in PDSCH-ServingCellConfig IE). For example, the one or more configuration parameters may configure N_{1DL}>0 DL HPs as feedback-enabled DL HPs and N_{1DL}>0 DL HPs as feedback-disabled DL HPs, where N_{DL}=N_{1DL}+N_{2DL}. In some cases, N_{DL}<N_{1DL}+N_{2DL} (e.g., the wireless device may ignore one or more DL HPs that are not configured).

As shown in FIG. 24, the wireless device may receive a DCI indicating at least one DL grant for DL transmission(s). For example, the DCI may indicate a first DL HP with HP #n (e.g., the first DL HP ID). For example, the DCI may indicate one or more fields comprising a TDRA field, a RV field, and/or an NDI field. For example, the wireless device may determine a bit width of the TDRA field, a bit width of the RV field, and/or a bit width of the NDI field to receive the DL transmission. In some cases, the wireless device may determine how many (different) TBs/PDSCHs are scheduled by the DCI.

In an example embodiment, as shown in FIG. 24 (e.g., at time T3), the wireless device (and/or the base station) may, based on a HARQ mode of the first DL HP, determine a HARQ information corresponding to a TB/PDSCH of the multiple TBs/PDSCHs. In some cases, based on the DCI and/or the HARQ mode of the first DL HP the wireless device (and/or the base station) may determine the HARQ information corresponding to (or of or associated to) a TB/PDSCH of the multiple TBs/PDSCHs.

For example, corresponding to an m-th TB/PDSCH of the multiple TBs/PDSCHs (e.g., m=0, 1, 2, . . . , M−1), the wireless device (and/or the base station) may determine a corresponding HARQ information. In some cases, the corresponding HARQ information of the m-th TB/PDSCH of the multiple TBs/PDSCHs (e.g., m=0, 1, 2, . . . , M−1) may comprise at least one of: a corresponding DL HP ID (e.g., HP #n when m=0 and HP #nₘ when m>0), a corresponding NDI, a corresponding RV, and/or a corresponding TB size. For example, based on the embodiments of FIG. 20 and/or FIG. 21, the wireless device (and/or the base station) may determine HP #nₘ for m>0. In some cases, to determine the corresponding HARQ information of the m-th TB/PDSCH of the multiple TBs/PDSCHs (e.g., m=0, 1, 2, . . . , M−1), the wireless device (and/or the base station) may determine at least one of the following: a number of scheduled TBs/PDSCHs by the DCI (e.g., M), and/or an applicable (or valid or acceptable) bit width of a TDRA field of the DCI, and/or an applicable (or valid or acceptable) bit width of an NDI field of the DCI, and/or an applicable (or valid or acceptable) bit width of an RV field of the DCI. For example, the wireless device may determine the TB size of the m-th TB/PDSCH of the multiple TBs/PDSCHs (e.g., m=0, 1, 2, . . . , M−1) based on a modulation and coding scheme (MSC) field of the DCI.

In an example embodiment, as shown in FIG. 24, the wireless device (and/or the base station) may determine a number of TBs/PDSCHs (e.g., M) scheduled by the (single) DCI based on a first value indicating a number of DL HPs that have the HARQ mode (e.g., feedback-enabled or feedback-disabled) of the first DL HP. In some examples, the wireless device (and/or the base station) may determine M (e.g., the number of TBs/PDSCHs scheduled by the DCI) based on the first value and/or a second value. For example, the second value may indicate a number of entries of the TDRA table of the multiple PDSCHs (e.g., the number of entries of pdsch-TimeDomainAllocationListForMultiPDSCH). In some cases, the second value may indicate a maximum number (e.g., maxNrofMultiplePDSCHs) of schedulable PDSCHs among all entries in the TDRA table of the multiple PDSCHs.

In an example embodiment, the wireless device (and/or the base station) may determine M (e.g., the number of TBs/PDSCHs scheduled by the DCI) based on a minimum of the first value and the second value. For example, the first DL HP may be a feedback-enabled DL HP (e.g., the HARQ mode of the first DL HP being feedback enabled). For example, the first DL HP may be a feedback-disabled DL HP (e.g., the HARQ mode of the first DL HP being feedback disabled). In response to the first value being smaller than the second value, the wireless device may determine M (e.g., the number of TBs/PDSCHs scheduled by the DCI) based on the first value (e.g., logarithm of the first value plus 1). In response to the first value not being smaller (or the first value being larger) than the second value, the wireless device may determine M (e.g., the number of TBs/PDSCHs scheduled by the DCI) based on the second value (e.g., logarithm of the second value plus 1)

For example, the wireless device (and/or the base station) may determine the DCI size based on the second value. This may allow a fixed (or a predefined) DCI size for detecting the DCI.

In an example embodiment, the wireless device (and/or the base station) may determine the DCI size based on the first value and/or the second value. For example, in response to the first DL HP being a feedback-enabled DL HP, the wireless device (and/or the base station) may determine the DCI size based on the second value and a number of the feedback-enabled DL HPs (e.g., a first value). In some cases, the wireless device may determine the DCI size based on a minimum (or maximum or summation) of the first value and the second value. For example, the wireless device may decode/read a HARQ field of the DCI and determine a HARQ mode of the first DL HP indicated by the DCI. This may allow a fixed (or a predefined) DCI size for detecting the DCI.

In an example embodiment, in response to the first DL HP being a feedback-disabled DL HP, the wireless device (and/or the base station) may determine the DCI size based on the second value and a number of the feedback-disabled DL HPs (e.g., a first value). In some cases, the wireless device may determine the DCI size based on a minimum (or maximum or summation) of the first value and the second value. For example, the wireless device may decode/read a HARQ field of the DCI and determine a HARQ mode of the first DL HP indicated by the DCI. This may allow a fixed (or a predefined) DCI size for detecting the DCI.

The wireless device may, based on the HARQ information of each TB/PDSCH of the multiple TBs/PDSCHs, determine at least one of: a reception time/occasion of each TB/PDSCH of the multiple (e.g., M) TBs/PDSCHs, and/or a whether each TB/PDSCH of the multiple TBs/PDSCHs is a new transmission or a retransmission (e.g., by determining an NDI associated with each TB/PDSCH), and/or a RV corresponding to each TB/PDSCH of the multiple TBs/PDSCHs. For example, the base station and/or the wireless device may reuse one or more DL HPs across the multiple TBs/PDSCHs.

For example, the wireless device may map a value of the TDRA field of the DCI to an element/entry of the TDRA table of the multiple PDSCHs (e.g., the number of entries of the pdsch-TimeDomainAllocationListForMultiPDSCH). In an example, a value b (e.g., b=0, 1, . . . , M−1) of the TDRA field of the DCI may correspond to a b-th element in the TDRA table the multiple PDSCHs of the number of entries (e.g., the first value) of the TimeDomainAllocationListForMultiPDSCH. For example, the value of the TDRA field of the DCI may be smaller than the minimum of the first value and the second value (e.g., the number of scheduled TBs/PDSCHs by the DCI, M). In some cases, the wireless device may consider a first/starting/initial M entries of the second value of entries of the multiple-PDSCH TDRA table. For example, the wireless device may determine the one or more configuration parameters configuring pdsch-TimeDomainResourceAllocationListForMultiPDSCH. Based on the first value being smaller than the second value, the wireless device (and/or the base station) may determine M (e.g., the number of scheduled TBs/PDSCHs by the DCI) based on the first value (e.g., equal to a logarithm of the first value plus 1). Based on the first value being larger than the second value, the wireless device (and/or the base station) may determine M (e.g., the number of scheduled TBs/PDSCHs by the DCI) based on the second value (e.g., equal to the logarithm of the second value plus 1).

For example, as shown in FIG. 24, the first DL HP, indicated by the DCI, may be a feedback-enabled DL HP. In an example embodiment, based on a first value (e.g., a number of feedback-enabled DL HPs) being smaller than the second value, the wireless device (and/or the base station) may determine M (e.g., the number of TBs/PDSCHs scheduled by the DCI) based on the first value (e.g., equal to a logarithm of the first value plus 1). In an example embodiment, based on the first value being larger than the second value, the wireless device (and/or the base station) may determine M (e.g., the number of TBs/PDSCHs scheduled by the DCI) based on the second value (e.g., equal to the logarithm of the second value plus 1).

For example, as shown in FIG. 24, the first DL HP, indicated by the DCI, may be a feedback-disabled DL HP. In an example embodiment, based on a first value (e.g., a number of feedback-disabled DL HPs) being smaller than the second value, the wireless device (and/or the base station) may determine M (e.g., the number of TBs/PDSCHs scheduled by the DCI) equal to the first value. In an example embodiment, based on the first value being larger than the second value, the wireless device (and/or the base station) may determine M (e.g., the number of TBs/PDSCHs scheduled by the DCI) equal to the second value.

In an example embodiment, the wireless device (and/or the base station) may, for communicating the multiple (e.g., M) TBs/PDSCHs, determine a bit width of a field of the DCI based on the second value (e.g., the number of entries of the TDRA table of the multiple PDSCHs, e.g., the number of entries of pdsch-TimeDomainAllocationListForMultiPDSCH) and/or the first value. For example, the field of the DCI may be at least one of the TDRA field the DCI and/or the NDI field the DCI and/or the RV field the DCI.

For example, the wireless device may (initially) determine a first bit width of the field (e.g., the TDRA field and/or the NDI field and/or the RV field) of DCI (e.g., in B bits where ┌log₂(second value)┐=B bits) based on the second value. The first bit width of the field may indicate a potential or a nominal bit width of the DCI. For example, the wireless device may determine the size of the DCI based on the first (e.g., potential/nominal) bit width of the DCI.

In an example, the wireless device may determine a second bit width of the field (e.g., in W bits) of DCI based on the first value and the second value (e.g., ┌log₂(minimum (first value, second value)┐=Wbits). For example, the second bit width of the field of the DCI may be an applicable (or an actual or a valid or an acceptable) bit width of the field of the DCI. For example, based on the applicable bit width of the TDRA field of the DCI, the wireless device may determine the scheduled TBs/PDSCHs by the DCI, e.g., M=2^{applicable bitwidth of TDRA field of DCI}. In some implementations, when the first value is larger than the second value, the number of scheduled TBs/PDSCHs by the DCI may be based on the number of entries of the multiple-PDSCH TDRA table). In other implementations, when the first value being smaller than the second value, the number of scheduled TBs/PDSCHs by the DCI may be based on the first value).

In some examples, the wireless device may skip (or ignore) r bits (e.g., a first/starting/earliest r bits or a last/ending/final r bits) of the field of the DCI to determine the applicable bit width of the field of the DCI from the nominal bit width of the field of the DCI. For example, the skipped/ignored bits (e.g., r) may be based on a difference between the second value and the first value (e.g., ┌log₂(|first value−second value|)┐=r bits). Based on the first value being smaller than the second value, the wireless device may skip (or ignore) r bits (e.g., a first/starting/earliest r bits or a last/ending/final r bits) of the B bits of the field (e.g., the TDRA field and/or the NDI field and/or the RV field) of the DCI (e.g., the wireless device may consider W bits for communicating the M TBs/PDSCHs with the base station). In other examples, based on the first value not being smaller than the second value, the wireless device may not skip/ignore any bits of the field (e.g., the TDRA field and/or the NDI field and/or the RV field) of the DCI (e.g., the wireless device may consider B bits for communicating the M TBs/PDSCHs with the base station), e.g., r=0.

As shown in FIG. 24, the wireless device may receive the (determined) multiple (e.g., M) TBs/PUSCHs, e.g., based on the applicable bit width of the TDRA field of the DCI. For example, the wireless device may receive the multiple TBs/PUSCHs based on the applicable bit width of the TDRA field of the DCI and/or the applicable bit width of the RV field of the DCI and/or the applicable bit width of the NDI field of the DCI.

In some cases, wireless device may, for each TB/PDSCH of the multiple TBs/PDSCHs and based on the applicable bit width of the TDRA field of the DCI, determine a reception time/occasion of each TB/PDSCH of the multiple (e.g., M) TBs/PDSCHs. In an example, a value b (e.g., b=0, 1, . . . , M−1) of the TDRA field of the DCI may correspond to a b-th element in the TDRA table the multiple PDSCHs of the number of entries (e.g., a first/initial/starting first value) of the multiple-PDSCH TDRA table. For example, the base station and/or the wireless device may reuse one or more DL HPs across the multiple TBs/PDSCHs.

In some cases, wireless device may, for each TB/PDSCH of the multiple TBs/PDSCHs and based on the applicable bit width of the NDI field of the DCI, determine whether each TB/PDSCH of the multiple TBs/PDSCHs is a new transmission or a retransmission (e.g., whether the NDI is toggled or not). For example, the wireless device (and/or the base station) may map each bit of applicable bits of the NDI field of the DCI (e.g., each bit of the W bits when the first value is smaller than the second value and each bit of the B bits when the first value is larger than the second value) to one scheduled TB/PDSCH of the multiple TBs/PDSCHs. In some implementations, the wireless device may, for receiving the multiple TBs/PDSCHs, map (e.g., in a one-to-one approach and in accordance with scheduling order of the multiple TBs/PDSCHs) each bit of the NDI field of the DCI to each TB/PDSCH of the multiple TBs/PDSCHs. In some cases, the LSB bits of the applicable bits of NDI field of the DCI may correspond to a last/final/ending/latest (e.g., M−1) scheduled TB/PDSCH of the multiple TBs/PDSCHs.

In some cases, wireless device may, for each TB/PDSCH of the multiple TBs/PDSCHs and based on the applicable bit width of the RV field of the DCI, determine RV value corresponding to each TB/PDSCH of the multiple TBs/PDSCHs. For example, the wireless device (and/or the base station) may map each bit of applicable bits of the RV field of the DCI (e.g., each bit of the W bits when the first value is smaller than the second value and each bit of the B bits when the first value is larger than the second value) to one scheduled TB/PDSCH of the multiple TBs/PDSCHs. In some implementations, the wireless device may, for receiving the multiple TBs/PDSCHs, map (e.g., in a one-to-one approach and in accordance with scheduling order of the multiple TBs/PDSCHs) each applicable bit of the RV field of the DCI to each TB/PDSCH of the multiple TBs/PDSCHs. In some cases, the LSB bits of the applicable bits of the RV field of the DCI may correspond to a last/final/ending/latest (e.g., M−1) scheduled TB/PDSCH of the multiple TBs/PDSCHs.

In some other implementations, the one or more configuration parameters (e.g., the one or more RRC configuration parameters) may configure/indicate a third configuration parameter. For example, the base station may indicate the third configuration parameters via a downlink signal (e.g., a MAC CE, a second DCI, and/or a RRC message). The second DCI may be the DCI. In some examples, the second DCI may be different than the DCI.

For example, based on the third configuration parameter being enabled, the wireless device (and/or the base station) may determine a corresponding HARQ information of the m-th TB/PDSCH of the multiple TBs/PDSCHs (e.g., m=0, 1, 2, . . . , M−1) based on the second value and the first value. In some cases, based on the third configuration parameter not being enabled (or being disabled and/or not being configured/indicated), the wireless device (and/or the base station) may determine a corresponding HARQ information of the m-th TB/PDSCH of the multiple TBs/PDSCHs (e.g., m=0, 1, 2, . . . , M−1) based on the second value. In some implementations, the base station may indicate/configure the third configuration parameter in response to determining the one or more configuration parameters comprising the feedback-enabled/disabled DL HPs. In some other implementations, the base station may configure/indicate (or enable) the first configuration parameter with value enabled based on determining the first value being smaller than the second value. In yet some other implementations, the base station may configure/indicate the first configuration parameter with value disabled or may not configure/indicate the first configuration parameter based on determining the first value being smaller than the second value.

In some cases, the DCI may comprise a field with a value. The value may indicate the number of scheduled TBs/PDSCHs by the DCI. For example, the wireless device (and/or the base station) may determine the first value (and/or the second value) based on the value of the field indicated by the DCI.

In some cases, the firth value may be smaller than the number of DL HP IDs with the HARQ mode (e.g., feedback-enabled or feedback-disabled) of the first DL HP identified with the first DL HP ID (e.g., HP #n). For example, based on the first DL HP being feedback-enabled, the wireless device may determine a first number of feedback-enabled DL HP IDs (e.g., p>0) not being configured (e.g., by the nrofHARQ-ProcessesForPDSCH). The wireless device may determine the first value equal a difference between the number of feedback-enabled DL HPs and the first number.

In another example, based on the first HP being feedback-disabled, the wireless device may determine a first number of feedback-disabled DL HP IDs (e.g., p>0) not being configured (e.g., by the nrofHARQ-ProcessesForPDSCH). The wireless device may determine the first value equal a difference between the number of feedback-disabled DL HPs and the first number.

In some cases, in response to determining the one or more configuration parameters not configuring the feedback-enabled DL HPs (e.g., all the configured DL HPs being feedback-disabled DL HPs), the wireless device may, based on the second value, determine at least one of the number of scheduled TBs/PDSCHs by the DCI (e.g., M), and/or the bit width of the TDRA field of the DCI, and/or the bit width of the NDI field of the DCI, and/or the bit width of the RV field of the DCI. In some other cases, in response to determining the one or more configuration parameters not configuring the feedback-disabled DL HPs (e.g., all the configured DL HPs being feedback-enabled DL HPs), the wireless device may, based on the second value, determine at least one of the number of scheduled TBs/PDSCHs by the DCI (e.g., M), and/or the bit width of the TDRA field of the DCI, and/or the bit width of the NDI field of the DCI, and/or the bit width of the RV field of the DCI. In some other cases, in response to determining the downlinkHARQ-FeedbackDisabled being absent from the one or more configuration parameters (e.g., feedback-enabled/disabled DL HPs not being configured), the wireless device may, based on the second value, determine at least one of the number of scheduled TBs/PDSCHs by the DCI (e.g., M), and/or the bit width of the TDRA field of the DCI, and/or the bit width of the NDI field of the DCI, and/or the bit width of the RV field of the DCI.

When the base station configures the wireless device with the feedback-enabled/disabled DL HPs, some example embodiments may allow the wireless device to dynamically determine the number of multiple TBs scheduled by the DCI, e.g., in order to maintain a consistent HARQ behavior across the multiple TBs. Example embodiments may allow the wireless device to determine (e.g., based on HARQ mode of the DL HP indicated by the DCI) applicable bit widths of one or more fields (e.g., TDRA and/or RV and/or NDI) of the DCI for communicating the multiple TBs/PDSCHs with the base station. Example embodiments may improve the DL transmission performance.

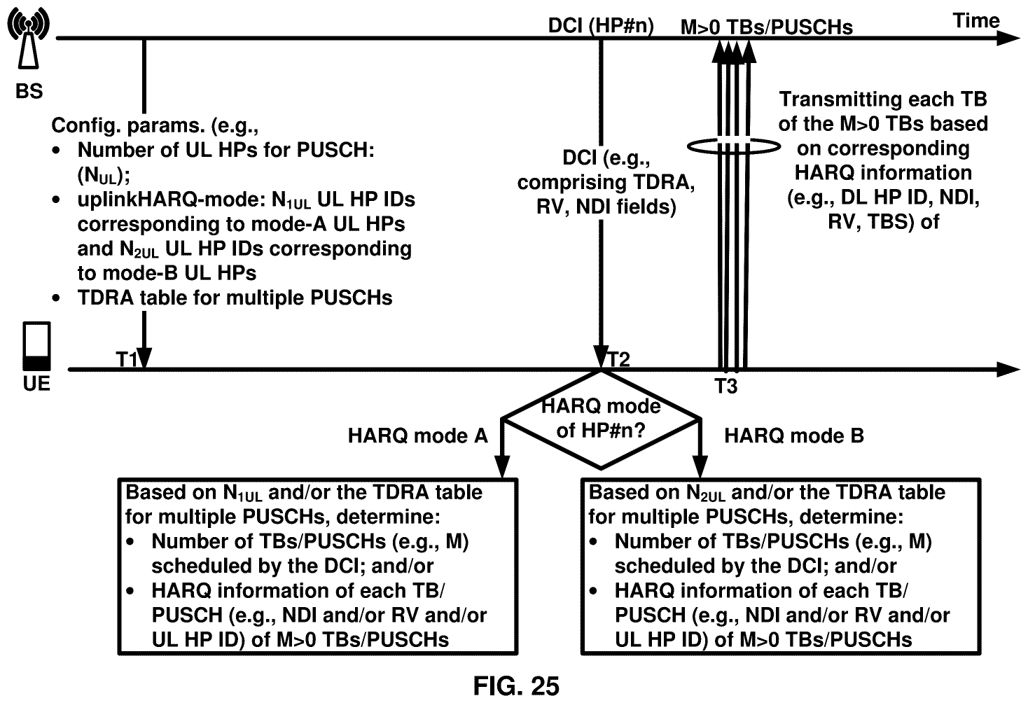

FIG. 25 shows an example embodiment of a HARQ operation/procedure in wireless communications systems per an aspect of the present disclosure. FIG. 25 may, for example, show an implementation of a method (or a process) for UL/DL transmissions at a base station and/or a wireless device. The base station may communicate with the wireless device via/using a cell (e.g., a serving cell). For example, the wireless device may be in an RRC_CONNECTED (or an RRC connected) state/mode.

In some implementations, the wireless device may communicate with the base station via a non-terrestrial network (NTN), e.g., the wireless device and the base station may operate in the NTN and/or the base station may be an NTN base station and/or the cell (e.g., the serving cell) may be part of the NTN.

In some other implementations, the wireless device may not communicate with the base station via the NTN (e.g., in a terrestrial network scenario). For example, the cell may not be part of the NTN.

As shown in FIG. 25, at time T1, the wireless device may receive the one or more configuration parameters from the base station. The one or more configuration parameters may comprise the one or more NTN configuration parameters. The one or more configuration parameters may configure the wireless device with one or more serving cell configuration parameters (e.g., ServingCellConfigCommon, ServingCellConfigCommonSIB, and/or ServingCellConfig). For example, the one or more configuration parameters configure the wireless device with PUSCH configuration(s) (e.g., PUSCH-Config IE). In some cases, the PUSCH configuration(s) may comprise the TDRA table for the multiple PUSCHs (e.g., pusch-TimeDomainAllocationListForMultiPUSCH). In some cases, the one or more configuration parameters may configure (e.g., via nrofHARQ-ProcessesForPUSCH in PUSCH-ServingCellConfig IE) the wireless device with a second number of UL HPs for PUSCH of the cell (e.g., the serving cell), e.g., Nur>0 UL HPs. In some other cases, when the one or more configuration parameters does not comprise/indicate the nrofHARQ-ProcessesForPUSCH, the wireless device may determine the second number of uL HPs for PUSCH of the cell by a predefined (or hard coded) value (e.g., N_{UL}=8 or N_{UL}=16).

In some implementations, as shown in FIG. 25, the one or more configuration parameters may configure the wireless device with mode-A UL HPs and/or mode-B UL HPs (e.g., via uplinkHARQ-mode in PUSCH-ServingCellConfig IE). For example, the one or more configuration parameters may configure N_{1UL}>0 UL HPs as mode-A UL HPs and N_{1UL}>0 UL HPs as mode-B UL HPs, where N_{UL}=N_{UL}+N_{UL}. In some cases, N_{UL} N_{UL}+N_{UL} (e.g., the wireless device may ignore one or more UL HPs that are not configured).

As shown in FIG. 25, at time T2, the wireless device may receive the DCI indicating at least one UL grant for UL data transmission(s). For example, the DCI may indicate a first UL HP identified with HP #n (e.g., the first UL HP ID). For example, the wireless device may determine the DCI indicate one or more fields comprising a TDRA field, a RV field, and/or an NDI field. For example, the wireless device may determine bit width of the TDRA field, the RV field, and/or the NDI field to receive the DL transmission. In some cases, the wireless device may determine how many (different) TBs/PUSCHs are scheduled by the DCI.

In an example embodiment, the wireless device (and/or the base station) may, based on a HARQ mode of the first UL HP, determine a HARQ information corresponding to a TB/PUSCH of the multiple TBs/PUSCHs. In some cases, based on the DCI and/or the HARQ mode of the first UL HP, the wireless device (and/or the base station) may determine the HARQ information corresponding to (or of or associated to) a TB/PDSCH of the multiple TBs/PDSCHs.

For example, corresponding to an m-th TB/PUSCH of the multiple TBs/PUSCHs (e.g., m=0, 1, 2, . . . , M−1), the wireless device (and/or the base station) may determine a corresponding HARQ information. In some cases, the corresponding HARQ information of the m-th TB/PUSCH of the multiple TBs/PUSCHs (e.g., m=0, 1, 2, . . . , M−1) may comprise at least one of: a corresponding UL HP ID (e.g., HP #n when m=0 and HP #nₘ when m>0), a corresponding NDI, a corresponding RV, and/or a corresponding TB size. For example, based on the embodiments of FIG. 22 and/or FIG. 23, the wireless device may determine HP #nₘ for m>0. In some cases, to determine the corresponding HARQ information of the m-th TB/PUSCH of the multiple TBs/PUSCHs (e.g., m=0, 1, 2, . . . , M−1), the wireless device may determine at least one of the following: a number of scheduled TBs/PUSCHs by the DCI (e.g., M), a bit width of a TDRA field of the DCI, and/or a bit width of an NDI field of the DCI, and/or a bit width of an RV field of the DCI. For example, the wireless device (and/or the base station) may determine the TB size of the m-th TB/PUSCH of the multiple TBs/PUSCHs (e.g., m=0, 1, 2, . . . , M−1) based on a modulation and coding scheme (MSC) field of the DCI.

In an example embodiment, as shown in FIG. 25, the wireless device (and/or the base station) may determine a number of TBs/PUSCHs (e.g., M) scheduled by the (single) DCI based on a first value indicating a number of UL HPs that have the HARQ mode (e.g., mode A or mode B) of the first UL HP. The DCI, received at time T2 in FIG. 25, may have a field indicating the first UL HP (e.g., by indicating a first UL HP ID). In some examples, the wireless device (and/or the base station) may determine M (e.g., the number of TBs/PUSCHs scheduled by the DCI) based on the first value and a second value indicating a number of entries of the TDRA table of the multiple PUSCHs (e.g., the number of entries of push-TimeDomainResourceAllocationListForMultiPUSCH). In some cases, the second value may indicate a maximum number (e.g., maxNrofMultiplePUSCHs) of schedulable PUSCHs among all entries in the TDRA table of the multiple PUSCHs.

In an example embodiment, the wireless device (and/or the base station) may determine M (e.g., the number of TBs/PUSCHs scheduled by the DCI) based on a minimum of the first value and the second value. For example, the first UL HP may be a mode-A UL HP (e.g., the HARQ mode of the first UL HP being mode A). For example, the first UL HP may be a mode-B UL HP (e.g., the HARQ mode of the first UL HP being mode B). In response to the first value being smaller than the second value, the wireless device may determine M (e.g., the number of TBs/PUSCHs scheduled by the DCI) based on the first value (e.g., logarithm of the first value plus 1). In response to the first value not being smaller (or the first value being larger) than the second value, the wireless device may determine M (e.g., the number of TBs/PUSCHs scheduled by the DCI) based on the first value (e.g., logarithm of the second value plus 1)

For example, the wireless device (and/or the base station) may determine the DCI size based on the second value. This may allow a fixed (or a predefined) DCI size for detecting the DCI.

In an example embodiment, the wireless device (and/or the base station) may determine the DCI size based on the first value and/or the second value. For example, in response to the first DL HP being a mode-A UL HP, the wireless device (and/or the base station) may determine the DCI size based on the second value and a number of the mode-A UL HPs (e.g., a first value). In some cases, the wireless device may determine the DCI size based on a minimum (or maximum or summation) of the first value and the second value. For example, the wireless device may decode/read a HARQ field of the DCI and determine a HARQ mode of the first UL HP indicated by the DCI. This may allow a fixed (or a predefined) DCI size for detecting the DCI.

In an example embodiment, in response to the first DL HP being a feedback-disabled DL HP, the wireless device (and/or the base station) may determine the DCI size based on the second value and a number of the mode-B UL HPs (e.g., a first value). In some cases, the wireless device may determine the DCI size based on a minimum (or maximum or summation) of the first value and the second value. For example, the wireless device may decode/read a HARQ field of the DCI and determine a HARQ mode of the first UL HP indicated by the DCI. This may allow a fixed (or a predefined) DCI size for detecting the DCI.

The wireless device may, based on the HARQ information of each TB/PUSCH of the multiple TBs/PUSCHs, determine at least one of: a transmission time/occasion of each TB/PUSCH of the multiple (e.g., M) TBs/PUSCHs, and/or a whether each TB/PUSCH of the multiple TBs/PUSCHs is a new transmission or a retransmission (e.g., by determining an NDI associated with each TB/PUSCH), and/or a RV corresponding to each TB/PUSCH of the multiple TBs/PUSCHs. For example, the base station and/or the wireless device may reuse one or more UL HPs across the multiple TBs/PUSCHs.

For example, the wireless device may map a value of the TDRA field of the DCI to an element/entry of the TDRA table of the multiple PUSCHs (e.g., the number of entries of the push-TimeDomainResourceAllocationListForMultiPUSCH). In an example, the value b (e.g., b=0, 1, . . . , M−1) of the TDRA field of the DCI may correspond to a b-th element in the TDRA table the multiple PUSCHs (e.g., the number of entries of the push-TimeDomainResourceAllocationListForMultiPUSCH). For example, the wireless device may determine the one or more configuration parameters configure pusch-TimeDomainAllocationListDCI-O-1 or pusch-TimeDomainAllocationListForMultiPUSCH or push-TimeDomainResourceAllocationListForMultiPUSCH-r17. For example, the value of the TDRA field of the DCI may be smaller than the minimum of the first value and the second value (e.g., the number of scheduled TBs/PUSCHs by the DCI, M). In some cases, the wireless device may consider a first/starting/initial M entries of the second value of entries of the multiple-PUSCH TDRA table, e.g., push-TimeDomainResourceAllocationListForMultiPUSCH. In response to the first value being smaller than the second value, the wireless device may determine M (e.g., the number of TBs/PUSCHs scheduled by the DCI) based on the first value (e.g., logarithm of the first value plus 1). In response to the first value not being smaller (or the first value being larger) than the second value, the wireless device may determine M (e.g., the number of TBs/PUSCHs scheduled by the DCI) based on the first value (e.g., logarithm of the second value plus 1).

For example, as shown in FIG. 25, the first UL HP, indicated by the DCI, may be a mode-A UL HP. In an example embodiment, based on a first value (e.g., a number of mode-A UL HPs) being smaller than the second value, the wireless device (and/or the base station) may determine M (e.g., the number of TBs/PUSCHs scheduled by the DCI) based on the first value. In an example embodiment, based on the first value being larger than the second value, the wireless device (and/or the base station) may determine M (e.g., the number of TBs/PUSCHs scheduled by the DCI) based on the second value.

For example, as shown in FIG. 25, the first UL HP, indicated by the DCI, may be a mode-B UL HP. In an example embodiment, based on a first value (e.g., a number of mode-B UL HPs) being smaller than the second value, the wireless device (and/or the base station) may determine M (e.g., the number of TBs/PUSCHs scheduled by the DCI) equal to the first value. In an example embodiment, based on the first value being larger than the second value, the wireless device (and/or the base station) may determine M (e.g., the number of TBs/PUSCHs scheduled by the DCI) equal to the second value.

In an example embodiment, the wireless device (and/or the base station) may, for communicating the multiple (e.g., M) TBs/PUSCHs, determine a bit width of a field of the DCI based on the second value (e.g., the number of entries of the TDRA table of the multiple PDSCHs, e.g., the number of entries of pusch-TimeDomainAllocationListForMultiPUSCH) and/or the first value. For example, the field of the DCI may be at least one of the TDRA field the DCI and/or the NDI field the DCI and/or the RV field the DCI.

For example, the wireless device may (initially) determine a first bit width of the field (e.g., the TDRA field and/or the NDI field and/or the RV field) of DCI (e.g., in B bits where ┌log₂(second value)┐=B bits) based on the second value. The first bit width of the field may indicate a potential or a nominal bit width of the DCI. For example, the wireless device may determine the size of the DCI based on the first (e.g., potential/nominal) bit width of the DCI.

In an example, the wireless device may determine a second bit width of the field (e.g., in W bits) of DCI based on the first value and the second value (e.g., ┌log₂(minimum(first value, second value)┐=W bits). For example, the second bit width of the field of the DCI may be an applicable (or an actual or a valid or an acceptable) bit width of the field of the DCI. For example, based on the applicable bit width of the TDRA field of the DCI, the wireless device may determine the scheduled TBs/PUSCHs by the DCI, e.g., M=2^{applicable bitwidth of TDRA field of DCI}. In some implementations, when the first value is larger than the second value, the number of scheduled TBs/PUSCHs by the DCI may be based on the number of entries of the multiple-PUSCH TDRA table). In other implementations, when the first value being smaller than the second value, the number of scheduled TBs/PUSCHs by the DCI may be based on the first value).

In some examples, the wireless device may skip (or ignore) r bits (e.g., a first/starting/earliest r bits or a last/ending/final r bits) of the field of the DCI to determine the applicable bit width of the field of the DCI from the nominal bit width of the field of the DCI. For example, the skipped/ignored bits (e.g., r) may be based on a difference between the second value and the first value (e.g., ┌log₂(|first value−second value|)┐=r bits). Based on the first value being smaller than the second value, the wireless device may skip (or ignore) r bits (e.g., a first/starting/earliest r bits or a last/ending/final r bits) of the B bits of the field (e.g., the TDRA field and/or the NDI field and/or the RV field) of the DCI (e.g., the wireless device may consider W bits for communicating the M TBs/PUSCHs with the base station). In other examples, based on the first value not being smaller than the second value, the wireless device may not skip/ignore any bits of the field (e.g., the TDRA field and/or the NDI field and/or the RV field) of the DCI (e.g., the wireless device may consider B bits for communicating the M TBs/PUSCHs with the base station), e.g., r=0.

As shown in FIG. 25, the wireless device may receive the (determined) multiple (e.g., M) TBs/PUSCHs, e.g., based on the applicable bit width of the TDRA field of the DCI. For example, the wireless device may receive the multiple TBs/PUSCHs based on the applicable bit width of the TDRA field of the DCI and/or the applicable bit width of the RV field of the DCI and/or the applicable bit width of the NDI field of the DCI.

In some cases, wireless device may, for each TB/PUSCH of the multiple TBs/PUSCHs and based on the applicable bit width of the TDRA field of the DCI, determine a reception time/occasion of each TB/PUSCH of the multiple (e.g., M) TBs/PUSCHs. In an example, a value b (e.g., b=0, 1, . . . , M−1) of the TDRA field of the DCI may correspond to a b-th element in the TDRA table the multiple PUSCHs of the number of entries (e.g., the first value) of the multiple-PUSCH TDRA talbe. For example, the base station and/or the wireless device may reuse one or more UL HPs across the multiple TBs/PUSCHs.

In some cases, wireless device may, for each TB/PUSCH of the multiple TBs/PUSCHs and based on the applicable bit width of the NDI field of the DCI, determine whether each TB/PUSCH of the multiple TBs/PDSCHs is a new transmission or a retransmission (e.g., whether the NDI is toggled or not). For example, the wireless device (and/or the base station) may map each bit of applicable bits of the NDI field of the DCI (e.g., each bit of the W bits when the first value is smaller than the second value and each bit of the B bits when the first value is larger than the second value) to one scheduled TB/PUSCH of the multiple TBs/PUSCHs. In some implementations, the wireless device may, for receiving the multiple TBs/PUSCHs, map (e.g., in a one-to-one approach and in accordance with scheduling order of the multiple TBs/PUSCHs) each bit of the NDI field of the DCI to each TB/PUSCH of the multiple TBs/PUSCHs. In some cases, the LSB bits of the applicable bits of NDI field of the DCI may correspond to a last/final/ending/latest (e.g., M−1) scheduled TB/PUSCH of the multiple TBs/PUSCHs.

In some cases, wireless device may, for each TB/PUSCH of the multiple TBs/PUSCHs and based on the applicable bit width of the RV field of the DCI, determine RV value corresponding to each TB/PUSCH of the multiple TBs/PUSCHs. For example, the wireless device (and/or the base station) may map each bit of applicable bits of the RV field of the DCI (e.g., each bit of the W bits when the first value is smaller than the second value and each bit of the B bits when the first value is larger than the second value) to one scheduled TB/PUSCH of the multiple TBs/PUSCHs. In some implementations, the wireless device may, for receiving the multiple TBs/PUSCHs, map (e.g., in a one-to-one approach and in accordance with scheduling order of the multiple TBs/PUSCHs) each applicable bit of the RV field of the DCI to each TB/PUSCH of the multiple TBs/PUSCHs. In some cases, the LSB bits of the applicable bits of the RV field of the DCI may correspond to a last/final/ending/latest (e.g., M−1) scheduled TB/PUSCH of the multiple TBs/PUSCHs (e.g., indicated by the TDRA field of the DCI).

In some implementations, the one or more configuration parameters (e.g., the one or more RRC configuration parameters) may configure/indicate a fourth configuration parameter. For example, the base station may indicate the fourth configuration parameters via a downlink signal (e.g., a MAC CE, a second DCI, and/or a RRC message). The second DCI may be the DCI. In some examples, the second DCI may be different than the DCI

For example, based on the third configuration parameter being enabled, the wireless device (and/or the base station) may determine a corresponding HARQ information of the m-th TB/PUSCH of the multiple TBs/PUSCHs (e.g., m=0, 1, 2, . . . , M−1) based on the second value and the first value. In some cases, based on the third configuration parameter not being enabled (or being disabled and/or not being configured/indicated), the wireless device (and/or the base station) may determine a corresponding HARQ information of the m-th TB/PUSCH of the multiple TBs/PUSCHs (e.g., m=0, 1, 2, . . . , M−1) based on the second value. In some implementations, the base station may indicate/configure the third configuration parameter in response to determining the one or more configuration parameters comprising the mode-A/mode-B UL HPs. In some other implementations, the base station may configure/indicate (or enable) the first configuration parameter with value enabled based on determining the first value being smaller than the second value. In yet some other implementations, the base station may configure/indicate the first configuration parameter with value disabled or may not configure/indicate the first configuration parameter based on determining the first value being smaller than the second value.

In some cases, the DCI may comprise a field with a value. The value may indicate the number of scheduled TBs/PUSCHs by the DCI. For example, the wireless device (and/or the base station) may determine the first value (and/or the second value) based on the value of the field indicated by the DCI.

In some cases, the first value may be smaller than the number of UL HP IDs with HARQ mode (e.g., mode A or mode B) of the first UL HP identified with the first UL HP ID (e.g., HP #n). For example, based on the first UL HP being a mode-A UL HP, the wireless device may determine a first number of mode-A UL HP IDs (e.g., p>0) not being configured (e.g., by the nrofHARQ-ProcessesForPUSCH). The wireless device may determine the first value equal a difference between the number of mode-A UL HPs and the first number.

In another example, based on the first UL HP being a mode-B UL HP, the wireless device may determine a first number of mode-B UL HP IDs (e.g., p>0) not being configured (e.g., by the nrofHARQ-ProcessesForPUSCH). The wireless device may determine the first value equal a difference between the number of mode-B UL HPs and the first number.

In some cases, in response to determining the one or more configuration parameters not configuring the mode-A UL HPs (e.g., all the configured UL HPs being mode-B UL HPs), the wireless device may, based on the second value, determine at least one of the number of scheduled TBs/PUSCHs by the DCI (e.g., M), and/or the bit width of the TDRA field of the DCI, and/or the bit width of the NDI field of the DCI, and/or the bit width of the RV field of the DCI. In some other cases, in response to determining the one or more configuration parameters not configuring the mode-B UL HPs (e.g., all the configured UL HPs being mode-A UL HPs), the wireless device may, based on the second value, determine at least one of the number of scheduled TBs/PUSCHs by the DCI (e.g., M), and/or the bit width of the TDRA field of the DCI, and/or the bit width of the NDI field of the DCI, and/or the bit width of the RV field of the DCI. In some other cases, in response to determining the uplinkHARQ-mode being absent from the one or more configuration parameters (e.g., mode-A/mode-B UL HPs not being configured), the wireless device may, based on the second value, determine at least one of the number of scheduled TBs/PUSCHs by the DCI (e.g., M), and/or the bit width of the TDRA field of the DCI, and/or the bit width of the NDI field of the DCI, and/or the bit width of the RV field of the DCI.

When the base station configures the wireless device with the mode-A/mode-B UL HPs, some example embodiments may allow the wireless device to dynamically determine the number of multiple TBs scheduled by the DCI, e.g., in order to maintain a consistent HARQ behavior across the multiple TBs. Example embodiments may allow the wireless device to determine (e.g., based on HARQ mode of the DL HP indicated by the DCI) bit widths of one or more fields (e.g., TDRA and/or RV and/or NDI) of the DCI. Example embodiments may improve the UL transmission performance.

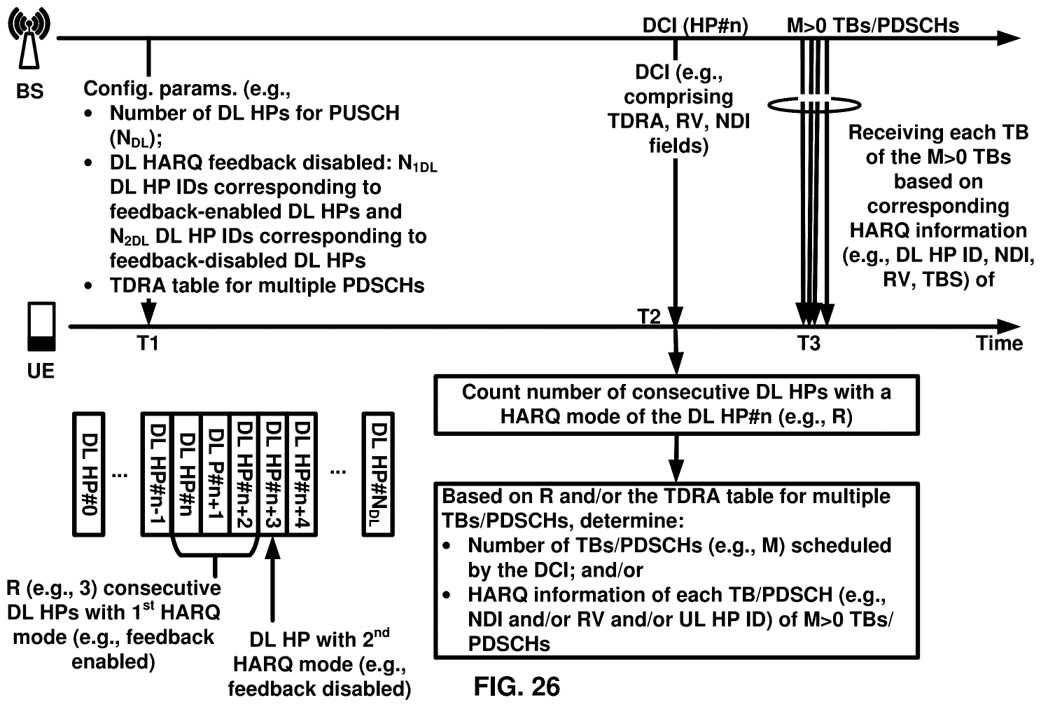

FIG. 26 shows an example embodiment of a HARQ operation/procedure in wireless communications systems per an aspect of the present disclosure. FIG. 26 may, for example, show an implementation of a method (or a process) for UL/DL transmissions at a base station and/or a wireless device. The base station may communicate with the wireless device via/using a cell (e.g., a serving cell). For example, the wireless device may be in an RRC_CONNECTED (or an RRC connected) state/mode. In some implementations, the wireless device may communicate with the base station via a non-terrestrial network (NTN), e.g., the wireless device and the base station may operate in the NTN and/or the base station may be an NTN base station and/or the cell (e.g., the serving cell) may be part of the NTN.

In some other implementations, the wireless device may not communicate with the base station via the NTN (e.g., in a terrestrial network scenario). For example, the cell may not be part of the NTN.

As shown in FIG. 26, the wireless device may receive the one or more configuration parameters from the base station. The one or more configuration parameters may comprise the one or more NTN configuration parameters. The one or more configuration parameters may configure the wireless device with one or more serving cell configuration parameters (e.g., ServingCellConfigCommon, ServingCellConfigCommonSIB, and/or ServingCellConfig). For example, the one or more configuration parameters configure the wireless device with the PDSCH configuration(s) (e.g., PDSCH-Config IE). In some cases, the PDSCH configuration(s) may comprise the TDRA table (or configuration parameters) for the multiple PDSCHs (e.g., the multipe-PDSCH TDRA table or pdsch-TimeDomainAllocationListForMultiPDSCH). In some cases, the one or more configuration parameters may configure (e.g., via nrofHARQ-ProcessesForPDSCH in PDSCH-ServingCellConfig IE) the wireless device with the first number of DL HPs for PDSCH of the cell (e.g., the serving cell), e.g., N_{DL}>0 DL HPs. In some other cases, when the one or more configuration parameters does not comprise/indicate the nrofHARQ-ProcessesForPDSCH, the wireless device may determine the first number of DL HPs for PDSCH of the cell by a predefined (or hard coded) value (e.g., N_{DL}=8 or N_{DL}=16).

In some implementations, as shown in FIG. 26, the one or more configuration parameters may configure the wireless device with the feedback-enabled DL HPs and/or the feedback-disabled DL HPs (e.g., via downlinkHARQ-FeedbackDisabled in PDSCH-ServingCellConfig IE). For example, the one or more configuration parameters may configure N_{1DL}>0 DL HPs as feedback-enabled DL HPs and N_{1DL}>0 DL HPs as feedback-disabled DL HPs, where N_{DL}=N_{1DL}+N_{2DL}. In some cases, N_{DL}<N_{1DL}+N_{2DL} (e.g., the wireless device may ignore one or more DL HPs that are not configured). FIG. 26 shows as example of the feedback-enabled DL HPs and/or the feedback-disabled DL HPs.

As shown in FIG. 26, the wireless device may receive the DCI indicating at least one DL grant for DL data transmission(s). For example, the DCI may indicate a first DL HP with HP #n (e.g., the first DL HP ID). For example, the wireless device may determine the DCI indicate one or more fields comprising a TDRA field, a RV field, and/or an NDI field. For example, the wireless device may determine bit width of the TDRA field, the RV field, and/or the NDI field to receive the DL transmission. In some cases, the wireless device may determine how many (different) TBs/PDSCHs are scheduled by the DCI.

For example, as shown in FIG. 26, corresponding to an m-th TB/PDSCH of the multiple TBs/PDSCHs (e.g., m=0, 1, 2, . . . , M−1), the wireless device may determine a corresponding HARQ information. In some cases, the corresponding HARQ information of the m-th TB/PDSCH of the multiple TBs/PDSCHs (e.g., m=0, 1, 2, . . . , M−1) may comprise at least one of: a corresponding DL HP ID (e.g., HP #n when m=0 and HP #nₘ when m>0), a corresponding NDI, a corresponding RV, and/or a corresponding TB size. For example, based on the embodiments of FIG. 20 and/or FIG. 21, the wireless device may determine HP #nₘ for m>0. In some cases, to determine the corresponding HARQ information of the m-th TB/PDSCH of the multiple TBs/PDSCHs (e.g., m=0, 1, 2, . . . , M−1), the wireless device may determine at least one of the following: a number of scheduled TBs/PDSCHs by the DCI (e.g., M), and/or an applicable (or valid or acceptable) bit width of a TDRA field of the DCI, and/or an applicable (or valid or acceptable) bit width of an NDI field of the DCI, and/or an applicable (or valid or acceptable) bit width of an RV field of the DCI. For example, the wireless device may determine the TB size of the m-th TB/PDSCH of the multiple TBs/PDSCHs (e.g., m=0, 1, 2, . . . , M−1) based on a modulation and coding scheme (MSC) field of the DCI.

In an example embodiment, as shown in FIG. 26, the wireless device (and/or the base station) may determine the number of TBs/PDSCHs (e.g., M) scheduled by the (single) DCI based on a third value (e. g., parameter R is FIG. 26) indicating how many consecutive DL HP IDs, started from the first DL HP ID (e.g., HP #n in FIG. 26), has HARQ mode (e.g., feedback-enabled or feedback-disabled) as of the first DL HP identified with the first DL HP ID. For example, the third value may indicate a number of consecutive DL HP IDs, started from HP #n, having HARQ mode as of the first DL HP identified with HP #n (e.g., in FIG. 26, the third value is 3). For example, the wireless device may determine that R=3 DL HP IDs from HP #n to HP #n+R have same HARQ mode as of the first DL HP identified with the first DL HP ID. In some examples, the wireless device (and/or the base station) may determine M (e.g., the number of TBs/PDSCHs scheduled by the DCI) based on the third value and the second value.

In some cases, the third value (R) may be smaller than the number of consecutive DL HP IDs, started from the first DL HP ID (e.g., HP #n in FIG. 26), with HARQ mode (e.g., feedback-enabled or feedback-disabled) of the first DL HP identified with the first DL HP ID. For example, the wireless device may determine a first number of DL HP IDs (e.g., >0) between HP #n and HP #n+R not being configured. The wireless device may determine the third value equal to R-r (e.g., a difference between R and r).

In an example embodiment, the wireless device (and/or the base station) may determine M (e.g., the number of TBs/PDSCHs scheduled by the DCI) based on a minimum of the third value and the second value. For example, the first DL HP may be a feedback-enabled DL HP (e.g., the HARQ mode of the first DL HP being feedback enabled). For example, the first DL HP may be a feedback-disabled DL HP (e.g., the HARQ mode of the first DL HP being feedback disabled). In response to the third value being smaller than the second value, the wireless device may determine M (e.g., the number of TBs/PDSCHs scheduled by the DCI) based on the third value (e.g., logarithm of the third value plus 1). In response to the third value not being smaller (or the third value being larger) than the second value, the wireless device may determine M (e.g., the number of TBs/PDSCHs scheduled by the DCI) based on the second value (e.g., logarithm of the second value plus 1)

For example, the wireless device (and/or the base station) may determine the DCI size based on the second value. This may allow a fixed (or a predefined) DCI size for detecting the DCI.

The wireless device may, based on the HARQ information of each TB/PDSCH of the multiple TBs/PDSCHs, determine at least one of: a reception time/occasion of each TB/PDSCH of the multiple (e.g., M) TBs/PDSCHs, and/or a whether each TB/PDSCH of the multiple TBs/PDSCHs is a new transmission or a retransmission (e.g., by determining an NDI associated with each TB/PDSCH), and/or a RV corresponding to each TB/PDSCH of the multiple TBs/PDSCHs. For example, the base station and/or the wireless device may reuse one or more DL HPs across the multiple TBs/PDSCHs.

For example, the wireless device may map a value of the TDRA field of the DCI to an element/entry of the TDRA table of the multiple PDSCHs (e.g., the number of entries of the pdsch-TimeDomainAllocationListForMultiPDSCH). In an example, a value b (e.g., b=0, 1, . . . , M−1) of the TDRA field of the DCI may correspond to a b-th element in the TDRA table the multiple PDSCHs of the number of entries (e.g., the first value) of the TimeDomainAllocationListForMultiPDSCH. For example, the value of the TDRA field of the DCI may be smaller than the minimum of the third value and the second value (e.g., the number of scheduled TBs/PDSCHs by the DCI, M). In some cases, the wireless device may consider a first/starting/initial M entries of the second value of entries of the multiple-PDSCH TDRA table. For example, the wireless device may determine the one or more configuration parameters configuring pdsch-TimeDomainResourceAllocationListForMultiPDSCH. Based on the third value being smaller than the second value, the wireless device (and/or the base station) may determine M (e.g., the number of scheduled TBs/PDSCHs by the DCI) based on the third value. Based on the third value being larger than the second value, the wireless device (and/or the base station) may determine M (e.g., the number of scheduled TBs/PDSCHs by the DCI) based on the second value.

For example, as shown in FIG. 26, the first DL HP, indicated by the DCI, may be a feedback-enabled DL HP. In an example embodiment, based on a third value (e.g., a number of consecutive DL HP IDs, started from HP #n, having HARQ mode as of the first DL HP) being smaller than the second value, the wireless device (and/or the base station) may determine M (e.g., the number of TBs/PDSCHs scheduled by the DCI) based on the third value. In an example embodiment, based on the third value being larger than the second value, the wireless device (and/or the base station) may determine M (e.g., the number of TBs/PDSCHs scheduled by the DCI) based on the second value (e.g., equal to the logarithm of the second value plus 1).

For example, as shown in FIG. 24, the first DL HP, indicated by the DCI, may be a feedback-disabled DL HP. In an example embodiment, based on a third value (e.g., a number of consecutive DL HP IDs, started from HP #n, having HARQ mode as of the first DL HP) being smaller than the second value, the wireless device (and/or the base station) may determine M (e.g., the number of TBs/PDSCHs scheduled by the DCI) based on the third value. In an example embodiment, based on the third value being larger than the second value, the wireless device (and/or the base station) may determine M (e.g., the number of TBs/PDSCHs scheduled by the DCI) based on the second value.

In an example embodiment, the wireless device (and/or the base station) may, for communicating the multiple (e.g., M) TBs/PDSCHs, determine a bit width of a field of the DCI based on the second value (e.g., the number of entries of the TDRA table of the multiple PDSCHs, e.g., the number of entries of pdsch-TimeDomainAllocationListForMultiPDSCH) and/or the third value. For example, the field of the DCI may be at least one of the TDRA field the DCI and/or the NDI field the DCI and/or the RV field the DCI.

For example, the wireless device may (initially) determine a first bit width of the field (e.g., the TDRA field and/or the NDI field and/or the RV field) of DCI (e.g., in B bits where ┌log₂(second value)┐=B bits) based on the second value. The first bit width of the field may indicate a potential or a nominal bit width of the DCI. For example, the wireless device may determine the size of the DCI based on the first (e.g., potential/nominal) bit width of the DCI.

In an example, the wireless device may determine a second bit width of the field (e.g., in W bits) of DCI based on the third value and the second value (e.g., ┌log₂(minimum(third value, second value)┐=W bits). For example, the second bit width of the field of the DCI may be an applicable (or an actual or a valid or an acceptable) bit width of the field of the DCI. For example, based on the applicable bit width of the TDRA field of the DCI, the wireless device may determine the scheduled TBs/PDSCHs by the DCI, e.g., M=2^{applicable bitwidth of TDRA field of DCI}. In some implementations, when the third value is larger than the second value, the number of scheduled TBs/PDSCHs by the DCI may be based on the number of entries of the multiple-PDSCH TDRA table). In other implementations, when the third value being smaller than the second value, the number of scheduled TBs/PDSCHs by the DCI may be based on the third value.

In some examples, the wireless device may skip (or ignore) r bits (e.g., a first/starting/earliest r bits or a last/ending/final r bits) of the field of the DCI to determine the applicable bit width of the field of the DCI from the nominal bit width of the field of the DCI. For example, the skipped/ignored bits (e.g., r) may be based on a difference between the second value and the third value (e.g., ┌log₂(|third value−second value|)┐=r bits). Based on the third value being smaller than the second value, the wireless device may skip (or ignore) r bits (e.g., a first/starting/earliest r bits or a last/ending/final r bits) of the B bits of the field (e.g., the TDRA field and/or the NDI field and/or the RV field) of the DCI (e.g., the wireless device may consider W bits for communicating the M TBs/PDSCHs with the base station). In other examples, based on the third value not being smaller than the second value, the wireless device may not skip/ignore any bits of the field (e.g., the TDRA field and/or the NDI field and/or the RV field) of the DCI (e.g., the wireless device may consider B bits for communicating the M TBs/PDSCHs with the base station), e.g., r=0.

As shown in FIG. 26, the wireless device may receive the (determined) multiple (e.g., M) TBs/PUSCHs, e.g., based on the applicable bit width of the TDRA field of the DCI. For example, the wireless device may receive the multiple TBs/PUSCHs based on the applicable bit width of the TDRA field of the DCI and/or the applicable bit width of the RV field of the DCI and/or the applicable bit width of the NDI field of the DCI.

In some cases, wireless device may, for each TB/PDSCH of the multiple TBs/PDSCHs and based on the applicable bit width of the TDRA field of the DCI, determine a reception time/occasion of each TB/PDSCH of the multiple (e.g., M) TBs/PDSCHs. In an example, a value b (e.g., b=0, 1, . . . , M−1) of the TDRA field of the DCI may correspond to a b-th element in the TDRA table the multiple PDSCHs of the number of entries (e.g., a first/initial/starting third value) of the multiple-PDSCH TDRA table. For example, the base station and/or the wireless device may reuse one or more DL HPs across the multiple TBs/PDSCHs.

In some cases, wireless device may, for each TB/PDSCH of the multiple TBs/PDSCHs and based on the applicable bit width of the NDI field of the DCI, determine whether each TB/PDSCH of the multiple TBs/PDSCHs is a new transmission or a retransmission (e.g., whether the NDI is toggled or not). For example, the wireless device (and/or the base station) may map each bit of applicable bits of the NDI field of the DCI (e.g., each bit of the W bits when the third value is smaller than the second value and each bit of the B bits when the third value is larger than the second value) to one scheduled TB/PDSCH of the multiple TBs/PDSCHs. In some implementations, the wireless device may, for receiving the multiple TBs/PDSCHs, map (e.g., in a one-to-one approach and in accordance with scheduling order of the multiple TBs/PDSCHs) each bit of the NDI field of the DCI to each TB/PDSCH of the multiple TBs/PDSCHs. In some cases, the LSB bits of the applicable bits of NDI field of the DCI may correspond to a last/final/ending/latest (e.g., M−1) scheduled TB/PDSCH of the multiple TBs/PDSCHs.

In some cases, wireless device may, for each TB/PDSCH of the multiple TBs/PDSCHs and based on the applicable bit width of the RV field of the DCI, determine RV value corresponding to each TB/PDSCH of the multiple TBs/PDSCHs. For example, the wireless device (and/or the base station) may map each bit of applicable bits of the RV field of the DCI (e.g., each bit of the W bits when the third value is smaller than the second value and each bit of the B bits when the third value is larger than the second value) to one scheduled TB/PDSCH of the multiple TBs/PDSCHs. In some implementations, the wireless device may, for receiving the multiple TBs/PDSCHs, map (e.g., in a one-to-one approach and in accordance with scheduling order of the multiple TBs/PDSCHs) each applicable bit of the RV field of the DCI to each TB/PDSCH of the multiple TBs/PDSCHs. In some cases, the LSB bits of the applicable bits of the RV field of the DCI may correspond to a last/final/ending/latest (e.g., M−1) scheduled TB/PDSCH of the multiple TBs/PDSCHs.

In some implementations, the one or more configuration parameters (e.g., the one or more RRC configuration parameters) may configure/indicate a fourth configuration parameter. For example, the base station may indicate the fourth configuration parameters via a downlink signal (e.g., a MAC CE, a second DCI, and/or a RRC message). The second DCI may be the DCI. In some examples, the second DCI may be different than the DCI

For example, based on the third configuration parameter being enabled, the wireless device (and/or the base station) may determine a corresponding HARQ information of the m-th TB/PUSCH of the multiple TBs/PUSCHs (e.g., m=0, 1, 2, . . . , M−1) based on the second value and the third value. In some cases, based on the third configuration parameter not being enabled (or being disabled and/or not being configured/indicated), the wireless device (and/or the base station) may determine a corresponding HARQ information of the m-th TB/PUSCH of the multiple TBs/PUSCHs (e.g., m=0, 1, 2, . . . , M−1) based on the second value. In some implementations, the base station may indicate/configure the third configuration parameter in response to determining the one or more configuration parameters comprising the mode-A/mode-B UL HPs.

In some cases, in response to determining the one or more configuration parameters not configuring the feedback-enabled DL HPs (e.g., all the configured DL HPs being feedback-disabled DL HPs), the wireless device may, based on the second value, determine at least one of the number of scheduled TBs/PDSCHs by the DCI (e.g., M), and/or the bit width of the TDRA field of the DCI, and/or the bit width of the NDI field of the DCI, and/or the bit width of the RV field of the DCI. In some other cases, in response to determining the one or more configuration parameters not configuring the feedback-disabled DL HPs (e.g., all the configured DL HPs being feedback-enabled DL HPs), the wireless device may, based on the second value, determine at least one of the number of scheduled TBs/PDSCHs by the DCI (e.g., M), and/or the bit width of the TDRA field of the DCI, and/or the bit width of the NDI field of the DCI, and/or the bit width of the RV field of the DCI. In some other cases, in response to determining the downlinkHARQ-FeedbackDisabled being absent from the one or more configuration parameters (e.g., feedback-enabled/disabled DL HPs not being configured), the wireless device may, based on the second value, determine at least one of the number of scheduled TBs/PDSCHs by the DCI (e.g., M), and/or the bit width of the TDRA field of the DCI, and/or the bit width of the NDI field of the DCI, and/or the bit width of the RV field of the DCI.

When the base station configures the wireless device with the feedback-enabled/disabled DL HPs, some example embodiments may allow the wireless device to dynamically determine the number of multiple TBs scheduled by the DCI, e.g., in order to maintain a consistent HARQ behavior across the multiple TBs. Example embodiments may allow the wireless device to determine (e.g., based on HARQ mode of the DL HP indicated by the DCI) bit widths of one or more fields (e.g., TDRA and/or RV and/or NDI) of the DCI. Example embodiments may improve the DL transmission performance.

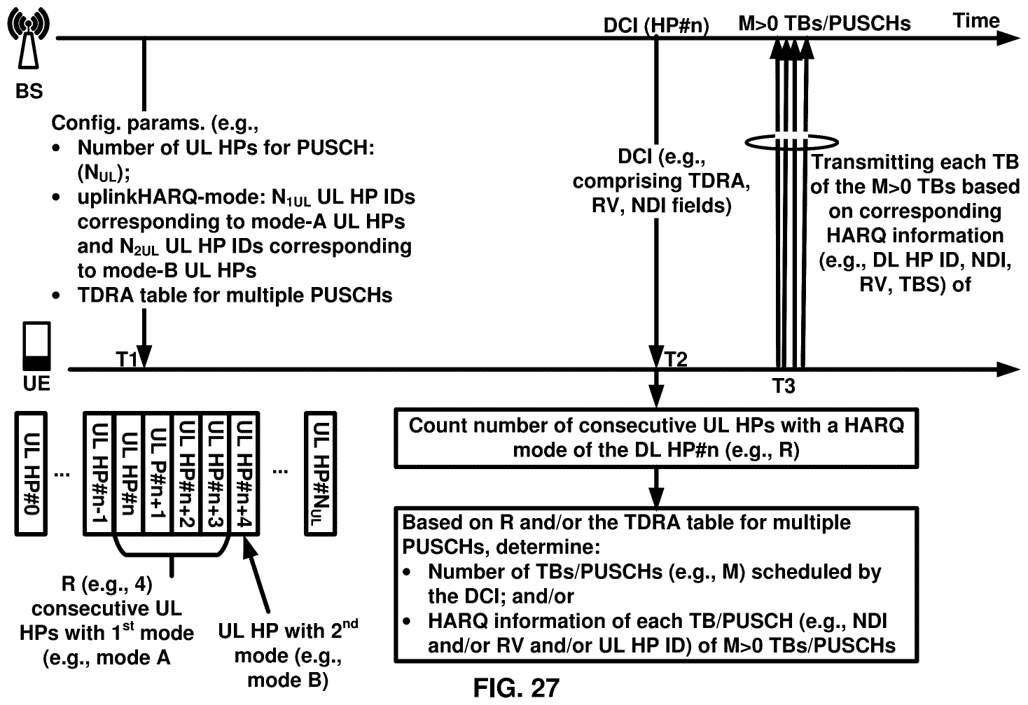

FIG. 27 shows an example embodiment of a HARQ operation/procedure in wireless communications systems per an aspect of the present disclosure. FIG. 27 may, for example, show an implementation of a method (or a process) for UL/DL transmissions at a base station and/or a wireless device. The base station may communicate with the wireless device via/using a cell (e.g., a serving cell). For example, the wireless device may be in an RRC_CONNECTED (or an RRC connected) state/mode. In some implementations, the wireless device may communicate with the base station via a non-terrestrial network (NTN), e.g., the wireless device and the base station may operate in the NTN and/or the base station may be an NTN base station and/or the cell (e.g., the serving cell) may be part of the NTN.

In some other implementations, the wireless device may not communicate with the base station via the NTN (e.g., in a terrestrial network scenario). For example, the cell may not be part of the NTN.

As shown in FIG. 27, at time T1, the wireless device may receive the one or more configuration parameters from the base station. The one or more configuration parameters may comprise the one or more NTN configuration parameters. The one or more configuration parameters may configure the wireless device with one or more serving cell configuration parameters (e.g., ServingCellConfigCommon, ServingCellConfigCommonSIB, and/or ServingCellConfig). For example, the one or more configuration parameters configure the wireless device with PUSCH configuration(s) (e.g., PUSCH-Config IE). In some cases, the PUSCH configuration(s) may comprise the TDRA table for the multiple PUSCHs (e.g., pusch-TimeDomainAllocationListForMultiPUSCH). In some cases, the one or more configuration parameters may configure (e.g., via nrofHARQ-ProcessesForPUSCH in PUSCH-ServingCellConfig IE) the wireless device with a second number of UL HPs for PUSCH of the cell (e.g., the serving cell), e.g., N_{UL}>0 UL HPs. In some other cases, when the one or more configuration parameters does not comprise/indicate the nrofHARQ-ProcessesForPUSCH, the wireless device may determine the second number of uL HPs for PUSCH of the cell by a predefined (or hard coded) value (e.g., N_{UL}=8 or N_{UL}=16).

In some implementations, as shown in FIG. 27, the one or more configuration parameters may configure the wireless device with mode-A UL HPs and/or mode-B UL HPs (e.g., via uplinkHARQ-mode in PUSCH-ServingCellConfig IE). For example, the one or more configuration parameters may configure N_{1UL}>0 UL HPs as mode-A UL HPs and N_{1UL}>0 UL HPs as mode-B UL HPs, where N_{UL}=N_{UL}+N_{UL}. In some cases, N_{UL} N_{UL}+N_{UL} (e.g., the wireless device may ignore one or more UL HPs that are not configured). FIG. 27 shows as example of the mode-A UL HPs and/or the mode-B UL HPs.

As shown in FIG. 27, the wireless device may receive the DCI indicating at least one UL grant for UL data transmission(s). For example, the DCI may indicate a first UL HP with HP #n (e.g., the first UL HP ID). For example, the wireless device may determine the DCI indicate one or more fields comprising a TDRA field, a RV field, and/or an NDI field. For example, the wireless device may determine bit width of the TDRA field, the RV field, and/or the NDI field to receive the DL transmission. In some cases, the wireless device may determine how many (different) TBs/PUSCHs are scheduled by the DCI.

In an example embodiment, the wireless device (and/or the base station) may, based on a HARQ mode of the first UL HP, determine a HARQ information corresponding to a TB/PUSCH of the multiple TBs/PUSCHs. In some cases, based on the DCI and/or the HARQ mode of the first UL HP, the wireless device (and/or the base station) may determine the HARQ information corresponding to (or of or associated to) a TB/PDSCH of the multiple TBs/PDSCHs.

For example, as shown in FIG. 27, corresponding to an m-th TB/PUSCH of the multiple TBs/PUSCHs (e.g., m=0, 1, 2, . . . , M−1), the wireless device may determine a corresponding HARQ information. In some cases, the corresponding HARQ information of the m-th TB/PUSCH of the multiple TBs/PUSCHs (e.g., m=0, 1, 2, . . . , M−1) may comprise at least one of: a corresponding UL HP ID (e.g., HP #n when m=0 and HP #nₘ when m>0), a corresponding NDI, a corresponding RV, and/or a corresponding TB size. For example, based on the embodiments of FIG. 22 and/or FIG. 23, the wireless device may determine HP #nₘ for m>0. In some cases, to determine the corresponding HARQ information of the m-th TB/PUSCH of the multiple TBs/PUSCHs (e.g., m=0, 1, 2, . . . , M−1), the wireless device may determine at least one of the following: a number of scheduled TBs/PUSCHs by the DCI (e.g., M), a bit width of a TDRA field of the DCI, and/or a bit width of an NDI field of the DCI, and/or a bit width of an RV field of the DCI. For example, the wireless device may determine the TB size of the m-th TB/PUSCH of the multiple TBs/PUSCHs (e.g., m=0, 1, 2, . . . , M−1) based on a modulation and coding scheme (MSC) field of the DCI.

In an example embodiment, as shown in FIG. 27, the wireless device (and/or the base station) may determine the number of TBs/PUSCHs (e.g., M) scheduled by the (single) DCI based on a third value (e.g., parameter R is FIG. 26) indicating how many consecutive UL HP IDs, started from the first UL HP ID (e.g., HP #n in FIG. 27), has HARQ mode (e.g., mode A or mode B) as of the first UL HP identified with the first UL HP ID (e.g., HP #n in FIG. 27). For example, the third value may indicate a number of consecutive UL HP IDs, started from HP #n, having HARQ mode as of the first UL HP identified with HP #n (e.g., in FIG. 27, the third value is 4). For example, the wireless device may determine that R=4 UL HP IDs from HP #n to HP #n+R have same HARQ mode as of the first UL HP identified with the first UL HP ID. In some examples, the wireless device (and/or the base station) may determine M (e.g., the number of TBs/PUSCHs scheduled by the DCI) based on the first value and a second value.

In some cases, the third value (R) may be smaller than the number of consecutive UL HP IDs, started from the first UL HP ID (e.g., HP #n in FIG. 27), with HARQ mode (e.g., mode A or mode B) of the first UL HP identified with the first UL HP ID. For example, the wireless device may determine a first number of UL HP IDs (e.g., >0) between HP #n and HP #n+R not being configured. The wireless device may determine the third value equal to R-r (e.g., a difference between R and r).

In an example embodiment, as shown in FIG. 27, the wireless device (and/or the base station) may determine a number of TBs/PUSCHs (e.g., M) scheduled by the (single) DCI based on the third value (e.g., a number of consecutive UL HP IDs, started from HP #n, having HARQ mode as of the first UL HP). The DCI, received at time T2 in FIG. 27, may have a field indicating the first UL HP (e.g., by indicating a first UL HP ID). In some examples, the wireless device (and/or the base station) may determine M (e.g., the number of TBs/PUSCHs scheduled by the DCI) based on the third value and a second value indicating a number of entries of the TDRA table of the multiple PUSCHs (e.g., the number of entries of push-TimeDomainResourceAllocationListForMultiPUSCH). In some cases, the second value may indicate a maximum number (e.g., maxNrofMultiplePUSCHs) of schedulable PUSCHs among all entries in the TDRA table of the multiple PUSCHs.

In an example embodiment, the wireless device (and/or the base station) may determine M (e.g., the number of TBs/PUSCHs scheduled by the DCI) based on a minimum of the third value and the second value. For example, the first UL HP may be a mode-A UL HP (e.g., the HARQ mode of the first UL HP being mode A). For example, the first UL HP may be a mode-B UL HP (e.g., the HARQ mode of the first UL HP being mode B). In response to the third value being smaller than the second value, the wireless device may determine M (e.g., the number of TBs/PUSCHs scheduled by the DCI) based on the first value (e. g., logarithm of the third value plus 1). In response to the third value not being smaller (or the first value being larger) than the second value, the wireless device may determine M (e.g., the number of TBs/PUSCHs scheduled by the DCI) based on the first value (e.g., logarithm of the second value plus 1)

The wireless device may, based on the HARQ information of each TB/PUSCH of the multiple TBs/PUSCHs, determine at least one of: a transmission time/occasion of each TB/PUSCH of the multiple (e.g., M) TBs/PUSCHs, and/or a whether each TB/PUSCH of the multiple TBs/PUSCHs is a new transmission or a retransmission (e.g., by determining an NDI associated with each TB/PUSCH), and/or a RV corresponding to each TB/PUSCH of the multiple TBs/PUSCHs. For example, the base station and/or the wireless device may reuse one or more UL HPs across the multiple TBs/PUSCHs.

For example, the wireless device may map a value of the TDRA field of the DCI to an element/entry of the TDRA table of the multiple PUSCHs (e.g., the number of entries of the push-TimeDomainResourceAllocationListForMultiPUSCH). In an example, the value b (e.g., b=0, 1, . . . , M−1) of the TDRA field of the DCI may correspond to a b-th element in the TDRA table the multiple PUSCHs (e.g., the number of entries of the push-TimeDomainResourceAllocationListForMultiPUSCH). For example, the wireless device may determine the one or more configuration parameters configure pusch-TimeDomainAllocationListDCI-0-1 or pusch-TimeDomainAllocationListForMultiPUSCH or push-TimeDomainResourceAllocationListForMultiPUSCH-r17. For example, the value of the TDRA field of the DCI may be smaller than the minimum of the first value and the second value (e.g., the number of scheduled TBs/PUSCHs by the DCI, M). In some cases, the wireless device may consider a first/starting/initial M entries of the second value of entries of the multiple-PUSCH TDRA table, e.g., push-TimeDomainResourceAllocationListForMultiPUSCH. In response to the first value being smaller than the second value, the wireless device may determine M (e.g., the number of TBs/PUSCHs scheduled by the DCI) based on the first value (e.g., logarithm of the first value plus 1). In response to the first value not being smaller (or the first value being larger) than the second value, the wireless device may determine M (e.g., the number of TBs/PUSCHs scheduled by the DCI) based on the first value (e.g., logarithm of the second value plus 1).

For example, the wireless device (and/or the base station) may determine the DCI size based on the second value. This may allow a fixed (or a predefined) DCI size for detecting the DCI.

For example, as shown in FIG. 27, the first UL HP, indicated by the DCI, may be a mode-A UL HP. In an example embodiment, based on a third (e.g., a number of consecutive UL HP IDs, started from HP #n, having HARQ mode as of the first UL HP) being smaller than the second value, the wireless device (and/or the base station) may determine M (e.g., the number of TBs/PUSCHs scheduled by the DCI) based on the third value. In an example embodiment, based on the third value being larger than the second value, the wireless device (and/or the base station) may determine M (e.g., the number of TBs/PUSCHs scheduled by the DCI) based on the second value.

For example, as shown in FIG. 27, the first UL HP, indicated by the DCI, may be a mode-B UL HP. In an example embodiment, based on a third value (e.g., a number of consecutive UL HP IDs, started from HP #n, having HARQ mode as of the first UL HP) being smaller than the second value, the wireless device (and/or the base station) may determine M (e.g., the number of TBs/PUSCHs scheduled by the DCI) based on the third value. In an example embodiment, based on the third value being larger than the second value, the wireless device (and/or the base station) may determine M (e.g., the number of TBs/PUSCHs scheduled by the DCI) based on the second value.

In an example embodiment, the wireless device (and/or the base station) may, for communicating the multiple (e.g., M) TBs/PUSCHs, determine a bit width of a field of the DCI based on the second value (e.g., the number of entries of the TDRA table of the multiple PDSCHs, e.g., the number of entries of pusch-TimeDomainAllocationListForMultiPUSCH) and/or the third value. For example, the field of the DCI may be at least one of the TDRA field the DCI and/or the NDI field the DCI and/or the RV field the DCI.

For example, the wireless device may (initially) determine a first bit width of the field (e.g., the TDRA field and/or the NDI field and/or the RV field) of DCI (e.g., in B bits where ┌log₂(second value)┐=B bits) based on the second value. The first bit width of the field may indicate a potential or a nominal bit width of the DCI. For example, the wireless device may determine the size of the DCI based on the first (e.g., potential/nominal) bit width of the DCI.

In an example, the wireless device may determine a second bit width of the field (e.g., in W bits) of DCI based on the third value and the second value (e.g., ┌log₂(minimum(first value, second value)┐=W bits). For example, the second bit width of the field of the DCI may be an applicable (or an actual or a valid or an acceptable) bit width of the field of the DCI. For example, based on the applicable bit width of the TDRA field of the DCI, the wireless device may determine the scheduled TBs/PUSCHs by the DCI, e.g., M=2^{applicable bitwidth of TDRA field of DCI}. In some implementations, when the third value is larger than the second value, the number of scheduled TBs/PUSCHs by the DCI may be based on the number of entries of the multiple-PUSCH TDRA table (e.g., the second value). In other implementations, when the third value being smaller than the second value, the number of scheduled TBs/PUSCHs by the DCI may be based on the third value.

In some examples, the wireless device may skip (or ignore) r bits (e.g., a first/starting/earliest r bits or a last/ending/final r bits) of the field of the DCI to determine the applicable bit width of the field of the DCI from the nominal bit width of the field of the DCI. For example, the skipped/ignored bits (e.g., r) may be based on a difference between the second value and the third value (e.g., ┌log₂(|third value−second value|)┐=r bits). Based on the third value being smaller than the second value, the wireless device may skip (or ignore) r bits (e.g., a first/starting/earliest r bits or a last/ending/final r bits) of the B bits of the field (e.g., the TDRA field and/or the NDI field and/or the RV field) of the DCI (e.g., the wireless device may consider W bits for communicating the M TBs/PUSCHs with the base station). In other examples, based on the third value not being smaller than the second value, the wireless device may not skip/ignore any bits of the field (e.g., the TDRA field and/or the NDI field and/or the RV field) of the DCI (e.g., the wireless device may consider B bits for communicating the M TBs/PUSCHs with the base station), e.g., r=0.

As shown in FIG. 27, the wireless device may receive the (determined) multiple (e.g., M) TBs/PUSCHs, e.g., based on the applicable bit width of the TDRA field of the DCI. For example, the wireless device may receive the multiple TBs/PUSCHs based on the applicable bit width of the TDRA field of the DCI and/or the applicable bit width of the RV field of the DCI and/or the applicable bit width of the NDI field of the DCI.

In some cases, wireless device may, for each TB/PUSCH of the multiple TBs/PUSCHs and based on the applicable bit width of the TDRA field of the DCI, determine a reception time/occasion of each TB/PUSCH of the multiple (e.g., M) TBs/PUSCHs. In an example, a value b (e.g., b=0, 1, . . . , M−1) of the TDRA field of the DCI may correspond to a b-th element in the TDRA table the multiple PUSCHs of the number of entries (e.g., a first/starting/initial/earliest third value) of the multiple-PUSCH TDRA talbe. For example, the base station and/or the wireless device may reuse one or more UL HPs across the multiple TBs/PUSCHs.

In some cases, wireless device may, for each TB/PUSCH of the multiple TBs/PUSCHs and based on the applicable bit width of the NDI field of the DCI, determine whether each TB/PUSCH of the multiple TBs/PDSCHs is a new transmission or a retransmission (e.g., whether the NDI is toggled or not). For example, the wireless device (and/or the base station) may map each bit of applicable bits of the NDI field of the DCI (e.g., each bit of the W bits when the third value is smaller than the second value and each bit of the B bits when the first value is larger than the second value) to one scheduled TB/PUSCH of the multiple TBs/PUSCHs. In some implementations, the wireless device may, for receiving the multiple TBs/PUSCHs, map (e.g., in a one-to-one approach and in accordance with scheduling order of the multiple TBs/PUSCHs) each bit of the NDI field of the DCI to each TB/PUSCH of the multiple TBs/PUSCHs. In some cases, the LSB bits of the applicable bits of NDI field of the DCI may correspond to a last/final/ending/latest (e.g., M−1) scheduled TB/PUSCH of the multiple TBs/PUSCHs.

In some cases, wireless device may, for each TB/PUSCH of the multiple TBs/PUSCHs and based on the applicable bit width of the RV field of the DCI, determine RV value corresponding to each TB/PUSCH of the multiple TBs/PUSCHs. For example, the wireless device (and/or the base station) may map each bit of applicable bits of the RV field of the DCI (e.g., each bit of the W bits when the third value is smaller than the second value and each bit of the B bits when the first value is larger than the second value) to one scheduled TB/PUSCH of the multiple TBs/PUSCHs. In some implementations, the wireless device may, for receiving the multiple TBs/PUSCHs, map (e.g., in a one-to-one approach and in accordance with scheduling order of the multiple TBs/PUSCHs) each applicable bit of the RV field of the DCI to each TB/PUSCH of the multiple TBs/PUSCHs. In some cases, the LSB bits of the applicable bits of the RV field of the DCI may correspond to a last/final/ending/latest (e.g., M−1) scheduled TB/PUSCH of the multiple TBs/PUSCHs (e.g., indicated by the TDRA field of the DCI).

In some implementations, the one or more configuration parameters may configure/indicate a sixth configuration parameter. For example, the sixth configuration parameter may be used by the wireless device to determine at least one of the number(s) of scheduled TBs/PUSCHs by the DCI (e.g., M), and/or the bit width of the TDRA field of the DCI, and/or the bit width of the NDI field of the DCI, and/or the bit width of the RV field of the DCI based on a third value (e.g., a number of consecutive UL HP IDs, started from HP #n, having HARQ mode as of the first UL HP identified with HP #n) and the second value. In some implementations, the base station may configure/indicate the sixth configuration parameter in response to determining the one or more configuration parameters comprising the mode-A/mode-B UL HPs.

In response to determining the sixth configuration parameters being configured (or being enabled or not being disabled or not being absent), the wireless device may, based on the third value, determine at least one of the number of scheduled TBs/PUSCHs by the DCI (e.g., M), and/or the bit width of the TDRA field of the DCI, and/or the bit width of the NDI field of the DCI, and/or the bit width of the RV field of the DCI. In another example, in response to determining the sixth configuration parameters being configured (or being enabled or not being disabled or not being absent), the wireless device may, based on the third value and the second value, determine at least one of the number of scheduled TBs/PUSCHs by the DCI (e.g., M), and/or the bit width of the TDRA field of the DCI, and/or the bit width of the NDI field of the DCI, and/or the bit width of the RV field of the DCI. In some cases, in response to determining the sixth configuration parameters not being configured (or not being enabled or being disabled), the wireless device may, based on the second value, determine the number of scheduled TBs/PUSCHs by the DCI (e.g., M), and/or the bit width of the TDRA field of the DCI, and/or the bit width of the NDI field of the DCI, and/or the bit width of the RV field of the DCI.

In some cases, in response to determining the one or more configuration parameters not configuring the mode-A UL HPs (e.g., all the configured UL HPs being mode-B UL HPs), the wireless device may, based on the second value, determine at least one of the number of scheduled TBs/PUSCHs by the DCI (e.g., M), and/or the bit width of the TDRA field of the DCI, and/or the bit width of the NDI field of the DCI, and/or the bit width of the RV field of the DCI. In some other cases, in response to determining the one or more configuration parameters not configuring the mode-B UL HPs (e.g., all the configured UL HPs being mode-A UL HPs), the wireless device may, based on the second value, determine at least one of the number of scheduled TBs/PUSCHs by the DCI (e.g., M), and/or the bit width of the TDRA field of the DCI, and/or the bit width of the NDI field of the DCI, and/or the bit width of the RV field of the DCI. In some other cases, in response to determining the uplinkHARQ-mode being absent from the one or more configuration parameters (e.g., mode-A/mode-B UL HPs not being configured), the wireless device may, based on the second value, determine at least one of the number of scheduled TBs/PUSCHs by the DCI (e.g., M), and/or the bit width of the TDRA field of the DCI, and/or the bit width of the NDI field of the DCI, and/or the bit width of the RV field of the DCI.

When the base station configures the wireless device with the mode-A/mode-B UL HPs, some example embodiments may allow the wireless device to dynamically determine the number of multiple TBs scheduled by the DCI, e.g., in order to maintain a consistent HARQ behavior across the multiple TBs. Example embodiments may allow the wireless device to determine (e.g., based on HARQ mode of the DL HP indicated by the DCI) bit widths of one or more fields (e.g., TDRA and/or RV and/or NDI) of the DCI. Example embodiments may improve the UL transmission performance.

An example method comprising: receiving, by a wireless device, a downlink control information (DCI) scheduling transmission of at least two physical uplink shared channels (PUSCHs), wherein the DCI indicates a first hybrid automatic repeat request (HARQ) process ID identifying a first HARQ process; transmitting a first PUSCH, of the at least two PUSCHs, corresponding to the first HARQ process ID; determining, for a second PUSCH of the at least two PUSCHs, a second HARQ process ID based on a HARQ mode of the first HARQ process; and transmitting the second PUSCH, of the at least two PUSCHs, corresponding to the second HARQ process ID.

One or more of the above-example methods further comprising receiving one or more configuration parameters.

One or more of the above-example methods wherein the one or more configuration parameters indicate: a first plurality of HARQ process IDs with a first HARQ mode; and a second plurality of HARQ process IDs with a second HARQ mode.

One or more of the above-example methods wherein: the first HARQ mode is an uplink HARQ mode A, wherein in response to a HARQ mode of a HARQ process being the uplink HARQ mode A, starting, after an initial transmission of an uplink data associated with the HARQ process, monitoring physical downlink control channel (PDCCH) for receiving an uplink grant for retransmission of the uplink data associated with the HARQ process; and the second HARQ mode is an uplink HARQ mode B, wherein in response to a HARQ mode of a HARQ process being the uplink HARQ mode A, not starting, after an initial transmission of an uplink data associated with the HARQ process, monitoring physical downlink control channel (PDCCH) for receiving an uplink grant for retransmission of the uplink data associated with the HARQ process.

One or more of the above-example methods wherein the one or more configuration parameters indicate a first time-domain resource allocation (TDRA) table, wherein the first TDRA table is for scheduling multiple physical uplink shared channels (PUSCHs) with/by a single DCI.

One or more of the above-example methods wherein: the transmitting the first PUSCH of the at least two PUSCHs is further based on the first TDRA table; and the transmitting the second PUSCH of the at least two PUSCHs is further based on the first TDRA table.

One or more of the above-example methods wherein the HARQ mode of the first HARQ process is the first HARQ mode based on the first plurality of HARQ process IDs comprising the first HARQ process ID.

One or more of the above-example methods wherein the HARQ mode of the first HARQ process is the second HARQ mode based on the second plurality of HARQ process IDs comprising the first HARQ process ID.

One or more of the above-example methods wherein a HARQ mode of a second HARQ process, identified with the second HARQ process ID, is same as the HARQ mode of the first HARQ process.

One or more of the above-example methods wherein the second HARQ process ID is further determined based on scheduling order of the second PUSCH among scheduling orders of the at least two PUSCHs.

One or more of the above-example methods wherein the second HARQ process ID differs a first value from the first HARQ process ID.

One or more of the above-example methods further comprising determining: the first value being larger than the scheduling order of the second PUSCH of the at least two PUSCHs based on a first condition being satisfied; or the first value being equal to the scheduling order of the second PUSCH of the at least two PUSCHs based on the first condition not being satisfied.

One or more of the above-example methods wherein the first condition is satisfied in response to determining a third HARQ process, identified with a third HARQ process ID, wherein: a HARQ mode of the third HARQ process is different than the HARQ mode of the first HARQ process; and a difference between the third HARQ process ID and the first HARQ process ID is smaller than the scheduling order of the second PUSCH of the at least two PUSCHs.

One or more of the above-example methods wherein: the first plurality of HARQ process IDs comprise a first number of consecutive HARQ process IDs of a number of HARQ process IDs; and the second plurality of HARQ process IDs comprise a second number of consecutive HARQ process IDs of the number of HARQ process IDs.

One or more of the above-example methods wherein the one or more configuration parameters indicate the number of HARQ process IDs.

One or more of the above-example methods wherein a fourth HARQ process ID of the first plurality of HARQ process IDs is smaller than a fifth HARQ process ID of the second plurality of HARQ process IDs.

One or more of the above-example methods wherein, in response to the HARQ mode of the first HARQ process being the first HARQ mode, the second HARQ process ID is further determined equal to a third value module operation of the first number of consecutive HARQ process IDs, wherein the third value is the first HARQ process ID plus a scheduling order of the second PUSCH of the at least two PUSCHs.

One or more of the above-example methods wherein, in response to the HARQ mode of the first HARQ process being the second HARQ mode, the second HARQ process ID is further determined equal to the first number of consecutive HARQ process IDs plus a fourth value, wherein the fourth value is the first HARQ process ID plus a fifth value module operation of the second number of consecutive HARQ process IDs, wherein the fifth value is a scheduling order of the second PUSCH of the at least two PUSCHs.

One or more of the above-example methods wherein a fourth HARQ process ID of the first plurality of HARQ process IDs is larger than a fifth HARQ process ID of the second plurality of HARQ process IDs.

One or more of the above-example methods wherein, in response to the HARQ mode of the first HARQ process being the second HARQ mode, the second HARQ process ID is further determined equal to a third value module operation of the first number of consecutive HARQ process IDs, wherein the third value is the first HARQ process ID plus a scheduling order of the second PUSCH of the at least two PUSCHs.

One or more of the above-example methods wherein, in response to the HARQ mode of the first HARQ process being the first HARQ mode, the second HARQ process ID is further determined equal to the first number of consecutive HARQ process IDs plus a fourth value, wherein the fourth value is the first HARQ process ID plus a fifth value module operation of the second number of consecutive HARQ process IDs, wherein the fifth value is a scheduling order of the second PUSCH of the at least two PUSCHs.

One or more of the above-example method wherein the one or more configuration parameters indicate a first configuration parameter.

One or more of the above-example methods further comprising determining the first configuration parameter being configured with value enabled.

One or more of the above-example methods further comprising: determining, for a third PUSCH of the at least two PUSCHs and in response to a first condition being satisfied, a third HARQ process ID based on first HARQ process ID and a scheduling order of the third PUSCH of the at least two PUSCHs; and transmitting the third PUSCH, of the at least two PUSCHs, corresponding to the third HARQ process ID.

One or more of the above-example methods wherein the first condition is satisfied based on at least one of: a first configuration parameter being configured with value disabled, wherein the one or more configuration parameters indicate a first configuration parameter; a cardinality of the first plurality of HARQ processes being zero; or a cardinality of the second plurality of HARQ processes being zero.

One or more of the above-example methods further comprising: determining, for a fourth PUSCH of the at least two PUSCHs and in response to a second condition being satisfied, a fourth HARQ process ID based on first HARQ process ID and a scheduling order of the fourth PUSCH of the at least two PUSCHs; and transmitting the fourth PUSCH, of the at least two PUSCHs, corresponding to the fourth HARQ process ID.

One or more of the above-example methods wherein the second condition is satisfied based on at least one of: a first plurality of HARQ processes not being configured; or a second plurality of HARQ processes not being configured.

One or more of the above-example methods wherein the wireless device is operating in a non-terrestrial network (NTN).

An example method comprising: receiving, by a wireless device, a downlink control information (DCI) scheduling reception of at least two physical downlink shared channels (PDSCHs), wherein the DCI indicates a first hybrid automatic repeat request (HARQ) process ID identifying a first HARQ process; receiving a first PDSCH, of the at least two PDSCHs, corresponding to the first HARQ process ID; determining, for a second PDSCH of the at least two PDSCHs, a second HARQ process ID based on a HARQ mode of the first HARQ process; and receiving the second PDSCH, of the at least two PDSCHs, corresponding to the second HARQ process ID.

The above-example method further comprising receiving one or more configuration parameters.

One or more of the above-example methods wherein the one or more configuration parameters indicate: a first plurality of HARQ process IDs with a first HARQ mode; and a second plurality of HARQ process IDs with a second HARQ mode.

One or more of the above-example methods wherein: the first HARQ mode is a HARQ enabled feedback, wherein a HARQ mode of a HARQ process is the HARQ enabled feedback when a HARQ feedback of the HARQ process is enabled; and the second HARQ mode sis a HARQ disabled feedback, wherein a HARQ mode of a HARQ process is the HARQ disabled feedback when a HARQ feedback of the HARQ process is disabled.

One or more of the above-example methods wherein the one or more configuration parameters indicate a second time-domain resource allocation (TDRA) table, wherein the second TDRA table is for scheduling multiple physical downlink shared channels (PDSCHs) with/by a single DCI.

One or more of the above-example methods wherein: the receiving the first PDSCH of the at least two PDSCHs is further based on the second TDRA table; and the receiving the second PDSCH of the at least two PDSCHs is further based on the second TDRA table.

One or more of the above-example methods wherein the HARQ mode of the first HARQ process is the first HARQ mode based on the first plurality of HARQ process IDs comprising the first HARQ process ID.

One or more of the above-example methods wherein the HARQ mode of the first HARQ process is the second HARQ mode based on the second plurality of HARQ process IDs comprising the first HARQ process ID.

One or more of the above-example methods wherein a HARQ mode of a second HARQ process, identified with the second HARQ process ID, is same as the HARQ mode of the first HARQ process.

One or more of the above-example methods wherein the second HARQ process ID is further determined based on scheduling order of the second PDSCH among scheduling orders of the at least two PDSCH s.

One or more of the above-example methods wherein the second HARQ process ID differs a first value from the first HARQ process ID.

One or more of the above-example methods further comprising determining: the first value being larger than the scheduling order of the second PDSCH of the at least two PDSCH s based on a first condition being satisfied; or the first value being equal to the scheduling order of the second PDSCH of the at least two PDSCH s based on the first condition not being satisfied.

One or more of the above-example methods wherein the first condition is satisfied in response to determining a third HARQ process, identified with a third HARQ process ID, wherein: a HARQ mode of the third HARQ process is different than the HARQ mode of the first HARQ process; and a difference between the third HARQ process ID and the first HARQ process ID is smaller than the scheduling order of the second PDSCH of the at least two PDSCHs.

One or more of the above-example methods wherein: the first plurality of HARQ process IDs comprise a first number of consecutive HARQ process IDs of a number of HARQ process IDs; and the second plurality of HARQ process IDs comprise a second number of consecutive HARQ process IDs of the number of HARQ process IDs.

One or more of the above-example methods wherein the one or more configuration parameters indicate the number of HARQ process IDs.

One or more of the above-example methods wherein a fourth HARQ process ID of the first plurality of HARQ process IDs is smaller than a fifth HARQ process ID of the second plurality of HARQ process IDs.

One or more of the above-example methods wherein, in response to the HARQ mode of the first HARQ process being the first HARQ mode, the second HARQ process ID is further determined equal to a third value module operation of the first number of consecutive HARQ process IDs, wherein the third value is the first HARQ process ID plus a scheduling order of the second PDSCH of the at least two PDSCHs.

One or more of the above-example methods in response to the HARQ mode of the first HARQ process being the second HARQ mode, the second HARQ process ID is further determined equal to the first number of consecutive HARQ process IDs plus a fourth value, wherein the fourth value is the first HARQ process ID plus a fifth value module operation of the second number of consecutive HARQ process IDs, wherein the fifth value is a scheduling order of the second PDSCH of the at least two PDSCHs.

One or more of the above-example methods wherein a fourth HARQ process ID of the first plurality of HARQ process IDs is larger than a fifth HARQ process ID of the second plurality of HARQ process IDs.

One or more of the above-example methods wherein, in response to the HARQ mode of the first HARQ process being the second HARQ mode, the second HARQ process ID is further determined equal to a third value module operation of the first number of consecutive HARQ process IDs, wherein the third value is the first HARQ process ID plus a scheduling order of the second PDSCH of the at least two PDSCHs.

One or more of the above-example methods wherein, in response to the HARQ mode of the first HARQ process being the first HARQ mode, the second HARQ process ID is further determined equal to the first number of consecutive HARQ process IDs plus a fourth value, wherein the fourth value is the first HARQ process ID plus a fifth value module operation of the second number of consecutive HARQ process IDs, wherein the fifth value is a scheduling order of the second PDSCH of the at least two PDSCHs.

One or more of the above-example methods wherein the one or more configuration parameters indicate a first configuration parameter.

One or more of the above-example methods further comprising determining the first configuration parameter being configured with value enabled.

One or more of the above-example methods further comprising: determining, for a third PDSCH of the at least two PDSCHs and in response to a first condition being satisfied, a third HARQ process ID based on first HARQ process ID and a scheduling order of the third PDSCHof the at least two PDSCHs; and receiving the third PDSCH, of the at least two PDSCHs, corresponding to the third HARQ process ID.

One or more of the above-example methods wherein the first condition is satisfied based on at least one of: a first configuration parameter being configured with value disabled, wherein the one or more configuration parameters indicate a first configuration parameter; a cardinality of the first plurality of HARQ processes being zero; or a cardinality of the second plurality of HARQ processes being zero.

One or more of the above-example methods further comprising: determining, for a fourth PDSCH of the at least two PDSCHs and in response to a second condition being satisfied, a fourth HARQ process ID based on first HARQ process ID and a scheduling order of the fourth PDSCH of the at least two PDSCHs; and receiving the fourth PDSCH, of the at least two PDSCHs, corresponding to the fourth HARQ process ID.

One or more of the above-example methods wherein the second condition is satisfied based on at least one of: a first plurality of HARQ processes not being configured; or a second plurality of HARQ processes not being configured.

One or more of the above-example methods wherein the wireless device is operating in a non-terrestrial network (NTN).

An example method comprising: receiving, by a wireless device, a downlink control information (DCI) scheduling communication of at least two transport blocks (TBs), wherein the DCI indicates a first hybrid automatic repeat request (HARQ) process ID identifying a first HARQ process; communicating, to a base station, a first TB, of the at least two TBs, corresponding to the first HARQ process ID; determining, for a second TB of the at least two TBs, a second HARQ process ID based on a HARQ mode of the first HARQ process; and communicating the second TB, of the at least two TBs, corresponding to the second HARQ process ID.

The above-example method further comprising receiving one or more configuration parameters.

One or more of the above-example methods wherein the one or more configuration parameters indicate: a first plurality of HARQ process IDs with a first HARQ mode; and a second plurality of HARQ process IDs with a second HARQ mode.

One or more of the above-example methods wherein: the first HARQ mode is an uplink HARQ mode A, wherein in response to a HARQ mode of a HARQ process being the uplink HARQ mode A, starting, after an initial transmission of an uplink data associated with the HARQ process, monitoring physical downlink control channel (PDCCH) for receiving an uplink grant for retransmission of the uplink data associated with the HARQ process; and the second HARQ mode is an uplink HARQ mode B, wherein in response to a HARQ mode of a HARQ process being the uplink HARQ mode A, not starting, after an initial transmission of an uplink data associated with the HARQ process, monitoring physical downlink control channel (PDCCH) for receiving an uplink grant for retransmission of the uplink data associated with the HARQ process.

One or more of the above-example methods wherein communicating the first TB of the at least two TBs comprises transmitting the first TB of the at least two TBs.

One or more of the above-example methods wherein the one or more configuration parameters indicate a first time-domain resource allocation (TDRA) table, wherein the first TDRA table is for scheduling multiple physical uplink shared channels (PUSCHs) with/by a single DCI.

One or more of the above-example methods wherein the communicating the first TB of the at least two TBs is further based on the first TDRA table.

One or more of the above-example methods wherein: the first HARQ mode is a HARQ enabled feedback, wherein a HARQ mode of a HARQ process is the HARQ enabled feedback when a HARQ feedback of the HARQ process is enabled; and the second HARQ mode sis a HARQ disabled feedback, wherein a HARQ mode of a HARQ process is the HARQ disabled feedback when a HARQ feedback of the HARQ process is disabled.

One or more of the above-example methods wherein communicating the first TB, of the at least two TBs, comprises receiving the first TB of the at least two TBs.

One or more of the above-example methods wherein the one or more configuration parameters indicate a second time-domain resource allocation (TDRA) table, wherein the second TDRA table is for scheduling multiple physical downlink shared channels (PDSCHs) with/by a single DCI.

One or more of the above-example methods wherein the communicating the first TB of the at least two TBs is further based on the second TDRA table.

One or more of the above-example methods wherein the HARQ mode of the first HARQ process is the first HARQ mode based on the first plurality of HARQ process IDs comprising the first HARQ process ID.

One or more of the above-example methods wherein the HARQ mode of the first HARQ process is the second HARQ mode based on the second plurality of HARQ process IDs comprising the first HARQ process ID.

One or more of the above-example methods wherein a HARQ mode of a second HARQ process, identified with the second HARQ process ID, is same as the HARQ mode of the first HARQ process.

One or more of the above-example methods wherein the second HARQ process ID is further determined based on scheduling order of the second TB among scheduling orders of the at least two TBs.

One or more of the above-example methods wherein the second HARQ process ID differs a first value from the first HARQ process ID.

One or more of the above-example methods further comprising determining: the first value being larger than the scheduling order of the second TB of the at least two TBs based on a first condition being satisfied; or the first value being equal to the scheduling order of the second TB of the at least two TBs based on the first condition not being satisfied.

One or more of the above-example methods wherein the first condition is satisfied in response to determining a third HARQ process, identified with a third HARQ process ID, wherein: a HARQ mode of the third HARQ process is different than the HARQ mode of the first HARQ process; and a difference between the third HARQ process ID and the first HARQ process ID is smaller than the scheduling order of the second TB of the at least two TBs.

One or more of the above-example methods wherein: the first plurality of HARQ process IDs comprise a first number of consecutive HARQ process IDs of a number of HARQ process IDs; and the second plurality of HARQ process IDs comprise a second number of consecutive HARQ process IDs of the number of HARQ process IDs.

One or more of the above-example methods wherein the one or more configuration parameters indicate the number of HARQ process IDs.

One or more of the above-example methods wherein a fourth HARQ process ID of the first plurality of HARQ process IDs is smaller than a fifth HARQ process ID of the second plurality of HARQ process IDs.

One or more of the above-example methods wherein, in response to the HARQ mode of the first HARQ process being the first HARQ mode, the second HARQ process ID is further determined equal to a third value module operation of the first number of consecutive HARQ process IDs, wherein the third value is the first HARQ process ID plus a scheduling order of the second TB of the at least two TBs.

One or more of the above-example methods wherein, in response to the HARQ mode of the first HARQ process being the second HARQ mode, the second HARQ process ID is further determined equal to the first number of consecutive HARQ process IDs plus a fourth value, wherein the fourth value is the first HARQ process ID plus a fifth value module operation of the second number of consecutive HARQ process IDs, wherein the fifth value is a scheduling order of the second TB of the at least two TBs.

One or more of the above-example methods wherein a fourth HARQ process ID of the first plurality of HARQ process IDs is larger than a fifth HARQ process ID of the second plurality of HARQ process IDs.

One or more of the above-example methods wherein, in response to the HARQ mode of the first HARQ process being the second HARQ mode, the second HARQ process ID is further determined equal to a third value module operation of the first number of consecutive HARQ process IDs, wherein the third value is the first HARQ process ID plus a scheduling order of the second TB of the at least two TBs.

One or more of the above-example methods wherein, in response to the HARQ mode of the first HARQ process being the first HARQ mode, the second HARQ process ID is further determined equal to the first number of consecutive HARQ process IDs plus a fourth value, wherein the fourth value is the first HARQ process ID plus a fifth value module operation of the second number of consecutive HARQ process IDs, wherein the fifth value is a scheduling order of the second TB of the at least two TBs.

One or more of the above-example methods wherein the one or more configuration parameters indicate a first configuration parameter.

One or more of the above-example methods further comprising determining the first configuration parameter being configured with value enabled.

One or more of the above-example methods further comprising: determining, for a third TB of the at least two TBs and in response to a first condition being satisfied, a third HARQ process ID based on first HARQ process ID and a scheduling order of the third TB of the at least two TBs; and communicating the third TB, of the at least two TBs, corresponding to the third HARQ process ID.

One or more of the above-example methods wherein the first condition is satisfied based on at least one of: a first configuration parameter being configured with value disabled, wherein the one or more configuration parameters indicate a first configuration parameter; a cardinality of the first plurality of HARQ processes being zero; or a cardinality of the second plurality of HARQ processes being zero.

One or more of the above-example methods further comprising: determining, for a fourth TB of the at least two TBs and in response to a second condition being satisfied, a fourth HARQ process ID based on first HARQ process ID and a scheduling order of the fourth TB of the at least two TBs; and communicating the fourth TB, of the at least two TBs, corresponding to the fourth HARQ process ID.

One or more of the above-example methods wherein the second condition is satisfied based on at least one of: a first plurality of HARQ processes not being configured; or a second plurality of HARQ processes not being configured.

One or more of the above-example methods wherein the wireless device is operating in a non-terrestrial network (NTN).

An example method comprising: receiving, by a wireless device, a downlink control information (DCI) scheduling transmission or reception of at least two transport blocks (TBs), wherein the DCI indicates a first hybrid automatic repeat request (HARQ) process ID identifying a first HARQ process; determining: a first HARQ information based on the first HARQ process ID; and a second HARQ information based on a HARQ mode of the first HARQ process; and transmitting or receiving: a first TB of the at least two TBs based on the first HARQ information; and a second TB of the at least two TBs based on the second HARQ information.

An example method comprising: receiving, by a wireless device, one or more configuration parameters indicating: a first plurality of HARQ process IDs with a first HARQ mode; and a second plurality of HARQ process IDs with a second HARQ mode; and receiving a downlink control information (DCI) scheduling transmission or reception of at least two transport blocks (TBs), wherein the DCI indicates a first hybrid automatic repeat request (HARQ) process ID identifying a first HARQ process; transmitting or receiving a first TB, of the at least two TBs, corresponding to the first HARQ process ID; determining, for a second TB of the at least two TBs, a second HARQ process ID based on whether a HARQ mode of the first HARQ process is the first HARQ mode or the second HARQ mode; and transmitting or receiving the second TB, of the at least two TBs, corresponding to the second HARQ process ID.

An example method comprising: receiving, by a wireless device, one or more configuration parameters indicating: a first plurality of HARQ process IDs with a first HARQ mode; and a second plurality of HARQ process IDs with a second HARQ mode; and receiving a downlink control information (DCI) scheduling transmission of at least two physical uplink shared channels (PUSCHs), wherein the DCI indicates a first hybrid automatic repeat request (HARQ) process ID identifying a first HARQ process; transmitting a first PUSCH, of the at least two PUSCHs, corresponding to the first HARQ process ID; determining, for a second PUSCH of the at least two PUSCHs, a second HARQ process ID based on whether a HARQ mode of the first HARQ process is the first HARQ mode or the second HARQ mode; and transmitting the second PUSCH, of the at least two PUSCHs, corresponding to the second HARQ process ID.

An example method comprising: receiving, by a wireless device, one or more configuration parameters indicating: a first plurality of HARQ process IDs with a first HARQ mode; and a second plurality of HARQ process IDs with a second HARQ mode; and receiving a downlink control information (DCI) scheduling reception of at least two physical downlink shared channels (PDSCHs), wherein the DCI indicates a first hybrid automatic repeat request (HARQ) process ID identifying a first HARQ process; receiving a first PDSCH, of the at least two PDSCHs, corresponding to the first HARQ process ID; determining, for a second PDSCH of the at least two PDSCHs, a second HARQ process ID based on whether a HARQ mode of the first HARQ process is the first HARQ mode or the second HARQ mode; and receiving the second PDSCH, of the at least two PDSCHs, corresponding to the second HARQ process ID.

An example method comprising: receiving, by a wireless device, one or more configuration parameters indicating at least one of: a first plurality of HARQ process IDs corresponding to a first HARQ mode; and a second plurality of HARQ process IDs corresponding to a second HARQ mode; receiving a downlink control information (DCI) scheduling PUSCH transmissions, wherein the DCI indicates a HARQ process ID; determining a number of the PUSCH transmissions based on whether the first plurality of HARQ process IDs or the second plurality of the HARQ process ID comprises the HARQ process ID; and transmitting the number of PUSCH transmissions.

The above-example method wherein: the first HARQ mode is an uplink HARQ mode A, wherein in response to a HARQ mode of a HARQ process being the uplink HARQ mode A, starting, after an initial transmission of an uplink data associated with the HARQ process, monitoring physical downlink control channel (PDCCH) for receiving an uplink grant for retransmission of the uplink data associated with the HARQ process; and the second HARQ mode is an uplink HARQ mode B, wherein in response to a HARQ mode of a HARQ process being the uplink HARQ mode A, not starting, after an initial transmission of an uplink data associated with the HARQ process, monitoring physical downlink control channel (PDCCH) for receiving an uplink grant for retransmission of the uplink data associated with the HARQ process.

One or more of the above-example methods wherein the one or more configuration parameters indicate a time-domain resource allocation (TDRA) table for multiple physical uplink shared channels (PUSCHs).

One or more of the above-example methods wherein the determining the number of the PUSCH transmissions is further based on a number of entries of the TDRA table for multiple PUSCHs.

One or more of the above-example methods wherein in response to the first plurality of HARQ process IDs comprising the HARQ process ID, the number of the PUSCH transmissions is based on a minimum of a first value and the number of the entries of the TDRA table for multiple PUSCHs.

One or more of the above-example methods wherein the first value is a cardinality of the first plurality of HARQ process IDs.

One or more of the above-example methods wherein the first value is a number of consecutive HARQ process IDs in the first plurality of HARQ process IDs starting from the first HARQ process ID.

One or more of the above-example methods wherein in response to the second plurality of HARQ process IDs comprising the HARQ process ID, the number of the PUSCH transmissions is based on a minimum of a second value and the number of the entries of the TDRA table for multiple PUSCHs.

One or more of the above-example methods wherein the second value is a cardinality of the second plurality of HARQ process IDs.

One or more of the above-example methods wherein the second value is a number of consecutive HARQ process IDs in the second plurality of HARQ process IDs starting from the first HARQ process ID.

One or more of the above-example methods wherein in response to the second plurality of HARQ process IDs comprising the HARQ process ID, the number of the PUSCH transmissions is based on a number of the entries of the TDRA table for multiple PUSCHs.

One or more of the above-example methods wherein the one or more configuration parameters indicate a first configuration parameter.

One or more of the above-example methods further comprising determining the first configuration parameter being enabled.

One or more of the above-example methods further comprising: receiving a second DCI scheduling PUSCH transmissions; determining, in response to a first condition being satisfied, a number of PUSCH transmissions based on a number of entries of a TDRA table for multiple PUSCHs; and transmitting the number of PUSCH transmissions.

One or more of the above-example methods wherein the first condition is satisfied based on determining a first configuration parameter being disabled, wherein the one or more configuration parameters indicate the first configuration parameter.

One or more of the above-example methods wherein the first condition is satisfied based on determining a cardinality of a first plurality of HARQ processes being zero.

One or more of the above-example methods wherein the first condition is satisfied based on determining a cardinality of a second plurality of HARQ processes being zero.

One or more of the above-example methods wherein the first condition is satisfied based on determining the one or more configuration parameters not indicating at least one of: a first plurality of HARQ processes; or a second plurality of HARQ processes.

One or more of the above-example methods further comprising determining a bit width of a first field of the DCI, wherein the first field of the DCI is at least one of: a TDRA field of the DCI; a new data indicator (NDI) field of the DCI; or a redundancy version (RV) field of the DCI.

One or more of the above-example methods wherein the determining the bit width of the first field of the DCI is based on at least one of: a first value, wherein the first value is either of: a cardinality of the first plurality of HARQ process IDs; or a number of consecutive HARQ process IDs in the first plurality of HARQ process IDs starting from the first HARQ process ID; a second value, wherein the second value is either of: a cardinality of the second plurality of HARQ process IDs; or a number of consecutive HARQ process IDs in the second plurality of HARQ process IDs starting from the first HARQ process ID; and a number of entries of a TDRA table for multiple PUSCHs.

One or more of the above-example methods wherein: in response to the first plurality of HARQ process IDs comprising the HARQ process ID, the bit width of the first field of the DCI is based on a minimum of the first value and the number of the entries of the TDRA table for multiple PUSCHs; and in response to the second plurality of HARQ process IDs comprising the HARQ process ID, the bit width of the first field of the DCI is based on a minimum of the second value and the number of the entries of the TDRA table for multiple PUSCHs.

One or more of the above-example methods further comprising: determining a bit width of the field of the DCI based on a number of entries of the TDRA table for multiple PUSCHs; and ignoring a number of bits of the field of the DCI from the determined bit width of the field of the DCI.

One or more of the above-example methods further comprising determining the number based on at least one of: a first value, wherein the first value is either of: a cardinality of the first plurality of HARQ process IDs; or a number of consecutive HARQ process IDs in the first plurality of HARQ process IDs starting from the first HARQ process ID; a second value, wherein the second value is either of: a cardinality of the second plurality of HARQ process IDs; or a number of consecutive HARQ process IDs in the second plurality of HARQ process IDs starting from the first HARQ process ID; and a number of entries of the TDRA table for multiple PUSCHs.

One or more of the above-example methods wherein: in response to the first plurality of HARQ process IDs comprising the HARQ process ID, the number is based on a difference between the number of the entries of the TDRA table for multiple PUSCHs and a third value, wherein the third value is a minimum of the first value and the number of the entries of the TDRA table for multiple PUSCHs; and in response to the second plurality of HARQ process IDs comprising the HARQ process ID, number is based on a difference between the number of the entries of the TDRA table for multiple PUSCHs and a fourth value, wherein the fourth value is a minimum of the second value and the number of the entries of the TDRA table for multiple PUSCHs.

One or more of the above-example methods further comprising determining a size of the DCI based on a number of the entries of a TDRA table for multiple PUSCHs.

One or more of the above-example methods wherein the determining the size of the DCI is further based on a number of configured HARQ processes.

One or more of the above-example methods wherein the determining the size of the DCI is further based on a cardinality of the first plurality of HARQ process IDs.

One or more of the above-example methods wherein the size of the DCI is based on a minimum of the cardinality of the first plurality of HARQ process IDs and the number of the entries of the TDRA table for multiple PUSCHs.

One or more of the above-example methods wherein the size of the DCI is based on a maximum of the cardinality of the first plurality of HARQ process IDs and the number of the entries of the TDRA table for multiple PUSCHs.

One or more of the above-example methods further comprising determining the first HARQ process ID being in the first plurality of HARQ process IDs.

One or more of the above-example methods wherein the determining the size of the DCI is further based on a cardinality of the second plurality of HARQ process IDs.

One or more of the above-example methods wherein the size of the DCI is based on a minimum of the cardinality of the second plurality of HARQ process IDs and the number of the entries of the TDRA table for multiple PUSCHs.

One or more of the above-example methods wherein the size of the DCI is based on a maximum of the cardinality of the second plurality of HARQ process IDs and the number of the entries of the TDRA table for multiple PUSCHs.

One or more of the above-example methods further comprising determining the first HARQ process ID being in the second plurality of HARQ process IDs.

One or more of the above-example methods wherein the wireless device is operating in a non-terrestrial network (NTN).

An example method comprising: receiving, by a wireless device, one or more configuration parameters indicating at least one of: a first plurality of HARQ process IDs corresponding to a first HARQ mode; and a second plurality of HARQ process IDs corresponding to a second HARQ mode; receiving a downlink control information (DCI) scheduling PDSCH transmissions, wherein the DCI indicates a HARQ process ID; determining a number of the PDSCH transmissions based on whether the first plurality of HARQ process IDs or the second plurality of the HARQ process ID comprises the HARQ process ID; and receiving the number of PDSCH transmissions.

The above-example method wherein: the first HARQ mode is a HARQ enabled feedback; and the second HARQ mode is a HARQ disabled feedback.

One or more of the above-example methods wherein the one or more configuration parameters indicate a time-domain resource allocation (TDRA) table for multiple physical downlink shared channels (PDSCHs).

One or more of the above-example methods wherein the determining the number of the PDSCH transmissions is further based on a number of entries of the TDRA table for multiple PDSCHs.

One or more of the above-example methods wherein in response to the first plurality of HARQ process IDs comprising the HARQ process ID, the number of the PDSCH transmissions is based on a minimum of a first value and the number of the entries of the TDRA table for multiple PDSCHs.

One or more of the above-example methods wherein the first value is a cardinality of the first plurality of HARQ process IDs.

One or more of the above-example methods wherein the first value is a number of consecutive HARQ process IDs in the first plurality of HARQ process IDs starting from the first HARQ process ID.

One or more of the above-example methods wherein in response to the second plurality of HARQ process IDs comprising the HARQ process ID, the number of the PDSCH transmissions is based on a minimum of a second value and the number of the entries of the TDRA table for multiple PDSCHs.

One or more of the above-example methods wherein the second value is a cardinality of the second plurality of HARQ process IDs.

One or more of the above-example methods wherein the second value is a number of consecutive HARQ process IDs in the second plurality of HARQ process IDs starting from the first HARQ process ID.

One or more of the above-example methods wherein in response to the second plurality of HARQ process IDs comprising the HARQ process ID, the number of the PDSCH transmissions is based on a number of the entries of the TDRA table for multiple PDSCHs.

One or more of the above-example methods wherein the one or more configuration parameters indicate a first configuration parameter.

One or more of the above-example methods further comprising determining the first configuration parameter being enabled.

One or more of the above-example methods further comprising: receiving a second DCI scheduling PDSCH transmissions; determining, in response to a first condition being satisfied, a number of PDSCH transmissions based on a number of entries of a TDRA table for multiple PDSCHs; and transmitting the number of PDSCH transmissions.

One or more of the above-example methods wherein the first condition is satisfied based on determining a first configuration parameter being disabled, wherein the one or more configuration parameters indicate the first configuration parameter.

One or more of the above-example methods wherein the first condition is satisfied based on determining a cardinality of the first plurality of HARQ processes being zero.

One or more of the above-example methods wherein the first condition is satisfied based on determining a cardinality of the second plurality of HARQ processes being zero.

One or more of the above-example methods wherein the first condition is satisfied based on determining the one or more configuration parameters not indicating at least one of: the first plurality of HARQ processes; or the second plurality of HARQ processes.

One or more of the above-example methods further comprising determining a bit width of a first field of the DCI, wherein the first field of the DCI is at least one of: a TDRA field of the DCI; a new data indicator (NDI) field of the DCI; or a redundancy version (RV) field of the DCI.

One or more of the above-example methods wherein the determining the bit width of the first field of the DCI is based on at least one of: a first value, wherein the first value is either of: a cardinality of the first plurality of HARQ process IDs; or a number of consecutive HARQ process IDs in the first plurality of HARQ process IDs starting from the first HARQ process ID; a second value, wherein the second value is either of: a cardinality of the second plurality of HARQ process IDs; or a number of consecutive HARQ process IDs in the second plurality of HARQ process IDs starting from the first HARQ process ID; and a number of entries of a TDRA table for multiple PDSCHs.

One or more of the above-example methods, wherein: in response to the first plurality of HARQ process IDs comprising the HARQ process ID, the bit width of the first field of the DCI is based on a minimum of the first value and the number of the entries of the TDRA table for multiple PDSCHs; and in response to the second plurality of HARQ process IDs comprising the HARQ process ID, the bit width of the first field of the DCI is based on a minimum of the second value and the number of the entries of the TDRA table for multiple PDSCHs.

One or more of the above-example methods further comprising: determining a bit width of the field of the DCI based on a number of entries of a TDRA table for multiple PDSCHs; and ignoring a number of bits of the first field of the DCI from the determined bit width of the first field of the DCI.

One or more of the above-example methods further comprising determining the number based on at least one of: a first value, wherein the first value is either of: a cardinality of the first plurality of HARQ process IDs; or a number of consecutive HARQ process IDs in the first plurality of HARQ process IDs starting from the first HARQ process ID; a second value, wherein the second value is either of: a cardinality of the second plurality of HARQ process IDs; or a number of consecutive HARQ process IDs in the second plurality of HARQ process IDs starting from the first HARQ process ID; and a number of entries of the TDRA table for multiple PDSCHs.

One or more of the above-example methods wherein: in response to the first plurality of HARQ process IDs comprising the HARQ process ID, the number is based on a difference between the number of the entries of the TDRA table for multiple PDSCHs and a third value, wherein the third value is a minimum of the first value and the number of the entries of the TDRA table for multiple PDSCHs; and in response to the second plurality of HARQ process IDs comprising the HARQ process ID, number is based on a difference between the number of the entries of the TDRA table for multiple PDSCHs and a fourth value, wherein the fourth value is a minimum of the second value and the number of the entries of the TDRA table for multiple PDSCHs.

One or more of the above-example methods further comprising determining a size of the DCI based on a number of the entries of a TDRA table for multiple PDSCHs.

One or more of the above-example methods wherein the determining the size of the DCI is further based on a number of configured HARQ processes.

One or more of the above-example methods wherein the determining the size of the DCI is further based on a cardinality of the first plurality of HARQ process IDs.

One or more of the above-example methods wherein the size of the DCI is based on a minimum of the cardinality of the first plurality of HARQ process IDs and the number of the entries of the TDRA table for multiple PDSCHs.

One or more of the above-example methods wherein the size of the DCI is based on a maximum of the cardinality of the first plurality of HARQ process IDs and the number of the entries of the TDRA table for multiple PUSCHs.

One or more of the above-example methods further comprising determining the first HARQ process ID being in the first plurality of HARQ process IDs.

One or more of the above-example methods wherein the determining the size of the DCI is further based on a cardinality of the second plurality of HARQ process IDs.

One or more of the above-example methods wherein the size of the DCI is based on a minimum of the cardinality of the second plurality of HARQ process IDs and the number of the entries of the TDRA table for multiple PDSCHs.

One or more of the above-example methods wherein the size of the DCI is based on a maximum of the cardinality of the second plurality of HARQ process IDs and the number of the entries of the TDRA table for multiple PDSCHs.

One or more of the above-example methods further comprising determining the first HARQ process ID being in the second plurality of HARQ process IDs.

One or more of the above-example methods wherein the wireless device is operating in a non-terrestrial network (NTN).

What is claimed is:

1. A wireless device comprising:
one or more processors; and
memory storing instructions that, when executed by the one or more processors, cause the wireless device to:
receive one or more configuration parameters for disabling hybrid automatic repeat request (HARQ) feedback, wherein the one or more configuration parameters indicate:
one or more feedback enabled downlink HARQ processes; and
one or more feedback disabled downlink HARQ processes;
receive a downlink control information (DCI) scheduling multiple transport blocks (TBs);
receive the multiple TBs; and
transmit multiple HARQ-acknowledgments (HARQ-ACKs) information corresponding to the multiple TBs, wherein a HARQ process, associated with a first TB of the multiple TBs, is a feedback disabled HARQ process.

2. The wireless device of claim 1, wherein the one or more feedback disabled downlink HARQ processes comprises the HARQ process.

3. The wireless device of claim 1, wherein transmitting the multiple HARQ-ACKs information is in response to the HARQ process being the feedback disabled HARQ process.

4. The wireless device of claim 1, wherein the DCI indicates the HARQ process.

5. The wireless device of claim 1, wherein the wireless device is in a non-terrestrial network (NTN) serving cell.

6. The wireless device of claim 1, wherein the instructions further cause the wireless device to receive one or more NTN configuration parameters comprising a cell-specific scheduling offset of an NTN, wherein the receiving the multiple HARQ-ACKs information is further based on the cell-specific scheduling offset.

7. The wireless device of claim 1, wherein transmitting the multiple HARQ-ACKs information is via one or more physical uplink control channel (PUCCH) transmission occasions.

8. A base station comprising:
one or more processors; and
memory storing instructions that, when executed by the one or more processors, cause the base station to:
transmit, to a wireless device, one or more configuration parameters for disabling hybrid automatic repeat request (HARQ) feedback, wherein the one or more configuration parameters indicate:
one or more feedback enabled downlink HARQ processes; and
one or more feedback disabled downlink HARQ processes;
transmit to the wireless device a downlink control information (DCI) scheduling multiple transport blocks (TBs);
transmit the multiple TBs; and
receive, from the wireless device, multiple HARQ-acknowledgments (HARQ-ACKs) information corresponding to the multiple TBs, wherein a HARQ process, associated with a first TB of the multiple TBs, is a feedback disabled HARQ process.

9. The base station of claim 8, wherein the one or more feedback disabled downlink HARQ processes comprises the HARQ process.

10. The base station of claim 8, wherein the receiving the multiple HARQ-ACKs information is in response to the HARQ process being the feedback disabled HARQ process.

11. The base station of claim 8, wherein the DCI indicates the HARQ process.

12. The base station of claim 8, wherein the wireless device is in a non-terrestrial network (NTN) serving cell.

13. The base station of claim 8, wherein the instructions further cause the base station to transmit, to the wireless device, one or more NTN configuration parameters comprising a cell-specific scheduling offset of an NTN, wherein the receiving the multiple HARQ-ACKs information is further based on the cell-specific scheduling offset.

14. The base station of claim 8, wherein receiving the multiple HARQ-ACKs information is via one or more physical uplink control channel (PUCCH) transmission occasions.

15. A non-transitory computer-readable medium comprising instructions that, when executed by one or more processors of a wireless device, cause the wireless device to:
receive one or more configuration parameters for disabling hybrid automatic repeat request (HARQ) feedback, wherein the one or more configuration parameters indicate:
one or more feedback enabled downlink HARQ processes; and
one or more feedback disabled downlink HARQ processes;
receive a downlink control information (DCI) scheduling multiple transport blocks (TBs);
receive the multiple TBs; and
transmit multiple HARQ-acknowledgments (HARQ-ACKs) information corresponding to the multiple TBs, wherein a HARQ process, associated with a first TB of the multiple TBs, is a feedback disabled HARQ process.

16. The non-transitory computer-readable medium of claim 15, wherein the one or more feedback disabled downlink HARQ processes comprises the HARQ process.

17. The non-transitory computer-readable medium of claim 15, wherein transmitting the multiple HARQ-ACKs information is in response to the HARQ process being the feedback disabled HARQ process.

18. The non-transitory computer-readable medium of claim 15, wherein the DCI indicates the HARQ process.

19. The non-transitory computer-readable medium of claim 15, wherein the wireless device is in a non-terrestrial network (NTN) serving cell.

20. The non-transitory computer-readable medium of claim 15, wherein the instructions further cause the wireless device to receive one or more NTN configuration parameters comprising a cell-specific scheduling offset of an NTN, wherein the receiving the multiple HARQ-ACKs information is further based on the cell-specific scheduling offset.
